(19) United States
(12) Patent Application Publication
(10) Pub. No.: US 2005/0108052 A1
(43) Pub. Date: May 19, 2005

(54) Proces for diagnosic system and method applying artificial intelligence techniques to a patient medical record and that combines customer relationship management (CRM) and enterprise resource planning (ERP) software in a revolutionary way to provide a unique-and uniquely powerful and easy-to-use-tool to manage veterinary or human medical clinics and hospitals

(76) Inventor: Nortey Jean Omaboe, Marchissy (CH)

Correspondence Address: NORTEY OMABOE, ROUTE SUISSE 9, MIES, VAUD, 1295, CH

(21) Appl. No.: 10/970,445

(22) Filed: Oct. 22, 2004

Related U.S. Application Data
(60) Provisional application No. 60/516,266, filed on Nov. 3, 2003.

(51) Int. Cl. G06F 17/60

(52) U.S. Cl. 705/2

(57) ABSTRACT

This medical (human and veterinary) CRM and ERP software affects every step of patient interaction: marketing, sales or service-related. It allows management of the workload by distributing the chores among staff members and automates medical and business processes through workflow rules. It enables users to view and update tasks, medical cases, appointments, sales, phone calls, faxes, emails, letters and automatic input of lab results into the patient's medical record. It also serves the needs of people in human resources; finance and inventory control, and integrates with Microsoft Word, Outlook, Excel, Great Plains and other business systems. It delivers detailed diagnostic differentials associated with a likelihood of their applicability to the given patients' record and physician's experience in his contextual situation; selects the most appropriate diagnostic procedures; offers the possibility for the user to implement context-sensitive tutorials; presents a context-sensitive source of information on diseases and medical procedures.

### CROSS REFERENCE TO RELATED APPLICATIONS

This application is based on provisional application Ser. No. 60/516266, filed on Nov. 3, 2003.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND OF THE INVENTION

This invention relates generally to the field of medicine and more specifically to a process for diagnostic system and method applying artificial intelligence techniques to a patent medical record and that combines customer relationship management (CRM) and enterprise resource planning (ERP) in a revolutionary way to provide unique and uniquely powerful and easy-to-use-tool to manage veterinary or human medical clinics and hospitals.

Dr. med. vet. Nortey Omaboe received his Veterinary Diploma from the University of Bern, Switzerland and performed his residency in Diagnostic Pathology at the University of Bern, where he also served as Assistant in Clinical Neurology.

His additional professional training includes a Doctorate in Cardiomyopathy from the University of Bern; post-graduate intensive training at the Animal Medical Center of New York; post-graduate intensive training with the world-famous veterinary surgeon Dr De Angelis ACVS; post-graduate training in echography; Diploma in Acupuncture; Moxibustion and Chinese Medicine from the Traditional Chinese Medicine Institute of Peking; Diploma of Specialist for evaluation of dangerous dogs, and three years of post-graduate training in animal behaviour.

Dr Omaboes' passions are medicine and computer development, both of which are reflected in the uniqueness of this invention called: Pygmalion Concept (trademark rights reserved). Whereas other medical software on the market have been produced either by IT people that have little knowledge of the medical profession or by doctors who understand little about computers, these programs are often not much more than “glorified filling systems and cash registers”. Pygmalion Concept (trademark rights reserved), on the other hand is the result of Dr Omaboes' 26 years of medical training and over 20,000 hours of program development and combines the best medical and IT knowledge to offer a truly revolutionary approach to managing a modern medical practice.

This invention relates to medical systems for diagnosis, and, more particularly, to programs aiding physicians and veterinarians in automatically diagnosing the medical problem/disease of a patient.

U.S. Pat. No. 6,629,937 to Watrous, the content of which is incorporated herein by reference thereto, describes a diagnostic method using acoustics to diagnose a patient's heart. No mention is made of the application of artificial intelligence techniques to diagnosing general ailments.

Many people delay in obtaining, or are prevented from seeking, medical attention because of cost, time constraints, or inconvenience. If the public had universal, unrestricted and easy access to medical information, many diseases could be prevented. Likewise, the early detection and treatment of numerous diseases could keep many patients from reaching the advanced stages of illness, the treatment of which is a significant part of the financial burden attributed to national health care systems.

A prior attempt at a health care solution for a limited set of conditions is described in U.S. Pat. No. 4,712,562. A patient's blood pressure and heart rate are measured and the measurements are sent via telephone to a remote central computer for storage and analysis. Reports are generated for submission to a physician or the patient. U.S. Pat. No. 4,531,527 describes a similar system, wherein the receiving office unit automatically communicates with the physician under predetermined emergency circumstances.

U.S. Pat. No. 4,838,275 discloses a device for a patient to lie on or sit in having electronics to measure multiple parameters related to a patient's health. These parameters are electronically transmitted to a central surveillance and control office where a highly trained observer interacts with the patient. The observer conducts routine diagnostic sessions except when an emergency is noted or from a patient-initiated communication. The observer determines if a non routine therapeutic response is required, and if so facilitates such a response. As previously mentioned, highly trained people are needed by this system along with the special measurement apparatus (embedded in a bed or chair).

Other prior attempts at a health care solution are typified by U.S. Pat. No. 5,012,411 which describes a portable self-contained apparatus for measuring; storing and transmitting detected physiological information to a remote location over a communication system. The information is evaluated by a physician or other health professional. As before, highly trained people are necessary to utilize such an apparatus.

Further, a knowledge-based portable health record is offered by Dr. Globe at www.drglobe.com. Dr. Globe's product known as “Our Health Account®” is a secure and confidential online tool to store, manage and access a patient's essential health information in one place. It is promoted as being an easy-to-use, quick reference tool to keep track of one's personal healthcare.

Their product includes an Emergency Card which is a personalized card to allow emergency room staff to immediately access the patient's essential health information and contacts online “anytime, anywhere”. Further, the product allows the upload and saving of important health documents such as x-rays, pictures and any other relevant files in one central place.

Accordingly, it is desirable and advantageous to derive a substantially automated system to support computer aided diagnostic decision making wherein information in the patient's medical record is the input, for use in human and animal diagnosis.

There is no medical (human and veterinary) CRM (Client Relationship Management) software.

There is no medical (human and veterinary) ERP (Enterprise resource planning) software invention integrates easily and powerfully with Microsoft Word, Outlook, Excel, Great Plains and other business systems.

There is no software with complete holistic reports that can document homeopathy, acupuncture, Chinese medicine, bio resonance, bio spectrum frequency and bio nutritional analysis at same time, and with artificial intelligence that selects a holistic management plan based on the patients' record.

There is no medical software with an automatic insertion of laboratory results from indoor as well as professional outdoor laboratories into the patient's record.

There is no medical software that establishes invoice estimates for recommended treatments and services for predefined symptomatologies.

There is no medical software with artificial intelligence that delivers detailed diagnostic differentials based on the patients' record and physician's experience in his contextual situation each of which is rated according to its relative probability of being appropriate; with a context-sensitive source of information on diseases and medical procedures; in which context-sensitive tutorials can be implemented by the user or by another source; with an automatic insertion of X-ray; cardiac echography; abdominal echography; CT Scan; radio-magnetic imaging (IRM); electrocardiograms (ECGs); surgery, dentistry, neurology, acupuncture, bioresonance, BSF, homeopathy, videos, photos; dictated memos; etc. (22 different document profiles) in the patients' record, with a multimediatheque (trademark rights reserved).

There is no interactive Real Case Reference Database of completely SOAP-ed real cases, all reviewed by specialists and that can be searched by any criteria in the report.

There is no medical software with a customizable, extended data base functionality, and information on how to accomplish procedures.

### BRIEF SUMMARY OF THE INVENTION

One object of the invention is to provide better medical software for, creating and maintaining accurate professionally useful patient records; effectively coordinating the daily administration of a medical practice, and is offered in a version for veterinary medicine and a version for medicine on humans.

Another object of the invention is to provide the only medical (human and veterinary) CRM (Client Relationship Management) software, that affects every step of patient interaction, whether it is marketing; sales; service-related or management of the workload by distributing the chores among staff members and automates medical and business processes through workflow rules. This enables precise, time-saving, stress-free communication of what must be done by each member of the staff with its degree of urgency and avoids misplacing the results of a procedure.

A further object of the invention is to provide sophisticated software which's artificial intelligence feature not only presents a list of possible diagnoses based on the patients' record and physician's experience in his contextual situation but also delivers detailed diagnostic differentials and selects the most appropriate diagnostic procedures and information on diseases.

Yet another object of the invention is to provide better medical software capable of establishing a complete or edited report and, when needed, sending it directly to a consultant.

Another object of the invention is to provide medical software that may increase profitability.

A further object of the invention is to provide the only medical (human and veterinary) ERP (Enterprise resource planning) software which serves the needs of people in medicine as well as it does the people in human resources; finance; inventory control, and integrates easily with Microsoft Word, Outlook, Excel, Great Plains and other business systems.

Still yet another object is to provide medical software that anyone with a basic understanding of Windows software; drop-down menus and essential medical terminology can master this software in just a few minutes.

Yet another object of the invention is to provide medical software with a better time efficiency

Still yet another object of the invention is to provide medical software with a better Record Module.

Another object of the invention is to provide medical software that allows doctors to use consulting services more easily and allow consultants not to waste time and energy with incomplete reports.

A further object of the invention is to provide the only medical software with complete holistic reports, and in which artificial intelligence selects, based on the patients record, a holistic management plan (for example: acupuncture points; Chinese medicine prescription; bio resonance; homeopathy: bio spectrum frequency . . . ).

Yet another object of the invention is to provide medical software with a neurological module that is structured to enter a complete neurological examination.

Still yet another object of the invention is to provide the only software that automatically creates from the information entered a complete (based on the ASMC and AFMC standards) text formatted behaviour Report, which is an extreme time saver.

Another object of the invention is to provide the only software with an automatic insertion of laboratory results from indoor as well as professional outdoor laboratories into the patient's record.

Another object of the invention is to provide better medical software that makes a enhanced use of laboratory services, therefore making the laboratory more profitable and increasing the standard of medicine.

A further object of the invention is to provide the only medical software that establishes invoice estimates for recommended treatments and services for predefined symptomatologies.

Yet another object of the invention is to provide the only medical software with artificial intelligence that delivers detailed diagnostic differentials, each of which is rated according to its relative probability of being appropriate.

Still yet another object of the invention is to provide the only medical software with a context-sensitive source of information on diseases and medical procedures.

Another object of the invention is to provide the only medical software in which context-sensitive tutorials can be implemented by the user.

Another object of the invention is to provide better medical software with a context-sensitive help.

A further object of the invention is to provide the only CRM and ERP medical software that helps minimize diagnostic errors, saves time, and is generally more cost-effective and better tolerated by clients.

Yet another object of the invention is to provide the only medical software with an automatic insertion of X-ray; cardiac echography; abdominal echography; CT Scan; radio-magnetic imaging (IRM); electrocardiograms (ECGs); surgery; dentistry; neurology; acupuncture; bio-resonance; bio spectrum frequency (BSF); homeopathy; videos; photos; dictated memos; etc. (22 different document profiles) in the patients' record.

Still yet another object of the invention is to provide the only veterinary and human medical software with multimedia fields integrated throughout the software which allow the user to tailor this module endlessly.

Another object of the invention is to provide the only medical software with a multimediatheque (trademark rights reserved).

Another object of the invention is to provide the only medical software with a interactive Real Case Reference Database of completely SOAP-ed real cases, all reviewed by specialists.

A further object of the invention is to provide a better medical software that assists even the best-experienced doctor to achieve a higher standard of medicine.

Yet another object of the invention is to provide the only medical software with a customizable extended data base functionality and information on how to accomplish procedures.

Still yet another object of the invention is to provide the only medical software with a Preventive Medicine Module that is pertinent to the patient's species; to the patient, and that is customized to the patient and to the user's way of practicing medicine.

Another object of the invention is to provide the only medical software with a grooming module which is designed to collect all the information as to the grooming of a small animal, such as fields specific for every body part as well as for comments concerning these anatomical regions.

Another object of the invention is to provide a better medical software that makes automatic back ups at a pre-determined time.

Yet another object of the invention is to provide better software with a hair dresser module for Humans.

Other objects and advantages of the present invention will become apparent from the following descriptions, taken in connection with the accompanying drawings, wherein, by way of illustration and example, an embodiment of the present invention is disclosed.

The invention includes software for creating and maintaining accurate and professionally useful patient records and coordinating the daily administration of a medical practice, which is offered in two versions: one for veterinary medicine; and one for human medicine.

The invention includes software which combines medical (human and veterinary) Customer Relationship Management (CRM) and Enterprise Resource Planning (ERP) in a revolutionary way to provide a unique-and uniquely powerful and easy-to-use-tool to manage any veterinary or human medical clinic or hospital.

The invention includes software is a sophisticated medical (human and veterinary) CRM software. The invention includes software which affects every step of patient interaction, whether it be marketing, sales or service-related, like: management of the workload by distributing the chores among staff members and automating medical and business processes through workflow rules; enabling users to view and update tasks, medical cases, appointments, sales, phone calls, faxes, emails, and letters.

The invention includes software with an Artificial intelligence feature which: presents a list of possible diagnoses based on the patients' record and the physician's experience in his contextual situation; delivers detailed diagnostic differentials; selects the most appropriate diagnostic procedures and information on diseases.

The invention includes software with the capability of establishing a complete SOAP-ed report; a complete holistic report or editing a report and, when needed, sending it directly to a consultant.

The invention includes software which is sophisticated medical (human and veterinary) ERP software. The invention includes software which serves the needs of people in medicine as well as it does the people in human resources, finance and inventory control like: inventory control with automatic ordering and integrates easily and powerfully with Microsoft Word; Outlook; Excel; Great Plains and other business systems.

The invention includes software which is easy to learn, easy to use and capable of infinite customization to fit the users' needs and the way of work.

The invention includes software with advantages like: Being the first interactive database of completely SOAP-ed real cases, all reviewed by specialists; automatically highlighting of pathological results; automatically inserting of laboratory results from indoor or professional outdoor laboratories into the patient's record; automatically inserting X-rays; CT Scans; radio-magnetic images (IRM); electrocardiograms (ECGs); surgery documents; dentistry documents, neurology documents; acupuncture documents; bio-resonance documents; bio-spectrum frequency (BSF) documents; bio-nutritional documents; homeopathy documents; videos; photos; dictated memos; etc. (22 different document profiles) in the patients' record; establishing invoice estimates for recommended treatments and services; presenting context-sensitive source of information on diseases and medical procedures; allowing context-sensitive tutorials can be implemented; displaying context-sensitive help; making automatic back ups at a pre-determined time; dispatching pending procedures among staff and follows up their executions.

The invention includes software which increases the profitability by means like: Decreased work load for clinic Staff; decreased administrative work for Doctors; reduction in management tasks.

### BRIEF DESCRIPTION OF THE DRAWINGS

Attached Figures are drawings showing the various graphical user interfaces; input screens; and output screens of the invention. The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 1.2 shows:

The field on the right which displays Help for a particular task is the Topic Window. Clicking on fields in the Context outline (left window) displays corresponding Help in the Topic Window.

FIG. 1.3 shows:

Hyperlinks when activated present additional information in a pop-up window.

FIG. 1.4 shows:

The Index tab alphabetically lists keywords that assist the user in finding a particular topic.

FIG. 1.5 shows:

This tab has a field named: “Type in the keyword to Find:” for entering keywords. As a keyword is being typed in this field, all the alphabetically related keywords are shown. When the user “double clicks” the keyword, the related topic is displayed in the Topic Window.

FIG. 1.6 shows:

If several topics concern the same keyword, a window pops up with a listing of these topics.

FIG. 1.7 and FIG. 1.8 shows:

Clicking a topic, then selecting “Click Display” presents the related topic in the Topic Window, highlights its location in the Context field and allows the user to locate the topic on the applications map (Context tab).

FIG. 1.9 through 1.10 shows:

That whether a field is present; absent; enabled or disabled on the context sensitive navigation menu (which pops up with a “Right Click”), depends on the current context.

FIG. 2.1 shows:

The owner form which supports viewing, entering, modifying and deleting owner information.

FIG. 2.2 through 2.5 shows:

that whether a field is present; absent; enabled or disabled on the context sensitive navigation menu (which pops up with a “Right Click”), depends on the current context.

FIG. 2.6 shows:

That selecting <<Ctrl H>> opens the context sensitive Customized Help, which in order to facilitate orientation, highlights the users' current location on the Context tab, which is a schematic representation of the context sensitive navigation menu (on the left).

FIG. 2.6 shows:

Hyperlinks in the Topic Window for the Owner form.

FIG. 2.7 shows:

How the user can find Owners according to the value of a field.

FIG. 2.8 shows:

Hyperlinks when activated present additional information in a pop-up window.

The example chosen here is: Use automatic dial up.

FIG. 2.9 shows:

What the user views when he is following the instructions displayed in the “Use automatic dial up” pop-up window.

FIG. 3.1 shows:

The patient module which supports viewing, entering, modifying and deleting patient information.

FIG. 3.2 through 3.6 shows:

That whether a field is present; absent; enabled or disabled on the context sensitive navigation menu (which pops up with a “Right Click”), depends on the current context.

FIG. 3.7 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 3.8 shows:

Hyperlinks in the Topic Window for the Patient form.

FIG. 3.9 through 3.11 shows:

That typing the first letter of the <<Gender>> and <<Species>> fields enters automatically the “Gender” and “Species” in their respective fields.

FIG. 3.12 shows:

Hyperlinks when activated present additional information in a pop-up window.

FIG. 3.13 shows:

Hyperlinks in the Topic Window for the Patient form as well as the central multimedia field on this form.

FIG. 3.14 through 3.16:

Walks us through following the indications from the Hyperlink pop-up window.

FIG. 3.16 shows:

That only Patients from the same Owner are looked up in this context.

FIG. 4.1 shows:

How to allocate the Visit-Subjective (medical record history)-objective (physical examination) form.

FIG. 4.2 shows:

The Visit-Subjective (medical record history)-objective (physical examination) form.

FIG. 4.3 through 4.16 shows:

that whether a field is present; absent; enabled or disabled on the context sensitive navigation menu (which pops up with a “Right Click”), depends on the current context.

FIG. 4.10 through FIG. 4.14 shows:

That from anywhere in the patients' record, the user may view the owners' and patients' profile.

FIG. 4.13 shows:

The patients' pop-up form with its central multimedia field.

FIG. 4.17 shows:

The Subjective (medical record history) form with a pathological value displayed in red.

FIG. 4.18 shows:

The Objective (physical examination) form with a pathological value displayed in red.

FIG. 4.19 shows:

The multimedia field for the Visit-Subjective (medical record history)-objective (physical examination) form.

FIG. 4.20 shows:

Hyperlinks in the Topic Window for the Subjective form.

FIG. 4.21 through 4.22 shows:

Hyperlinks when activated present additional information in a pop-up window.

FIG. 4.23 shows:

Hyperlinks in the Topic Window for the Objective form.

FIG. 4.24 shows:

Hyperlinks when activated present additional information in a pop-up window.

FIG. 5.1 shows:

The Assessment forms' topic Window Hyperlinks and context sensitive navigation menu.

FIG. 6.1 shows:

The Reports' Topic Window Hyperlinks as well as its context sensitive navigation menu.

FIG. 6.2 shows:

Hyperlinks when activated present additional information in a pop-up window:

FIG. 6.3 shows:

How to preview the SOAP Report.

FIG. 6.4 shows:

A preview of a SOAP Report with its context sensitive navigation menu.

FIG. 6.5 shows:

Hyperlinks when activated present additional information in a pop-up window:

FIG. 6.6 shows:

How to preview the SOAP (Laboratory) Report.

FIG. 6.7 through 6.8 shows:

A preview of a SOAP (Laboratory) Report with its context sensitive navigation menu.

FIG. 6.9 through 6.10 shows:

How to select images to be included in the report:

FIG. 6.11 shows:

a Hyperlink pop up explaining how to preview a SOAP Report.

FIG. 6.12 shows:

How to preview the SOAP (Complete) Report.

FIG. 6.13 shows:

A preview of a SOAP (Complete) Report with its context sensitive navigation menu.

FIG. 6.14 shows:

An example of a Hyperlink in the Reports Topic Window.

FIG. 7.1 shows:

How to allocate the Preventive Medicine Module.

FIG. 7.2 through FIG. 7.10 shows:

The feline vaccination module.

FIG. 7.3 through 7.7 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 7.4 shows:

Hyperlinks in the Topic Window for the Preventive Medicine Module.

FIG. 7.5 shows:

Hyperlink for the vaccination protocol, which when activated present additional information in a pop-up window.

FIG. 7.6 shows:

Hyperlink for the deworming protocol, which when activated present additional information in a pop-up window

FIG. 7.7 shows:

Hyperlink for the monitoring protocol, which when activated present additional information in a pop-up window

FIG. 7.10 shows:

That whether a field is present; absent; enabled or disabled on the context sensitive navigation menu (which pops up with a “Right Click”), depends on the current context.

FIG. 7.11 through FIG. 7.15 shows:

The canine vaccination module.

FIG. 7.16 shows:

The vaccination module for rabbits.

FIG. 7.17 through FIG. 7.19 shows:

The vaccination module for species other than feline; canine and rabbits.

FIG. 7.20 shows:

How to allocate the deworming module.

FIG. 7.21 shows:

The deworming module.

FIG. 7.22 shows:

How to allocate the monitoring module.

FIG. 7.23 through FIG. 7.28 shows:

The feline female monitoring module.

The Periodical Check Up for this module is the same as in FIG. 7.29.

FIG. 7.21 shows:

The deworming module. Groups 2; 3 and 4 show a similar display as group1

FIG. 7.22 shows:

How to allocate the monitoring module.

FIG. 7.29 through FIG. 7.33 shows:

The canine female monitoring module.

FIG. 7.34 shows:

Preventive module for other species then canine; feline and rabbit.

Groups 2; 3 and 4 show a similar display as group1

FIG. 8.1 shows:

An example of symptoms in the Workup selection.

FIG. 8.2 shows:

The MDB for Feline PUPD inserted in the health plan (Trademark rights reserved), with the possibility for the user of according a discount.

FIG. 8.3 shows:

That whether a field is present; absent; enabled or disabled on the context sensitive navigation menu (which pops up with a “Right Click”), depends on the current context.

FIG. 8.4 through 8.6 shows:

The MDB for Feline Coughing inserted in the health plan (Trademark rights reserved), with possibility for the user of according a discount.

FIG. 8.5 shows:

That when the price of an examination may differ among patients (for example: X-Ray prices may depend on the size of the X-Ray and the radiography dimensions are proportional to the patient's size), a message box prompts the user to determine choice.

FIG. 8.7 through 8.9 shows:

The MDB for Feline Dyspnea inserted in the health plan (Trademark rights reserved), with the possibility for the user of according a discount.

FIG. 8.8 shows:

That when the price of an examination may differ among patients (for example: X-Ray prices may depend on the size of the X-Ray and the radiography dimensions are proportional to the patient's size), a message box prompts the user to determine choice.

FIG. 8.10 shows:

The MDB for Feline Vomiting acute with polysytemic signs inserted in the health plan (Trademark rights reserved), with the possibility for the user of according a discount.

FIG. 8.11 shows:

That when the price of an examination may differ among patients (for example: X-Ray prices may depend on the size of the X-Ray and the radiography dimensions are proportional to the patient's size), a message box prompts the user to determine choice.

FIG. 8.12 shows:

Radiographies inserted in the health plan (Trademark rights reserved),

FIG. 8.13 shows:

The MDB for Feline chronic vomiting signs inserted in the health plan (Trademark rights reserved), with the possibility for the user of according a discount.

FIG. 8.14 shows:

The MDB for Feline Diarrhea acute with polysytemic signs inserted in the health plan (Trademark rights reserved), with the possibility for the user of according a discount.

FIG. 8.15 shows:

That when the price of an examination may differ among patients (for example: X-Ray prices may depend on the size of the X-Ray and the radiography dimensions are proportional to the patient's size), a message box prompts the user to determine choice.

FIG. 8.16 shows:

That when the price of an examination may differ among patients (for example: X-Ray prices may depend on the size of the X-Ray and the radiography dimensions are proportional to the patient's size).

FIG. 8.17 shows:

the MDB for Feline Diarrhea chronic diarrhea signs inserted in the health plan (Trademark rights reserved), with the possibility for the user of according a discount.

FIG. 8.18 shows:

That when the price of an examination may differ among patients (for example: X-Ray prices may depend on the size of the X-Ray and the radiography dimensions are proportional to the patient's size), a message box prompts the user to determine choice.

FIG. 8.19 shows:

The MDB for Feline Diarrhea chronic diarrhea signs inserted in the health plan (Trademark rights reserved).

FIG. 8.20 through FIG. 8.25 shows:

How the software enters data in the “Health Plan” when it already contains data.

FIG. 8.26 through FIG. 8.27 shows:

That whether a field is present; absent; enabled or disabled on the context sensitive navigation menu (which pops up with a “Right Click”), depends on the current context.

FIG. 8.27 shows:

The current Visit module and that the invention has automatically entered the data from the Health Plan in it.

FIG. 9.1 through FIG. 9.4 shows:

How the user should proceed to enter all reference and optimal values from a specific laboratory in the patients' form.

FIG. 9.5 shows:

Steps involved in delivering a laboratory result.

FIG. 9.6 and FIG. 9.7 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 9.8 shows:

Hyperlinks when activated present additional information in a pop-up window.

FIG. 9.9 shows:

How to allocate the Laboratory module and that whether a field is present; absent; enabled or disabled on the context sensitive navigation menu (which pops up with a “Right Click”), depends on the current context.

FIG. 9.10 shows:

The Laboratory annual profile

FIG. 9.11 through FIG. 9.12 shows:

The Laboratory Preanaesthetic and Admission Profile

FIG. 9.13 through FIG. 9.14 shows:

The Laboratory CBC Profile

FIG. 9.15 shows:

The Laboratory Chemistry Small Profile

FIG. 9.16 shows:

The Laboratory Chemistry Critical Care Profile

FIG. 9.17 shows:

The Laboratory Chemistry Supplement Profile

FIG. 9.18 through FIG. 9.19 shows:

The Laboratory Chemistry Large Profile

FIG. 9.20 shows:

The Laboratory Urine Profile

FIG. 9.21 through FIG. 9.23 shows:

The Laboratory Microbiology and Parasitology Profile

FIG. 9.24 shows:

The Laboratory Endocrinology and Immunology Profile

FIG. 10.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 10.2 shows:

How to allocate the Imaging module as well as the hyperlinks in its' the Topic Window.

FIG. 10.3 shows:

Hyperlinks when activated present additional information in a pop-up window. The example illustrated here is the Imaging Topic Window.

FIG. 10.4 shows:

The Imaging Module and that whether a field is present; absent; enabled or disabled on the context sensitive navigation menu (which pops up with a “Right Click”), depends on the current context. It also shows the XR form.

FIG. 10.5 through FIG. 10.6 shows:

Hyperlinks when activated present additional information in a pop-up window. The example illustrated here is the Imaging Topic Window.

FIG. 10.7 shows:

The first plain radiographies form

FIG. 10.8 shows:

The following plain radiographies form

FIG. 10.9 shows:

The contrast radiographies form

FIG. 10.10 shows:

The Electrocardiogram form

FIG. 10.11 shows:

The cardiac and abdominal and other body parts echography form

FIG. 10.12 shows:

The movie form

FIG. 10.13 shows:

The computered tomography form

FIG. 10.14 shows:

Double-clicking the field enlarges this field on the screen and brings up three command buttons (Insert; Open; and Activate)

FIG. 10.14 shows:

The “Activate” button, which activates the Document in place; the “Open” button, which opens the Document in its own editing window.

FIG. 10.15 shows:

Clicking on the “Insert” button calls up the Insert Dialog box allowing the user to insert the selected Document.

FIG. 11.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 11.2 shows:

Hyperlinks when activated present additional information in a pop-up window.

FIG. 11.3 through FIG. 11.4 shows:

How to allocate the Neurology module and that whether a field is present; absent; enabled or disabled on the context sensitive navigation menu (which pops up with a “Right Click”), depends on the current context.

FIG. 11.5 through FIG. 11.13 shows:

The screen images of the different forms contained in the Neurology module.

FIG. 12.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 12.2 shows:

Hyperlinks in the Topic Window for the Holistic module.

FIG. 12.3 shows:

Hyperlinks when activated present additional information in a pop-up window.

FIG. 12.4 shows:

That whether a field is present; absent; enabled or disabled on the context sensitive navigation menu (which pops up with a “Right Click”), depends on the current context

FIG. 12.5 through FIG. 12.22 shows:

The Holistic Module forms.

FIG. 13.1 shows:

The context sensitive Customized Help for the surgery/dentistry module.

FIG. 13.2 shows:

Hyperlinks when activated present additional information for the surgery/dentistry module in a pop-up window.

FIG. 13.3 shows:

How to allocate the surgery/dentistry module.

FIG. 13.4 shows:

That whether a field is present; absent; enabled or disabled on the context sensitive navigation menu (which pops up with a “Right Click”), depends on the current context. The example here is the surgery/dentistry modules' navigation menu.

FIG. 13.5 through FIG. 13.11 shows:

The Surgery Dentistry Module forms.

FIG. 14.1a through 14.2a shows:

The context sensitive Customized Help for the CRM.

FIG. 14.1 shows:

Hyperlinks when activated present additional information in a pop-up window. This pop up window indicates how to allocate the “This Visit” module.

FIG. 14.2 through FIG. 14.3:

Walks us through to the “This Visit” modules' allocation.

FIG. 14.4 shows:

That whether a field is present; absent; enabled or disabled on the context sensitive navigation menu (which pops up with a “Right Click”), depends on the current context. The example here is for the “This Visit” module.

FIG. 14.5 through FIG. 14.6 shows:

That if ones selects “This Visit” from the “Health Plan”, all the items of the “Health Plan” are automatically inserted in the Pending list.

FIG. 14.7 through FIG. 14.8 shows:

That if ones selects “This Visit” from the “Invoice”, all the items of the “Bill” are automatically inserted in the Pending list.

FIG. 15.1 shows:

The context sensitive Customized Help for the Employees module.

FIG. 15.2 shows:

Hyperlinks when activated present additional information in a pop-up window. This pop up window indicates how to allocate the “Employees” module.

FIG. 15.3 through FIG. 15.5:

Walks us through to how to allocate the “Employees” module.

FIG. 15.5 shows:

A dialog box asking to choose between viewing the To-do list of all the employees or only of a specific one; and the tab button marked “Chores for Visit Nr: Vist number ID”.

FIG. 15.6 shows:

That clicking on the tab button marked “Chores for Visit Nr: Vist number ID” will bring the user to the corresponding visit. From now on the user is in the software at the precise visit where the chore must be entered. This whole Visit (SOAP) is labeled with the word “chores” in red. This reminds the user that a specific task must be accomplished.

FIG. 16.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the artificial intelligence module.

FIG. 16.2 shows:

Hyperlinks when activated present additional information in a pop-up window. This pop up window indicates how to allocate the “artificial intelligence” module.

FIG. 16.3 shows:

Walks us through to allocating the “artificial intelligence” module and shows that whether a field is present; absent; enabled or disabled on the context sensitive navigation menu (which pops up with a “Right Click”), depends on the current context.

FIG. 16.4 shows:

The module that allows the user to personalize the degree of importance of individual tests.

FIG. 16.5 shows:

The clinician may elect to base the work-up on one symptom rather than another.

FIG. 16.6 shows:

that whether a field is present; absent; enabled or disabled on the context sensitive navigation menu (which pops up with a “Right Click”), depends on the current context. Here is represented the context sensitive navigation menu for the module that allows the user to personalize the degree of importance of individual tests.

FIG. 16.7 shows:

How to allocate the “General interpretation” module.

FIG. 16.8 shows:

An example of results in the “General interpretation” module and its' respective context sensitive navigation menu.

FIG. 16.9 shows:

How to allocate the “Symptom based interpretation” module.

FIG. 16.10 shows:

The message box that appears when no there are no diseases in the “Symptom based interpretation” module rules out list for the chosen symptom.

FIG. 16.11 through 16.16 shows:

The “Symptom based interpretation” module rules outs for the chosen symptom and the current patient.

FIG. 16.15 shows:

The customizable extended data base functionality and information on how to accomplish procedures.

FIG. 16.16 shows:

To insert a source of information in a multimedia field: double click the field; select “import”; then select the document in “explorer” and click “ok”.

FIG. 16.17 shows:

By selecting “Rule Out List” button (another possibility is through the context sensitive menu) the user allocates: the “Symptom based interpretation” module displaying the rule outs with their respective scores and raisons for which the artificial intelligence has selected them.

FIG. 16.18 shows:

The “Symptom based interpretation” module displays rule outs with their respective scores and raisons for which the artificial intelligence has selected them. Its' respective context sensitive navigation menu is also displayed.

FIG. 17.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Multimediatheque module.

FIG. 17.2 shows:

Hyperlinks when activated present additional information in a pop-up window. This pop up window indicates how to allocate the “Multimediatheque” (trademark rights reserved) module.

FIG. 17.3:

Walks us through to allocating the “Multimediatheque” (trademark rights reserved) module from without the “Multimediatheque” module, and shows that whether a field is present; absent; enabled or disabled on the context sensitive navigation menu (which pops up with a “Right Click”), depends on the current context.

FIG. 17.4:

Walks us through to allocating the “Multimediatheque” (trademark rights reserved) module from within the “Multimediatheque(trademark rights reserved)” module.

FIG. 17.5 through 17.14 shows:

The “Multimediatheque” (trademark rights reserved) module.

FIG. 19.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Consultants module.

FIG. 19.2:

Walks us through to allocating the “consultants” module and shows that whether a field is present; absent; enabled or disabled on the context sensitive navigation menu (which pops up with a “Right Click”), depends on the current context.

FIG. 19.3 shows:

That the “Disponibilities” button when activated opens a web page where the disponibility of each consultant is displayed

FIG. 19.4 through FIG. 19.5 shows:

How to select images to be sent to a consultant.

FIG. 19.6 shows:

That in order stay informed about every report that has been sent to a consultant: the software displays, the name of the consultant as well as contact button, on the SO form of the visit from which the report has been sent. This button when clicked opens automatically “MS Outlooks' Contact” Form with all the consultants information(Name address, email . . . ).

FIG. 20.1 through FIG. 20.3 shows:

How the user can use context sensitive Customized Help in combination with the context sensitive navigation menu: selecting <<Ctrl H>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic. This tab has a field named: “Type in the keyword to Find:” for entering keywords. As a keyword is being typed in this field (in this case: Sell), all the alphabetically related keywords are shown. When the user “double clicks” the keyword, the related topic is displayed in the Topic Window. Since several topics concern the same keyword, a window pops up with a listing of these topics. Clicking a topic, then selecting “Click Display” presents the related topic in the Topic Window, highlights its location in the Context field and allows the user to locate the topic on the applications map (Context tab).

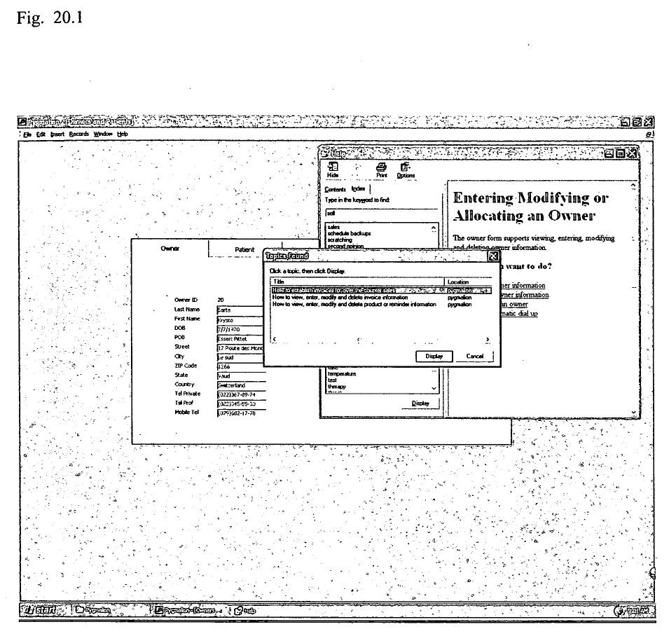

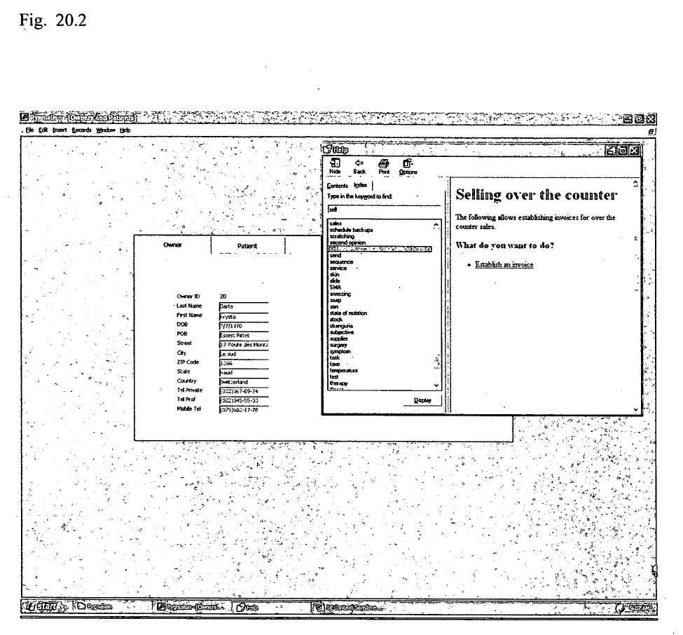

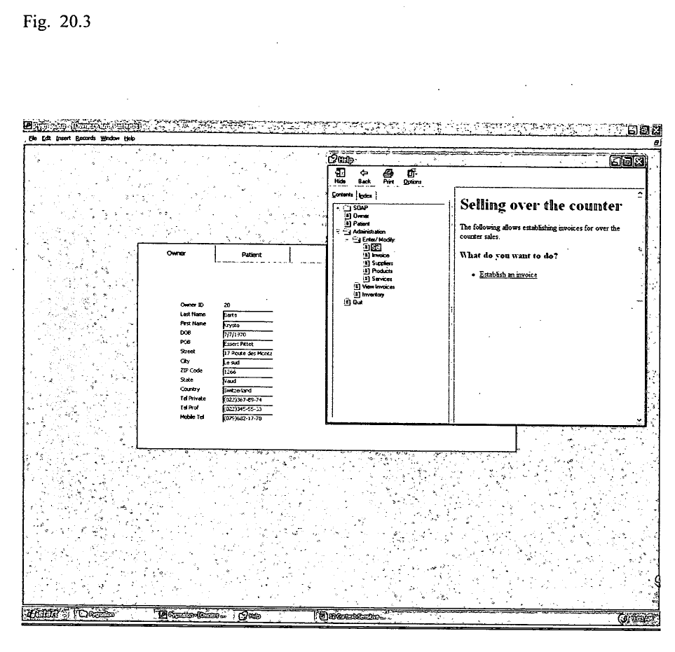

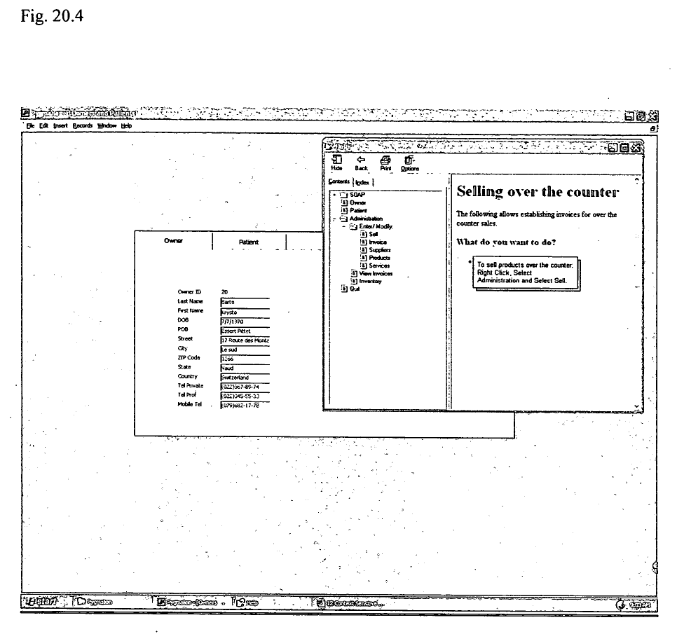

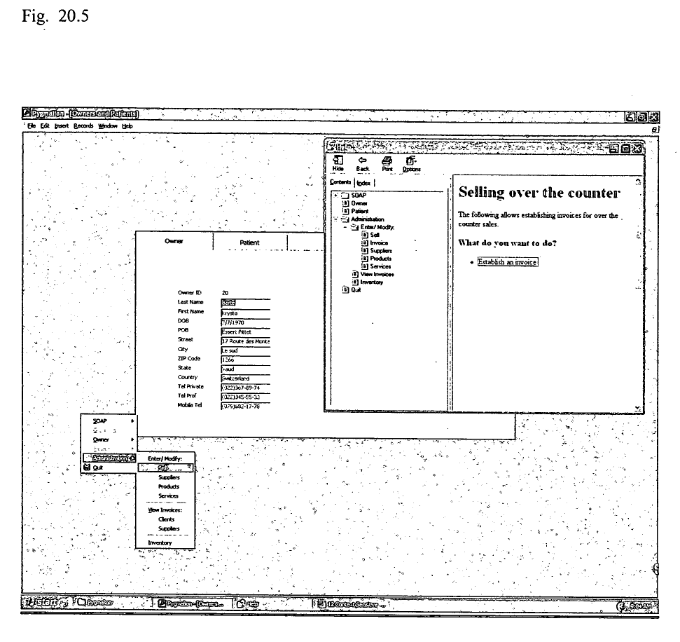

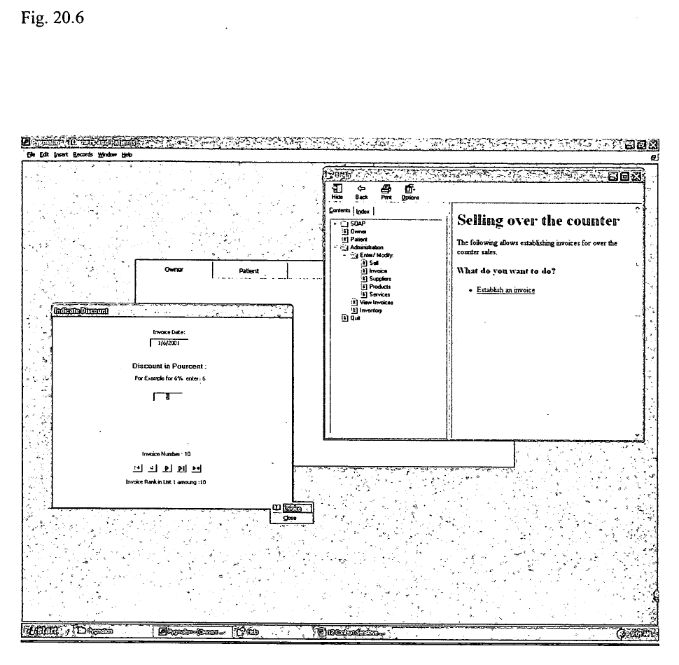

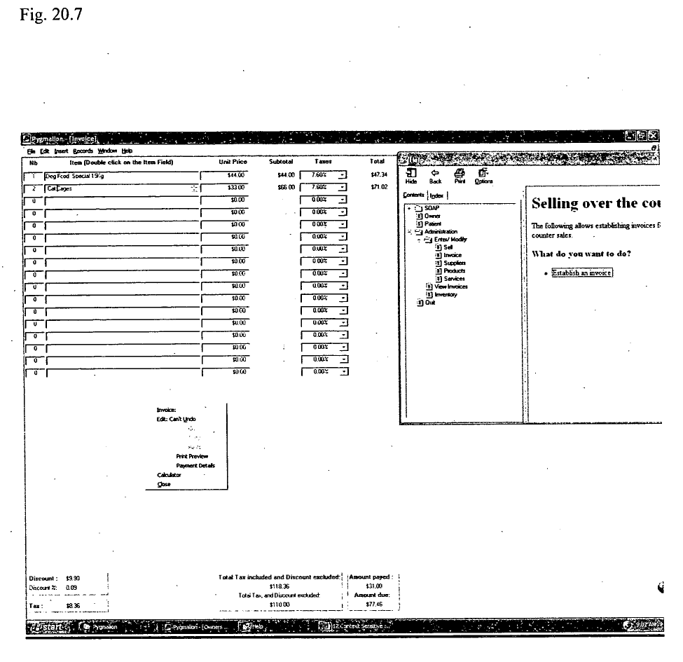

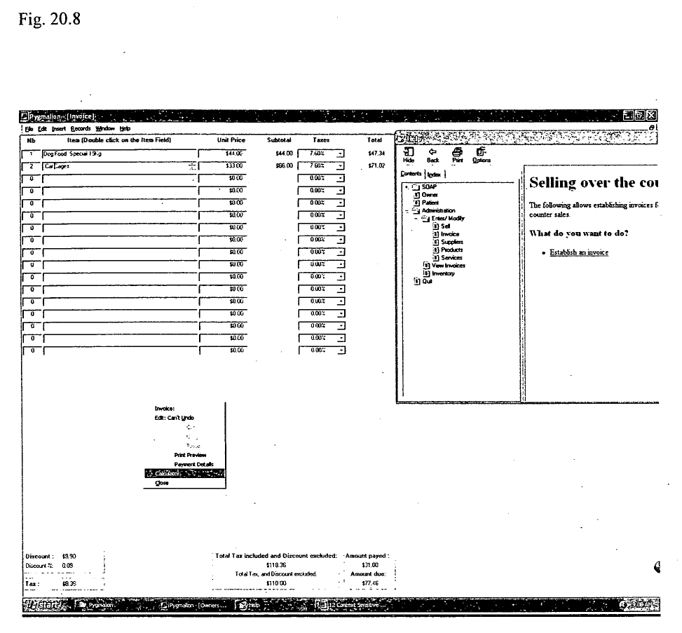

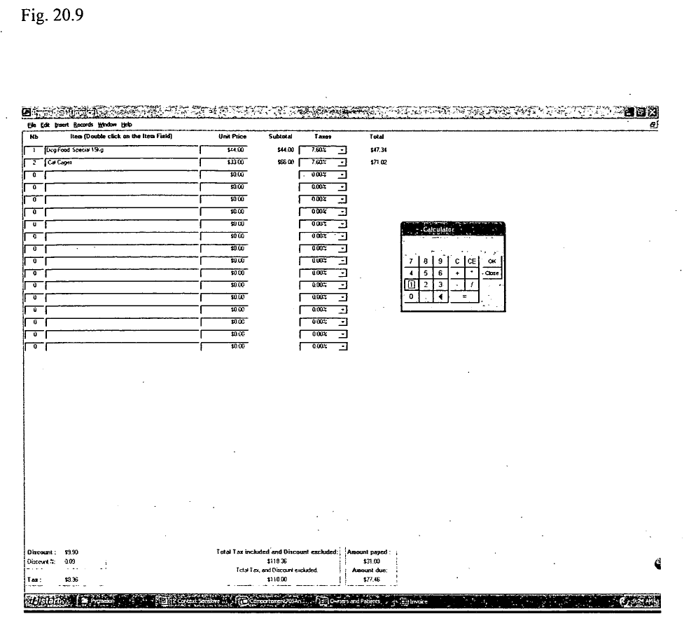

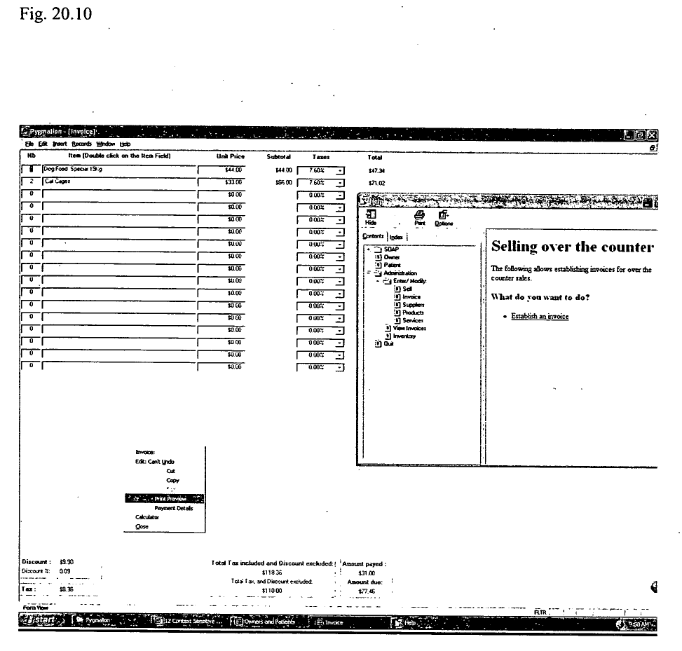

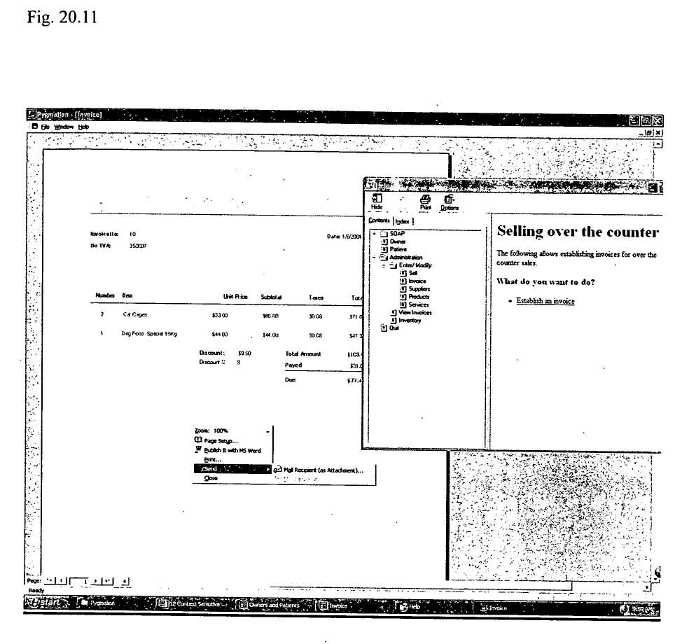

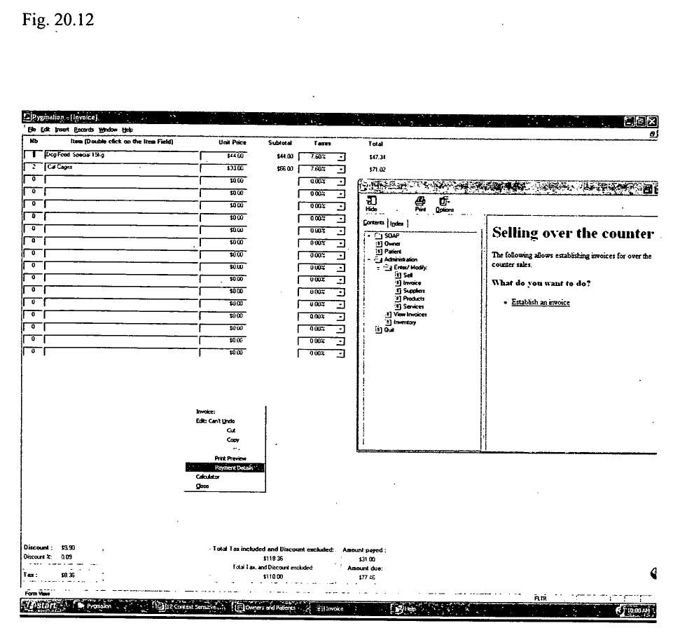

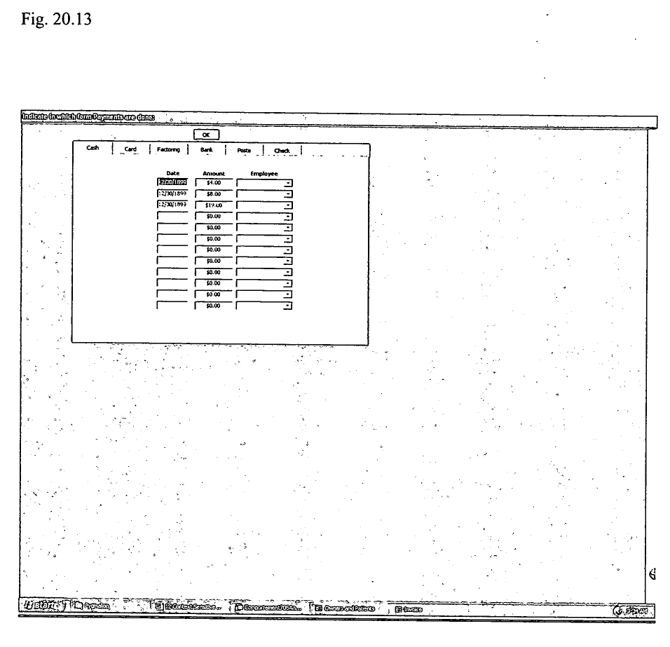

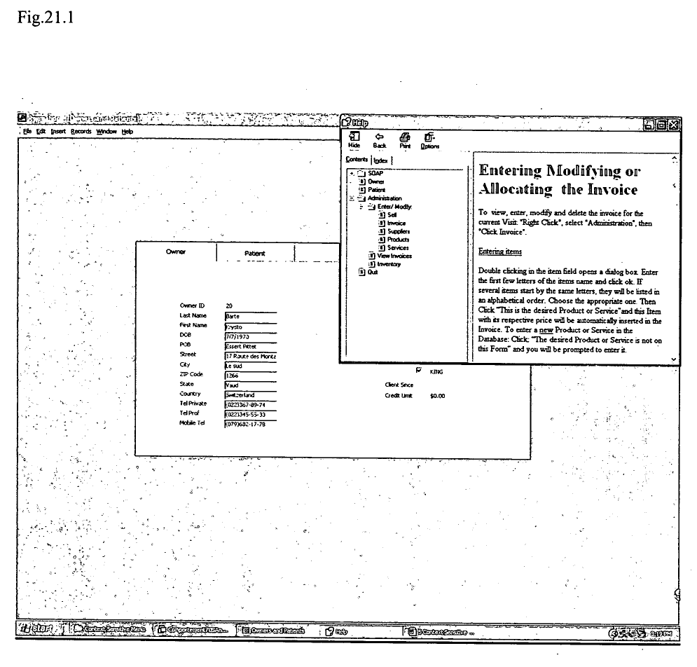

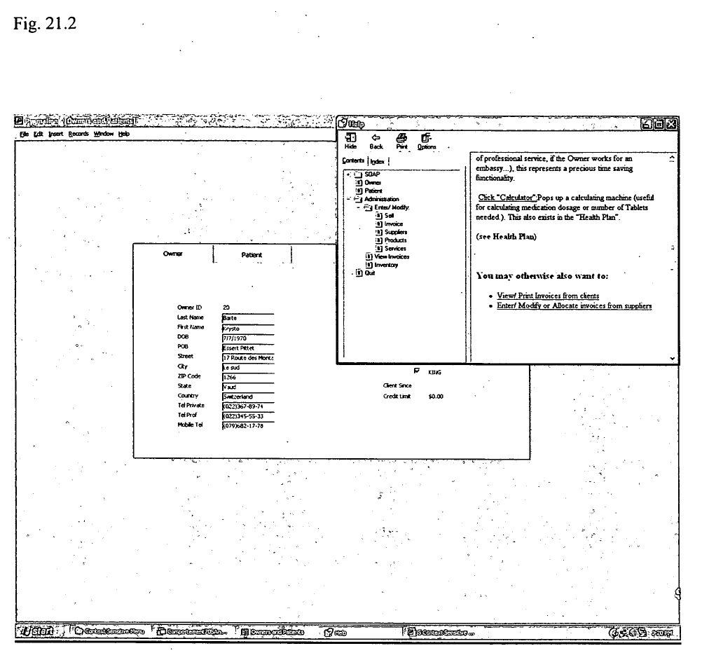

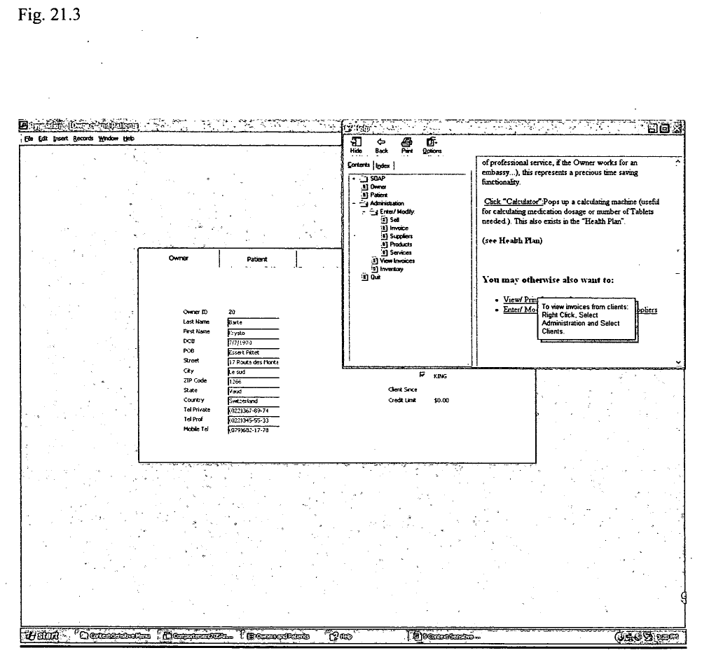

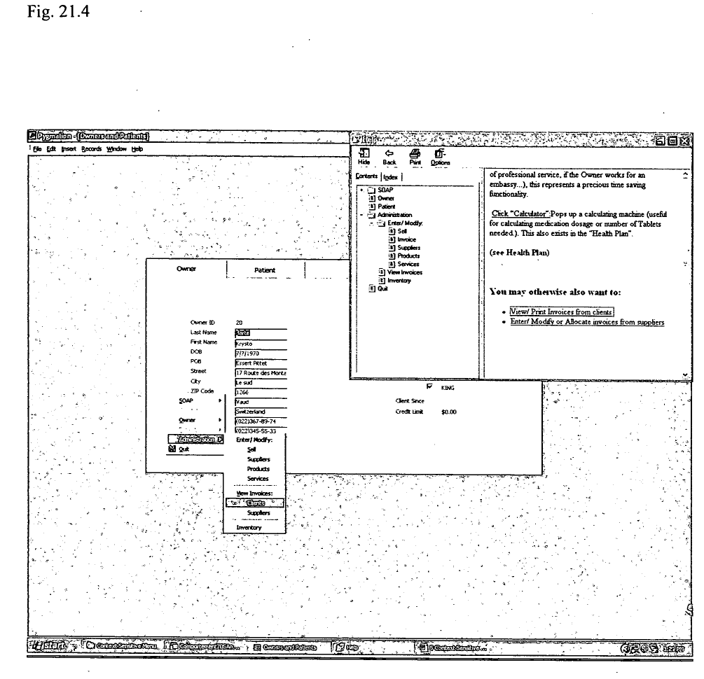

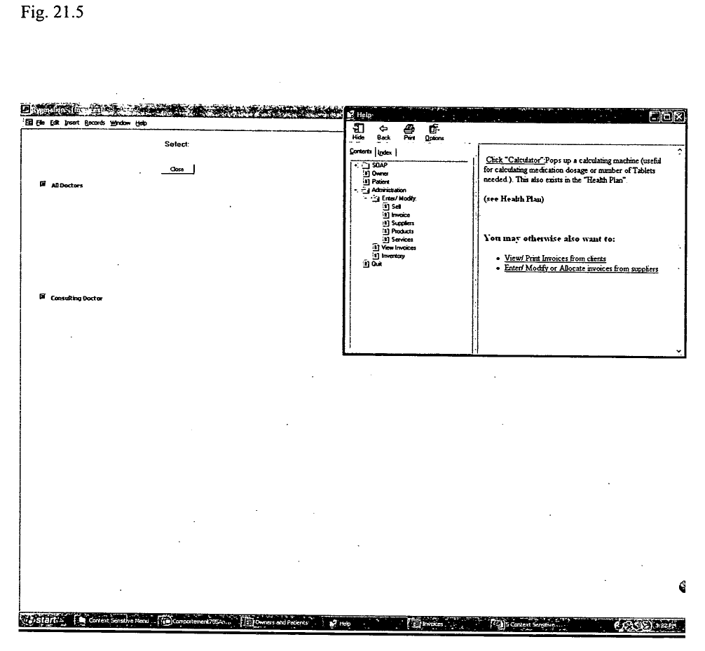

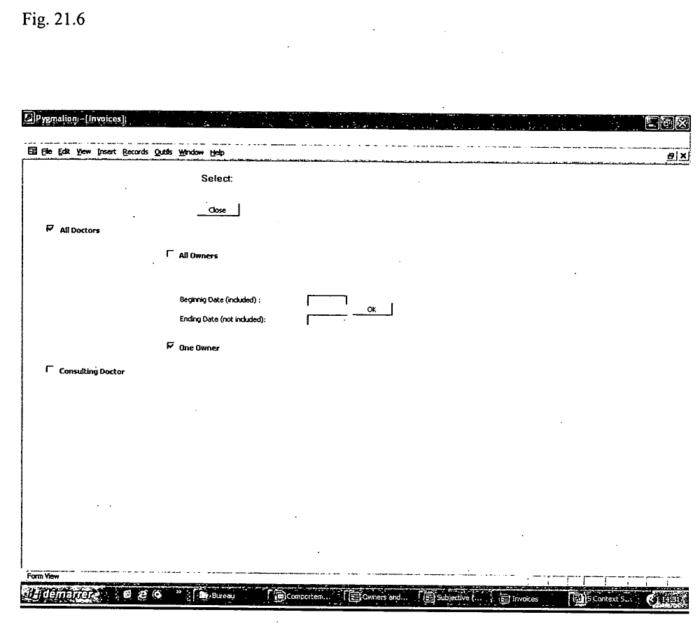

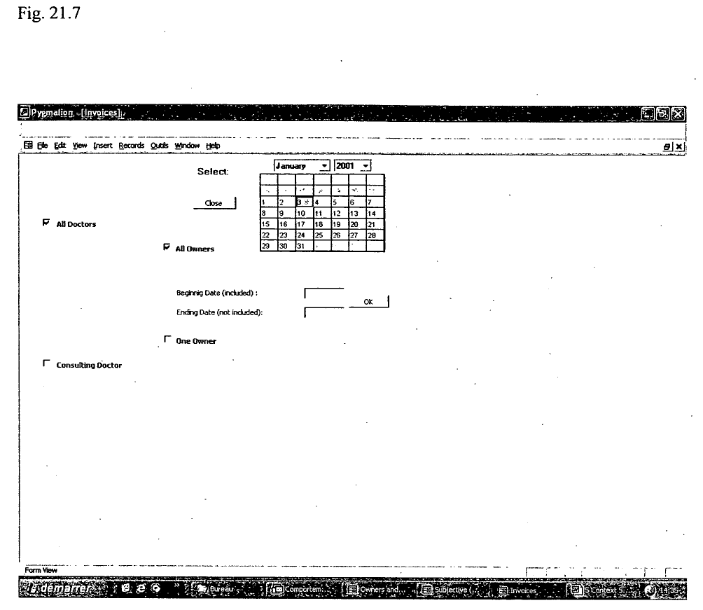

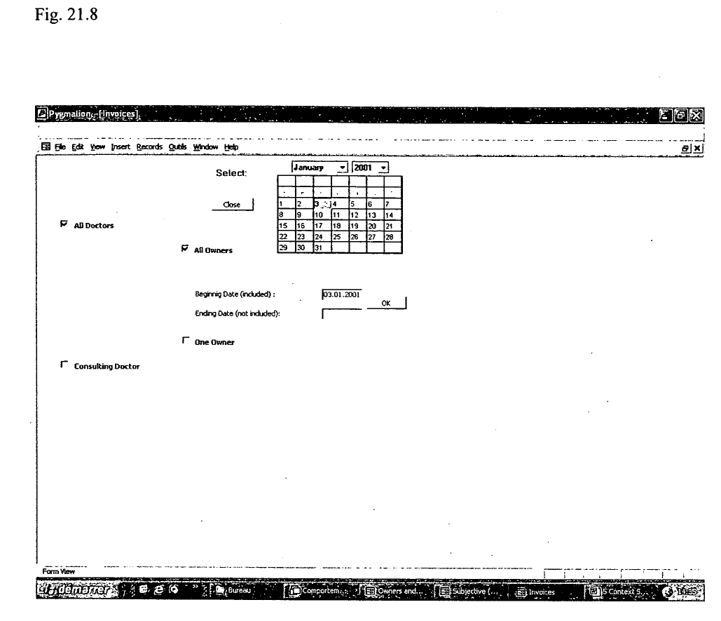

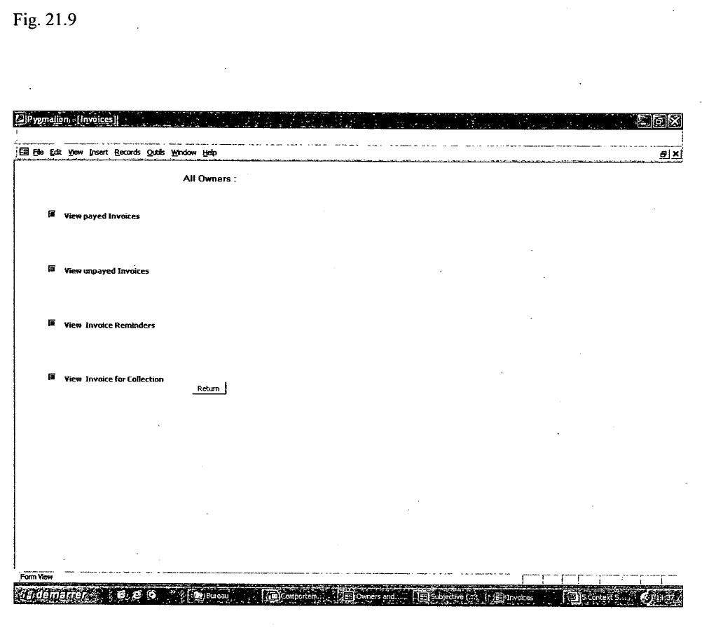

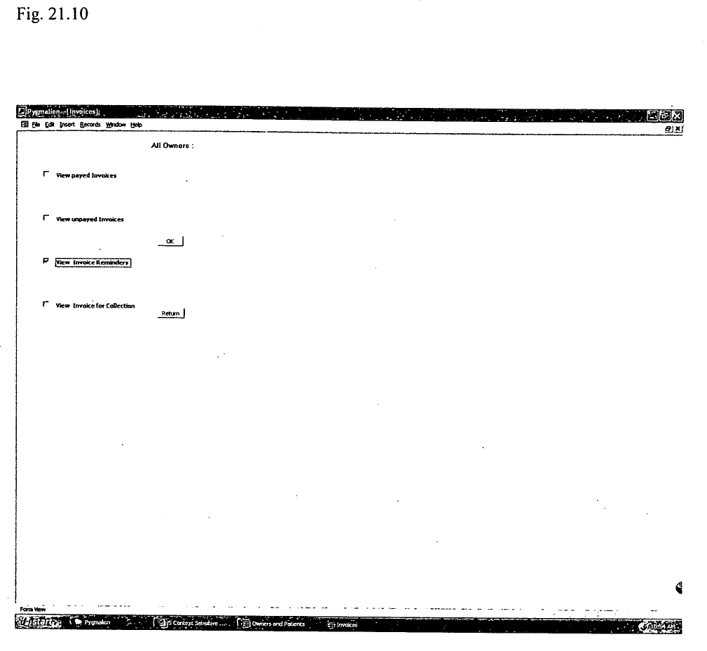

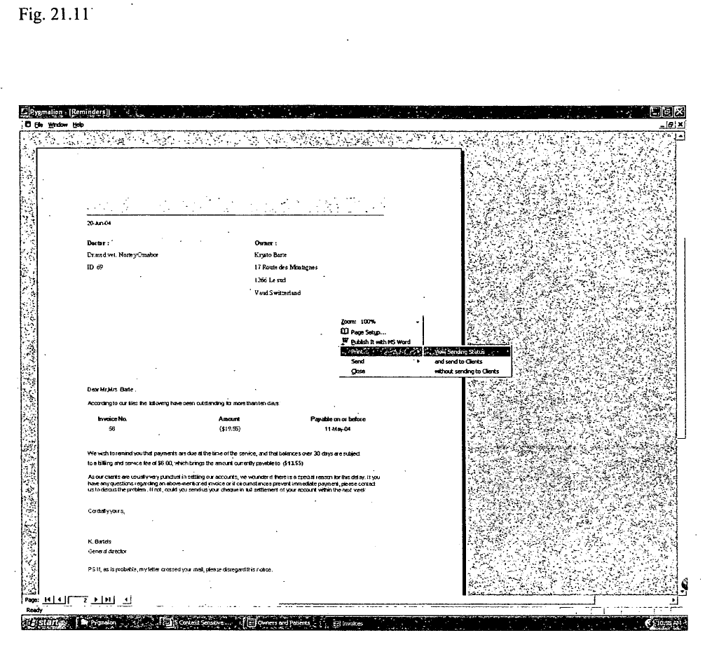

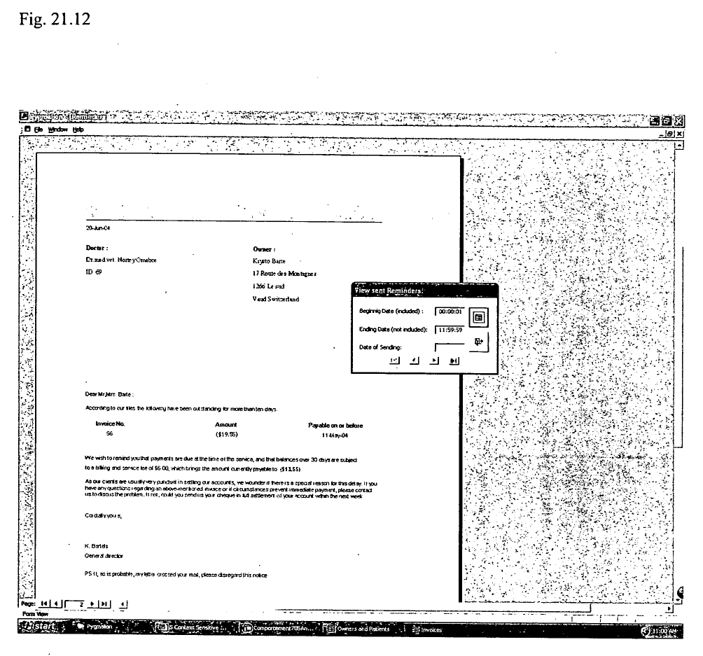

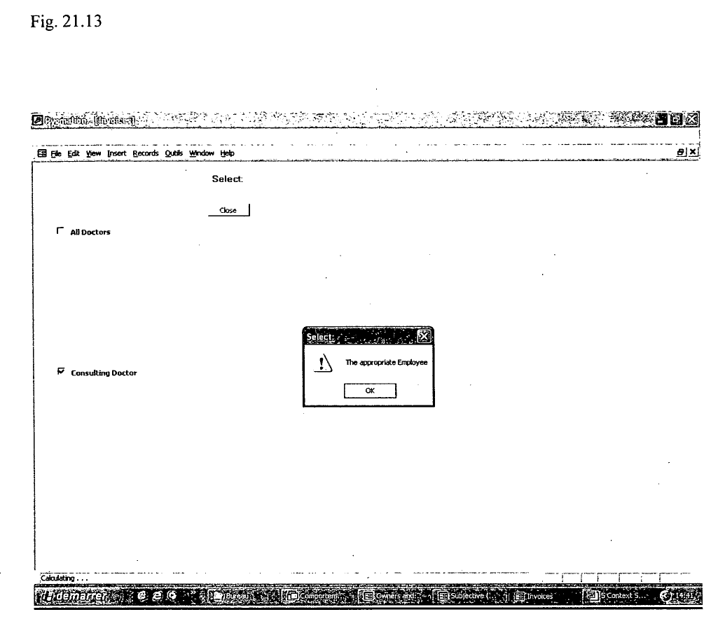

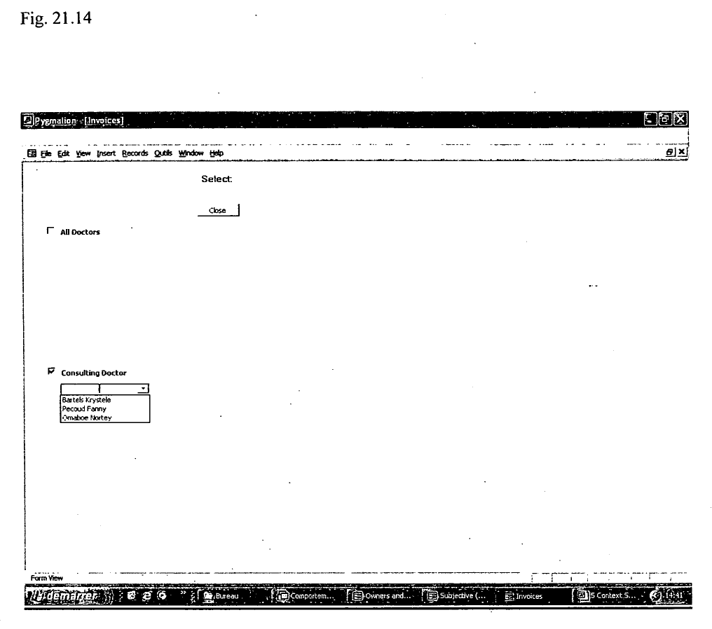

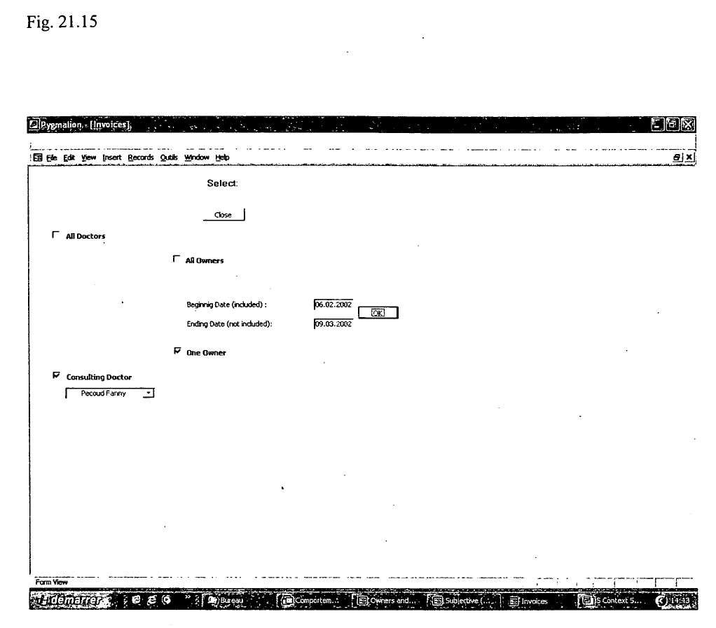

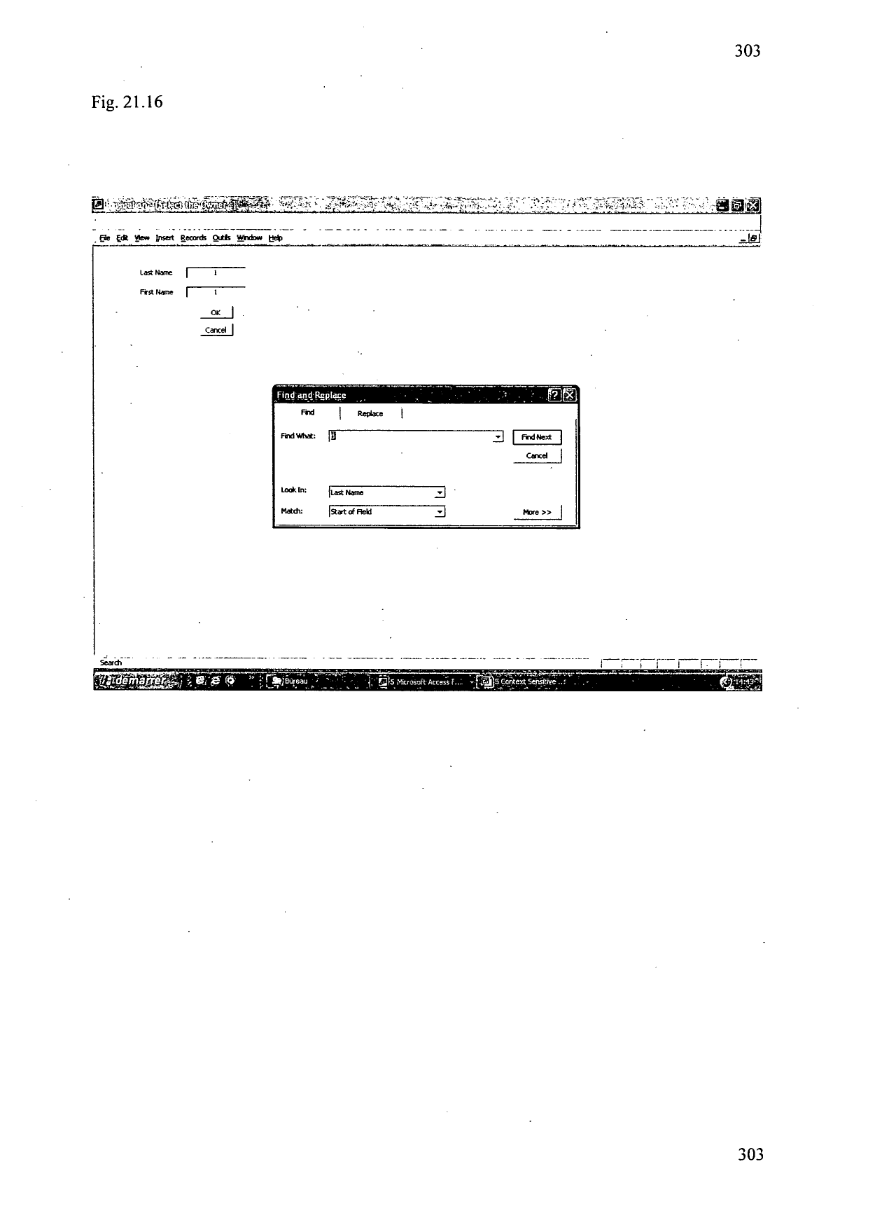

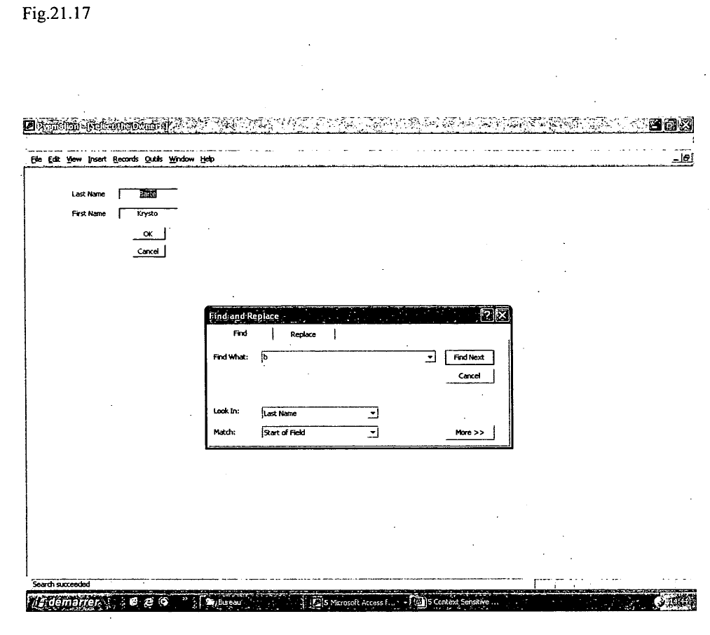

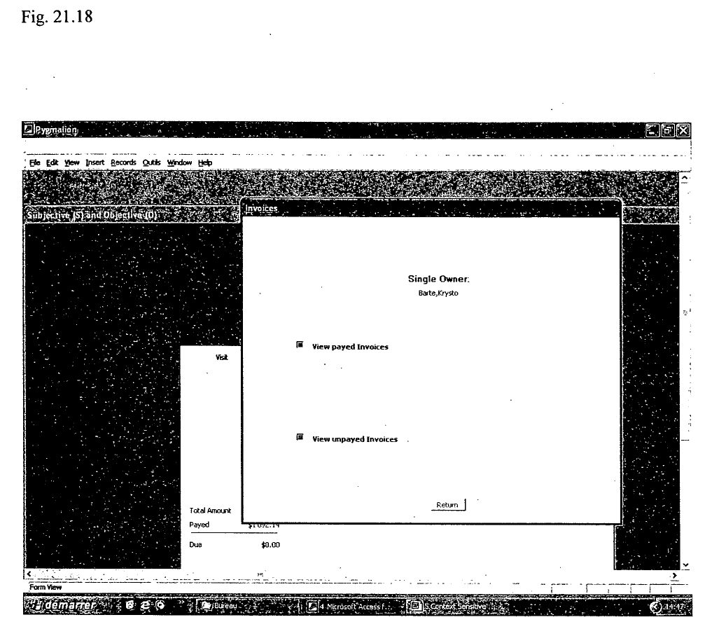

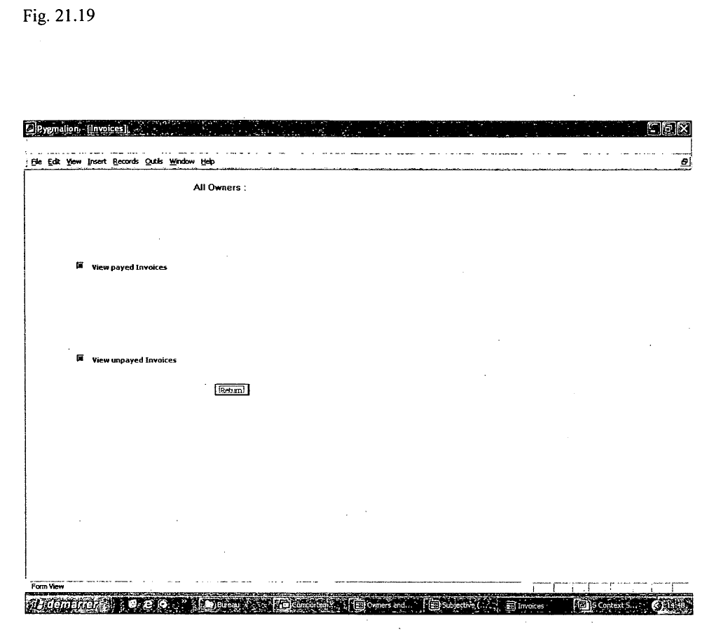

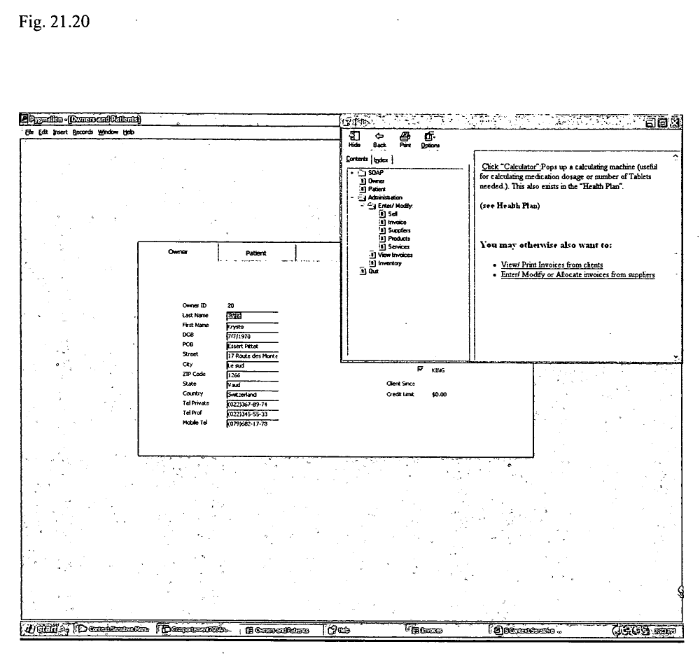

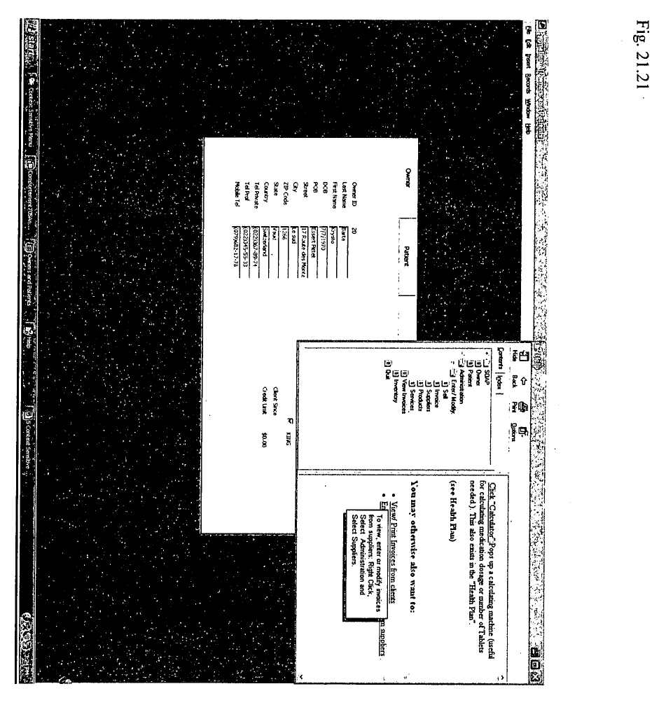

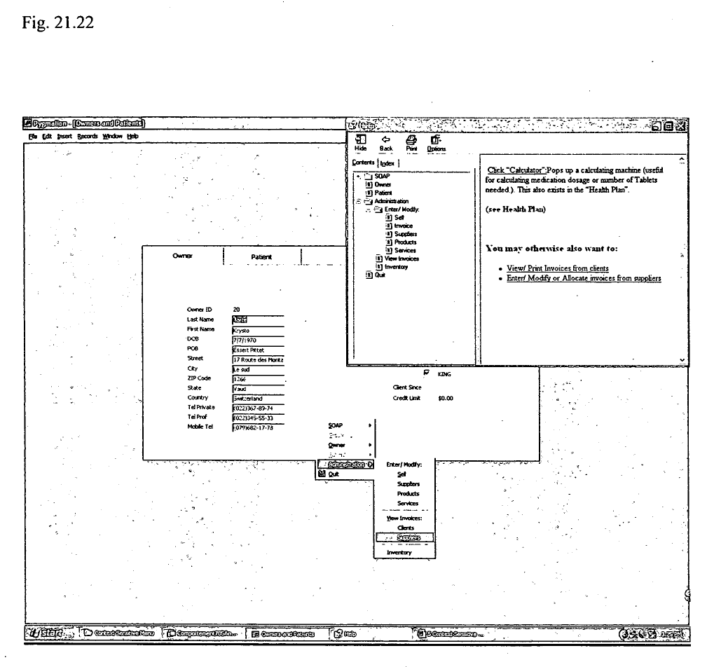

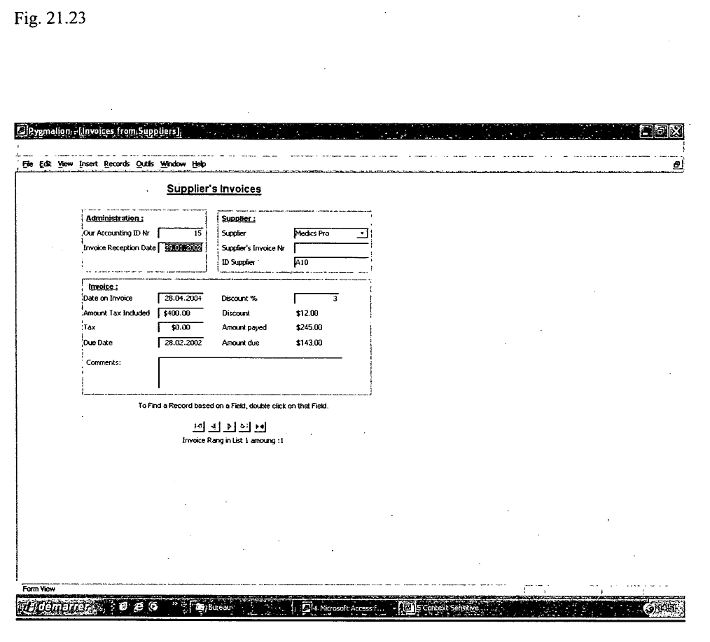

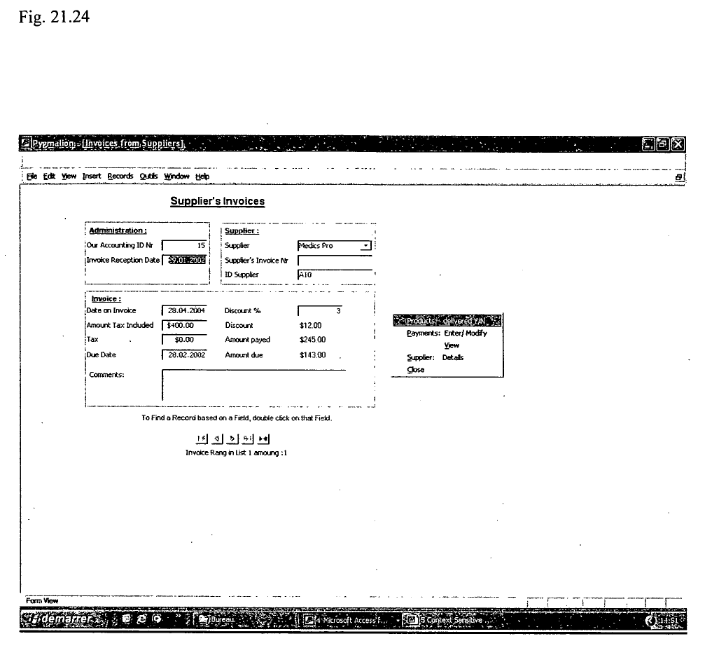

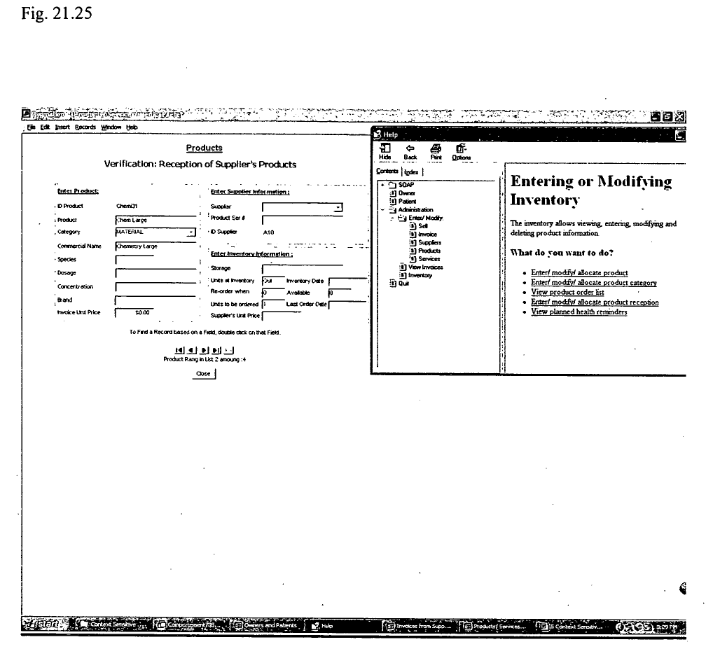

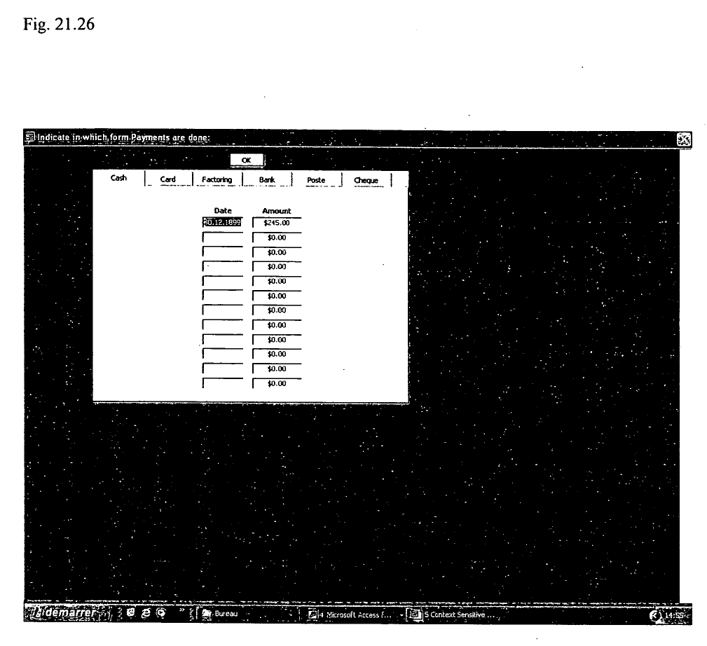

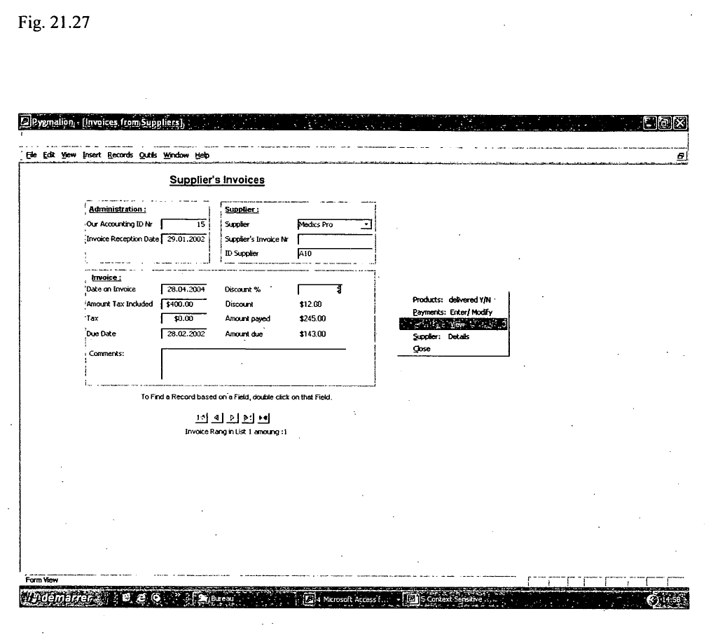

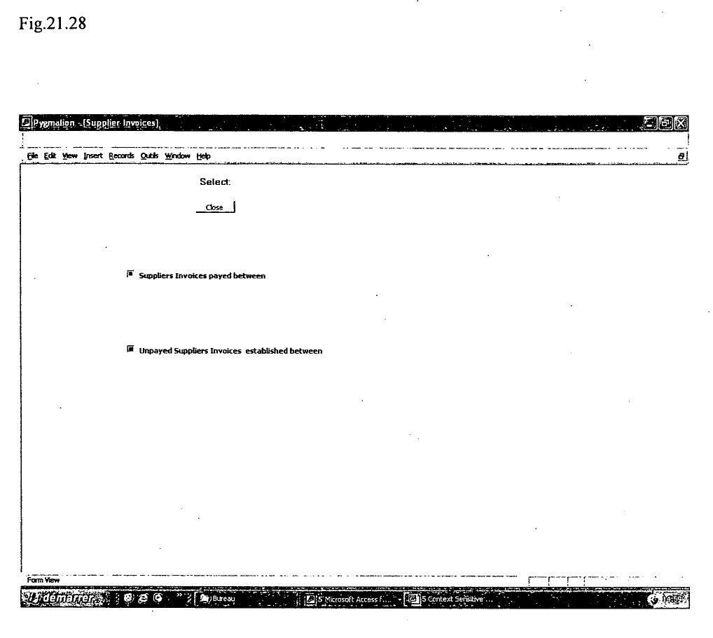

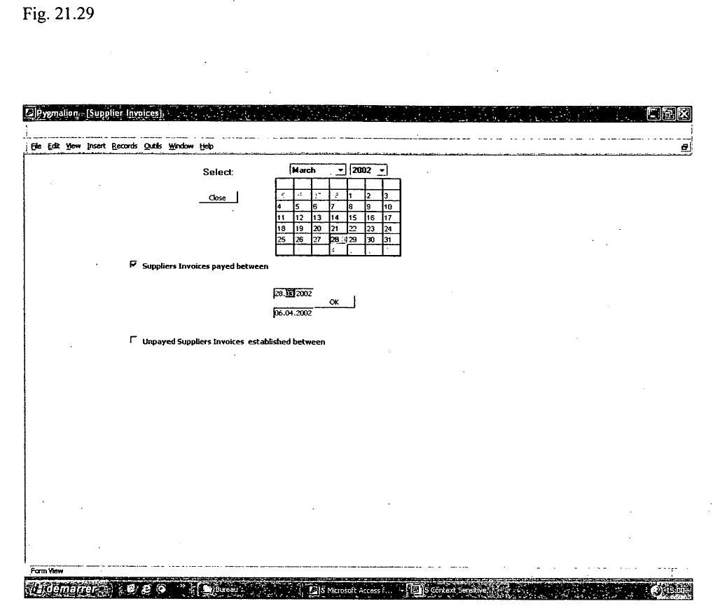

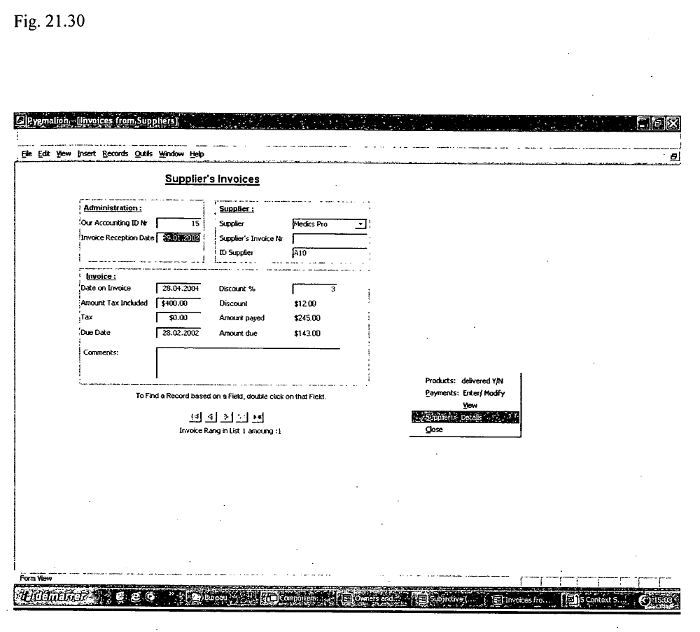

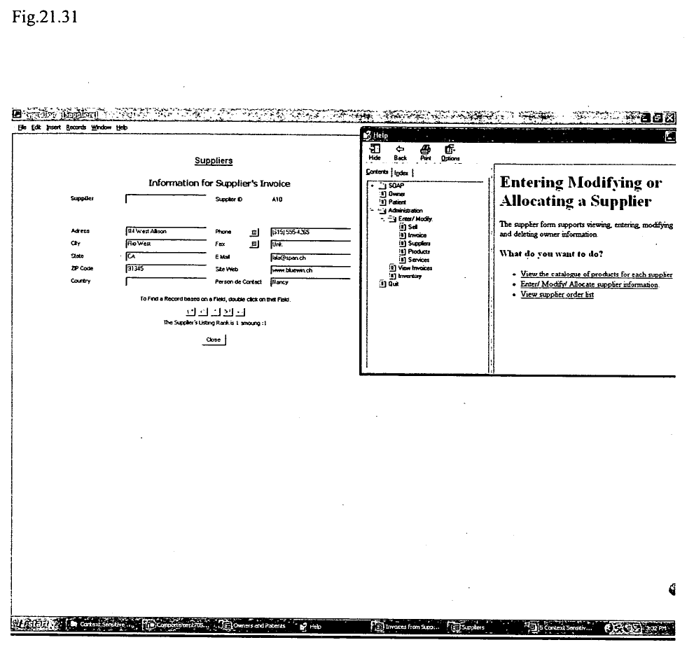

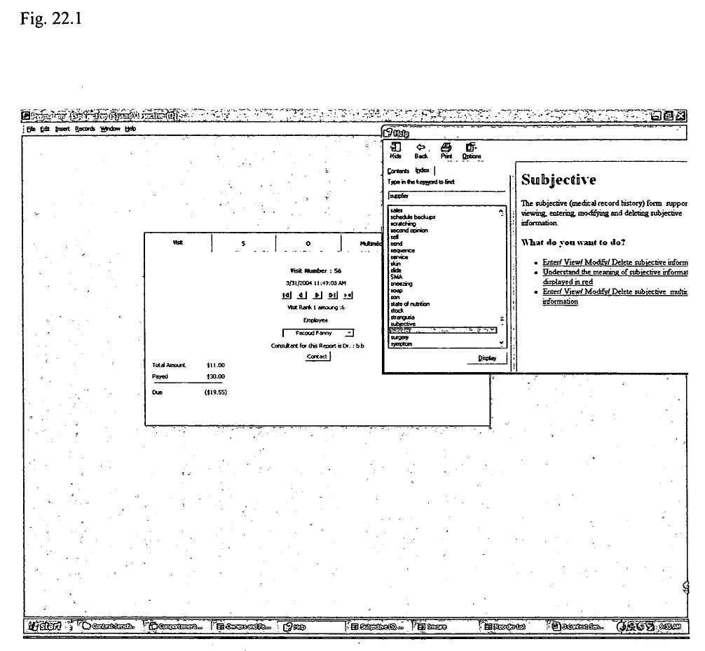

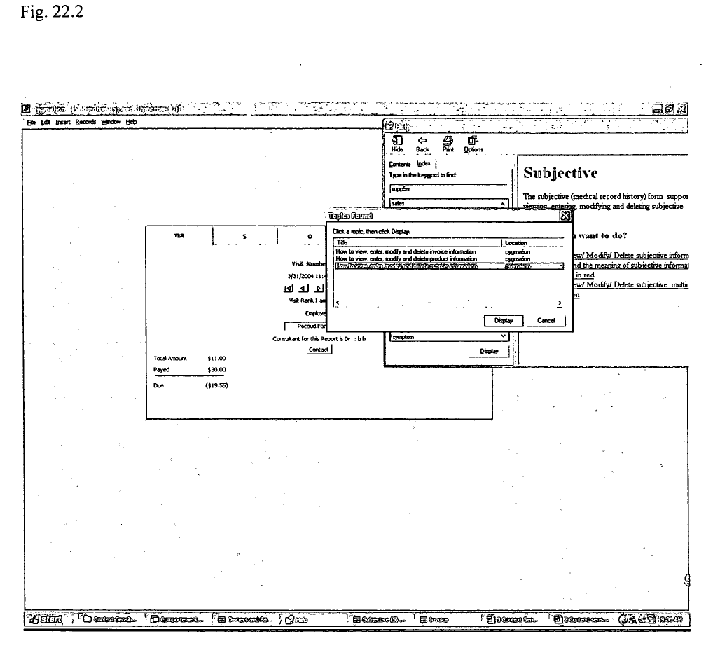

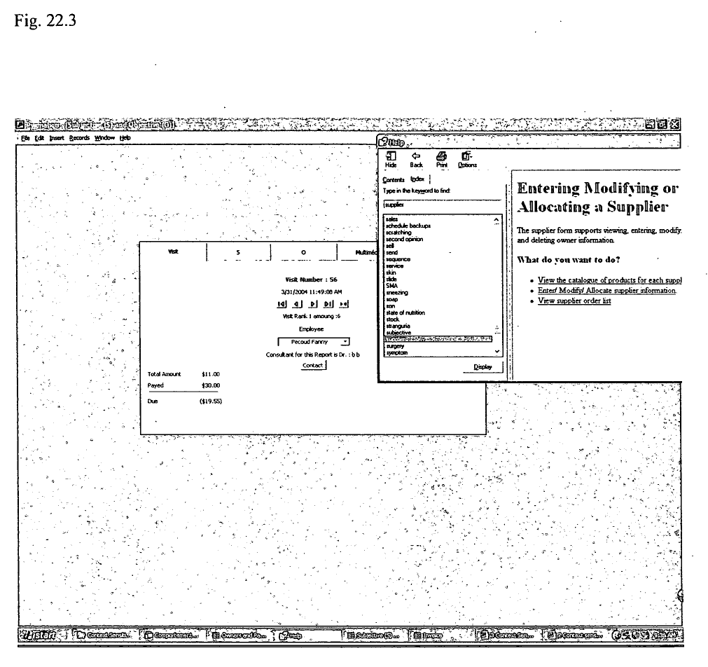

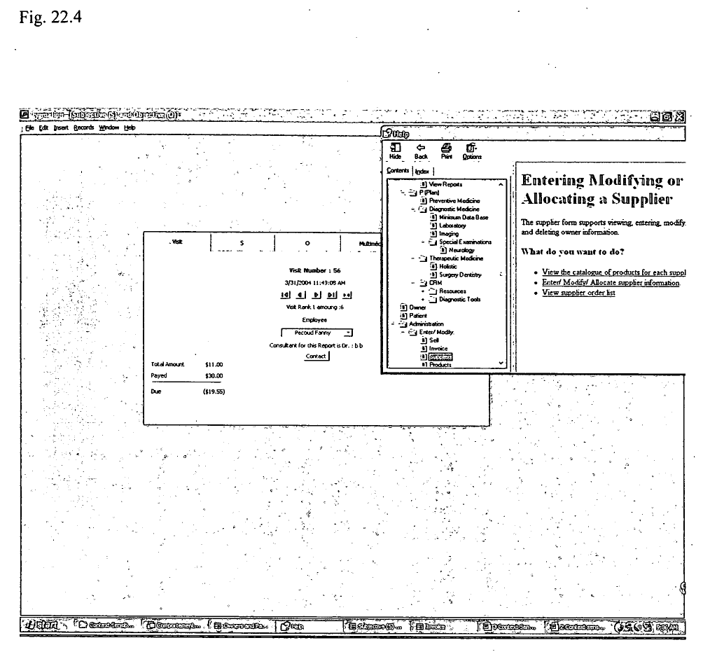

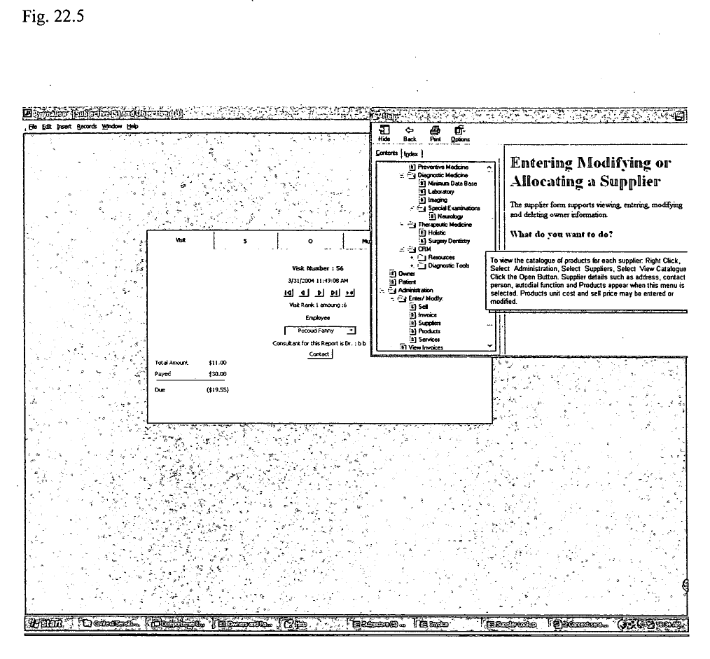

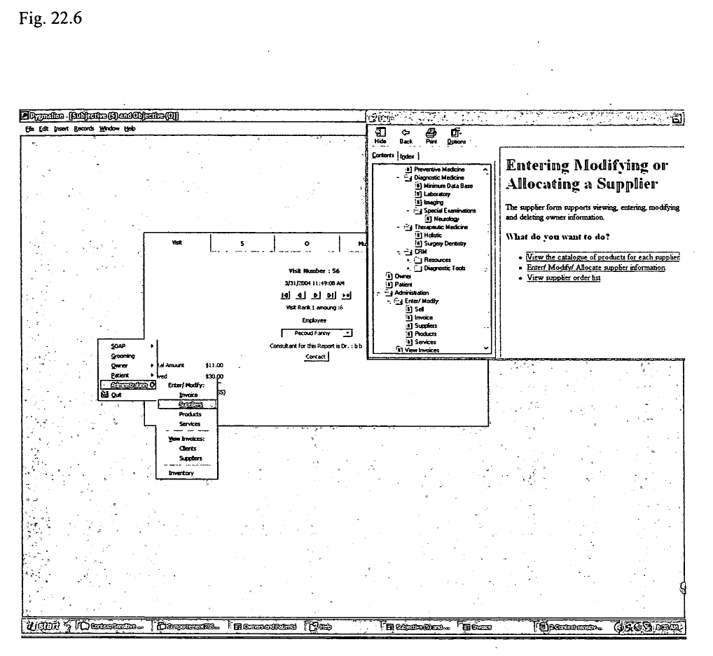

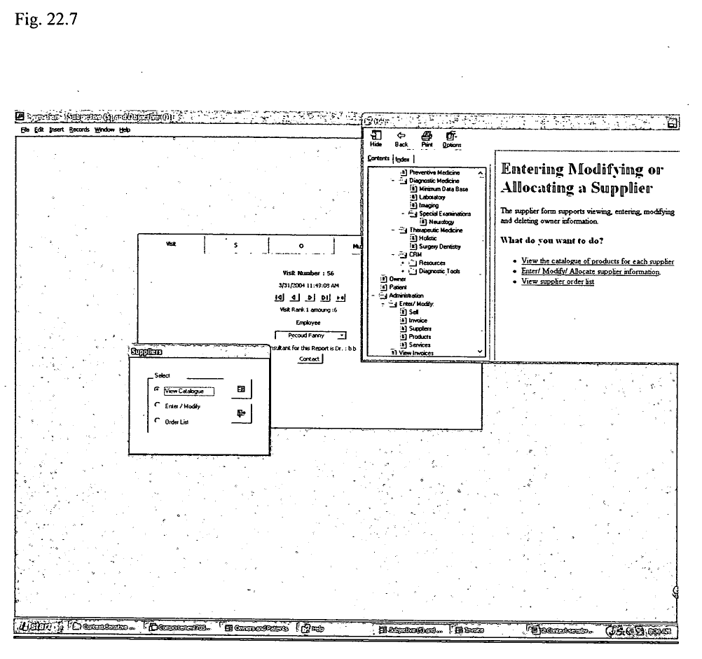

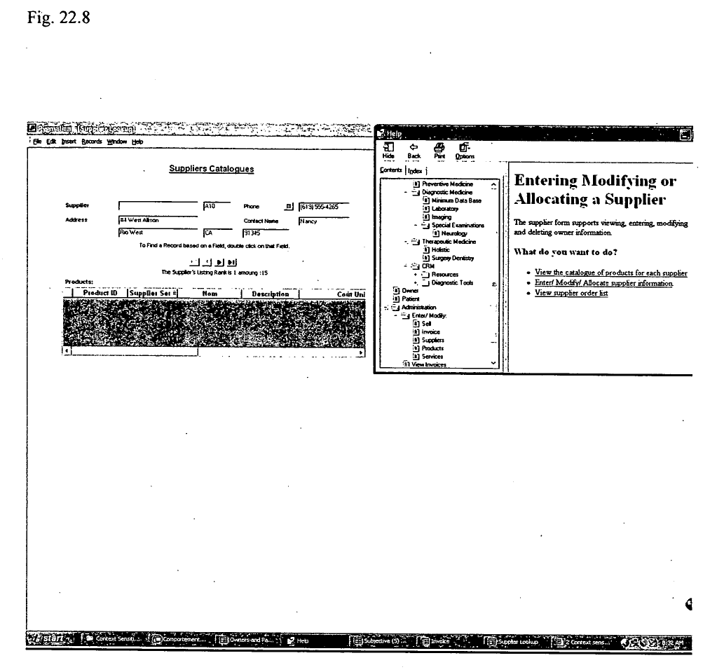

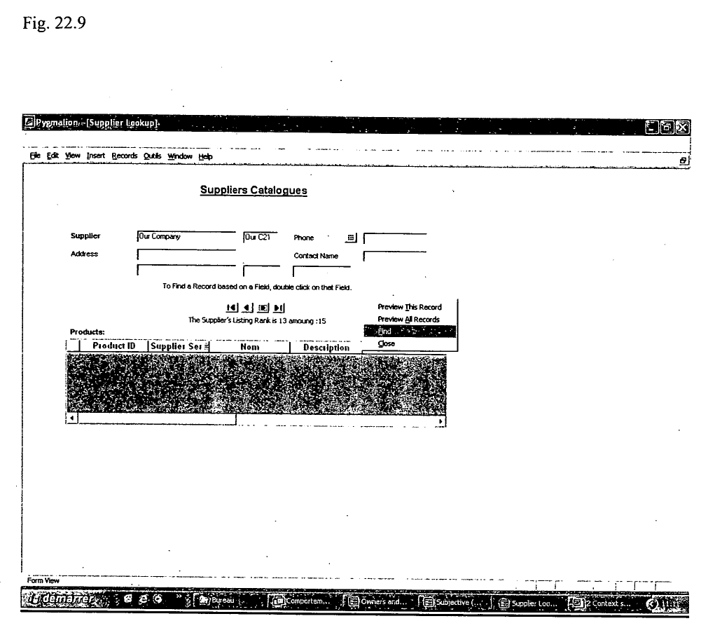

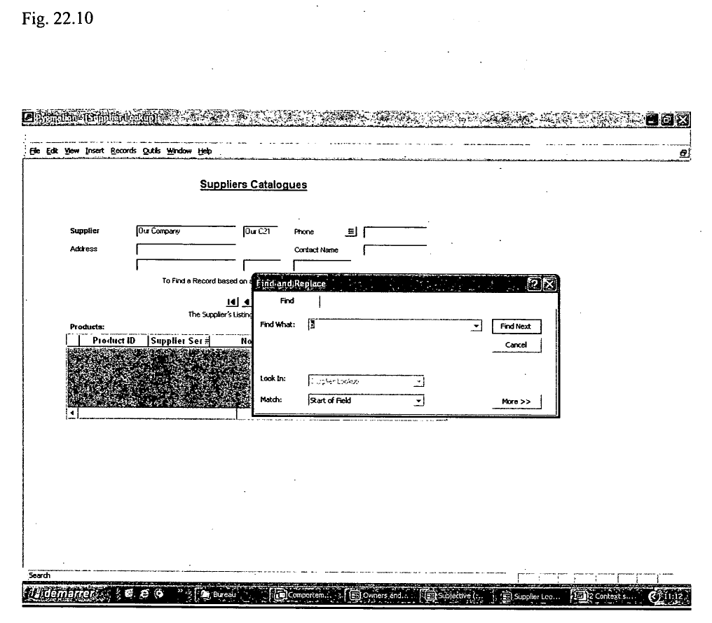

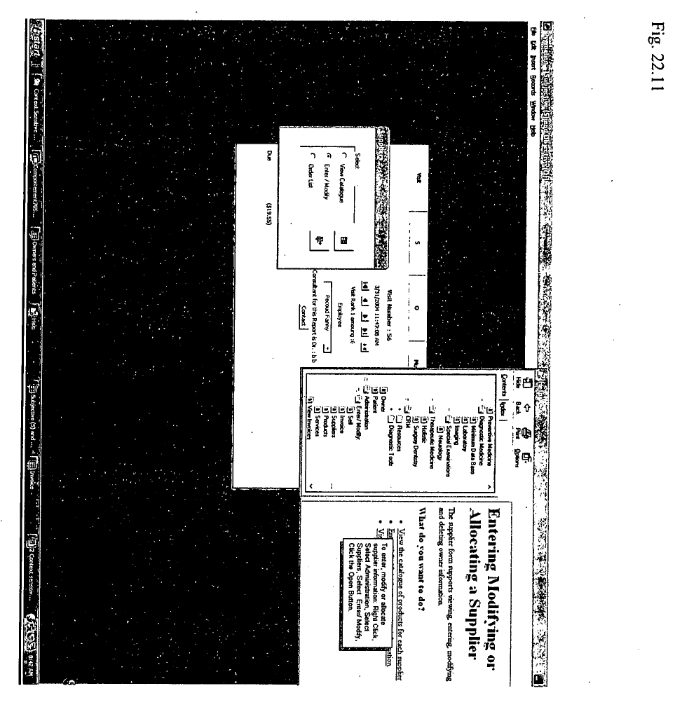

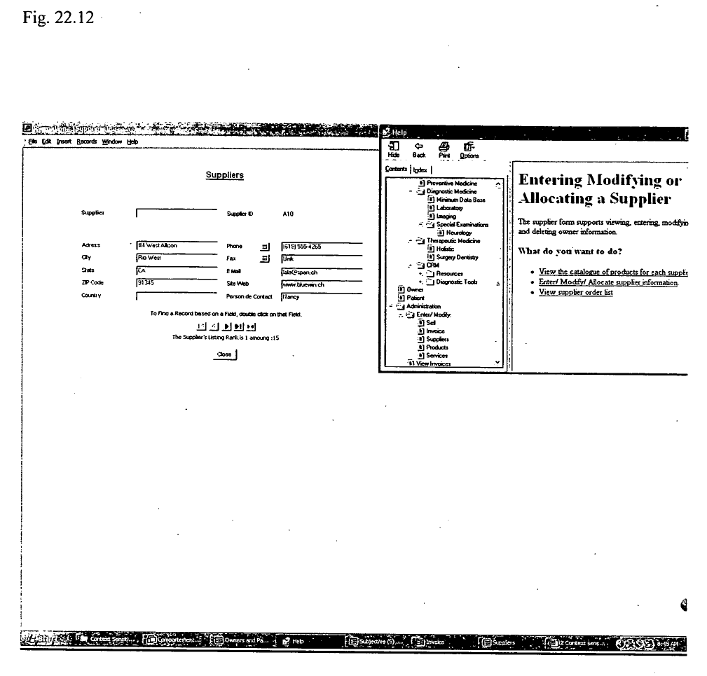

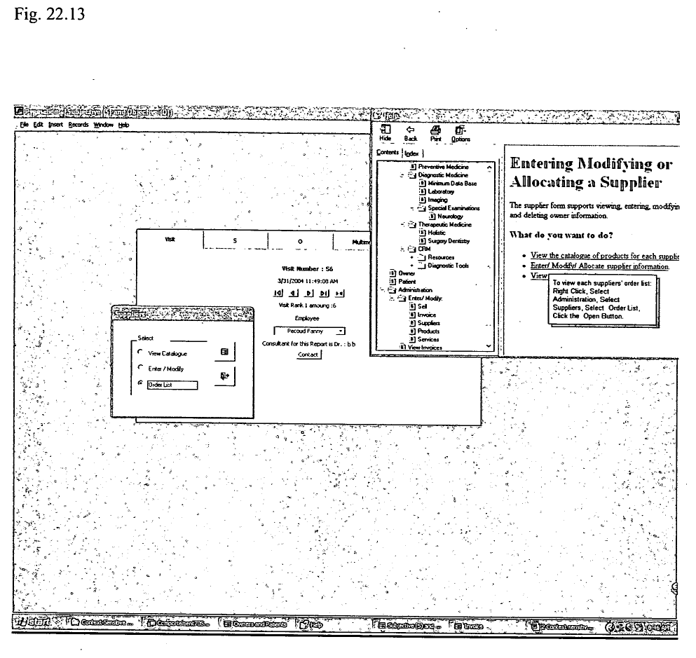

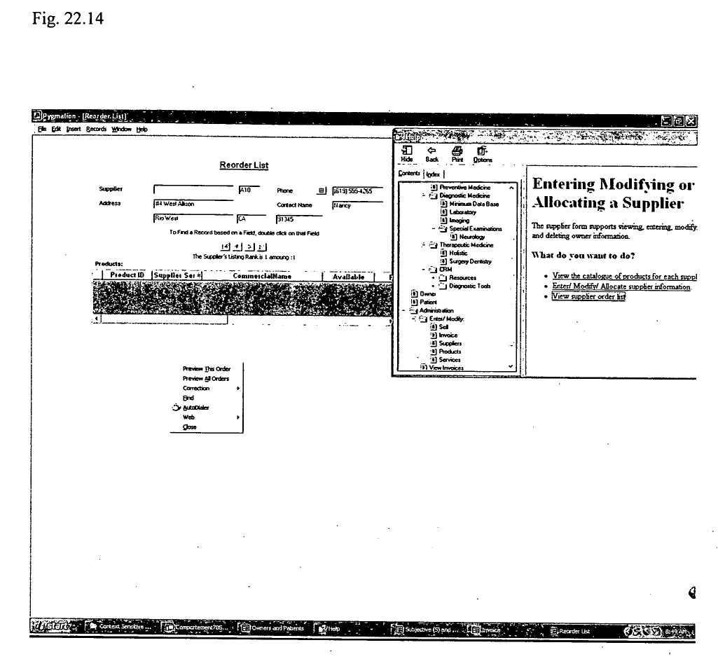

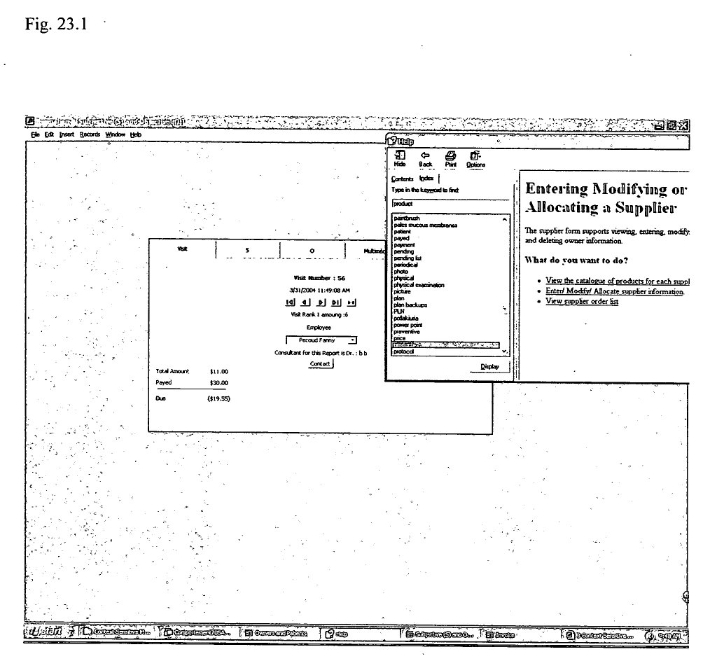

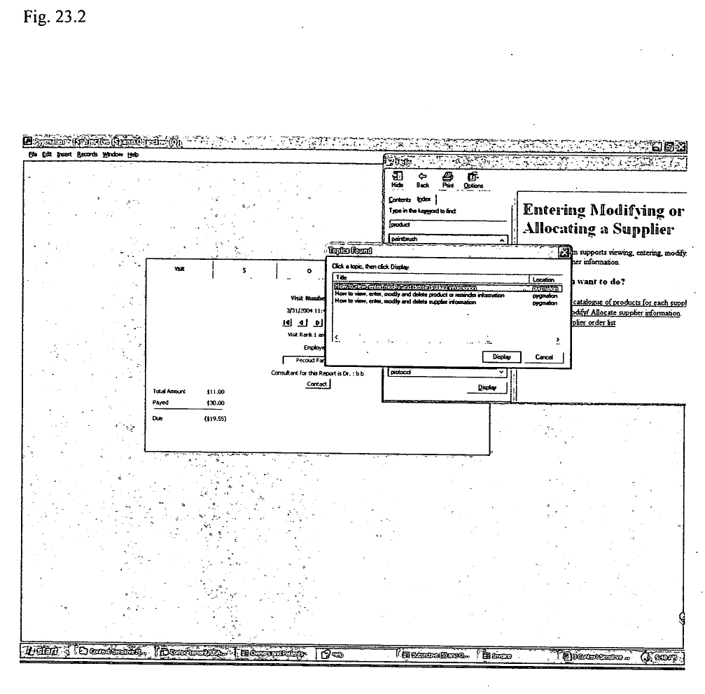

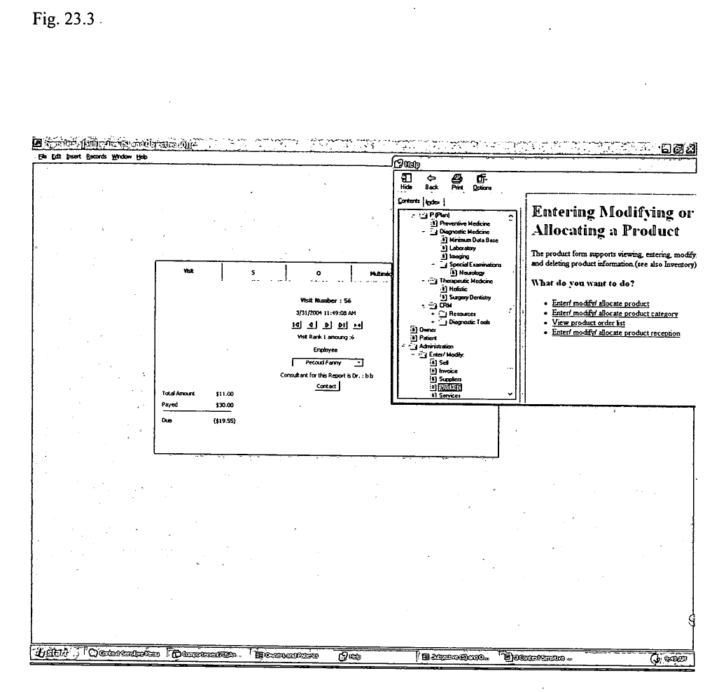

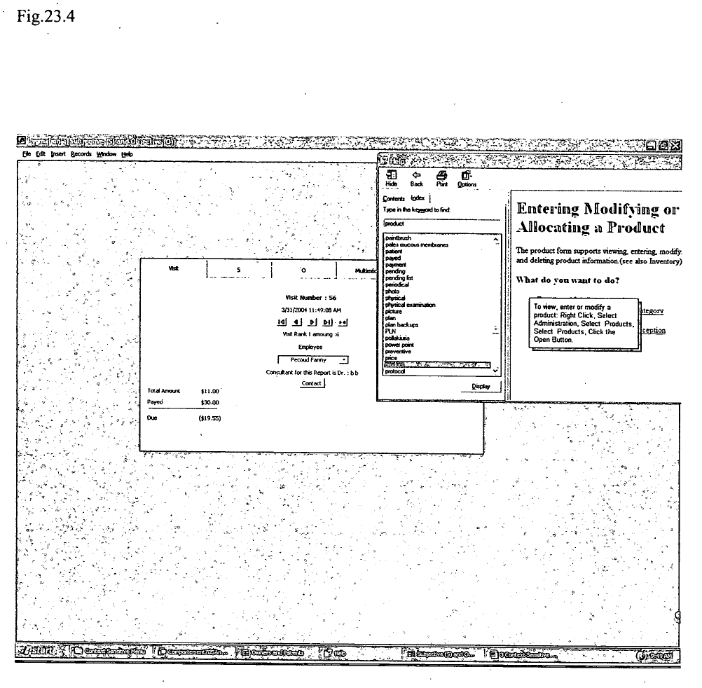

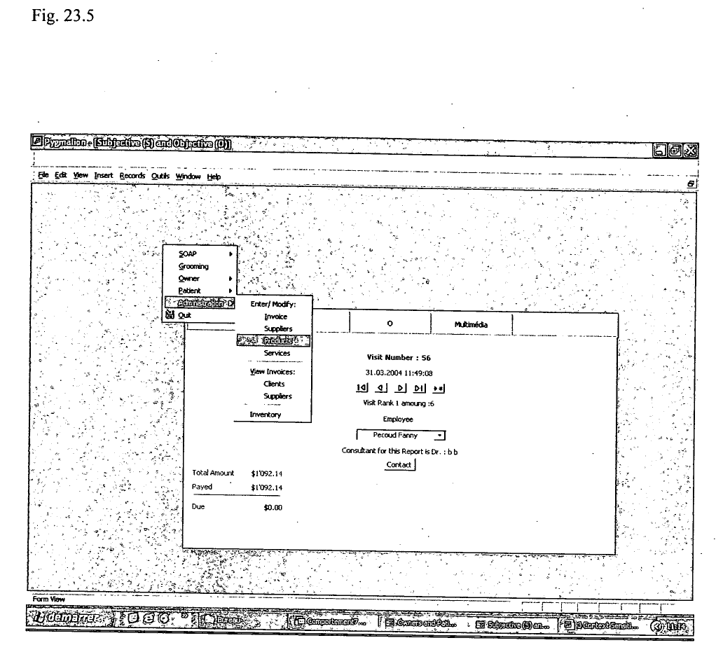

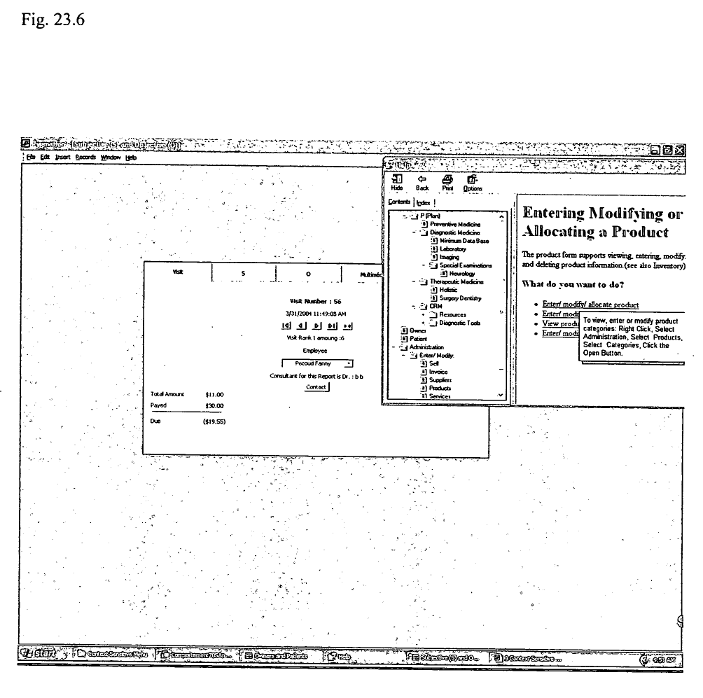

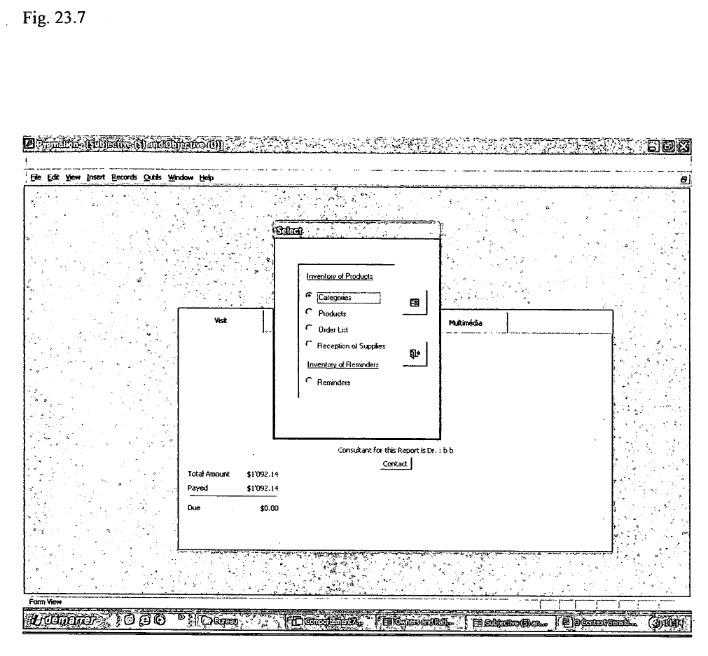

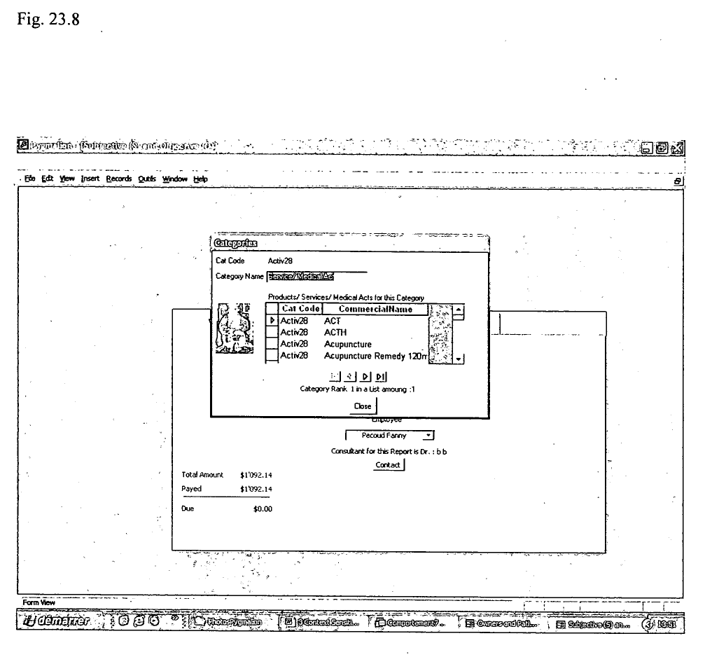

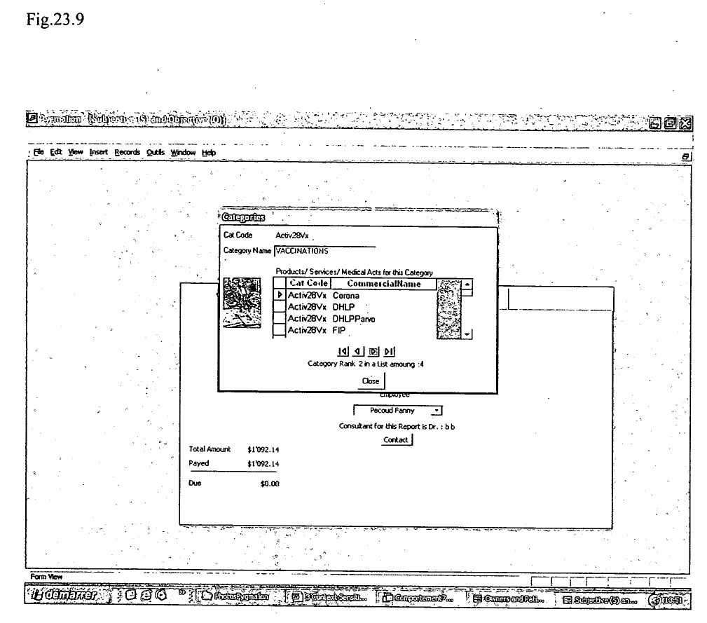

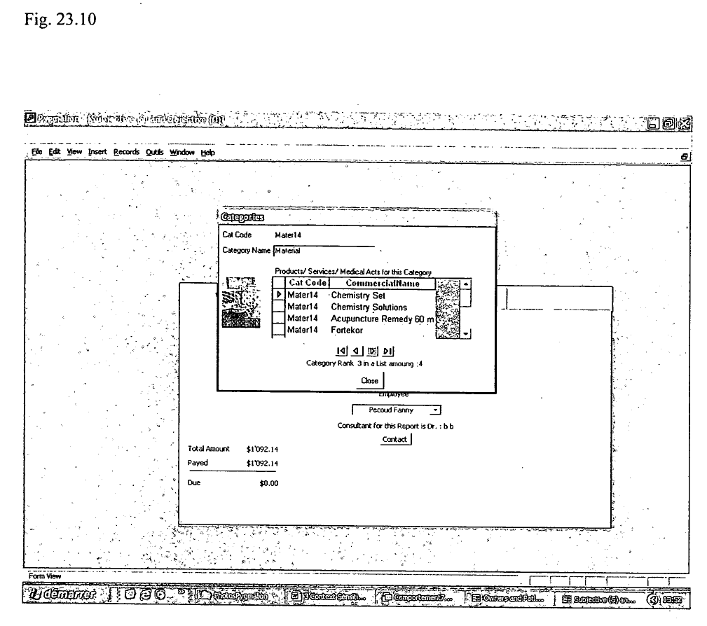

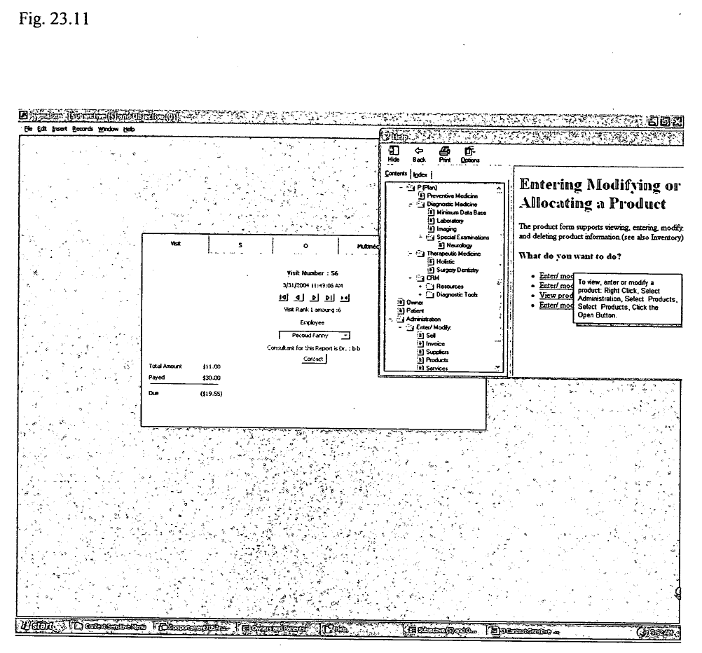

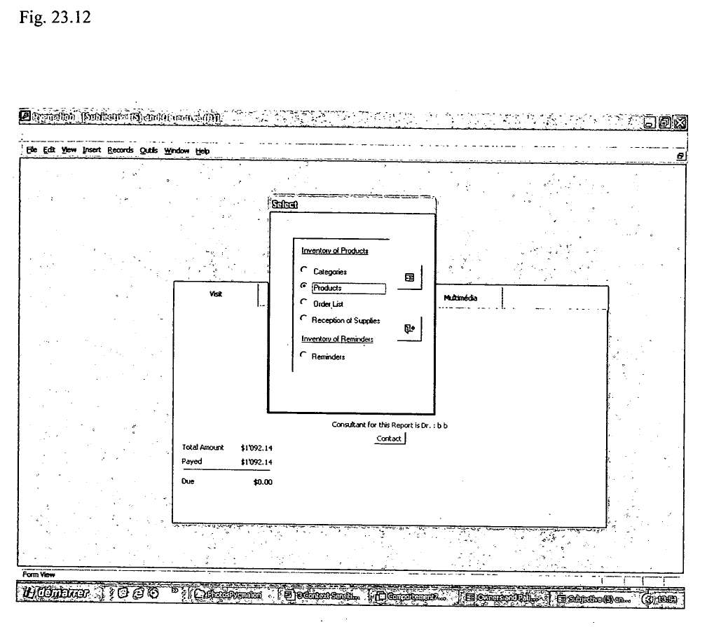

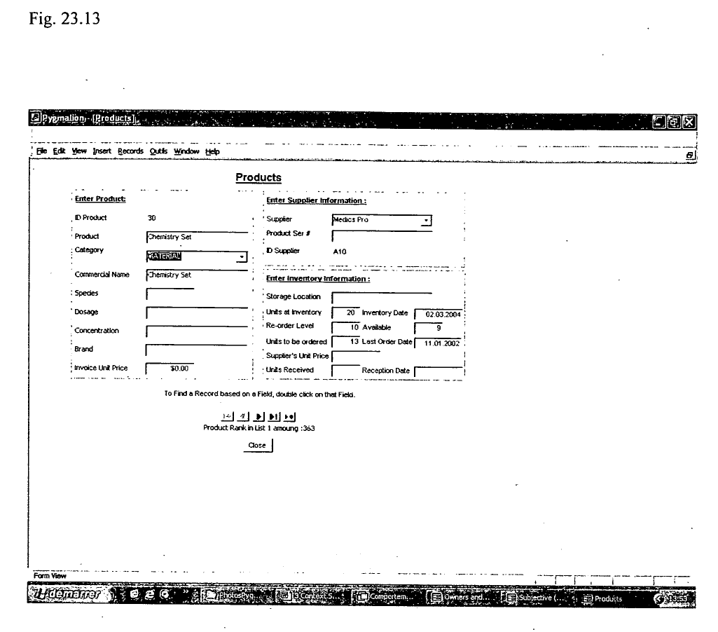

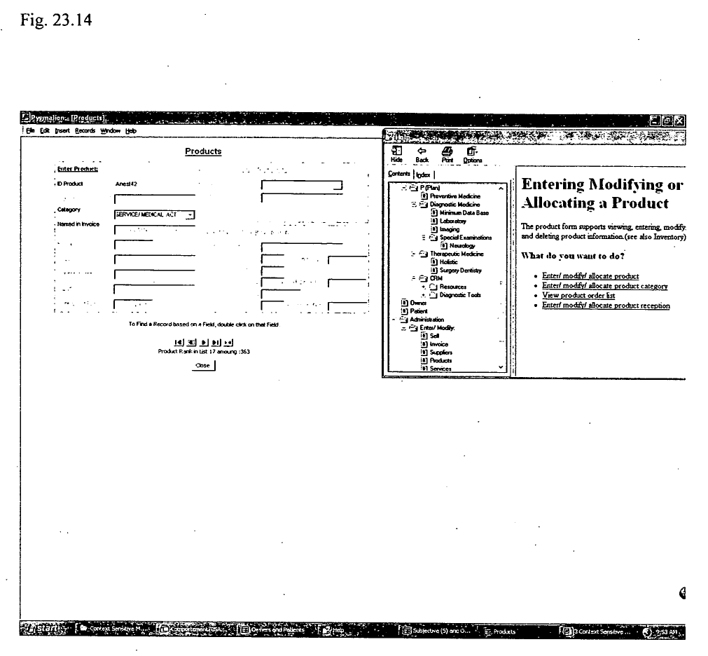

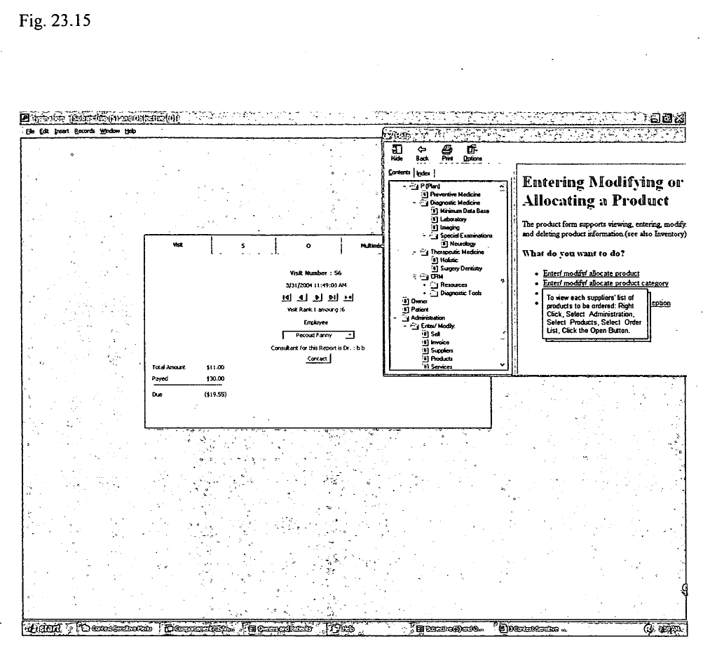

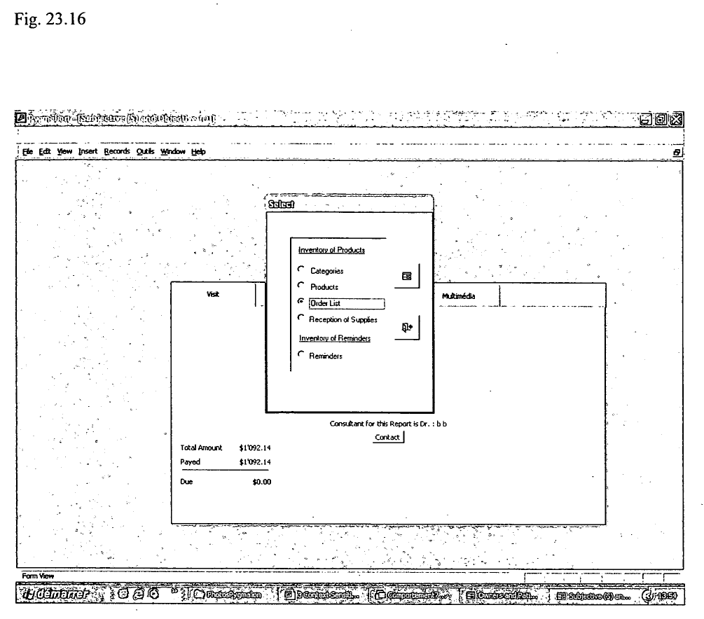

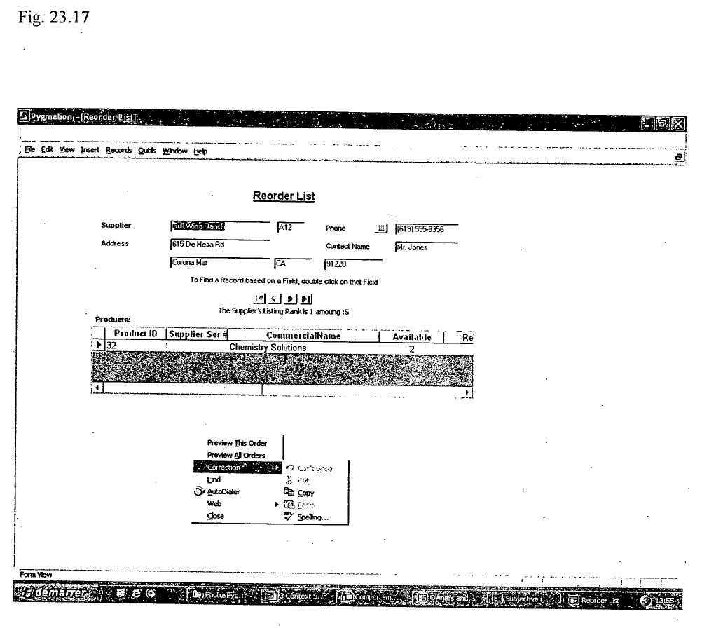

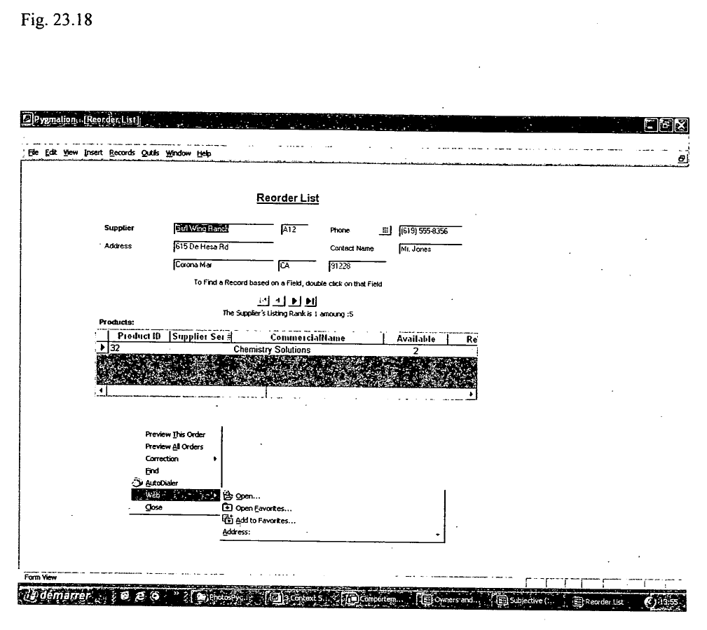

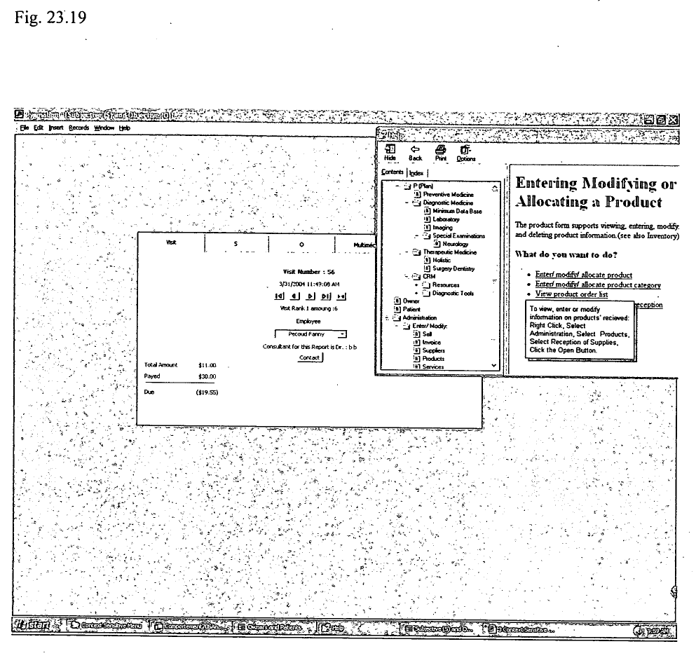

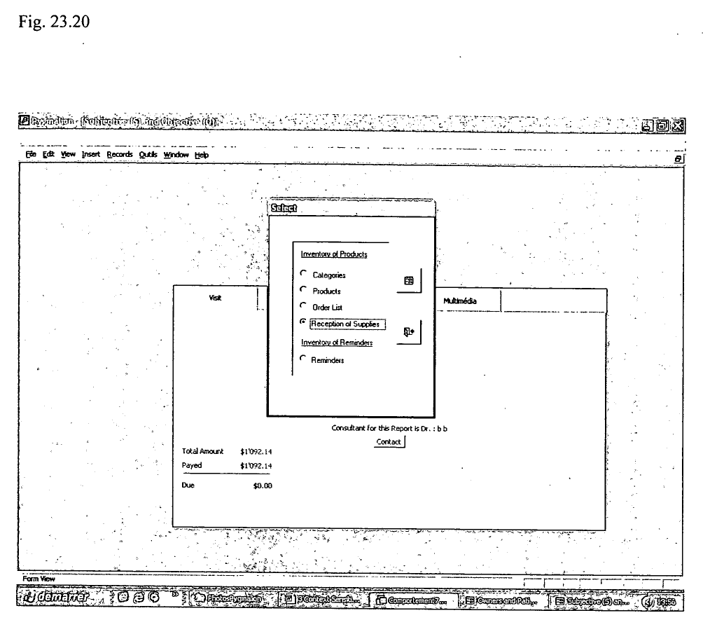

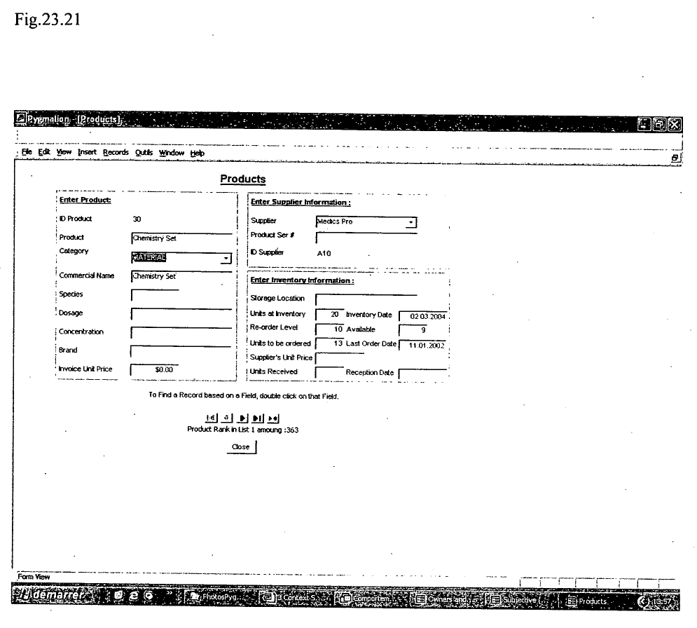

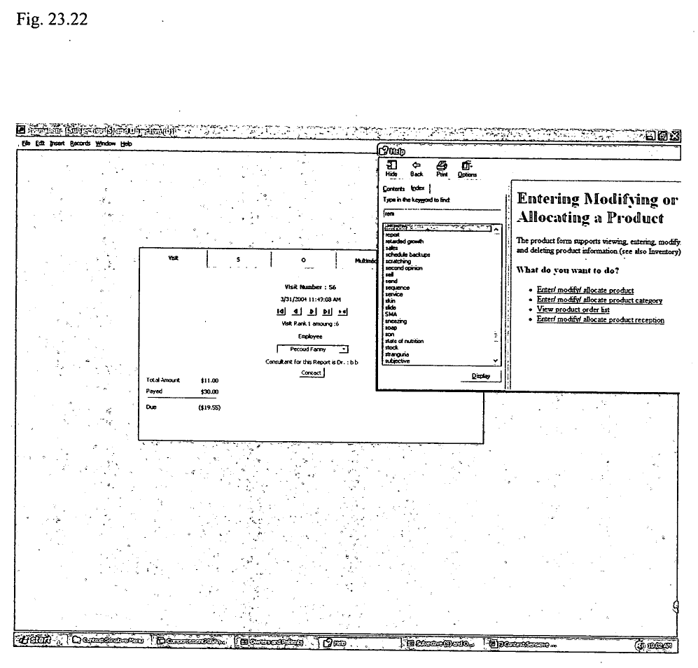

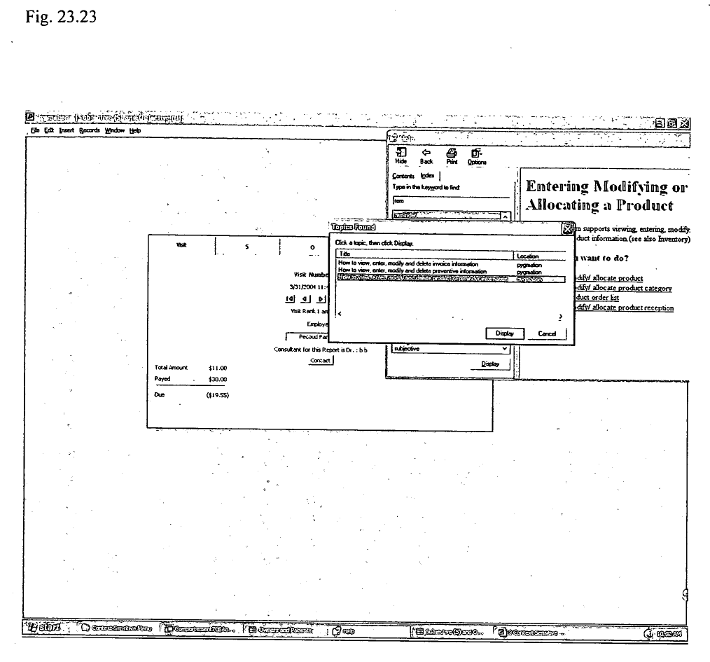

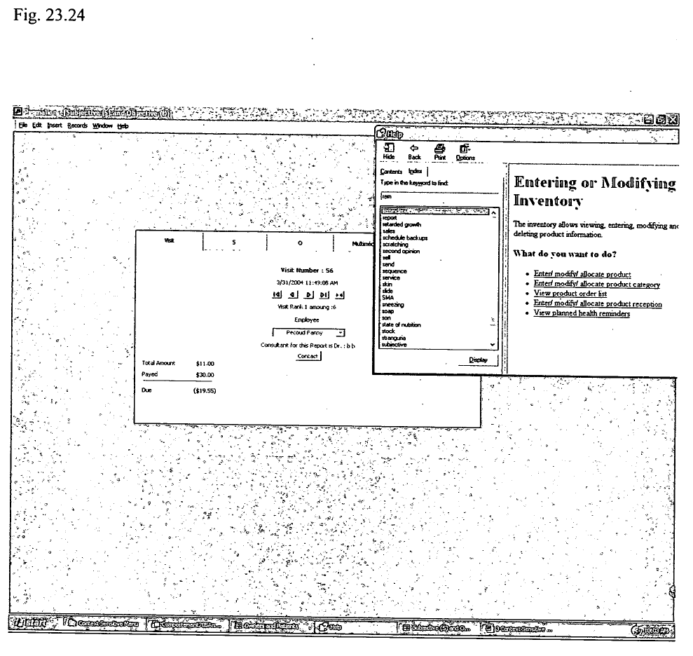

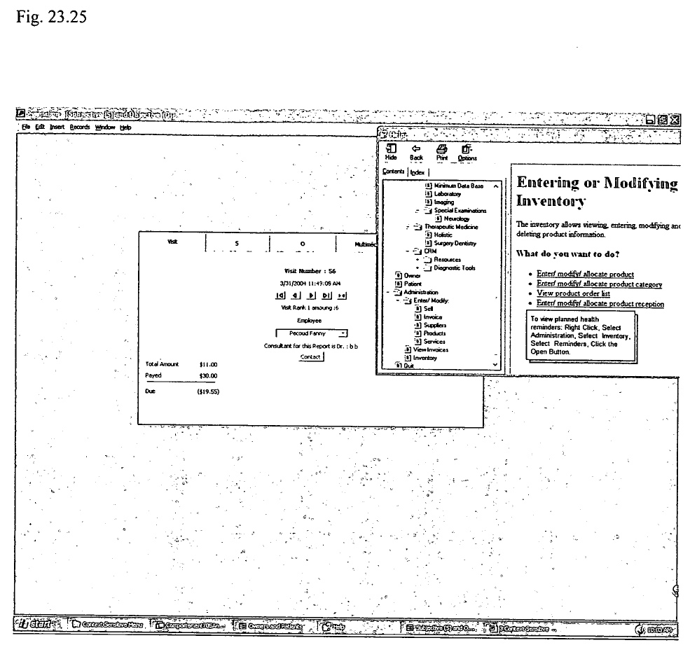

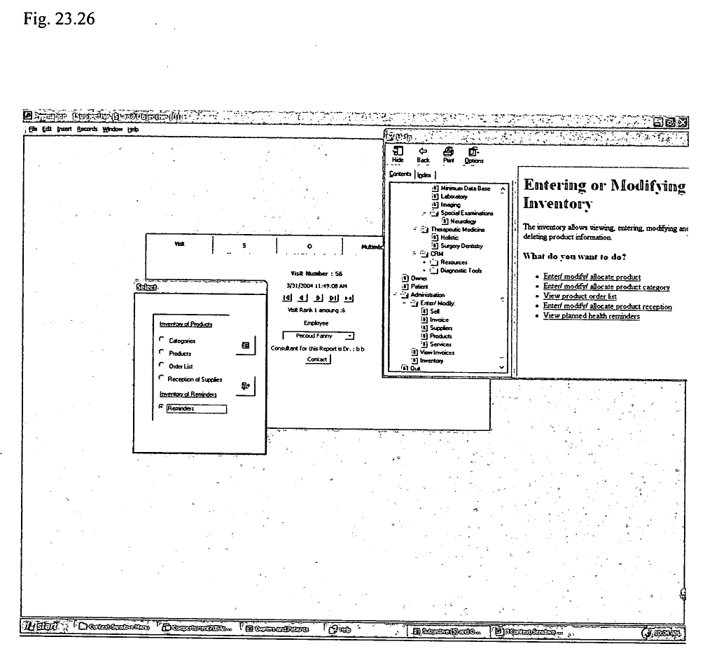

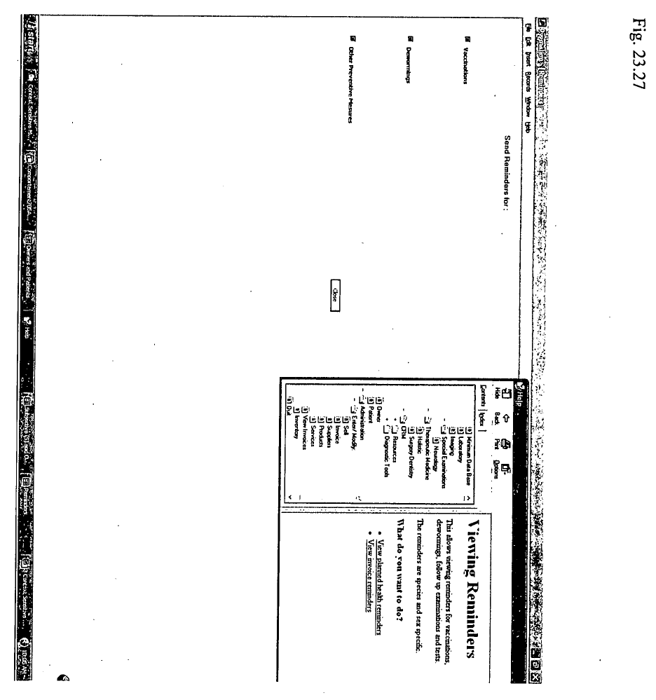

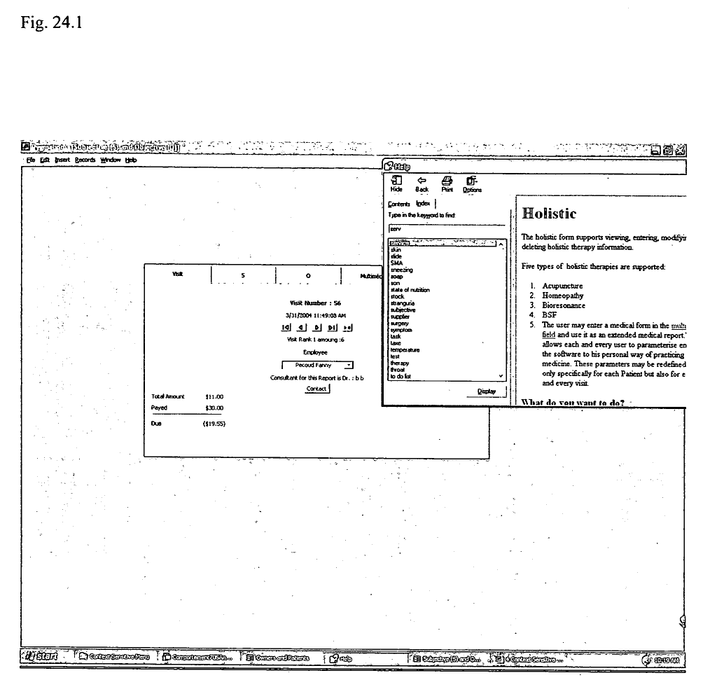

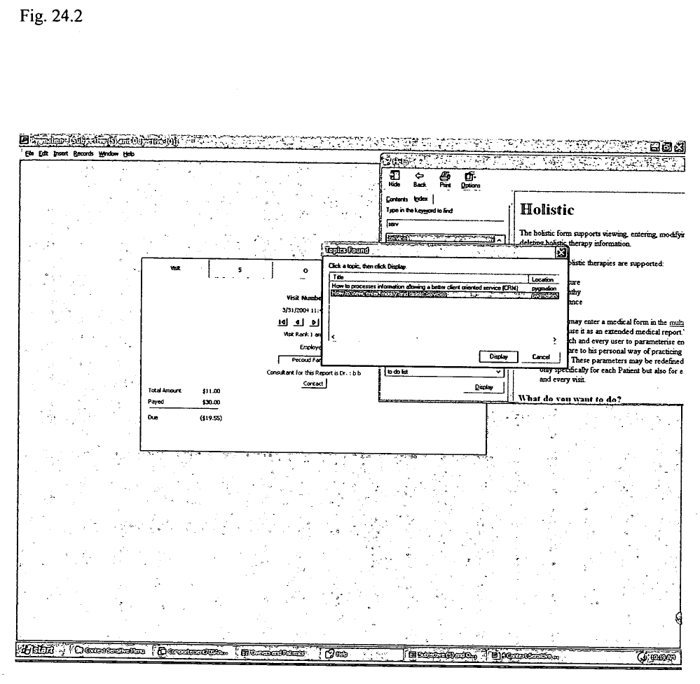

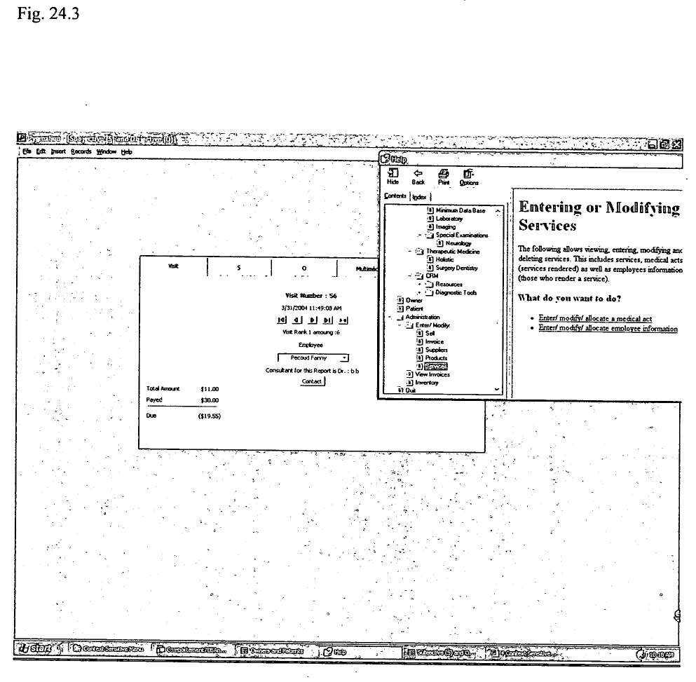

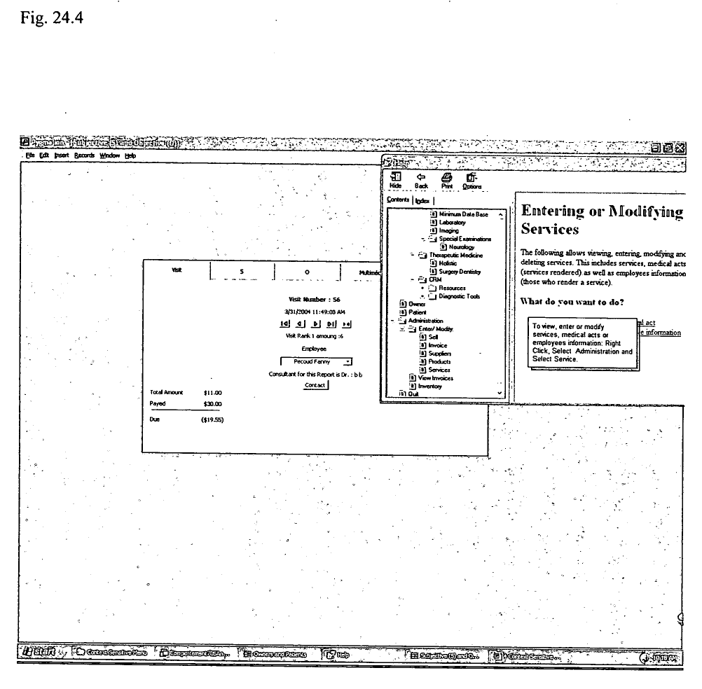

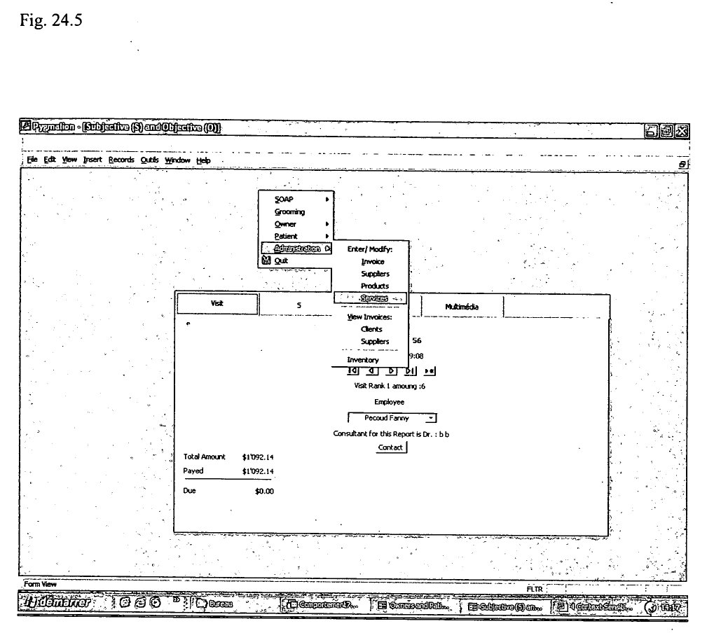

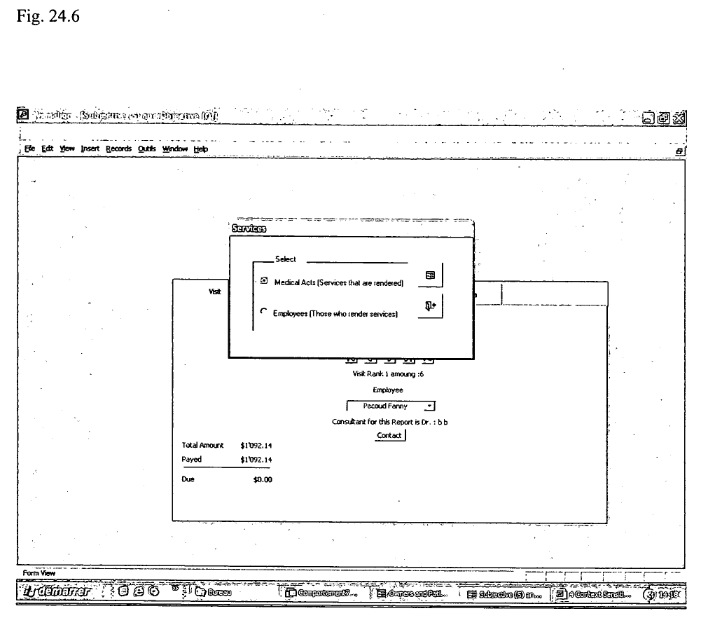

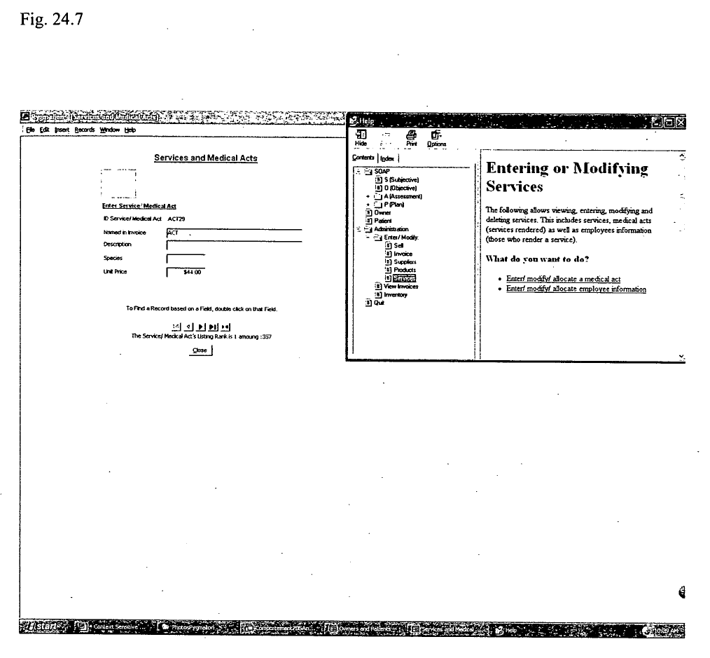

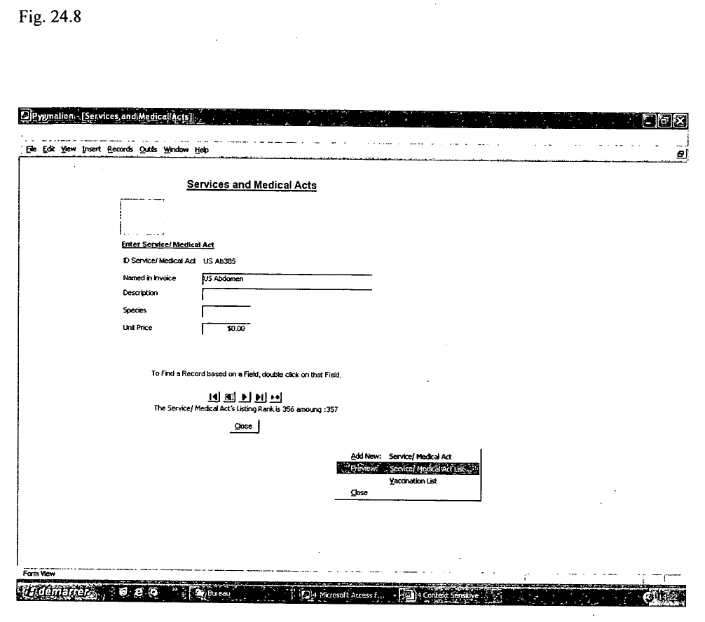

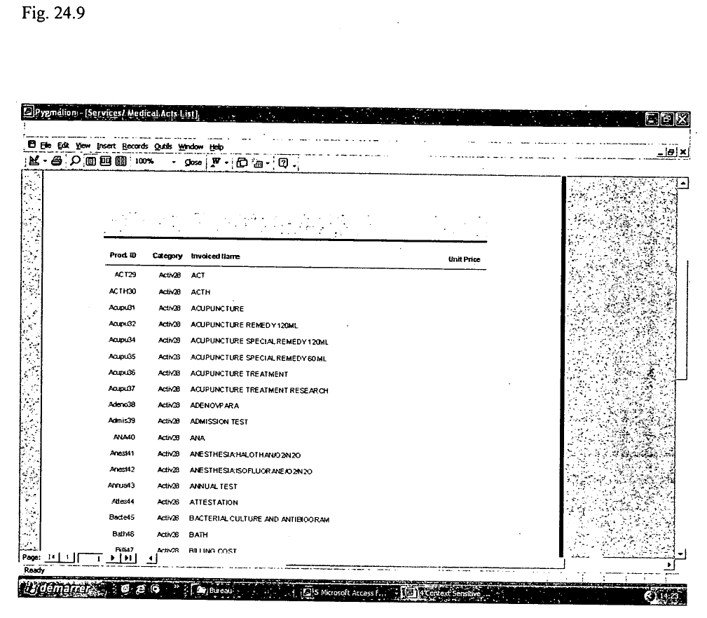

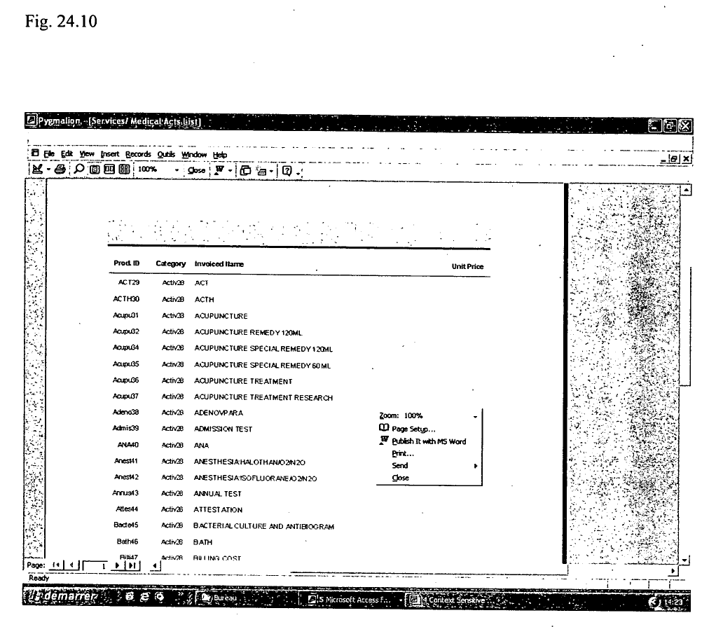

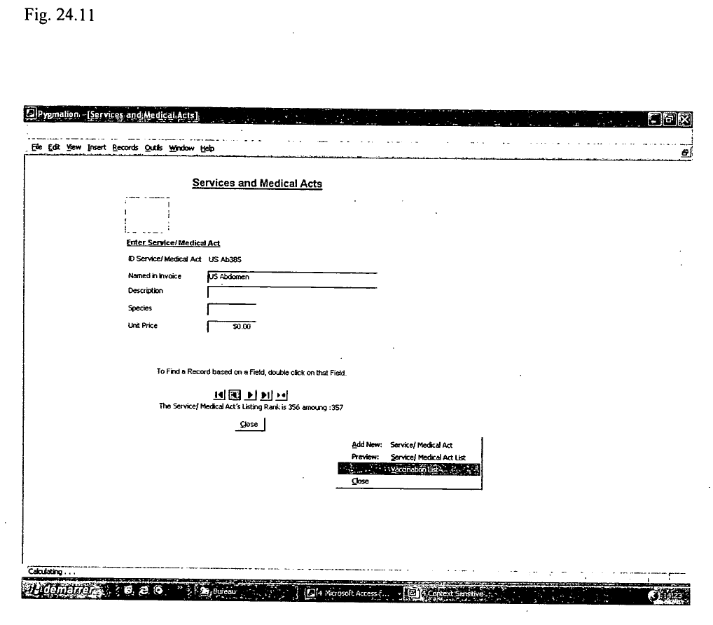

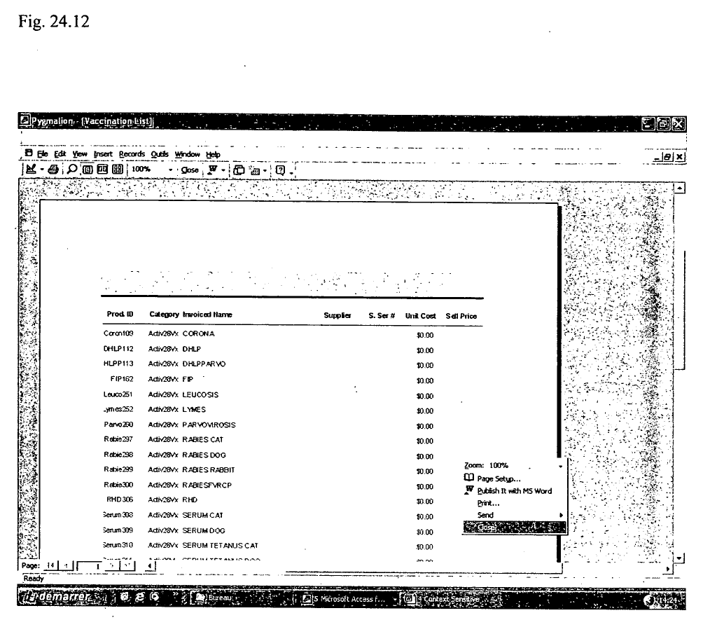

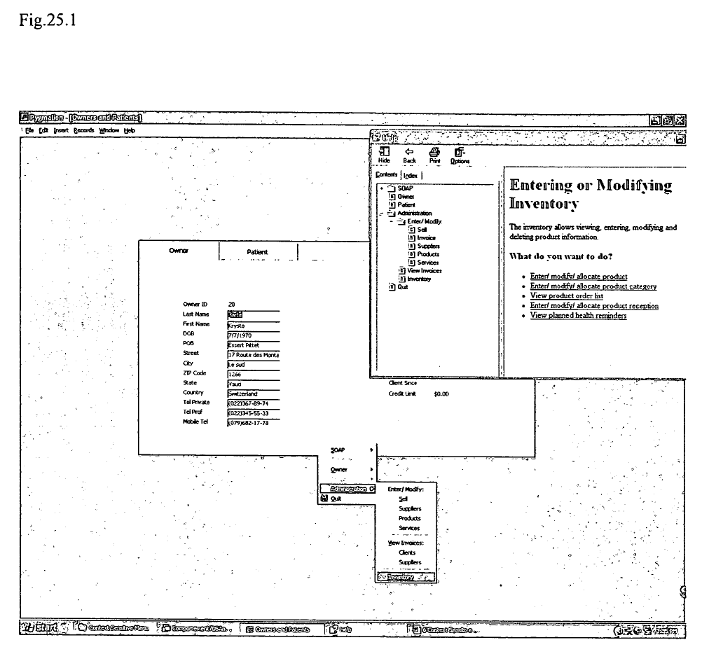

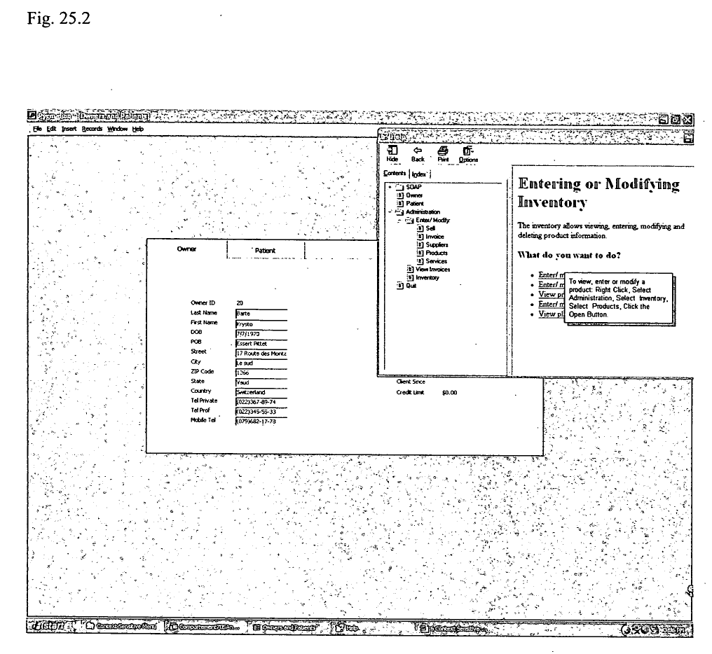

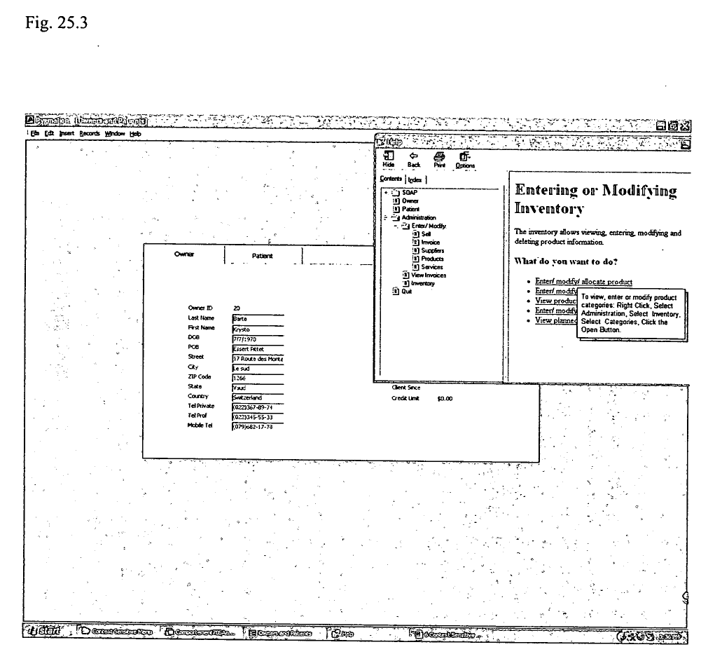

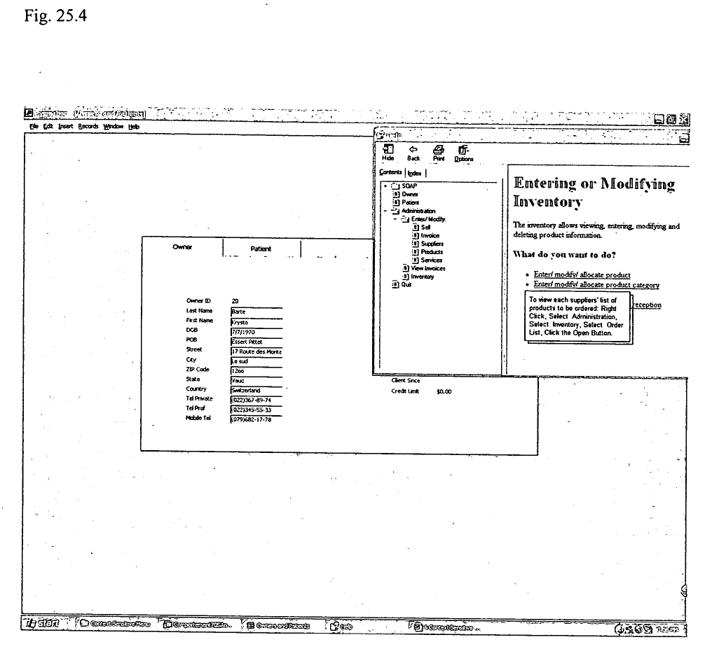

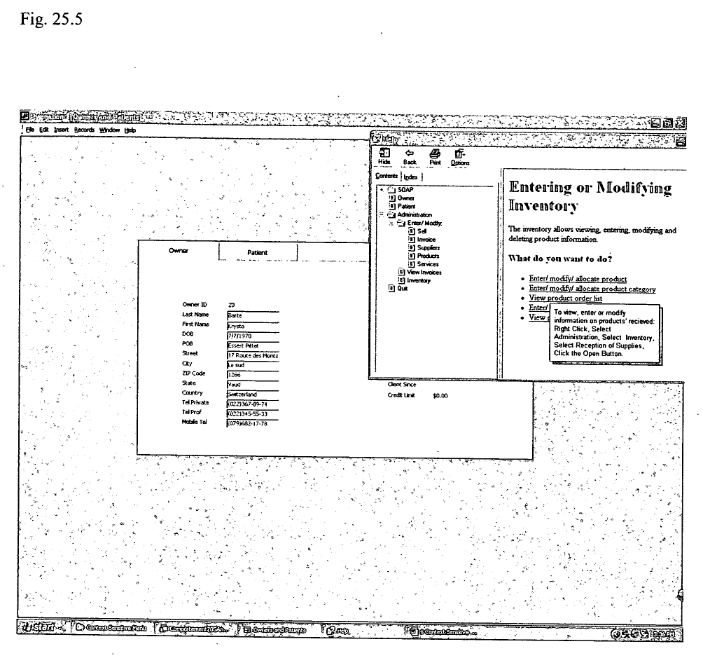

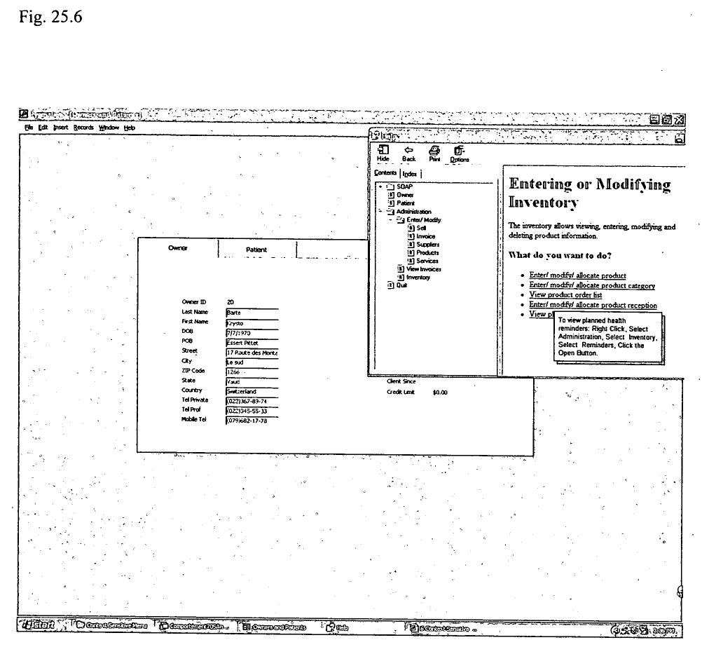

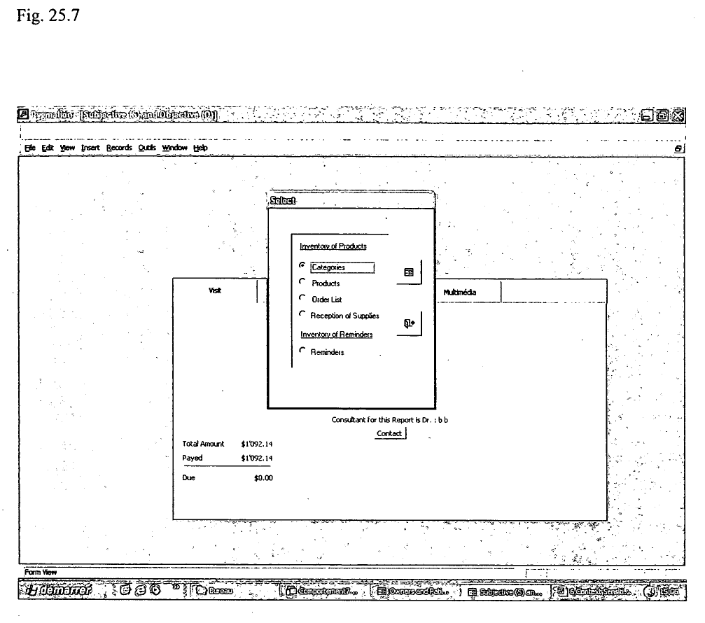

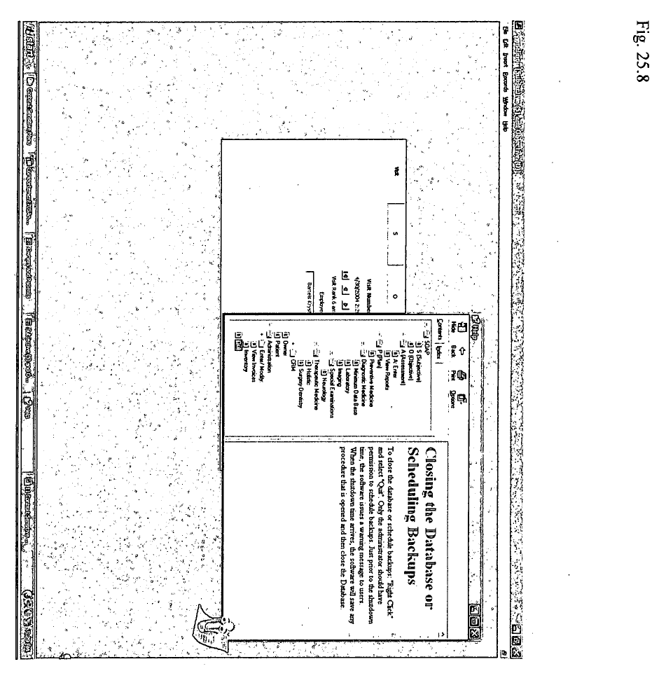

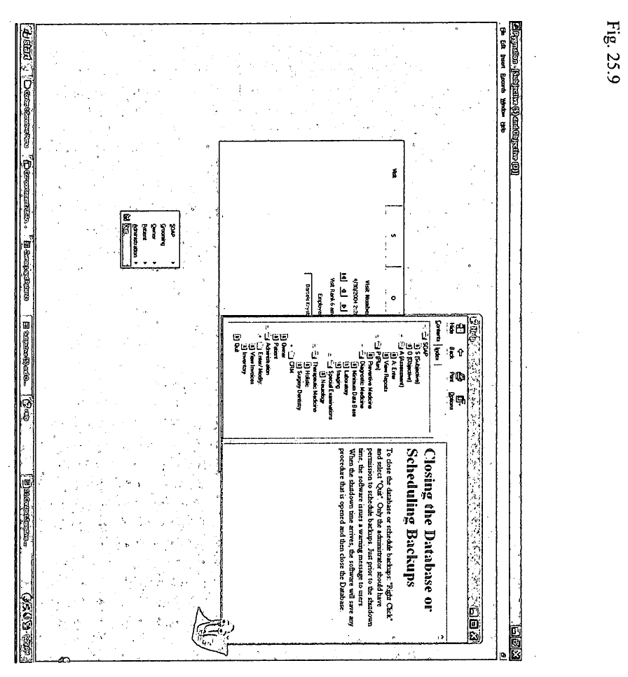

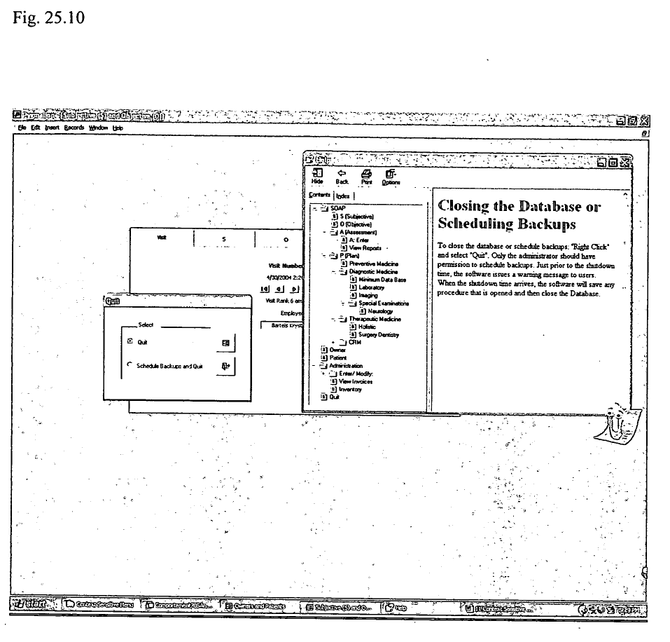

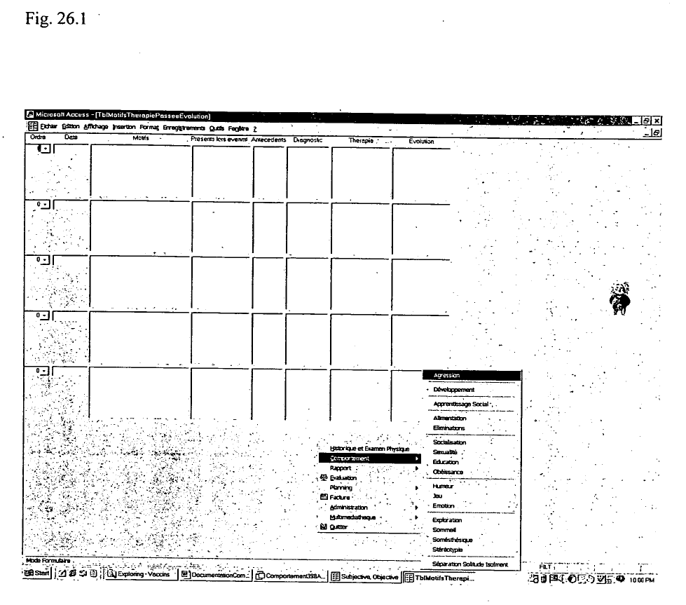

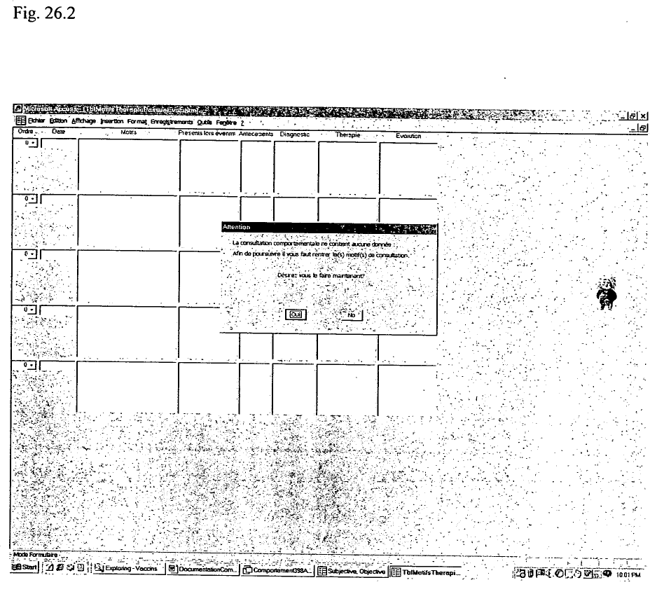

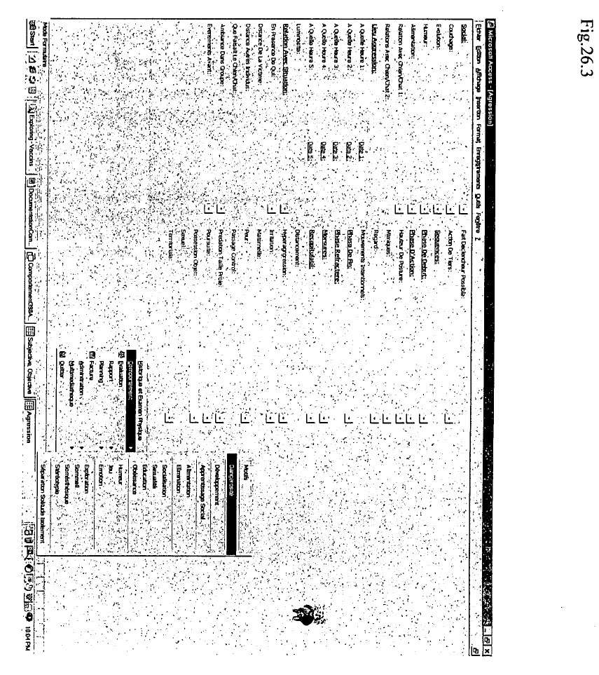

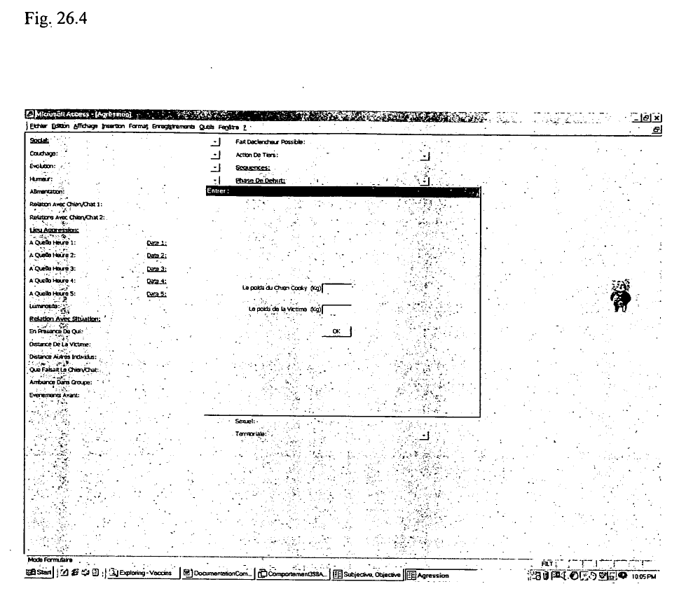

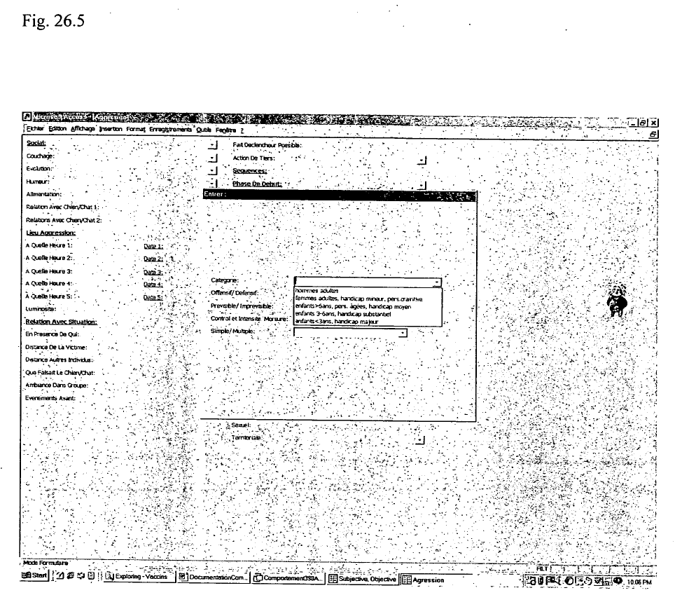

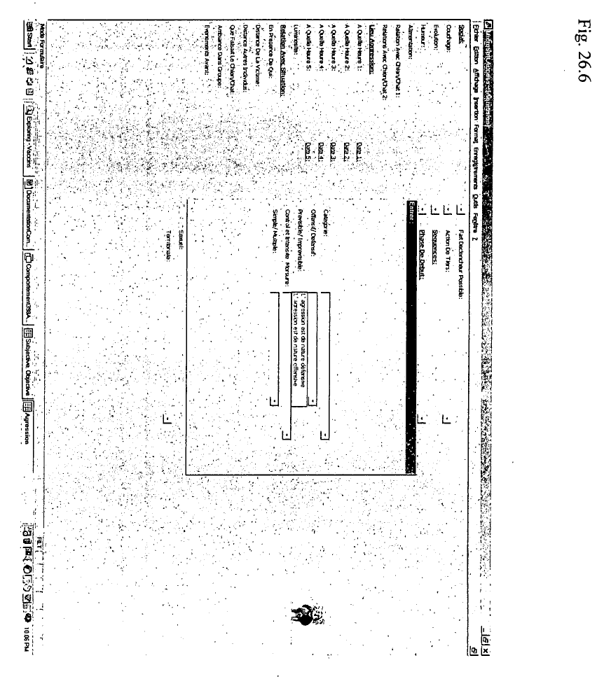

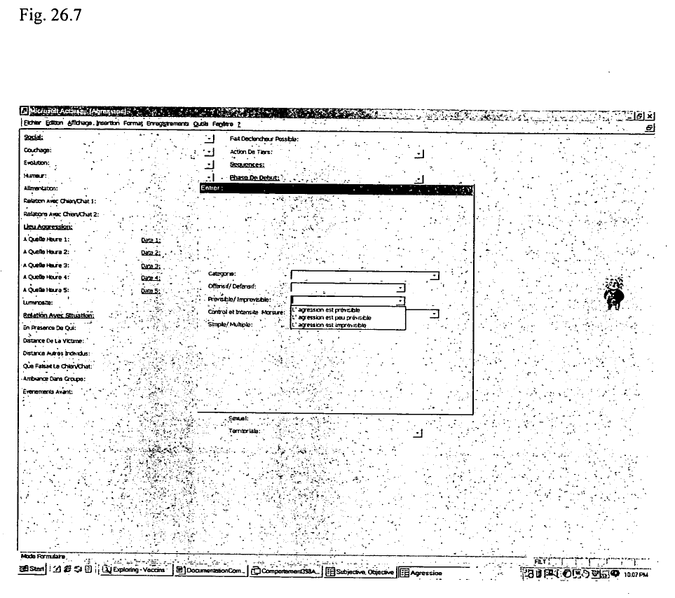

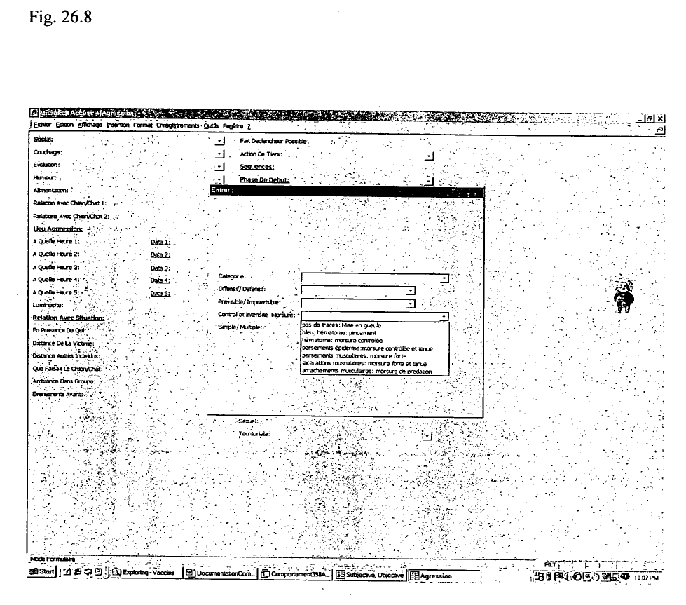

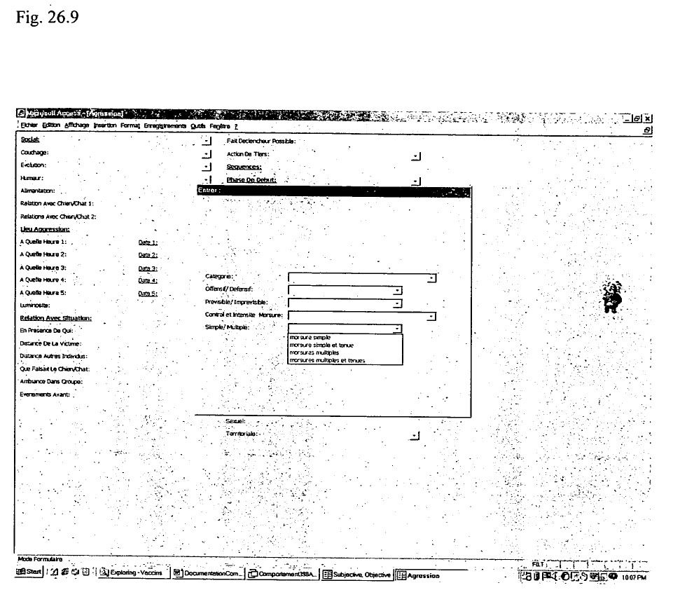

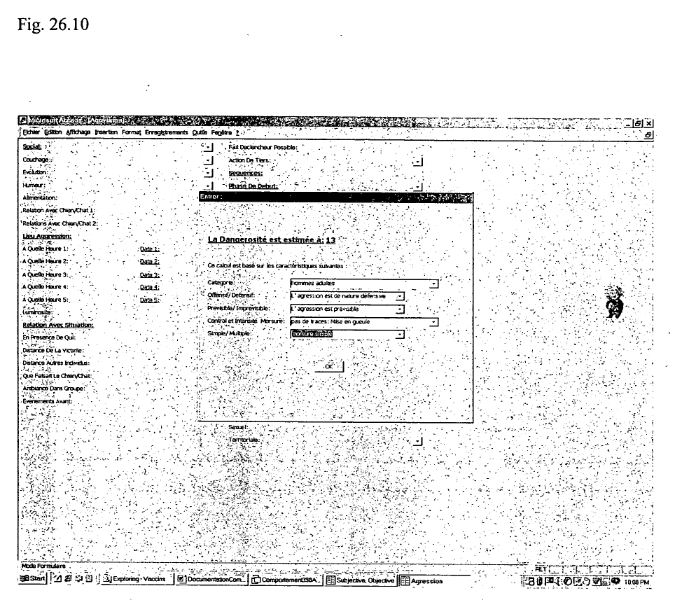

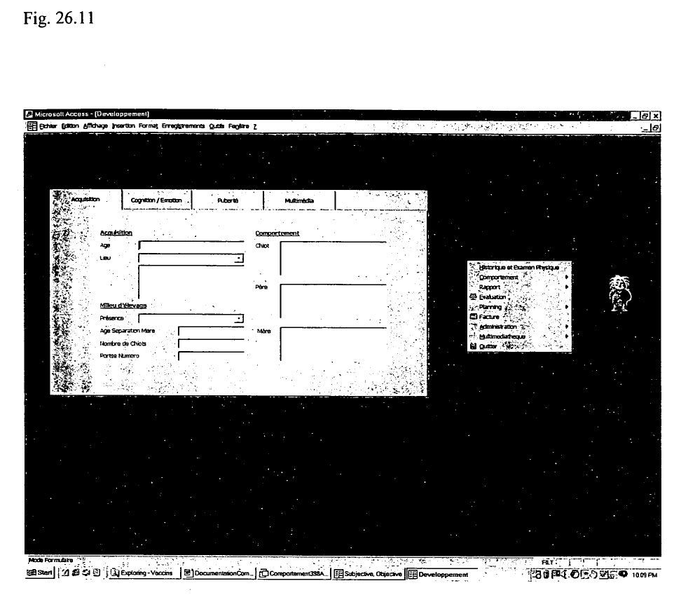

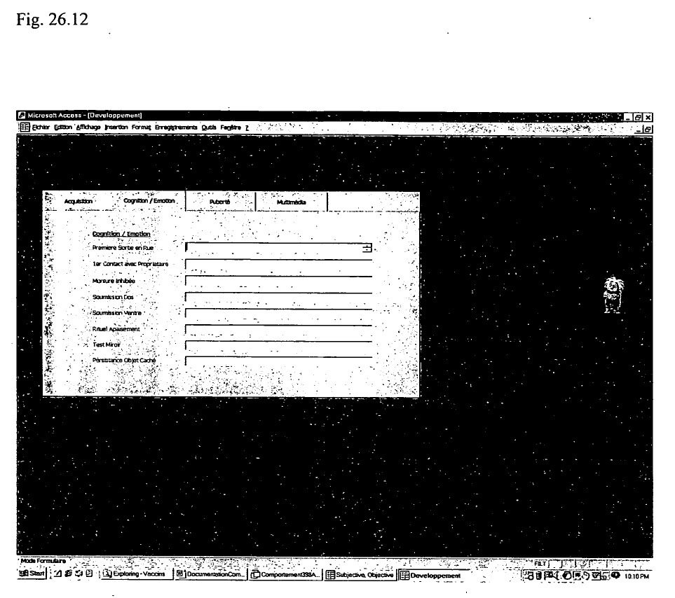

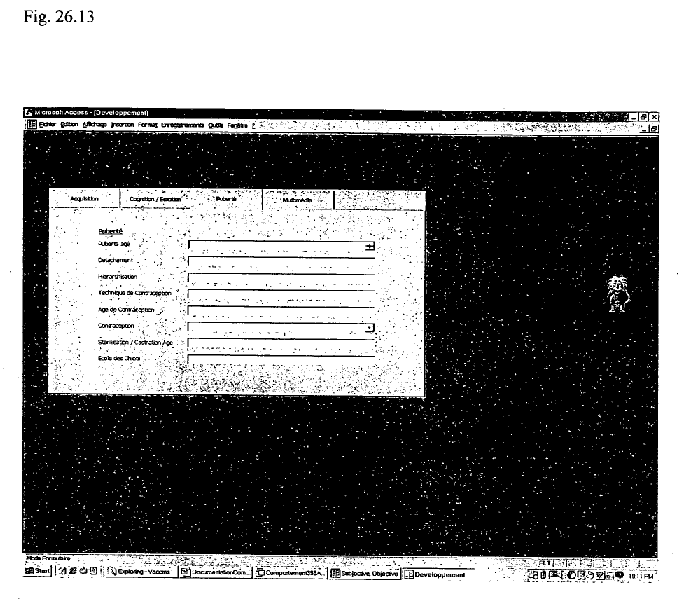

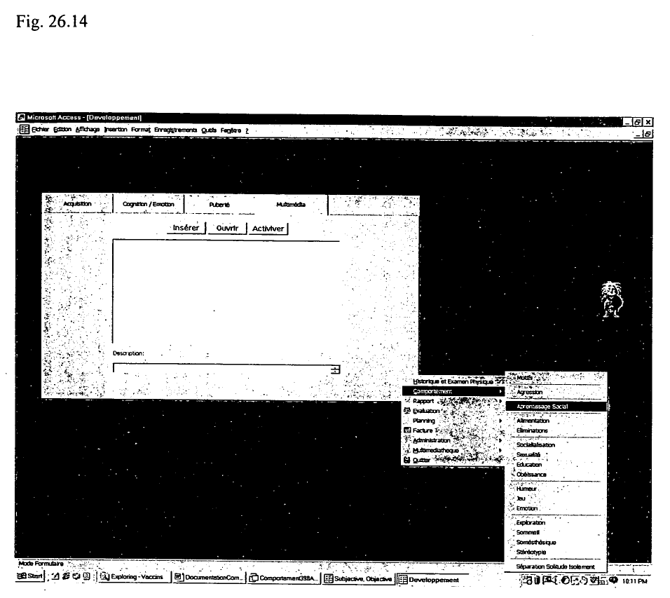

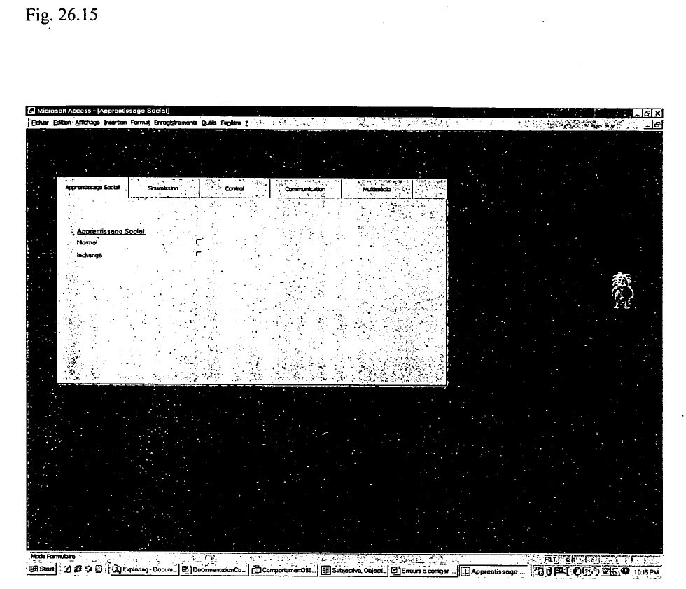

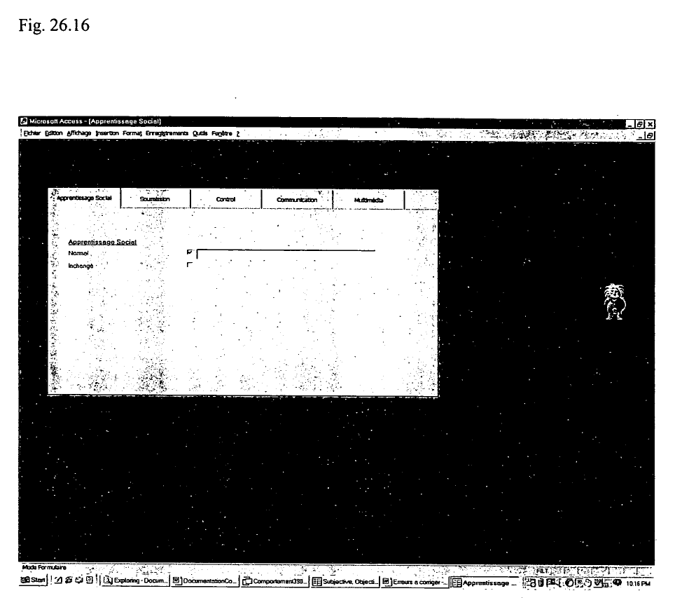

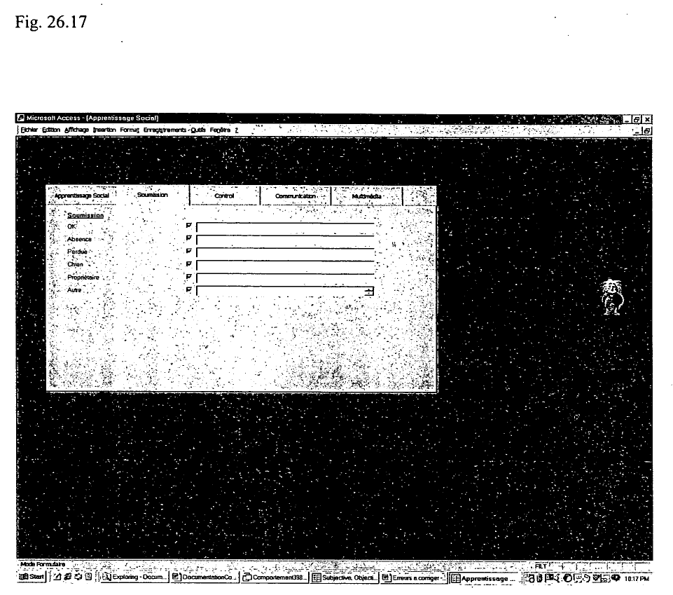

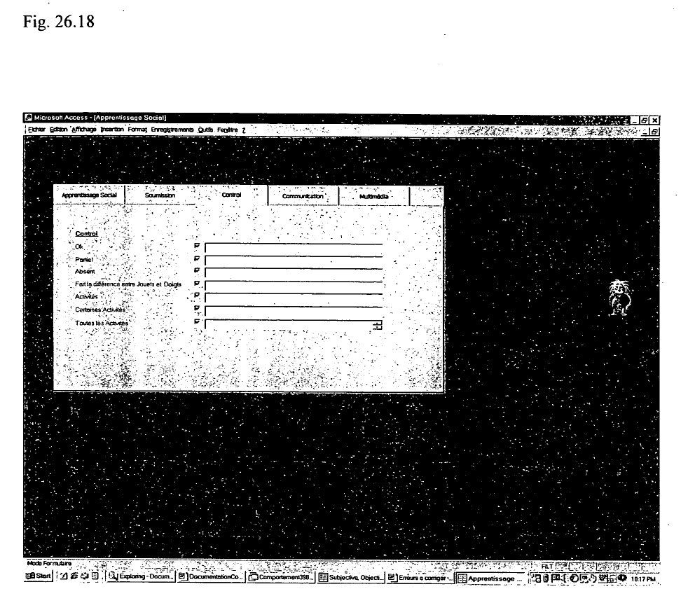

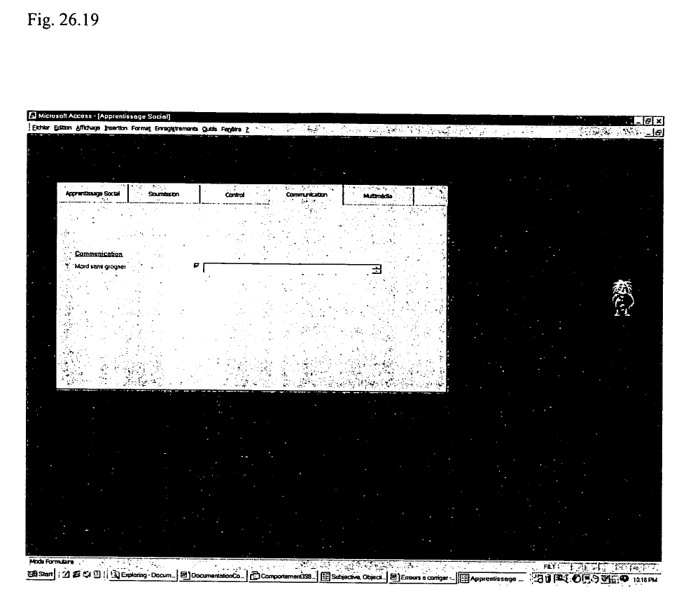

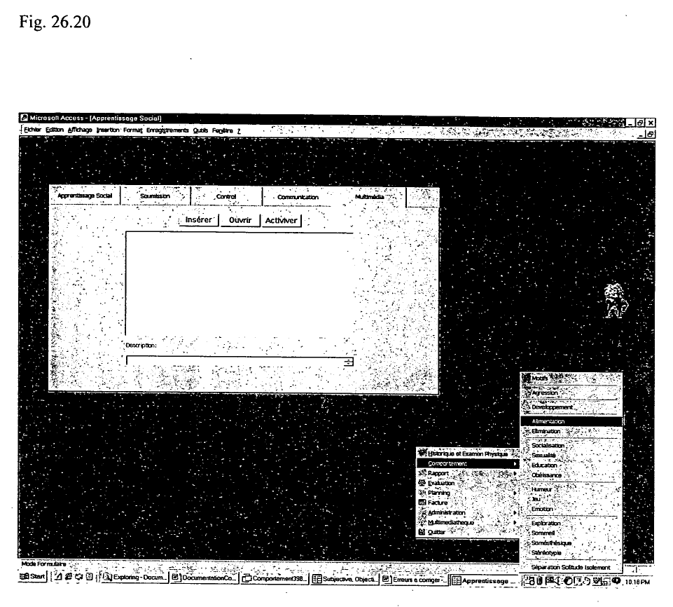

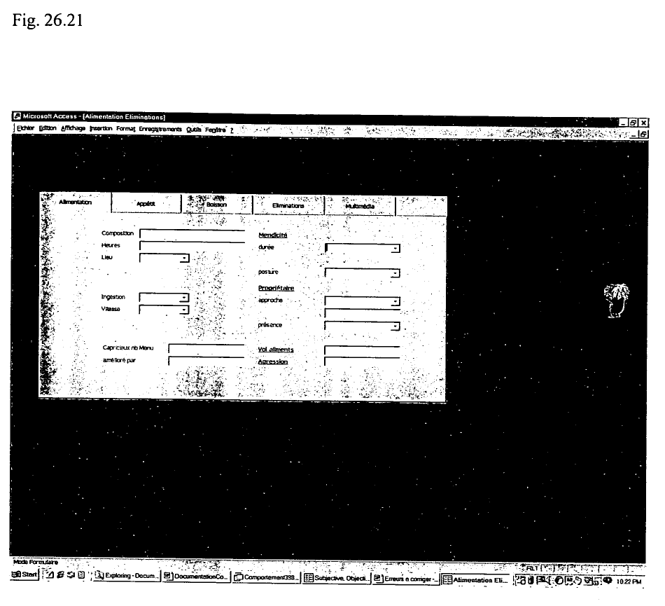

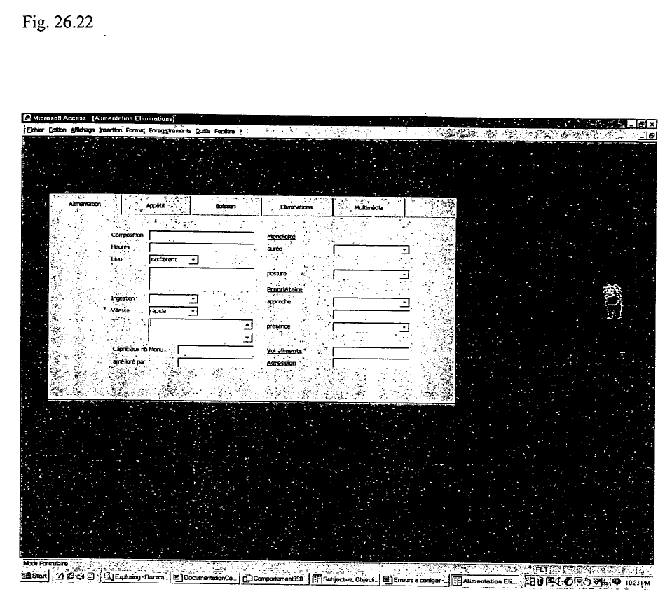

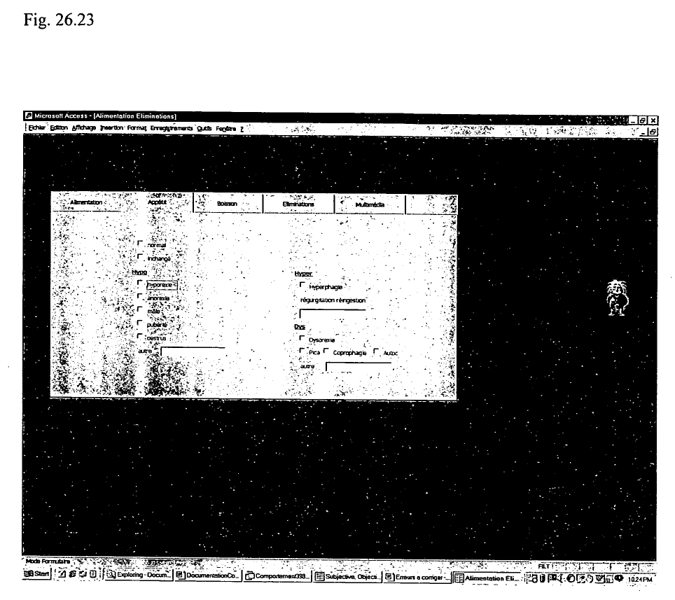

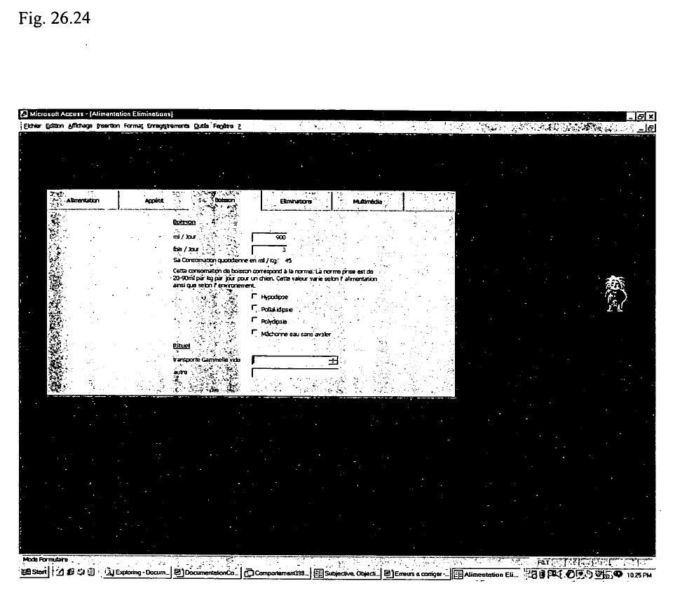

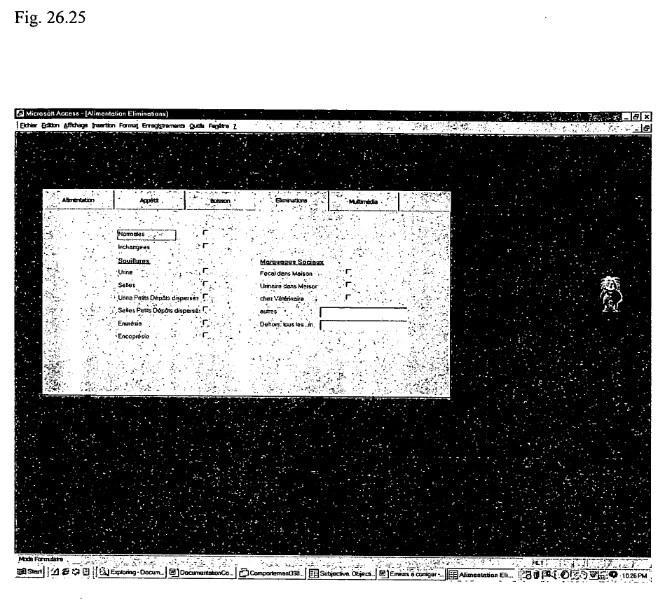

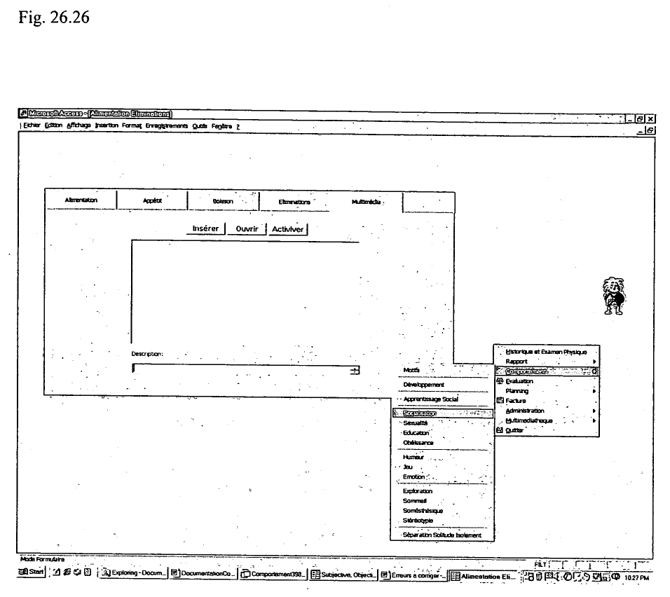

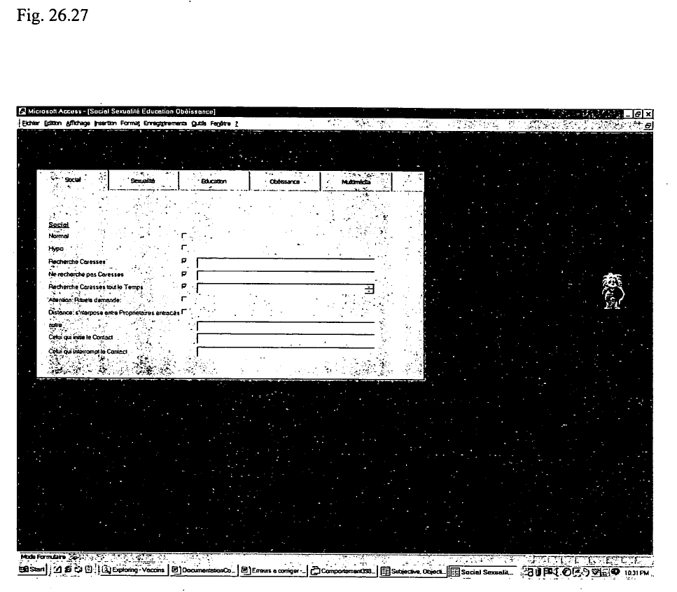

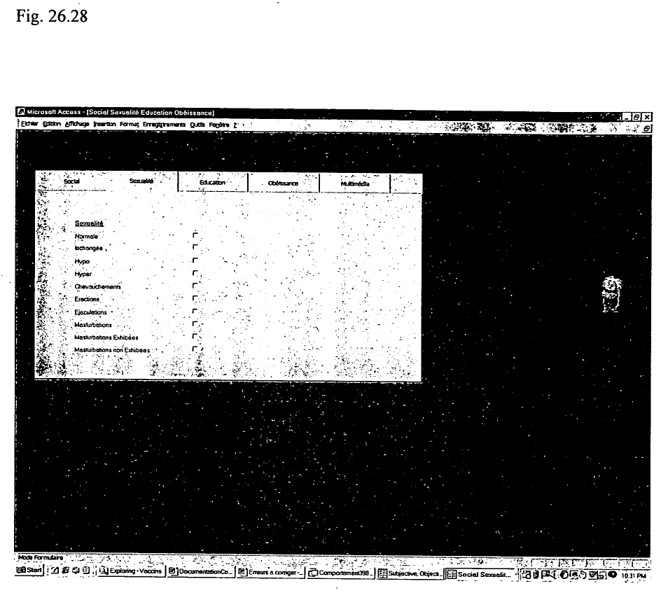

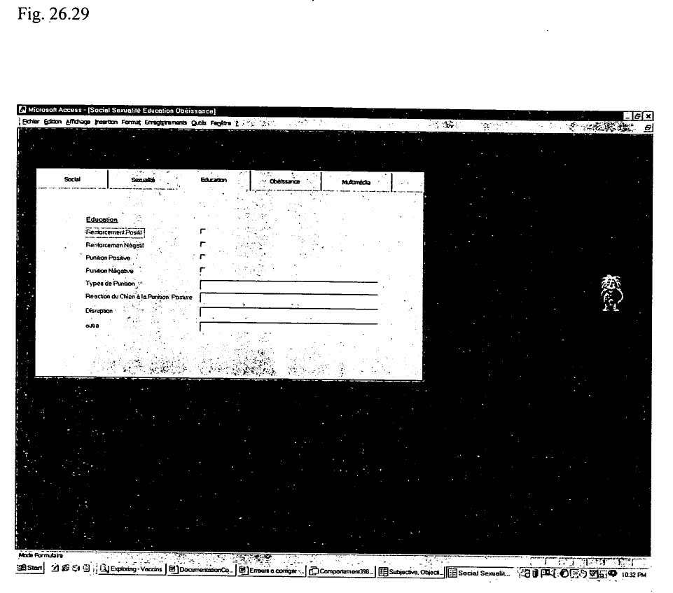

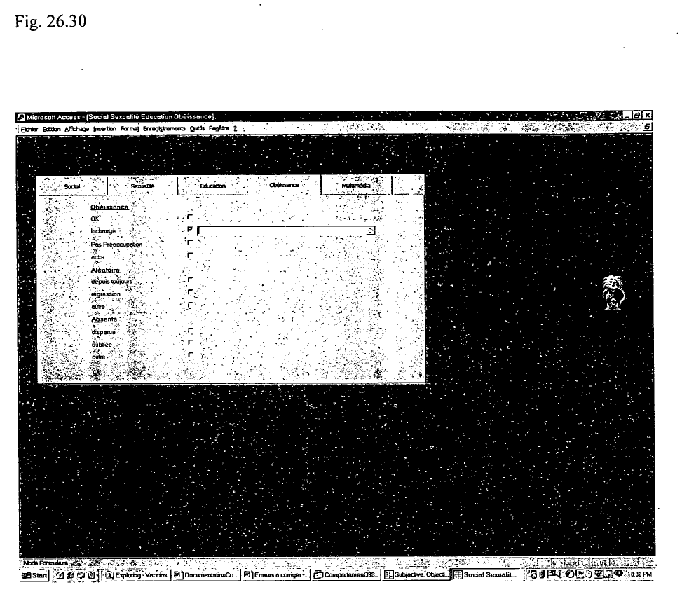

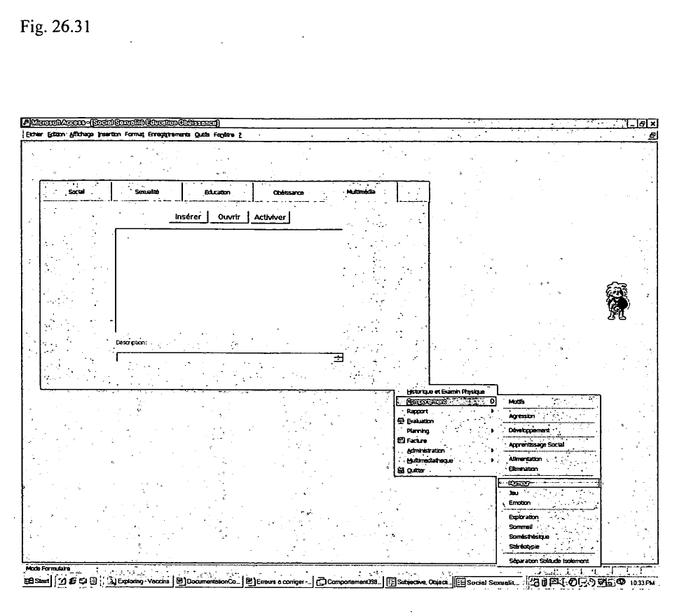

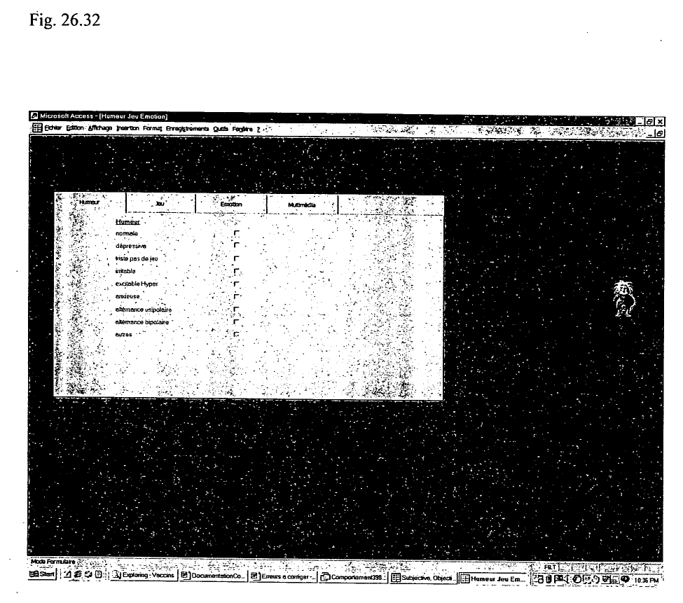

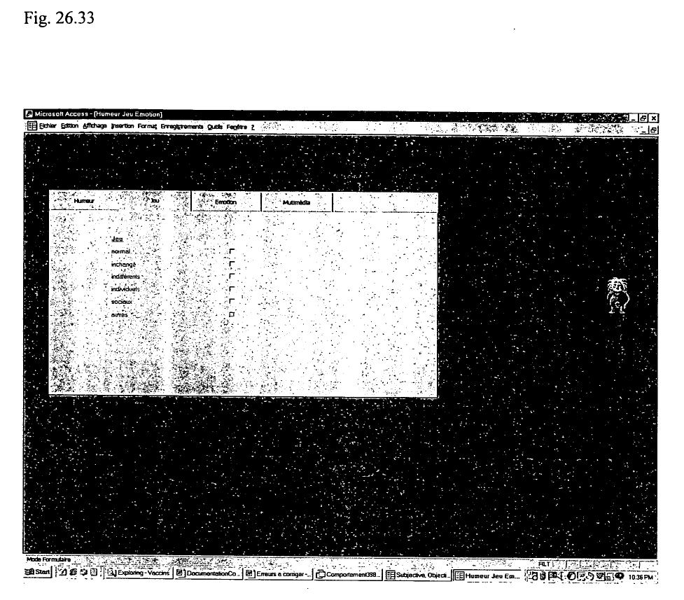

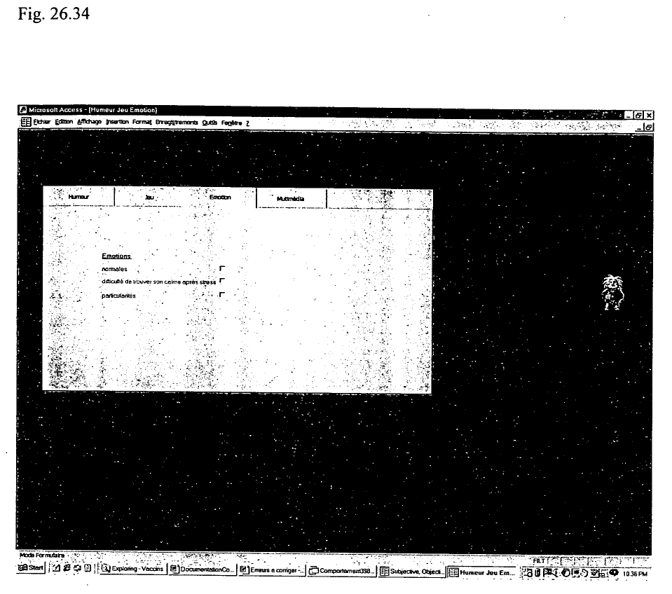

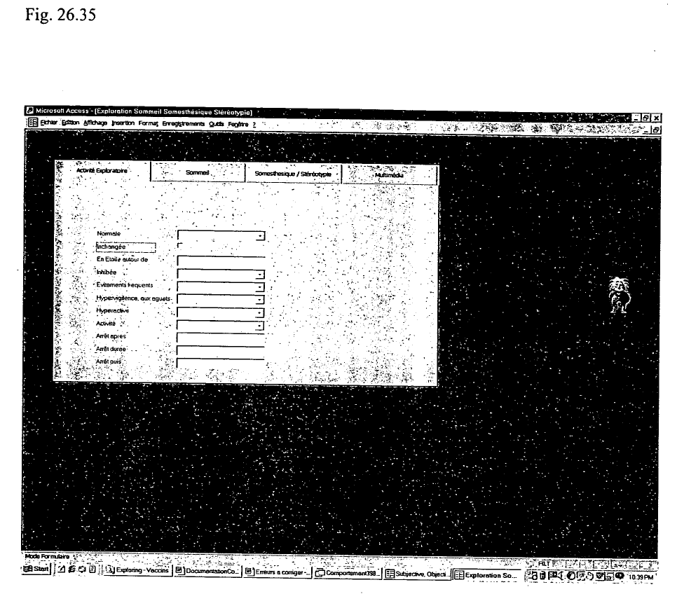

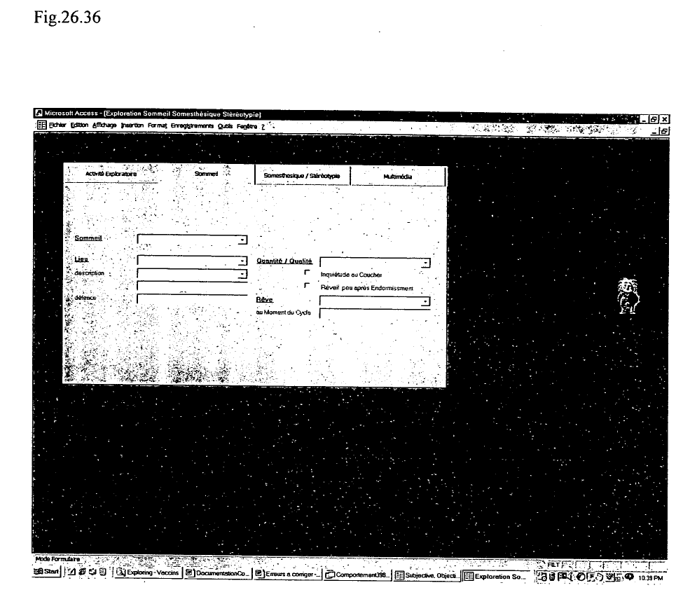

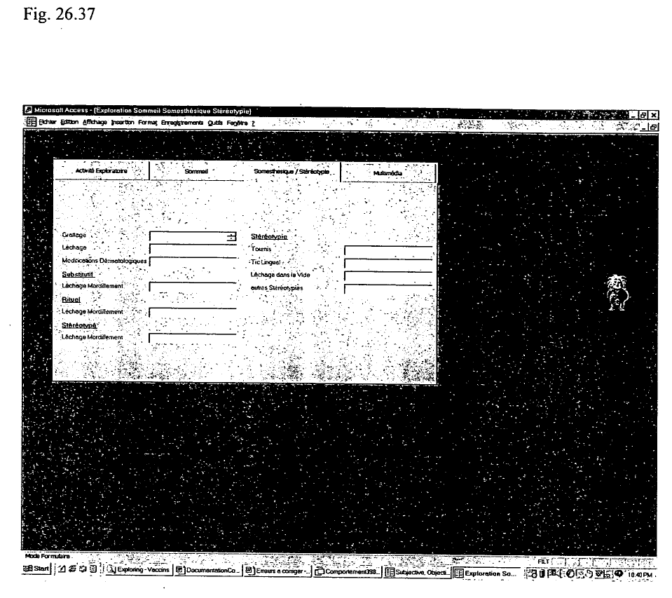

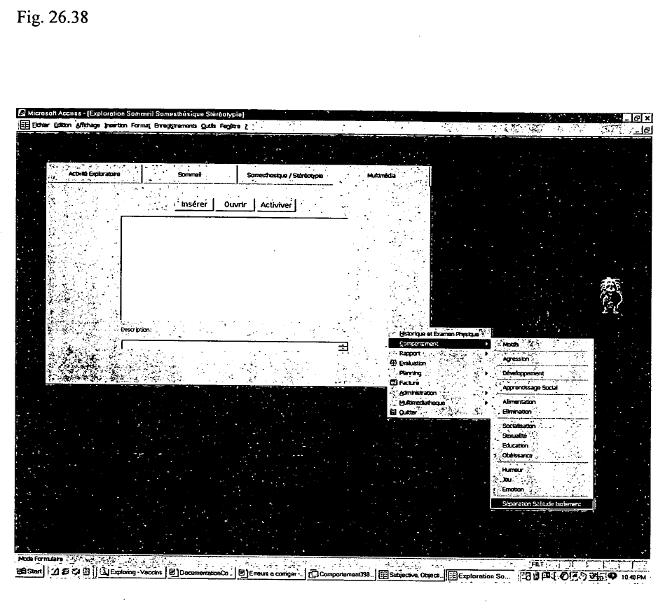

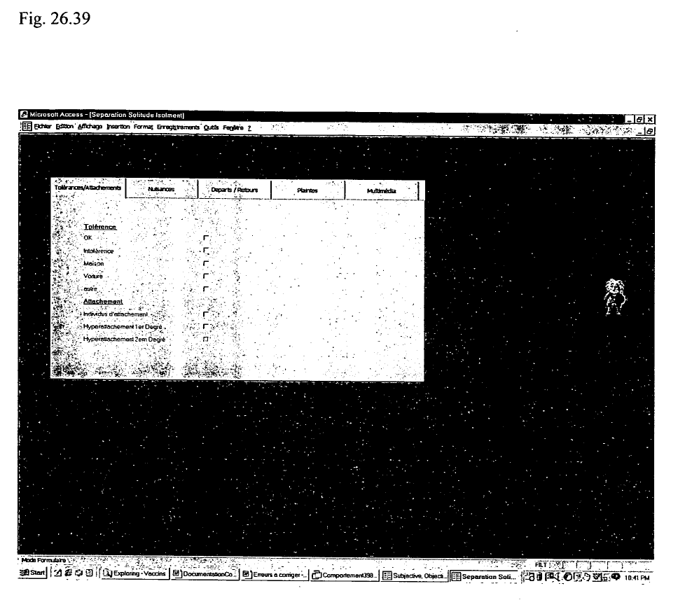

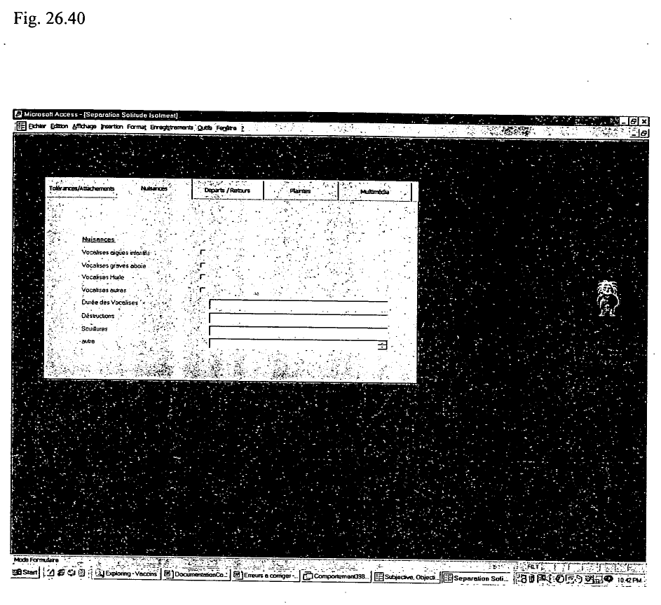

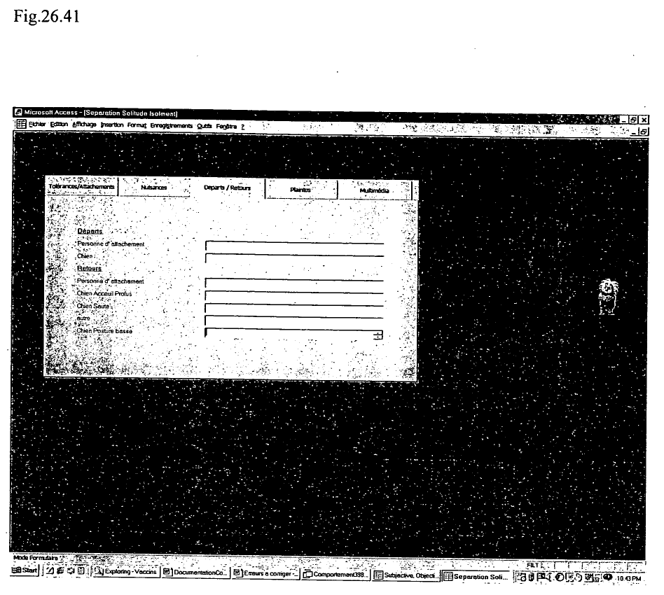

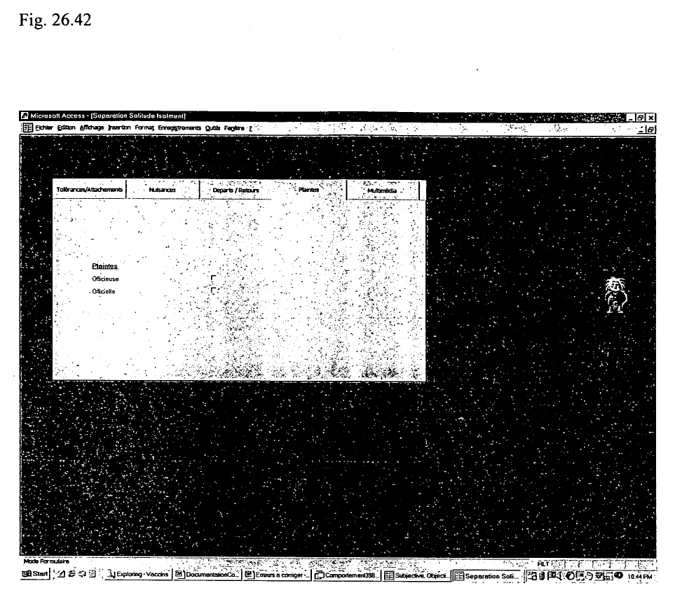

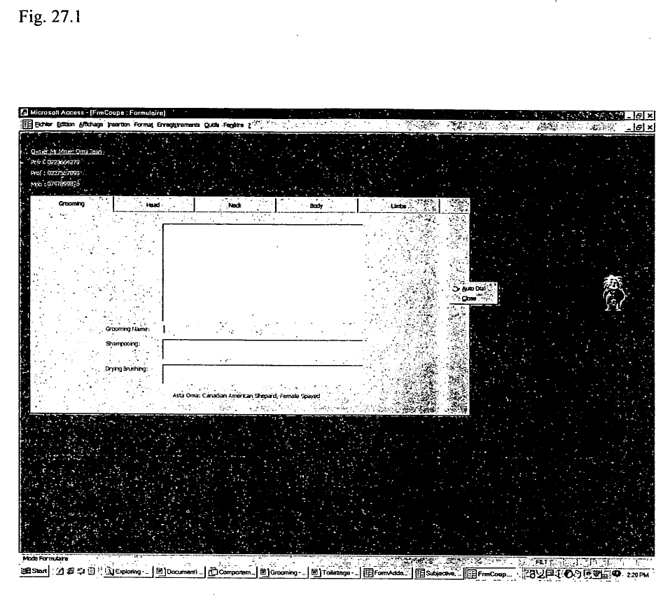

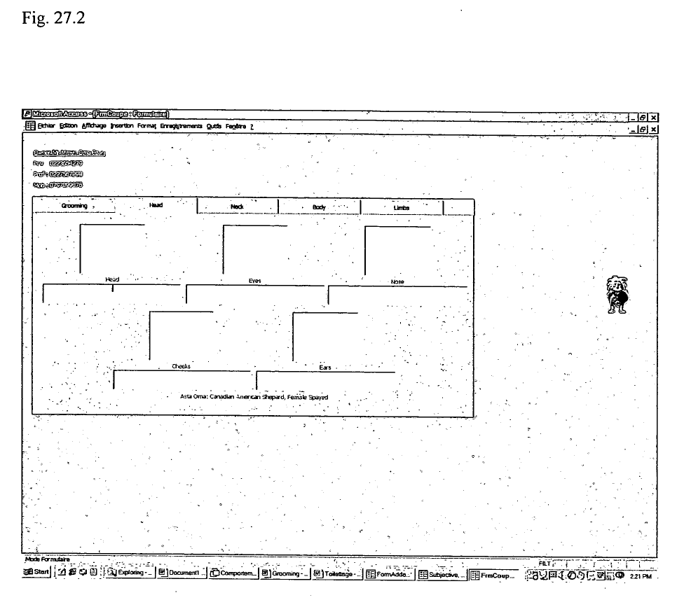

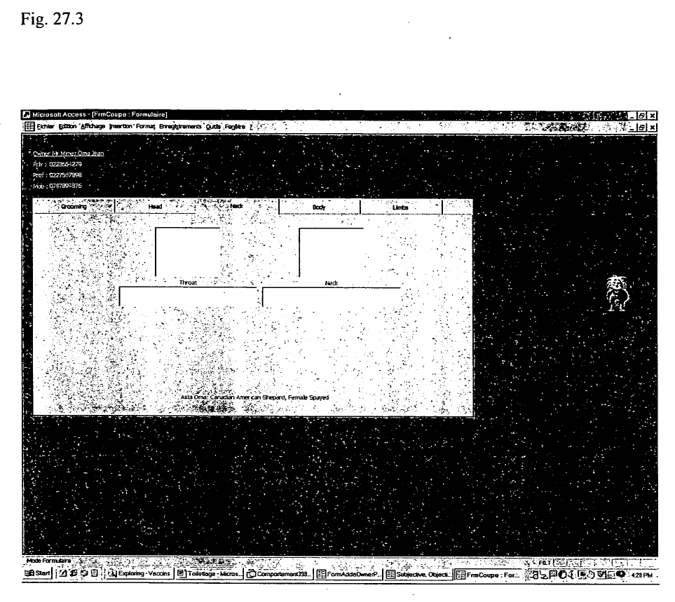

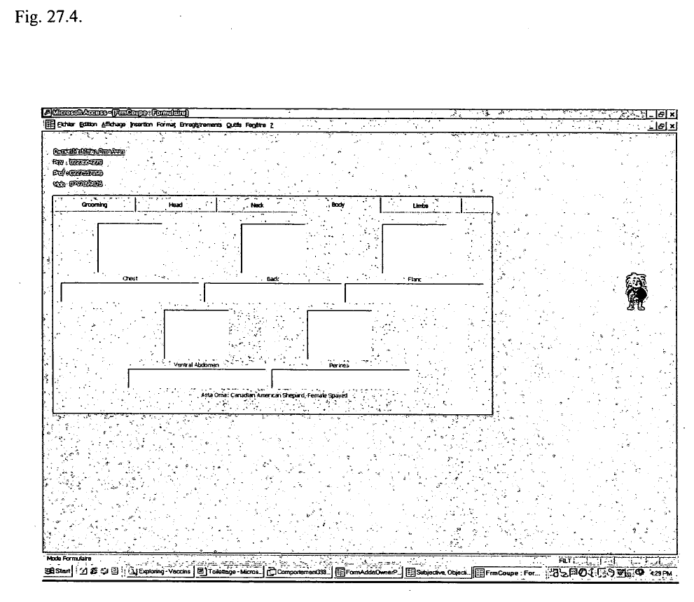

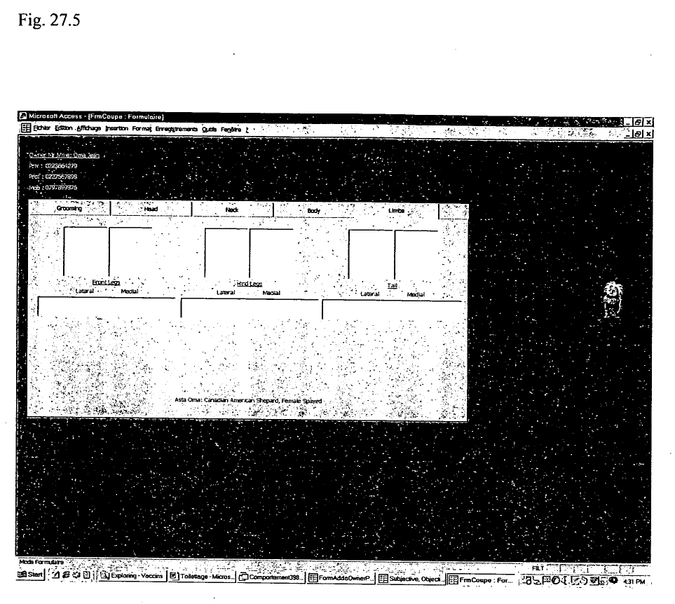

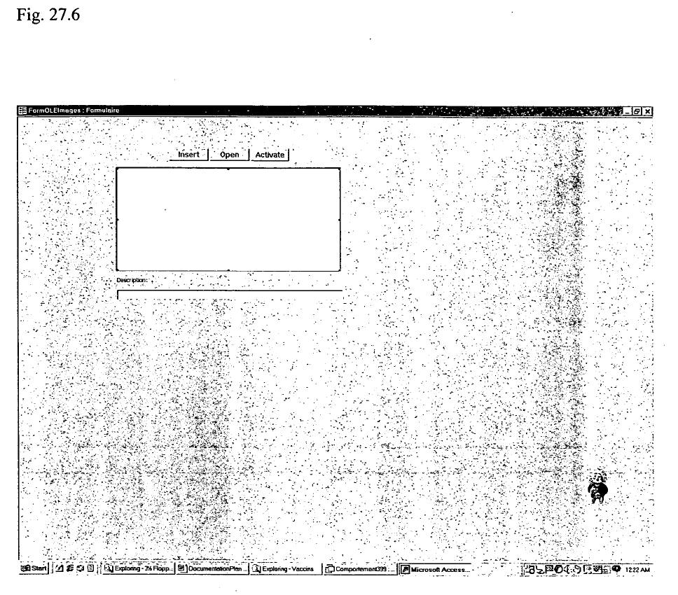

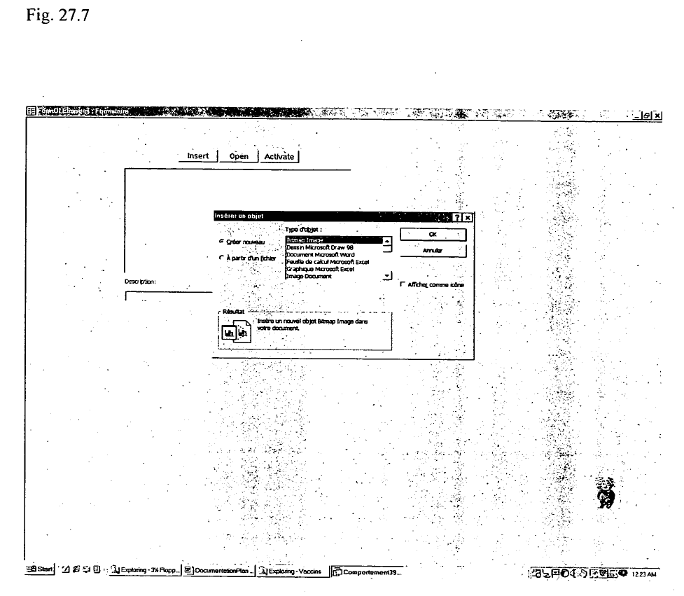

FIG. 20.4 shows:

The additional information displayed in the pop-up window, when the hyperlink for “Selling over the counter” is activated.

FIG. 20.5 through FIG. 20.13:

Walks us through following the indications from the Hyperlink pop-up window for “Selling over the counter”, and shows that whether a field is present; absent; enabled or disabled on the context sensitive navigation menu (which pops up with a “Right Click”), depends on the current context.

FIG. 21.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Invoices module.

FIG. 21.2 shows:

Hyperlinks in the Topic Window for the Invoices module.

FIG. 21.3:

Walks us through to allocating the “Invoice” module.

FIG. 21.4 shows:

That whether a field is present; absent; enabled or disabled on the context sensitive navigation menu (which pops up with a “Right Click”), depends on the current context.

FIG. 21.5 through FIG. 21.13 shows:

the functionalities of the Invoice from all Doctors module.

FIG. 21.11 through FIG. 21.12 shows:

The Invoice Reminders (or Invoices to collection) and that before sending them, the user may check when the Invoices have been sent.

FIG. 21.13 through FIG. 21.19 shows:

The functionalities of the Invoice from one Doctors module.

FIG. 21.20 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Suppliers module.

FIG. 21.21 shows:

Hyperlinks when activated present additional information in a pop-up window. This pop up window indicates how to allocate the “Suppliers” module.

FIG. 21.22:

Walks us through to allocating the “Suppliers” module and shows that whether a field is present; absent; enabled or disabled on the context sensitive navigation menu (which pops up with a “Right Click”), depends on the current context.

FIG. 21.23 shows:

The “Suppliers” module.

FIG. 21.24 shows:

That to check if a product has been delivered the user must select <<Products Delivered Y/N”

FIG. 21.25 shows:

The module allowing the user to check if a product has been delivered or not, for example before paying the invoice.

FIG. 21.26 through FIG. 21.29 shows:

The module allowing the user to follow up on payments made to suppliers. To allocate this module the user must select “Payments Enter/Modify”. This form has the same fields and presentation as the form for entering payments made.

FIG. 21.27 shows:

How the user should select” Payments: View” in order to view payments made to suppliers.

FIG. 21.28 through FIG. 21.29 shows:

The module allowing to view payments concerning Suppliers' Invoice.

FIG. 21.30 through FIG. 21.31 shows:

How, while viewing payments concerning Suppliers' Invoice, the user may access supplementary information concerning the Supplier.

FIG. 22.1 through FIG. 22.7 shows:

How the user can use context sensitive Customized Help in combination with the context sensitive navigation menu to allocate the Supplier module: selecting <<Ctrl H>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic. This tab has a field named: “Type in the keyword to Find:” for entering keywords. As a keyword is being typed in this field (in this case: Supplier), all the alphabetically related keywords are shown. When the user “double clicks” the keyword, the related topic is displayed in the Topic Window. Since several topics concern the same keyword, a window pops up with a listing of these topics. Clicking a topic, then selecting “Click Display” presents the related topic in the Topic Window, highlights its location in the Context field and allows the user to locate the topic on the applications map (Context tab).

FIG. 22.8 through FIG. 22.10 shows:

The Suppliers Catalogues' functionalities.

FIG. 22.11 through FIG. 22.12 shows:

How to enter or modify a Supplier.

FIG. 22.13 shows:

How to allocate the order List.

FIG. 22.14 shows:

The order Lists' functionalities.

FIG. 23.1 through FIG. 23.5 shows:

Hyperlinks in the Topic Window for “Entering, Modifying or Allocating a Product”, and walks us through what the user encounters while following their indications.

FIG. 23.6 through FIG. 23.7 shows:

Hyperlinks in the Topic Window for “Entering, Modifying or Allocating Product Category” and walks us through what the user encounters while following their indications.

FIG. 23.8 shows:

Service/Medical Act Category

FIG. 23.9 shows:

Vaccinations Category

FIG. 23.10 shows:

Medication Category

FIG. 23.11 through FIG. 23.12 shows:

Hyperlinks in the Topic Window for “Entering, Modifying or Allocating a Product”, and walks us through what the user encounters while following their indications.

FIG. 23.13 shows:

Product module.

FIG. 23.14 shows:

Products are in the Categories of “Material” and “Medicament”. When the category is Service/Medical Act or Vaccinations all fields except for the “Category” field are disabled.

FIG. 23.15 shows:

Hyperlinks in the Topic Window for “View Product order List”, and walks us through what the user encounters while following their indications.

FIG. 23.16 shows:

Hyperlinks in the Topic Window for “View Product order List”, and walks us through what the user encounters while following their indications.

FIG. 23.17 through FIG. 23.18 shows:

Product order List and some of its' functionalities.

FIG. 23.19 shows:

How the user can use context sensitive Customized Help in combination with the context sensitive navigation menu to allocate the “View; Enter; modify information on Products received”.

FIG. 23.20 through FIG. 23.21 shows:

How to “View; Enter; modify information on Products received”.

FIG. 23.22 through FIG. 23.27 shows:

Hyperlinks in the Topic Window for “Entering, Modifying or Allocating a Product; Entering or Modifying Inventory and Viewing Reminders”, and walks us through what the user encounters while following their indications.

FIG. 23.22 through FIG. 23.27 shows:

How the user can use context sensitive Customized Help in combination with the context sensitive navigation menu to allocate the “Reminders for ordering Products and for preventive medicine” modules: selecting <<Ctrl H>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic. This tab has a field named: “Type in the keyword to Find:” for entering keywords. As a keyword is being typed in this field (in this case: Reminders), all the alphabetically related keywords are shown. When the user “double clicks” the keyword, the related topic is displayed in the Topic Window. Since several topics concern the same keyword, a window pops up with a listing of these topics. Clicking a topic, then selecting “Click Display” presents the related topic in the Topic Window, highlights its location in the Context field and allows the user to locate the topic on the applications map (Context tab).

FIG. 23.22 through FIG. 23.27 shows:

Hyperlinks in the Topic Window for “Entering, Modifying or Allocating a Product; Entering or Modifying Inventory and Viewing Reminders”, and walks us through what the user encounters while following their indications.

FIG. 24.1 shows:

How the user can use context sensitive Customized Help in combination with the context sensitive navigation menu to allocate the “Medical Acts” modules: selecting <<Ctrl H>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic. This tab has a field named: “Type in the keyword to Find:” for entering keywords. As a keyword is being typed in this field, all the alphabetically related keywords are shown. When the user “double clicks” the keyword, the related topic is displayed in the Topic Window.

FIG. 24.2 shows:

If several topics concern the same keyword, a window pops up with a listing of these topics. Clicking a topic, then selecting “Click Display” presents the related topic in the Topic Window, highlights its location in the Context field and allows the user to locate the topic on the applications map (Context tab).

FIG. 24.3 shows:

That clicking a topic, then selecting “Click Display” presents the related topic in the Topic Window, highlights its location in the Context field and allows the user to locate the topic on the applications map (Context tab).

FIG. 24.4 shows:

Hyperlinks in the Topic Window for “Entering or Modifying Services”, and walks us through what the user encounters in the Medical Act module.

FIG. 24.5:

Walks us through opening the “Services” module.

FIG. 24.6:

Walks us through opening the “Medical Act” module.

FIG. 24.7 shows:

The “Medical Act” module.

FIG. 24.8 through FIG. 24.12 shows:

The “Services and Medical Acts” module and its' context sensitive menu.

FIG. 25.1 through FIG. 25.6 shows:

Hyperlinks in the Topic Window for “Entering or Modifying Inventory”.

FIG. 25.7 shows:

What the user encounters when selecting “Inventory” on the context sensitive menu.

FIG. 25.8 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic (in this case “Quit”), then selecting “Click Display” presents the related topic in the Topic Window, highlights its location in the Context field and allows the user to locate the topic on the applications map (Context tab).

FIG. 25.9 through FIG. 25.10 shows:

How the user allocates the “Quit” module.

FIG. 26.1 through FIG. 26.2 shows:

Motifs form

FIG. 26.3 shows:

The Aggression form

FIG. 26.4 through FIG. 26.10 shows:

Dangerosité form

FIG. 26.11 through FIG. 26.14 shows:

Développement form

FIG. 26.15 through FIG. 26.20 shows:

Apprentissage Social form

FIG. 26.21 through FIG. 26.26 shows:

Alimentation Elimination form

FIG. 26.27 through FIG. 26.31 shows:

“Socialisation Sexualité Education Obéissance>> form

FIG. 26.32 through FIG. 26.34 shows:

“Humeur Jeu Emotion” form

FIG. 26.35 through FIG. 26.38 shows:

“Exploration Sommeil Somesthésie Stéréotypie>> form

FIG. 26.39 through FIG. 26.42 shows:

“Séparation Solitude Isolement>> form

FIG. 27.1 through FIG. 27.7 shows:

The “Grooming” modules' forms for entering documents concerning the grooming of different body parts.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A computer-readable medium encoded with a method of diagnosing a patient wherein the method applies artificial intelligence techniques to a patient's medical record. This software is composed of some thirty three modules. A detailed discussion of these modules and their functions, including screen prints of typical graphical user interfaces, input screens, output screens, are provided, the contents of which are incorporated herein by reference there to and relied upon.

The artificial intelligence techniques comprise the knowledge of the physician's experience in his contextual situation (patients' history; previous and current treatments; physical examinations; tests results; laboratory particularities; geographical location; epidemiological situation; practioners' experience and expertise; restricted as well as not restricted to current symptoms etcetera . . . ), such knowledge being recorded in a database and retrieved when the patient's medical record (e.g. diagnostic lab results and clinical signs) matches a given number of parameters associated with a disease profile.

The method compares and prioritizes a list of likely diagnoses, which are presented in association with a likelihood (represented via a numeric score) of their applicability to the given patient.

The artificial intelligence techniques comprise a “Symptom based interpretation”0 module (which is based on the patients laboratory results; the degree of importance of individual tests and on the symptom selected by the user and upon which the interpretation should be focused) and a “General interpretation” module (which is based on the patients laboratory results; the degree of importance of individual tests and is focused on all the symptoms).

A computerized medium encoded with a computer readable method of managing the front office and back office a medical practice, wherein the method controls modules comprising (a) an accounting module; and (b) a lab result submission, importation and data storage module.

In an advantage of the invention, patient diagnosis is automated to a significant extent by making greater use of the patient's medical record and prior recorded experiences of a practitioner.

In another advantage, input forms, or media otherwise linked to the lab's results data record, enable results to be transmittable by email, thus enabling the effortless input of the results into the patient's medical record.

In another advantage the method is offered in a version for veterinary medicine and a version for medicine on humans.

In still another advantage, the invention provides an automated, medical record-based, workflow management system for a medical practitioner's office.

In another feature, the activities of a groomer or a hairdresser (Client Management, Appointments Management, Pictorial or vocal documentation of the haircuts, Inventory control) may be organized by combining the appropriate modules. Further modules include:

Visit with unique features, as well as others listed in the detailed description below.

Assessment with unique features, as well as others listed in the detailed description below.

Report with unique features, as well as others listed in the detailed description below.

Minimum Data Base with unique features, as well as others listed in the detailed description below.

Holistic Medicine with unique features, as well as others listed in the detailed description below.

Surgery with unique features, as well as others listed in the detailed description below.

Imaging with unique features, as well as others listed in the detailed description below.

Dentistry with unique features, as well as others listed in the detailed description below.

Neurology with unique features, as well as others listed in the detailed description below.

Preventive medicine and Disease Monitoring, as well as others listed in the detailed description below.

Consultants, as well as others listed in the detailed description below.

Contact and sharing Information with Colleagues, as well as others listed in the detailed description below.

Multimediatheque™ with unique features, as well as others listed in the detailed description below.

Interactive Reference Database with unique features, as well as others listed in the detailed description below.

Behaviour Medicine with unique features, as well as others listed in the detailed description below.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

General Orientation

The context sensitive Customized help and Context sensitive Menus make orientation throughout the software easy. These two functionalities allow even a moderately technical person to be able to use the software within minutes.

1. Customized Help

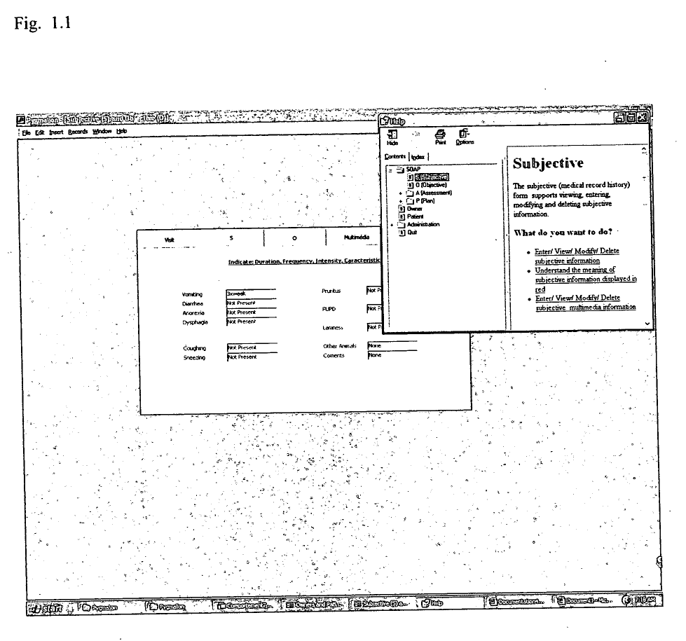

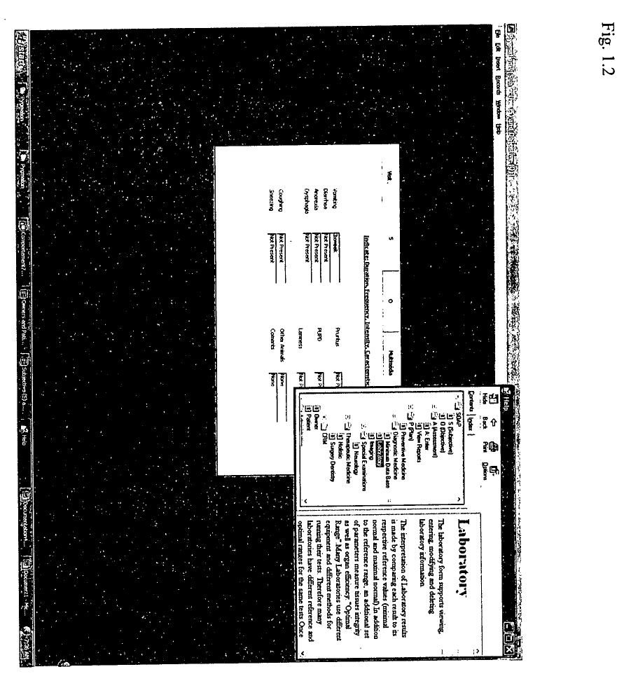

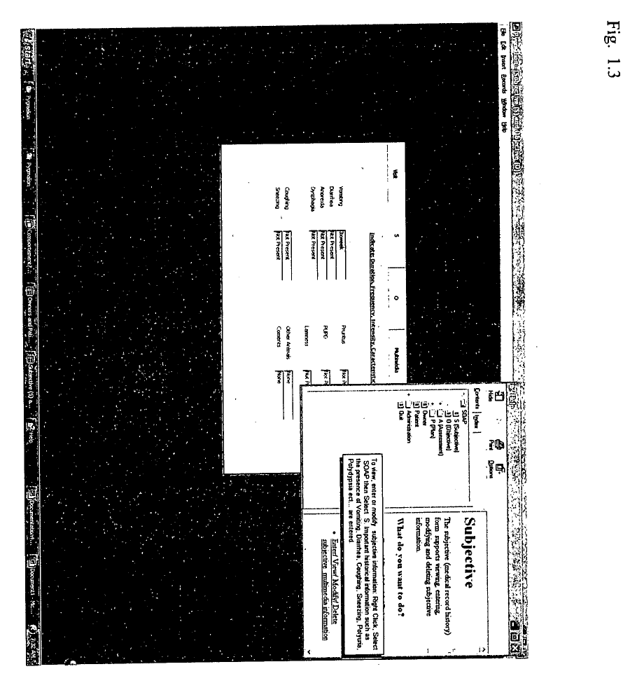

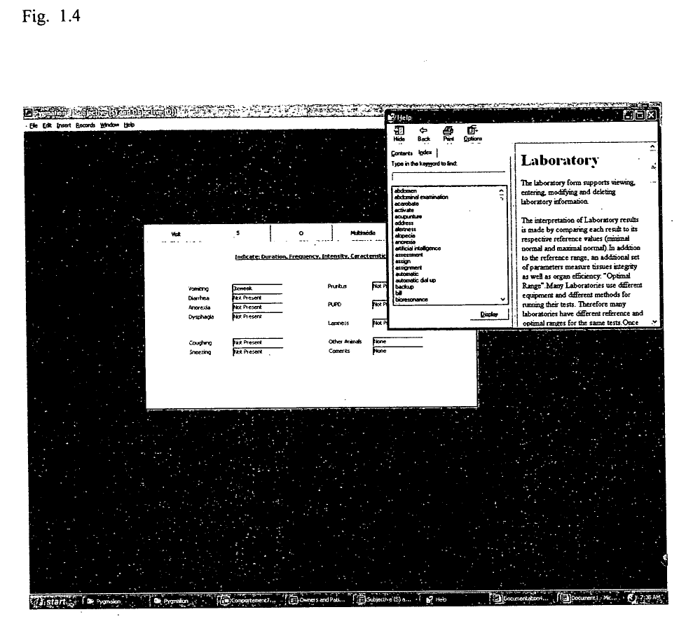

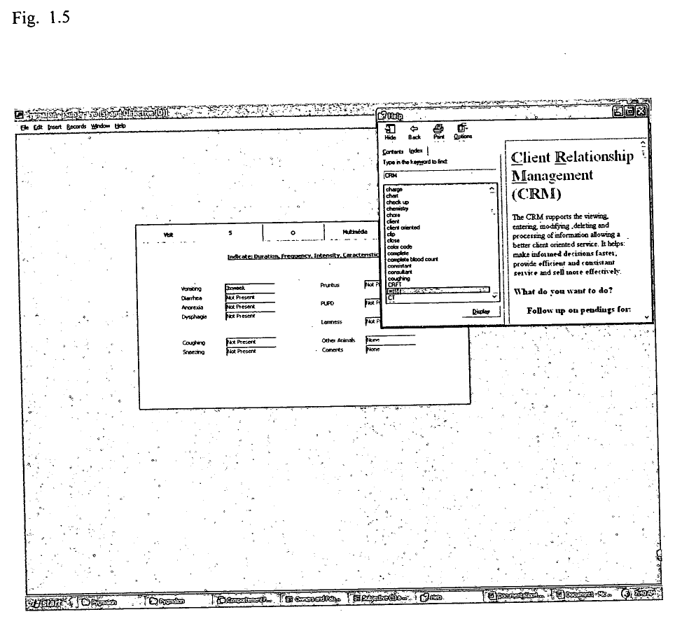

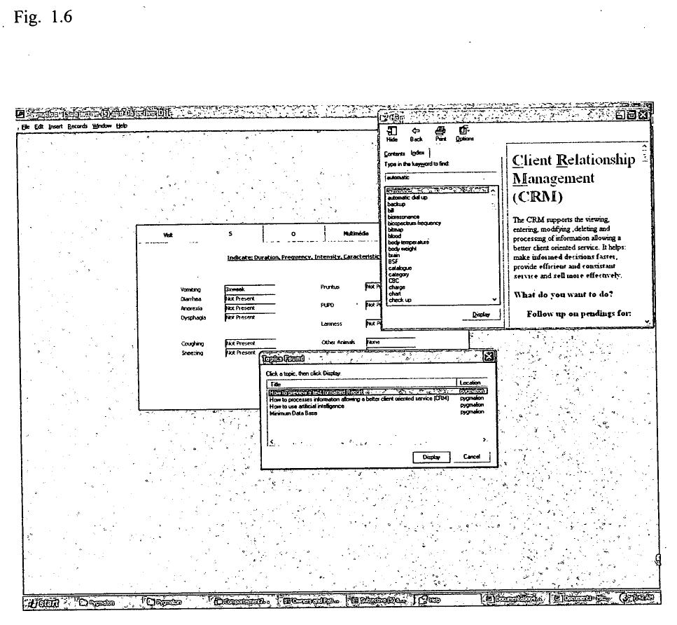

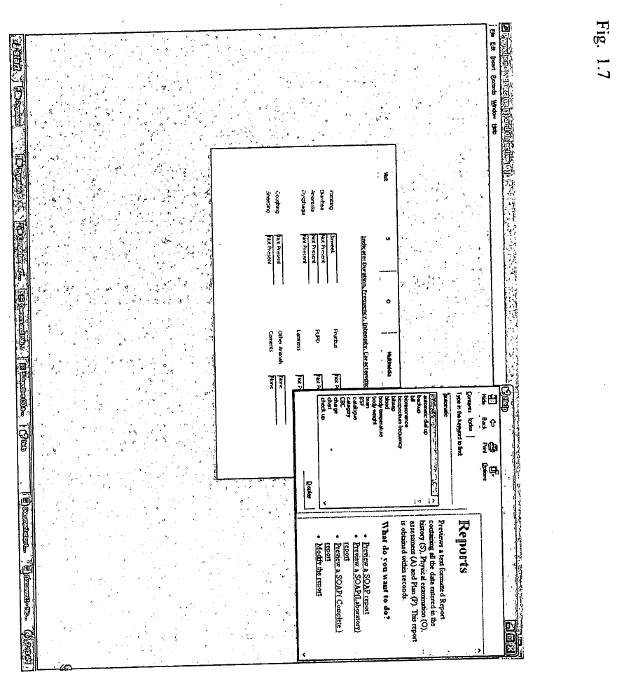

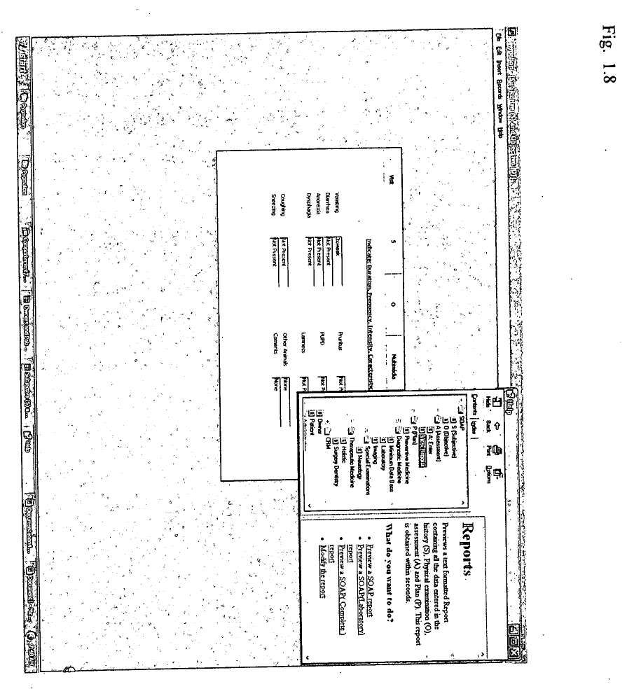

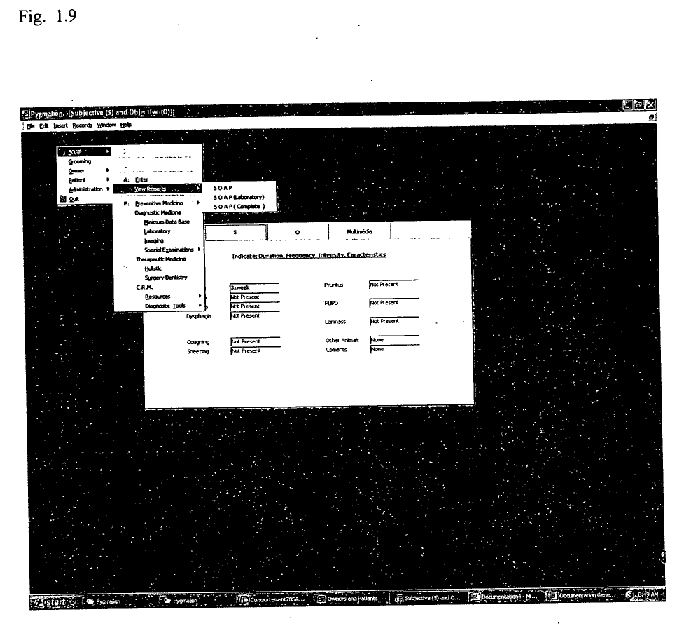

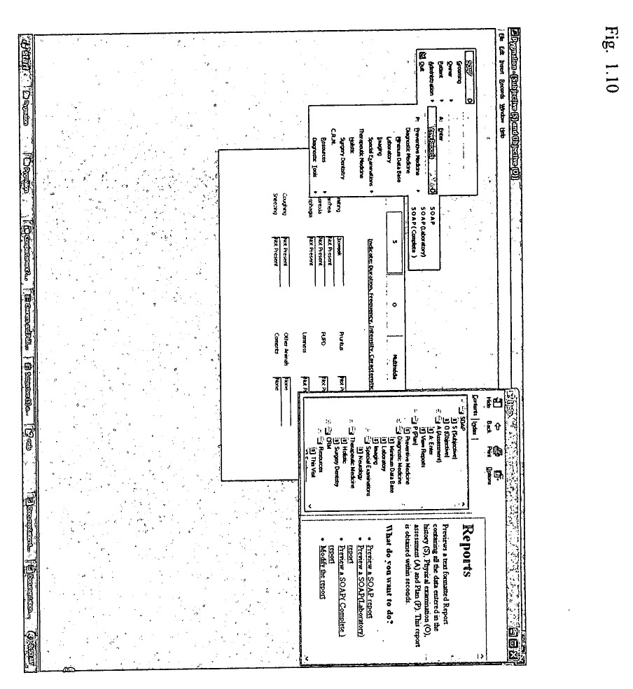

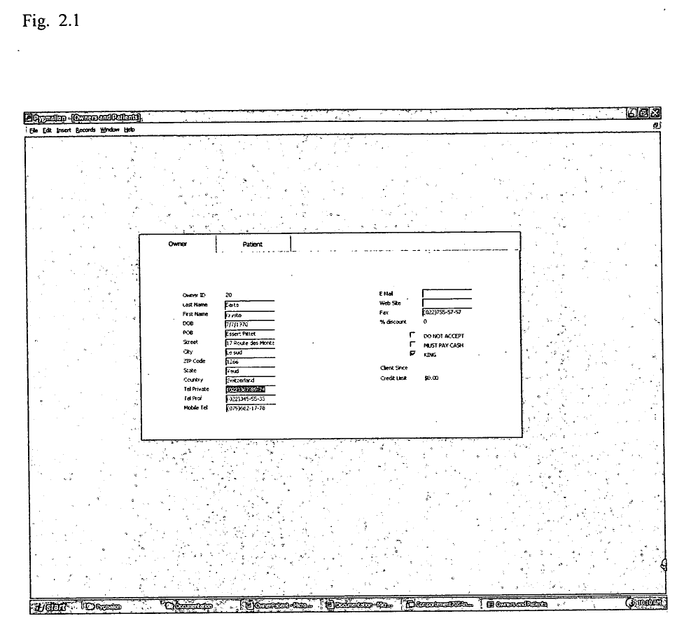

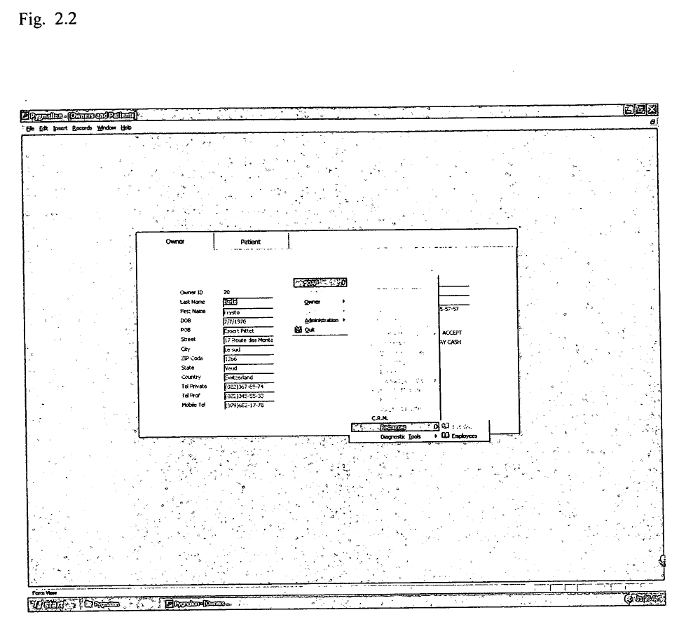

FIG. 1.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 1.2 shows:

The field on the right which displays Help for a particular task is the Topic Window. Clicking on fields in the Context outline (left window) displays corresponding Help in the Topic Window.

FIG. 1.3 shows:

Hyperlinks when activated present additional information in a pop-up window.

FIG. 1.4 shows:

The Index tab alphabetically lists keywords that assist the user in finding a particular topic.

FIG. 1.5 shows:

This tab has a field named: “Type in the keyword to Find:” for entering keywords. As a keyword is being typed in this field, all the alphabetically related keywords are shown. When the user “double clicks” the keyword, the related topic is displayed in the Topic Window.

FIG. 1.6 shows:

If several topics concern the same keyword, a window pops up with a listing of these topics.

FIG. 1.7 and FIG. 1.8 shows:

Clicking a topic, then selecting “Click Display” presents the related topic in the Topic Window, highlights its location in the Context field and allows the user to locate the topic on the applications map (Context tab).

2. Context Sensitive Menus

FIG. 1.9 through 1.10 shows:

That whether a field is present; absent; enabled or disabled on the context sensitive navigation menu (which pops up with a “Right Click”), depends on the current context.

Thanks to context driven menus, the user is always just one mouse click away from any logical link he may need. Thanks to Context-sensitive help the user is always just a few mouse clicks away from any localisation in the software he may need to access. This functionality makes learning how to use this software fast, easy and intuitive. Anyone with a basic understanding of Windows software, drop-down menus and essential medical terminology can master this software in just a few minutes, when hours to weeks of training are normally required to learn how to a use software dedicated to any branch of the medical profession.

Owner

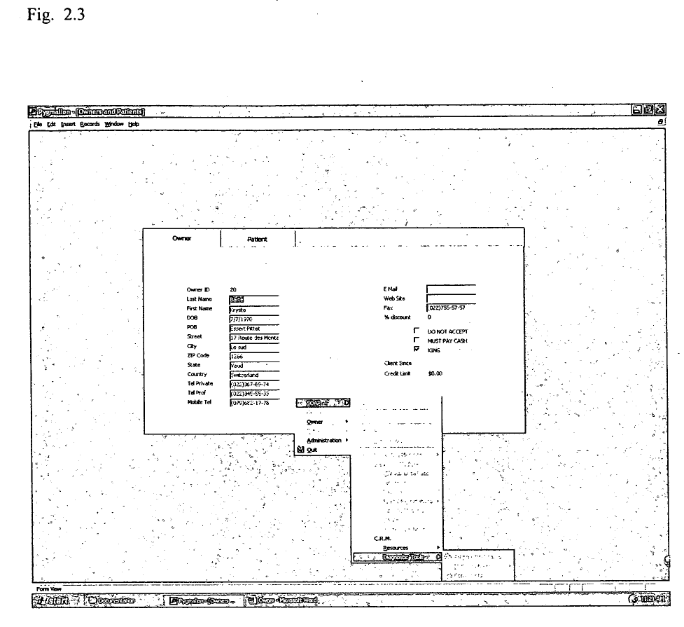

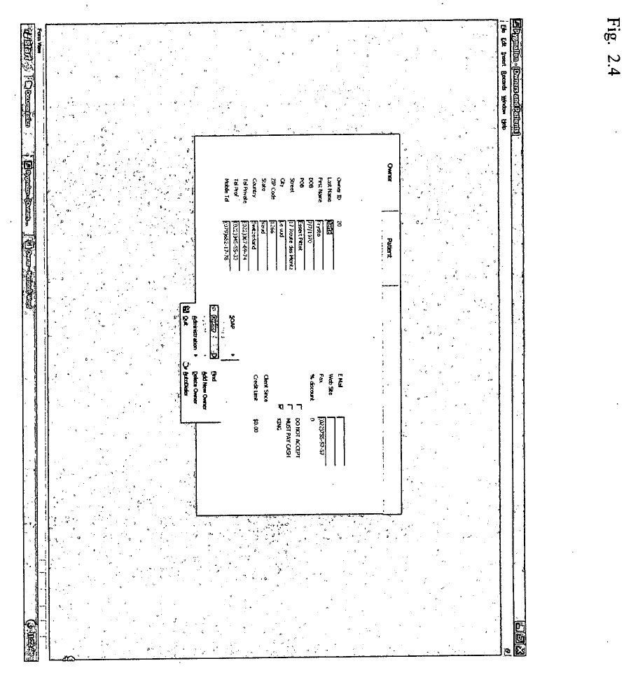

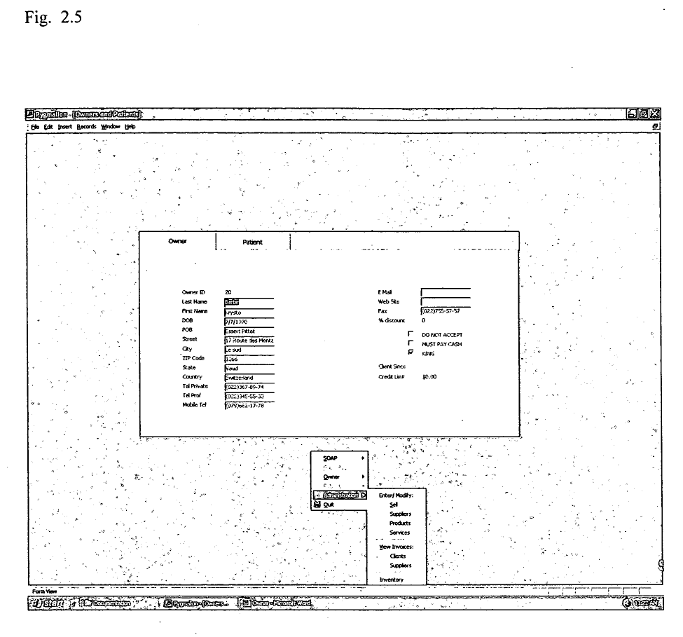

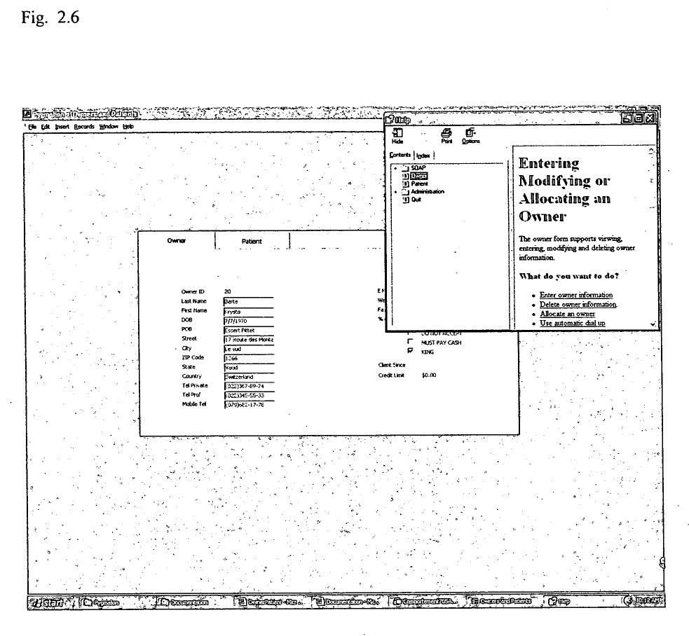

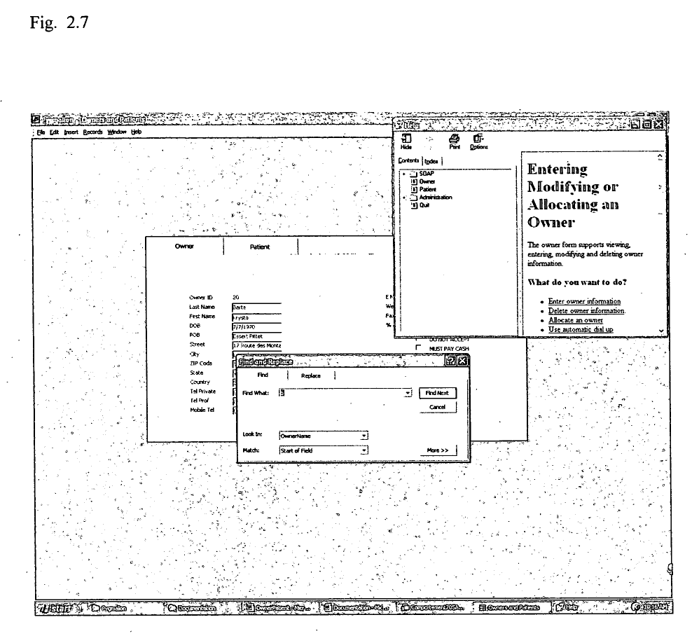

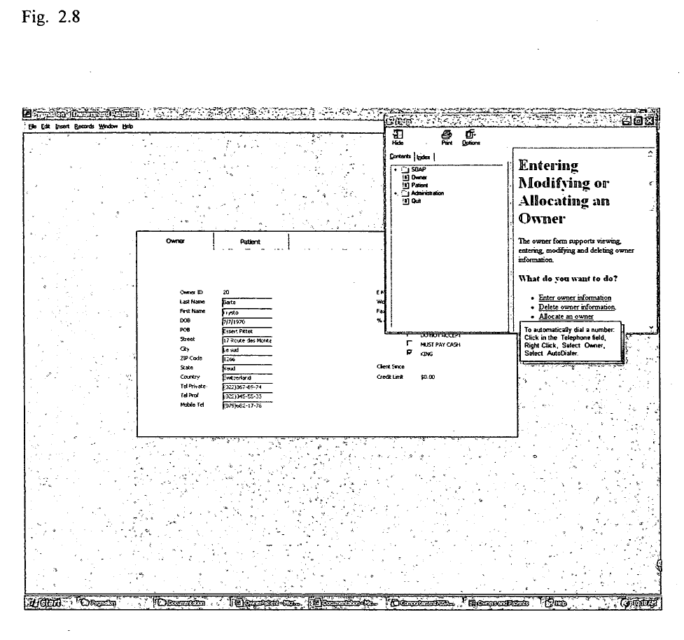

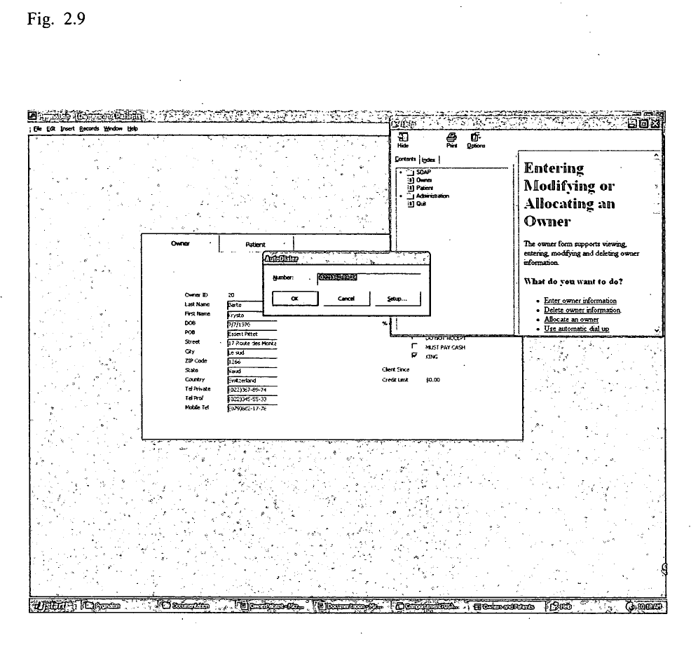

FIG. 2.1 shows:

The owner form which supports viewing, entering, modifying and deleting owner information.

The owners' form contains the following information which allows a good overview: the credit limit allowed by the clinics administration for this owner. The clinic may decide to have, default credit limit that may be personalized.

FIG. 2.2 through 2.5 shows:

That whether a field is present; absent; enabled or disabled on the context sensitive navigation menu (which pops up with a “Right Click”), depends on the current context.

FIG. 2.6 shows:

That selecting <<Ctrl H>> opens the context sensitive Customized Help, which in order to facilitate orientation, highlights the users' current location on the Context tab, which is a schematic representation of the context sensitive navigation menu (on the left).

FIG. 2.6 shows:

Hyperlinks in the Topic Window for the Owner form.

FIG. 2.7 shows:

How the user can find Owners according to the value of a field. For example if you select the field “Owner Name” and click “Find” then enter the first letter of the requested “Owner Name”, all the Owners whose name start by this letter will be selected in an alphabetical order. The same functionality applies for all the fields in this Form (address; Email; Phone; ect . . . ) as well as all other forms and modules when needed.

This medical software invention supplies auto-dialup fields distributed throughout the application where ever phone or fax numbers are present. For example:

FIG. 2.8 shows:

Hyperlinks when activated present additional information in a pop-up window.

The example chosen here is: Use automatic dial up.

FIG. 2.9 shows:

What the user views when he is following the instructions displayed in the “Use automatic dial up” pop-up window.

This medical software invention supplies auto-link fields distributed throughout the application where ever web addresses are present. For example: FIG. 2.1.

Patient

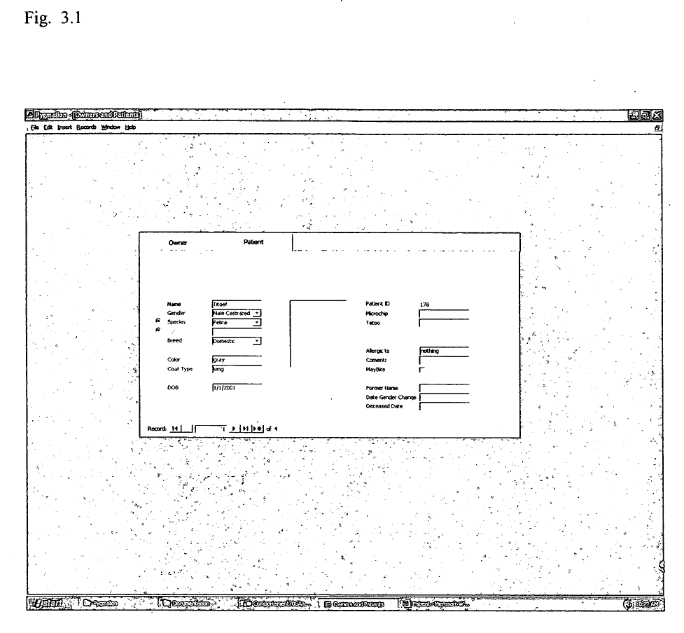

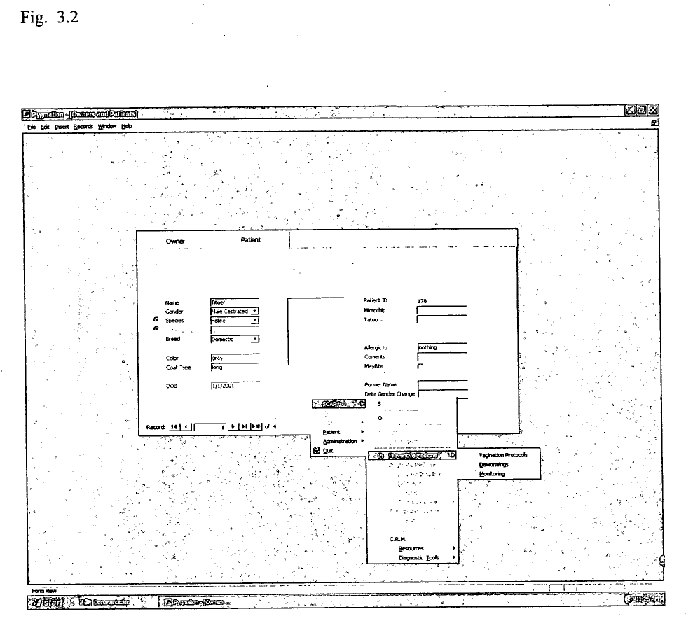

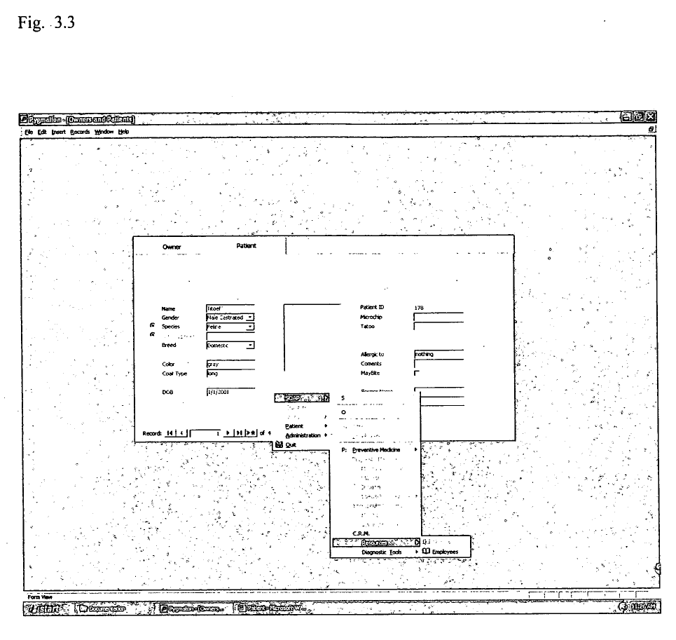

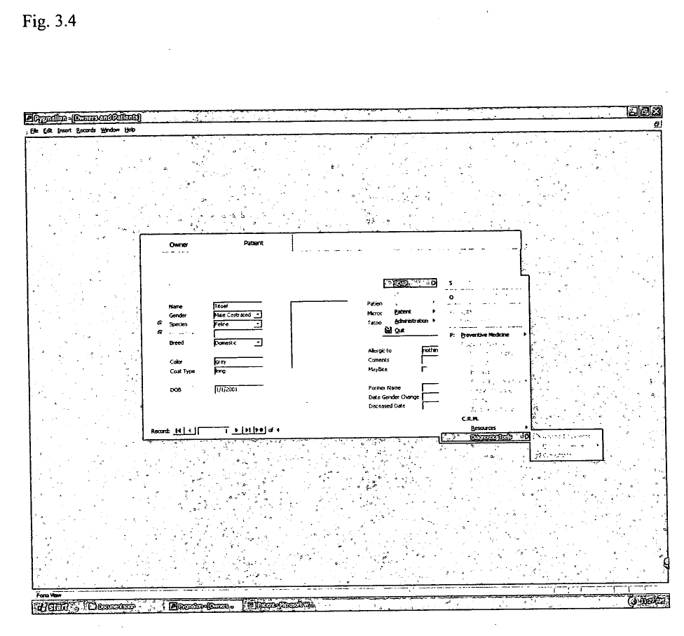

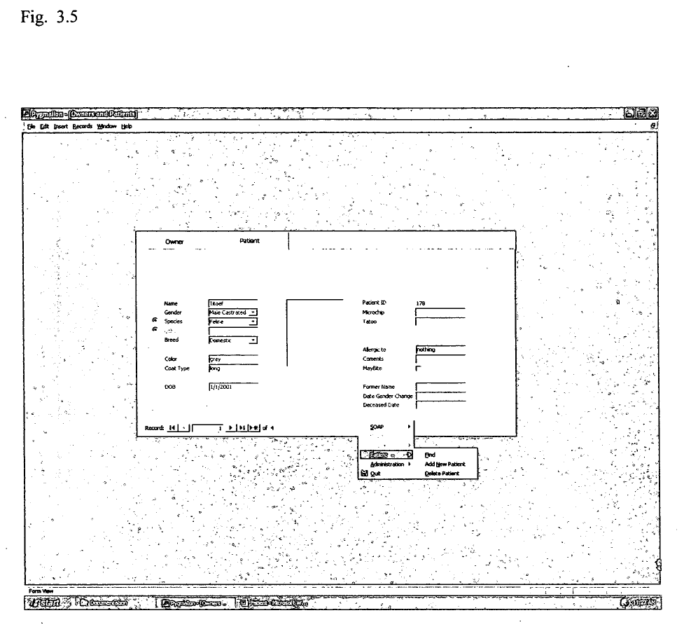

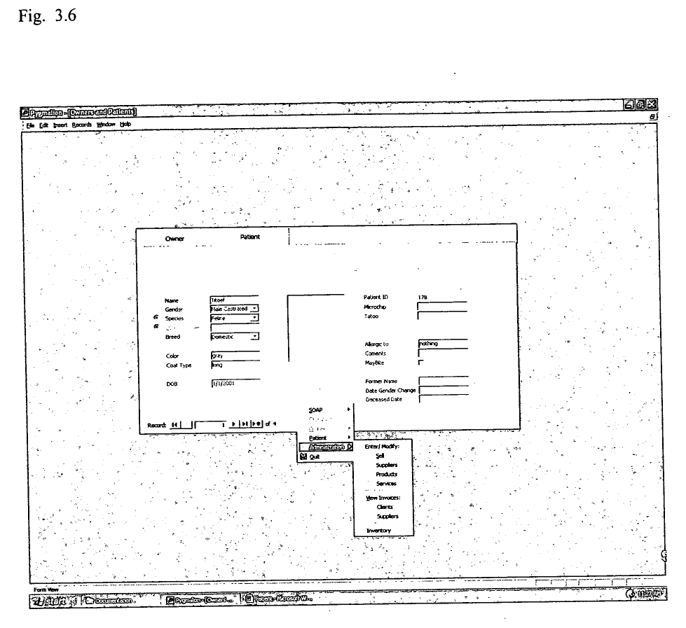

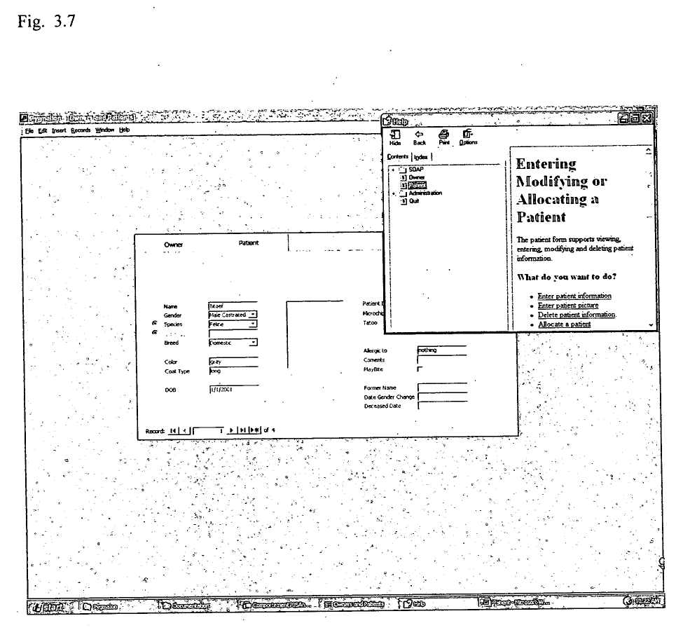

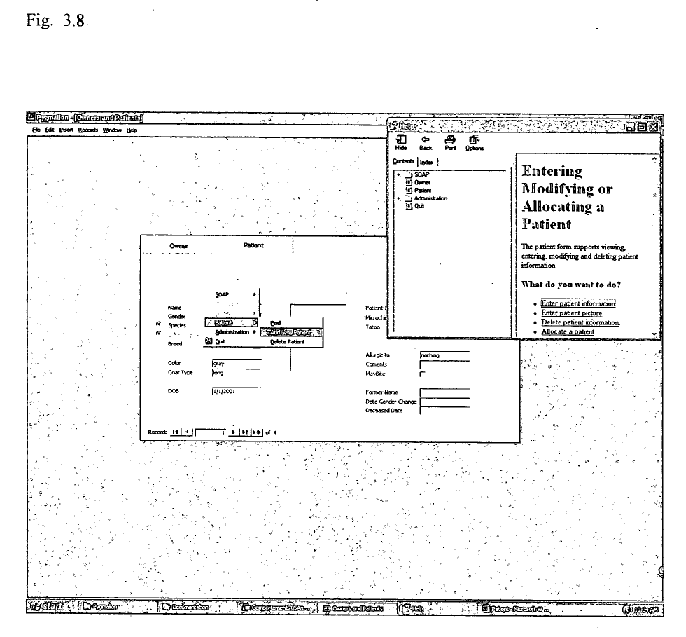

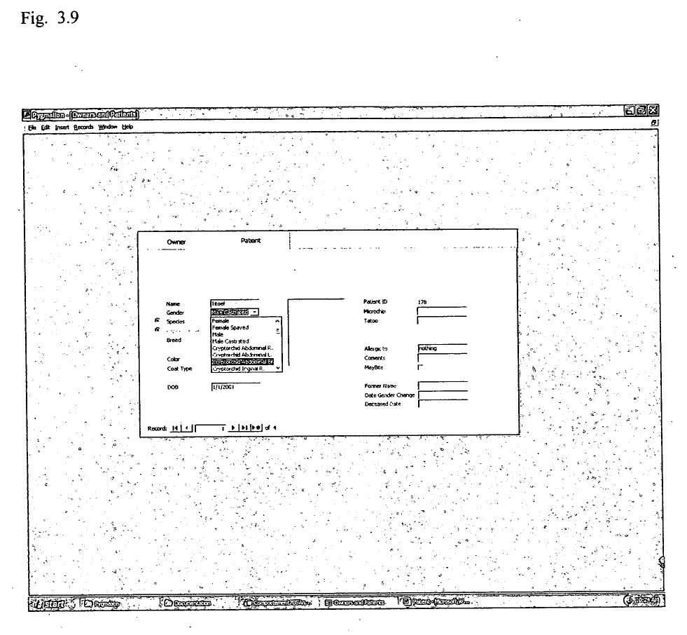

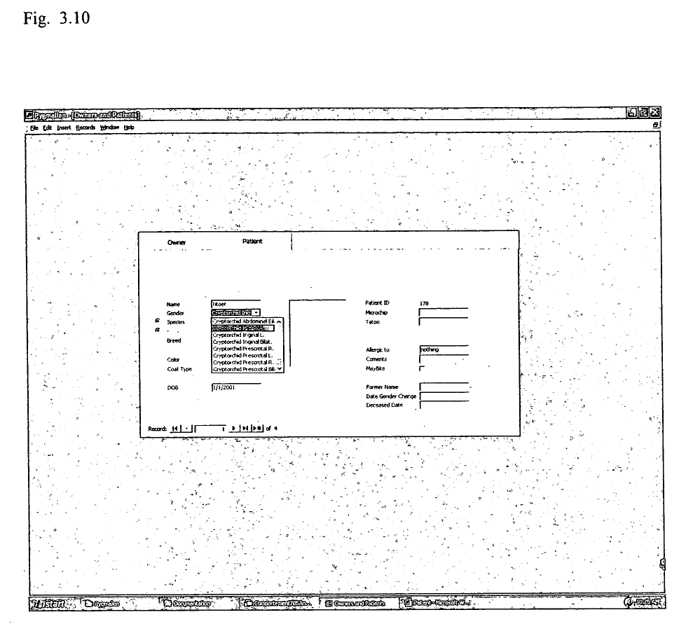

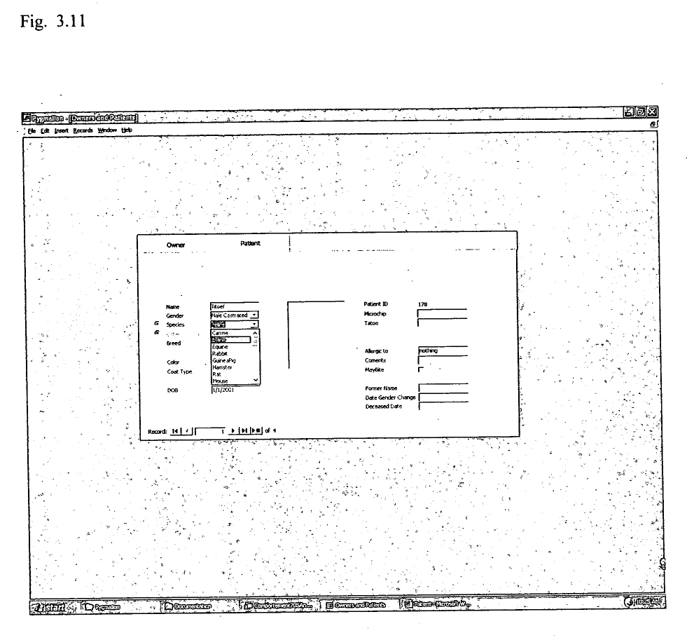

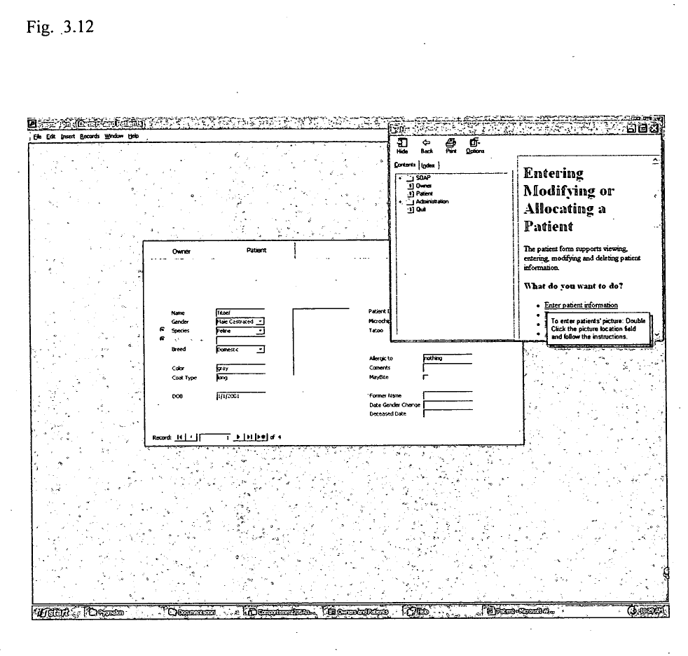

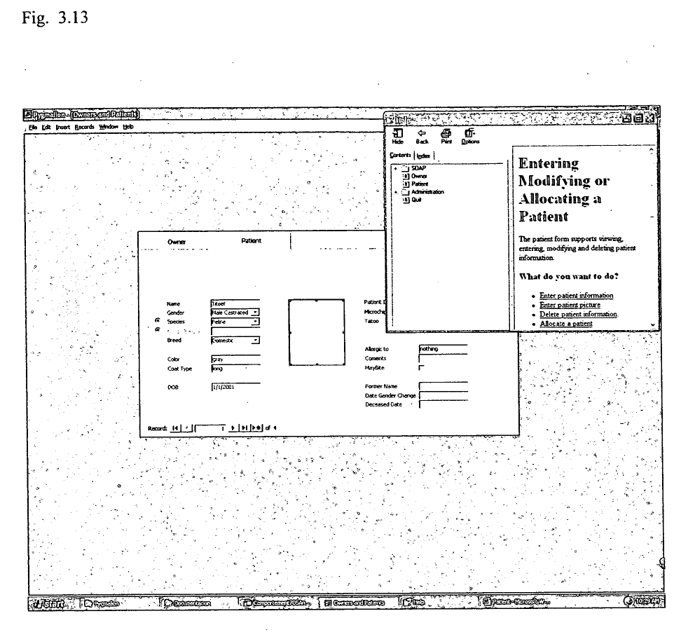

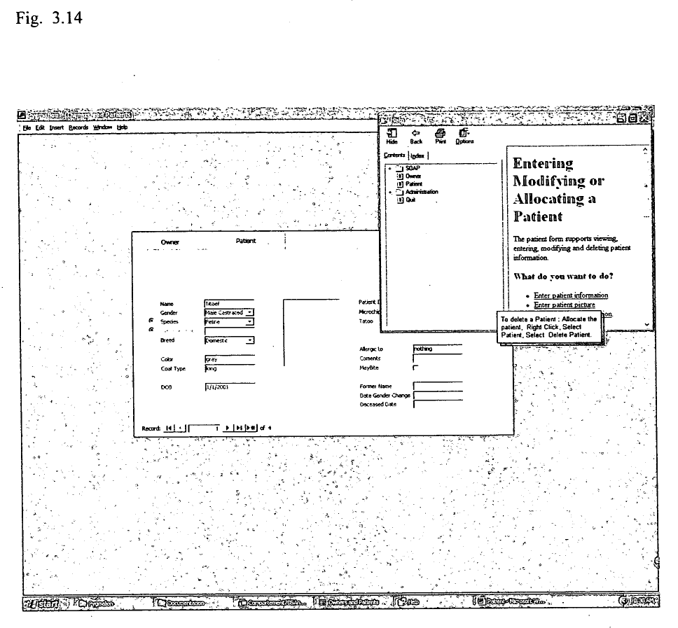

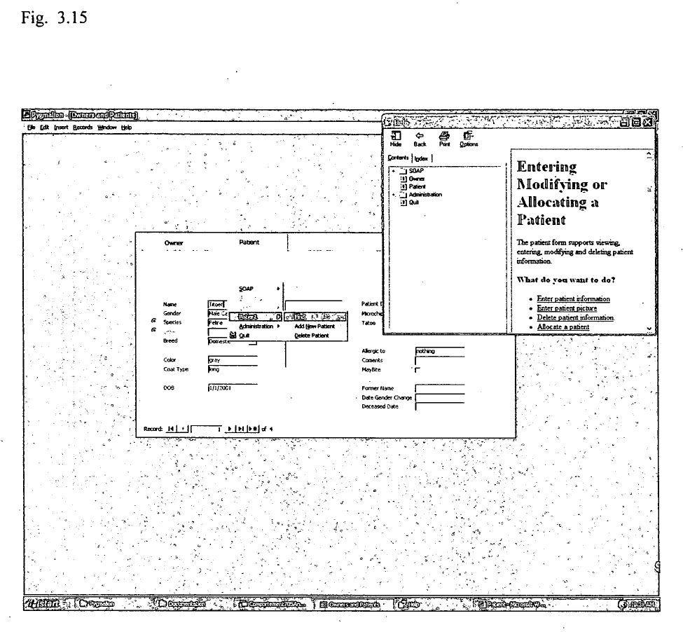

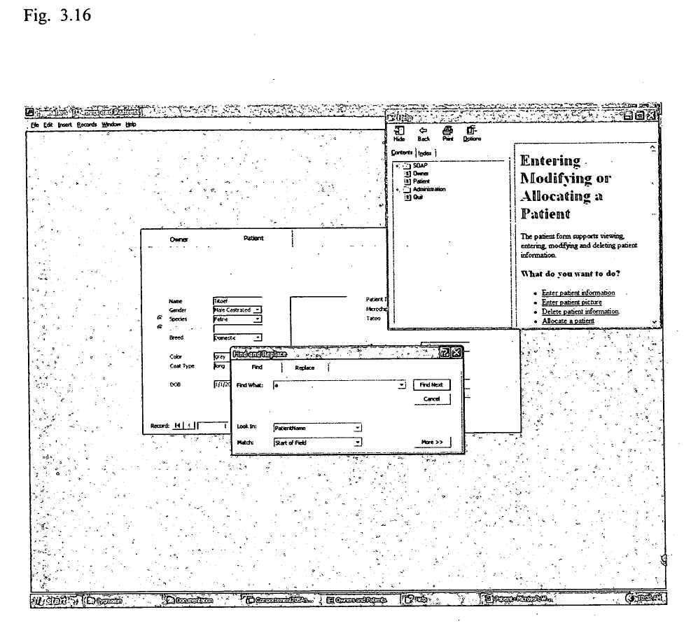

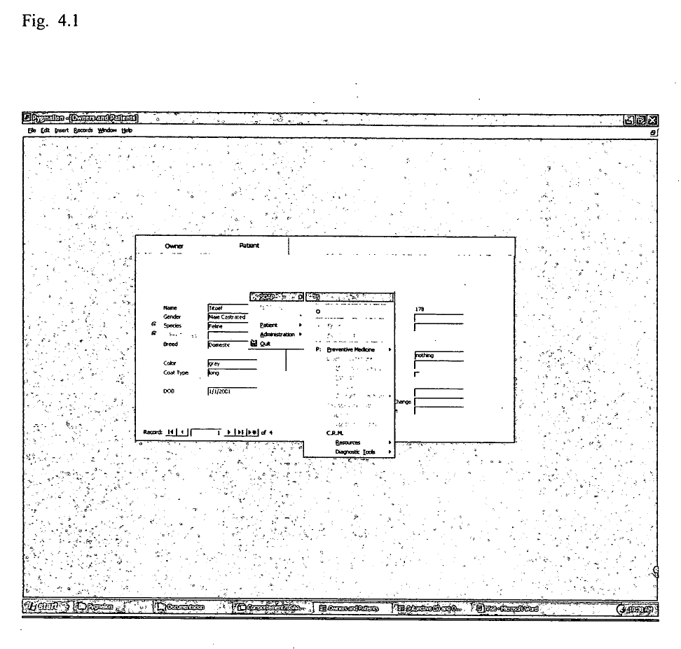

FIG. 3.1 shows:

The patient module which supports viewing, entering, modifying and deleting patient information.

FIG. 3.2 through 3.6 shows:

That whether a field is present; absent; enabled or disabled on the context sensitive navigation menu (which pops up with a “Right Click”), depends on the current context.

FIG. 3.7 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 3.8 shows:

Hyperlinks in the Topic Window for the Patient form.

This medical software invention has a better time efficiency, since data is entered with minimal typing (through for example: combo boxes, scroll down menus and other functionalities), time is saved but nevertheless the medical Record is complete.

FIG. 3.9 through 3.11 shows:

That typing the first letter of the <<Gender>> and <<Species>> fields enters automatically the “Gender” and “Species” in their respective fields.

FIG. 3.12 shows:

Hyperlinks when activated present additional information in a pop-up window.

FIG. 3.13 shows:

Hyperlinks in the Topic Window for the Patient form as well as the central multimedia field on this form.

FIG. 3.14 through 3.16:

Walks us through following the indications from the Hyperlink pop-up window.

FIG. 3.16 shows:

That only Patients from the same Owner are looked up in this context.

Visit-Subjective-Objective (=SO)

The Visit-Subjective (medical record history)-objective (physical examination) form supports entering; viewing; modifying and deleting, Visit; Subjective and Objective information.

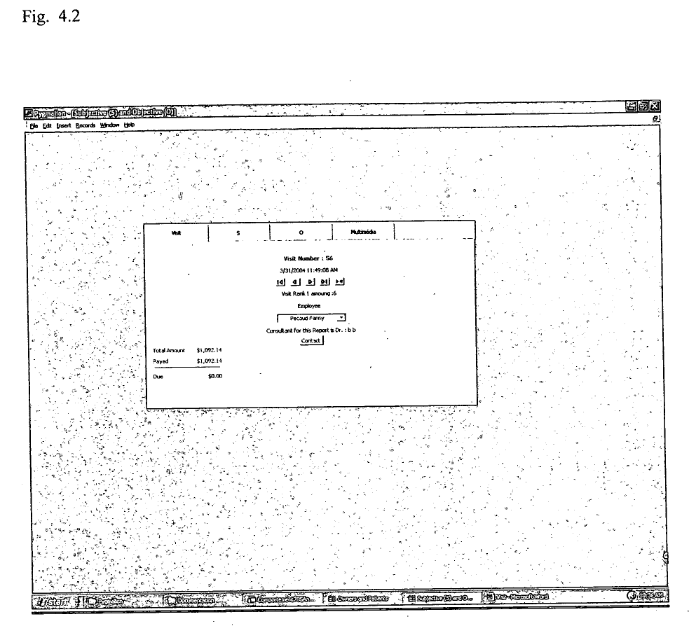

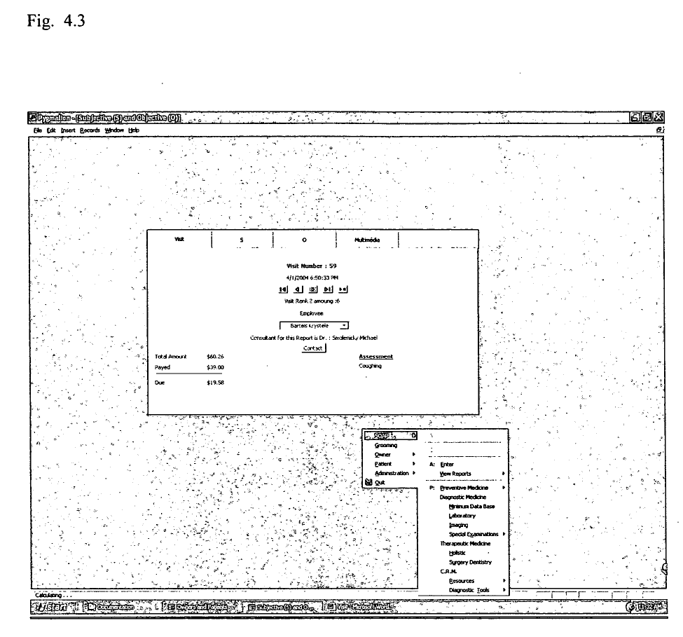

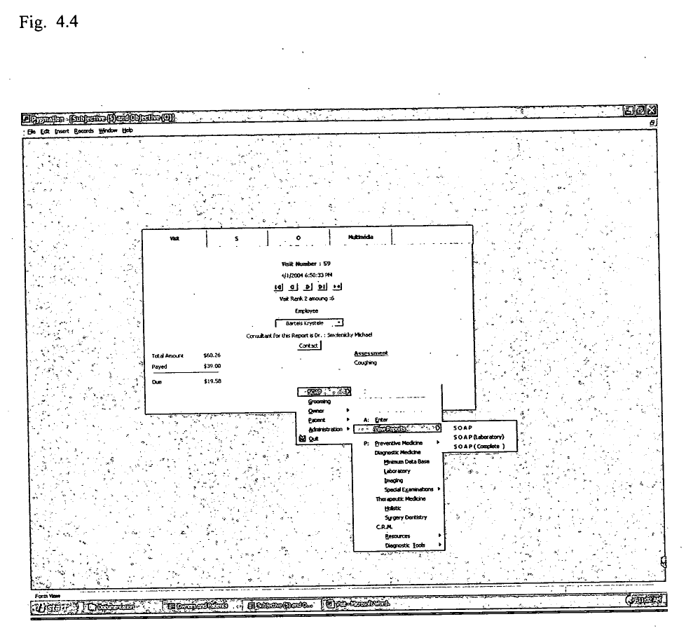

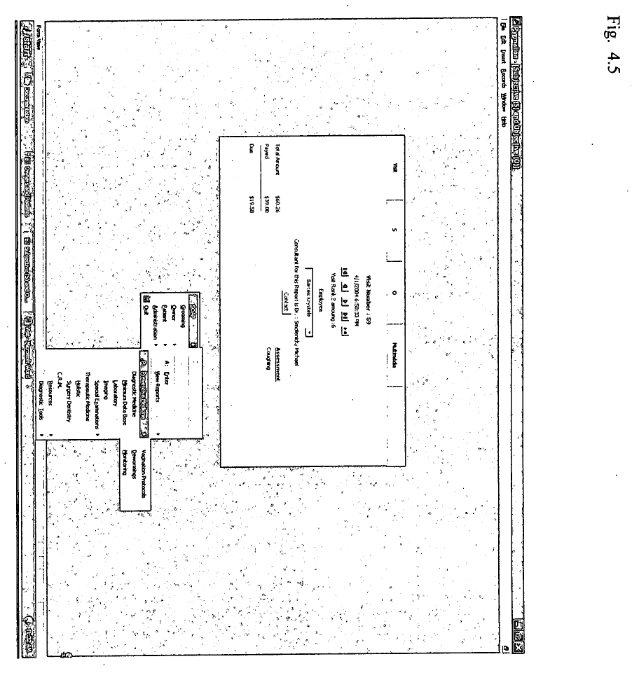

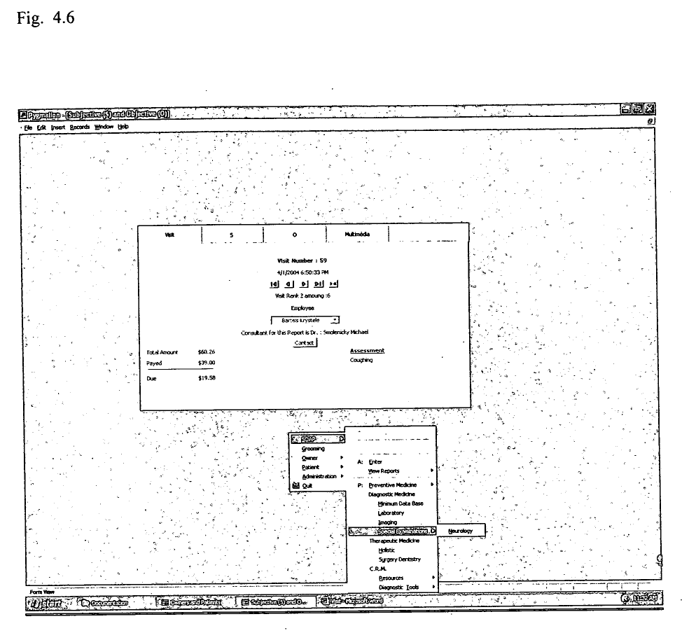

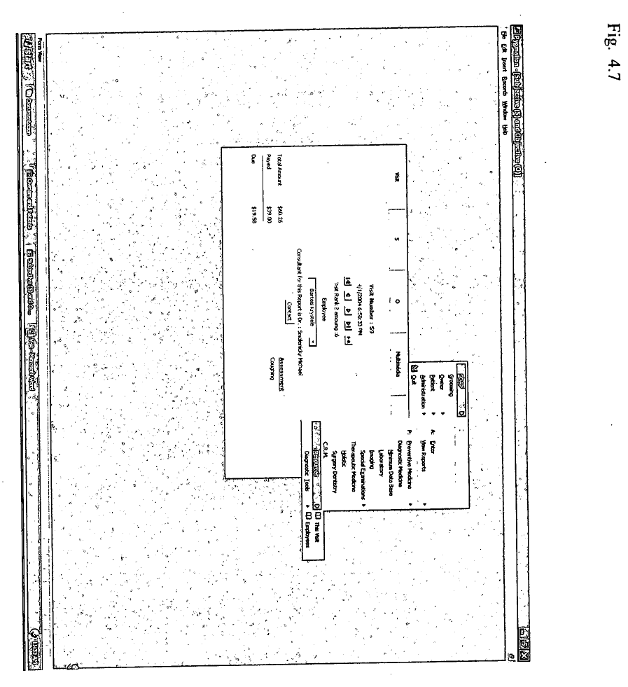

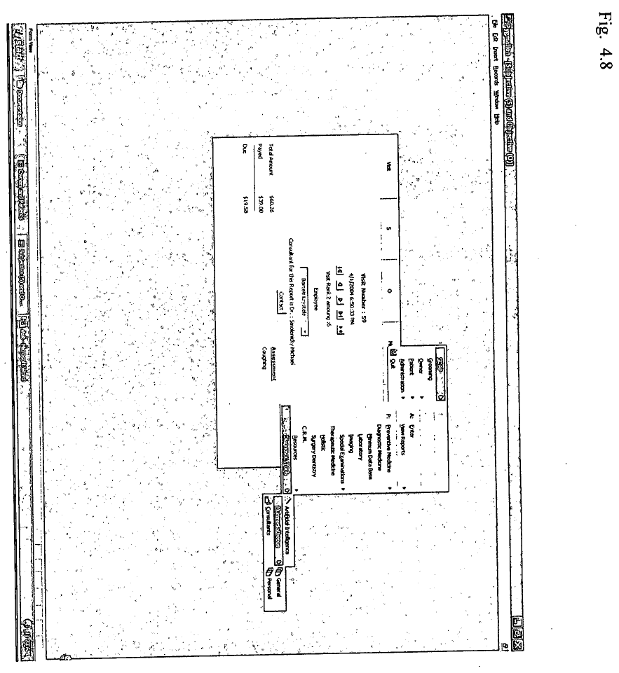

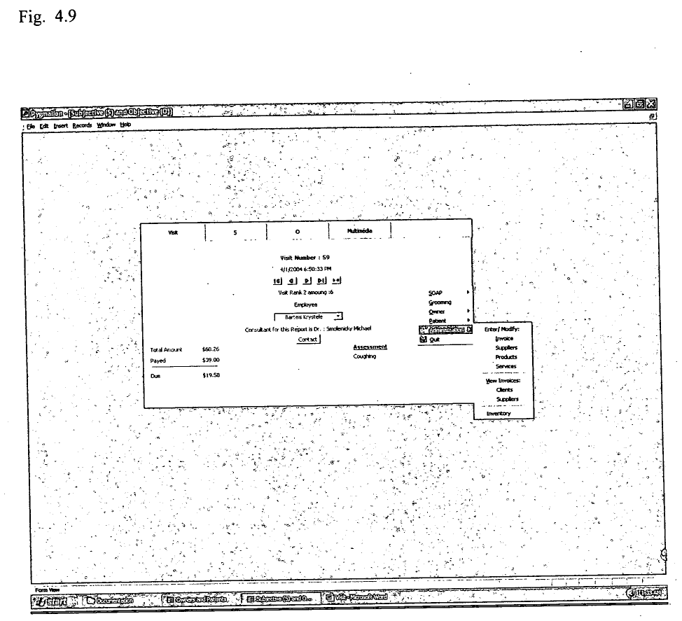

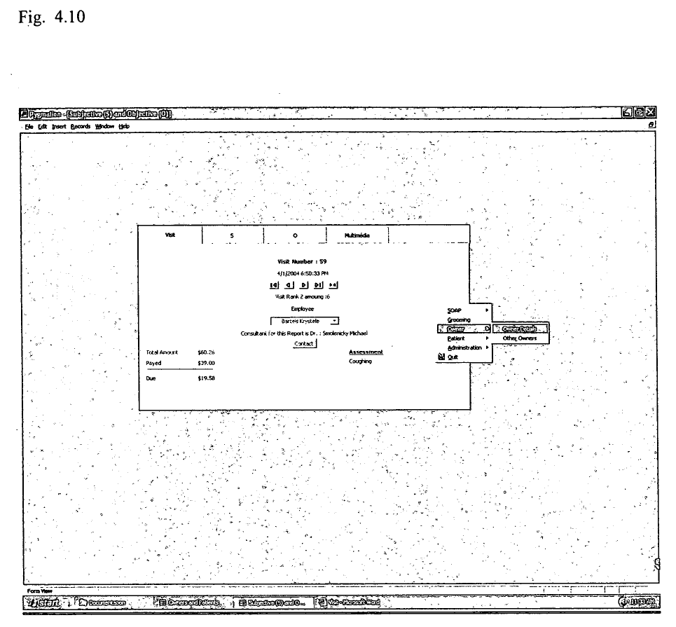

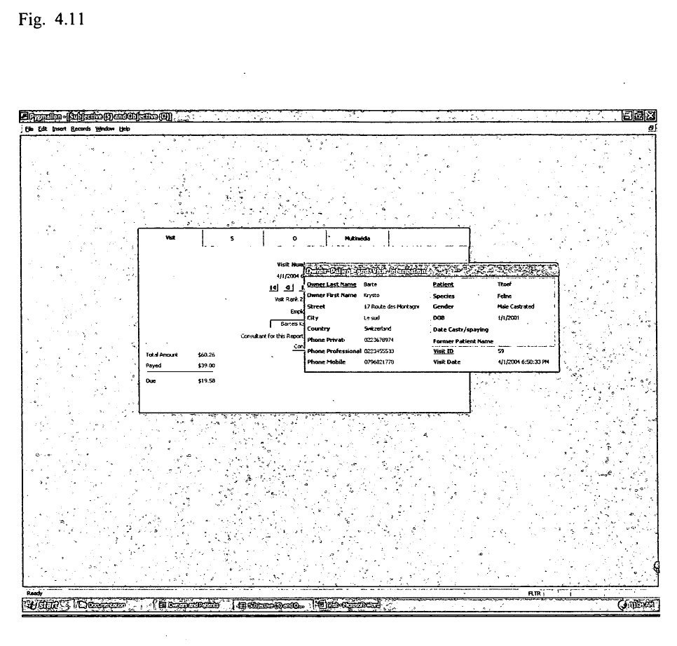

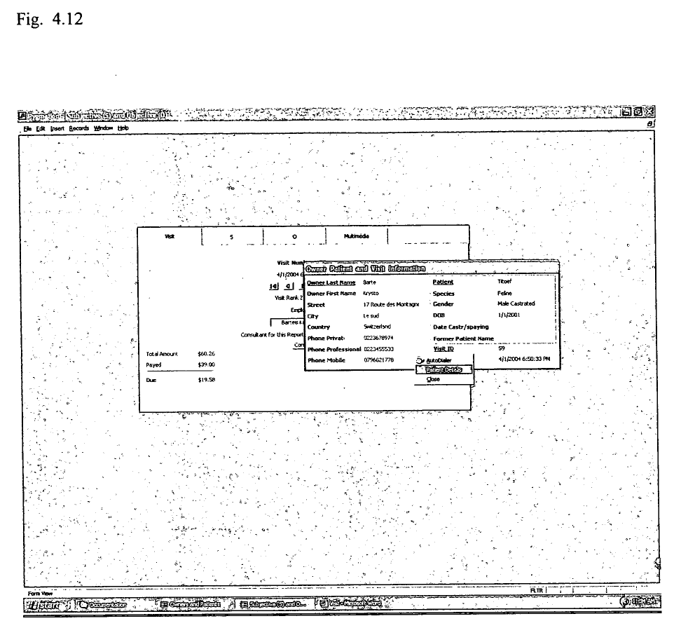

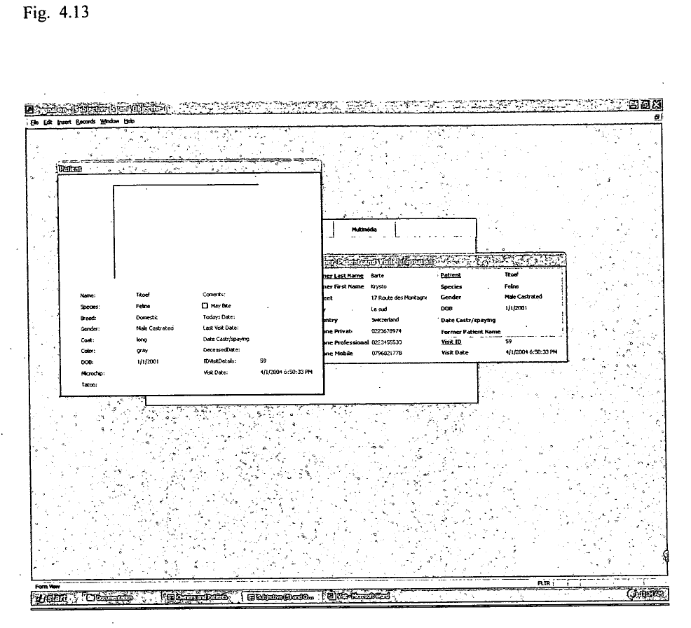

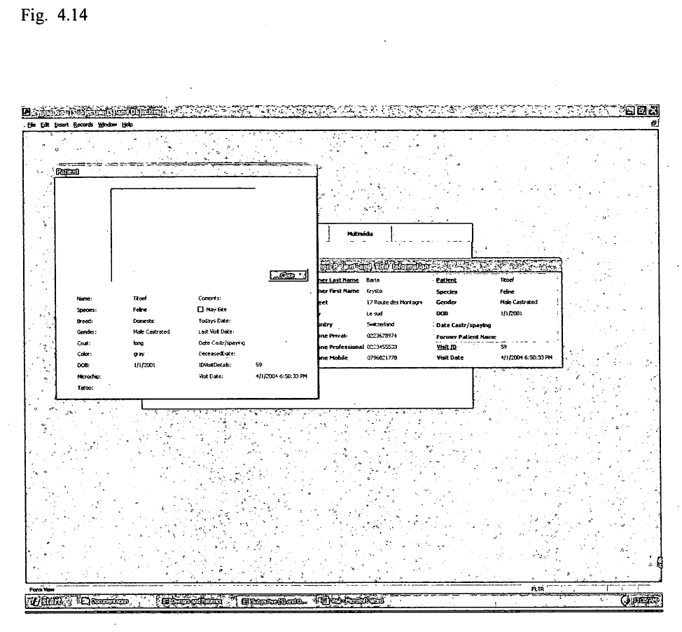

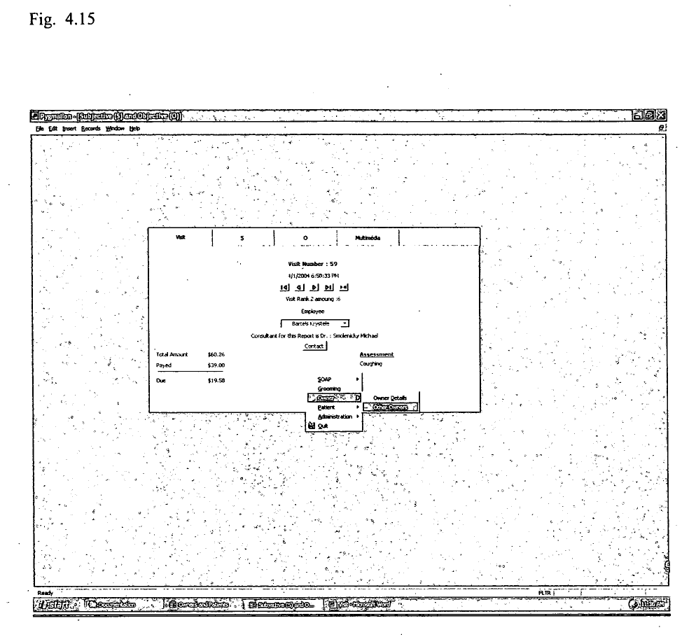

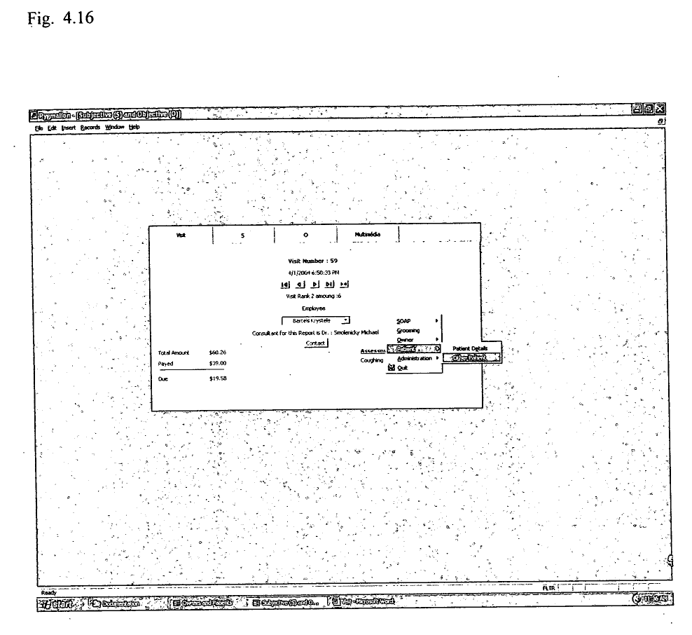

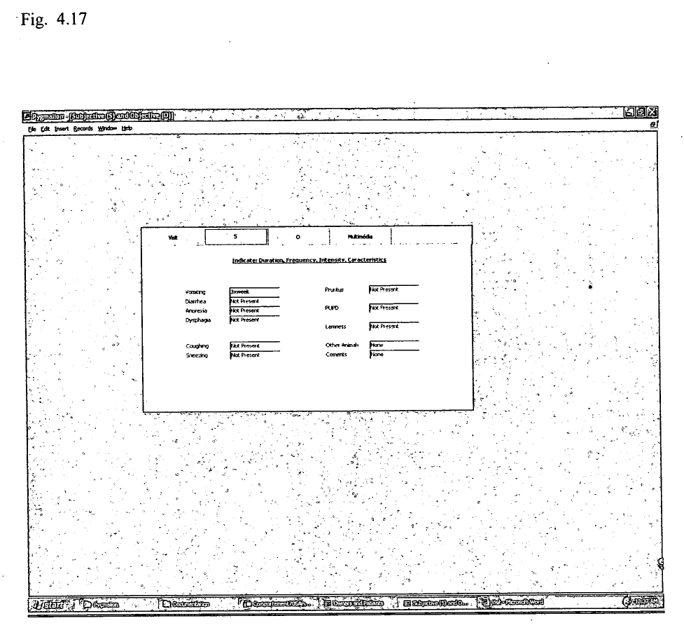

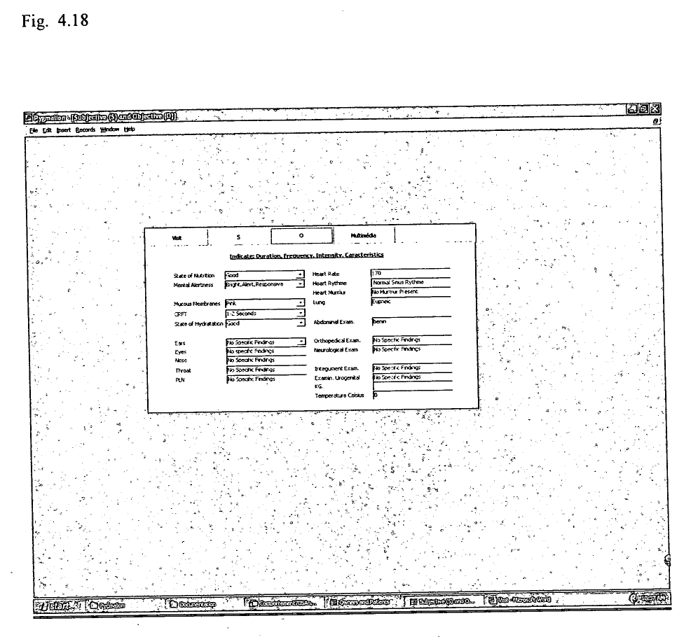

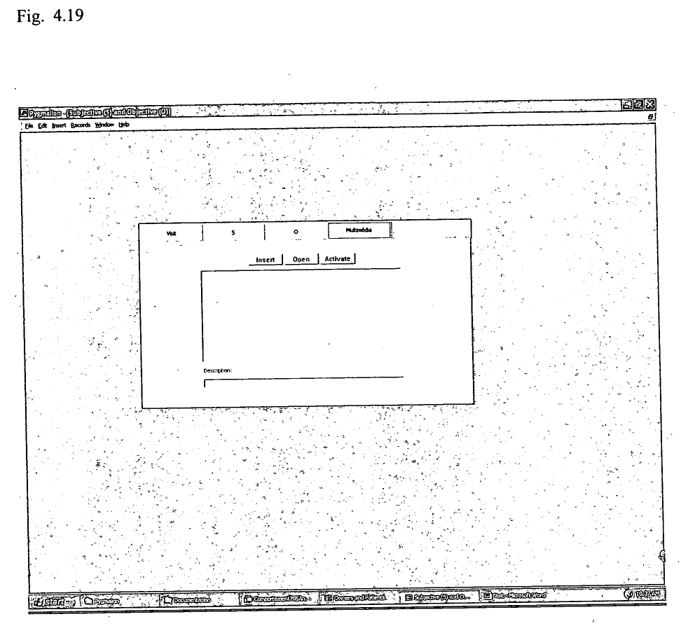

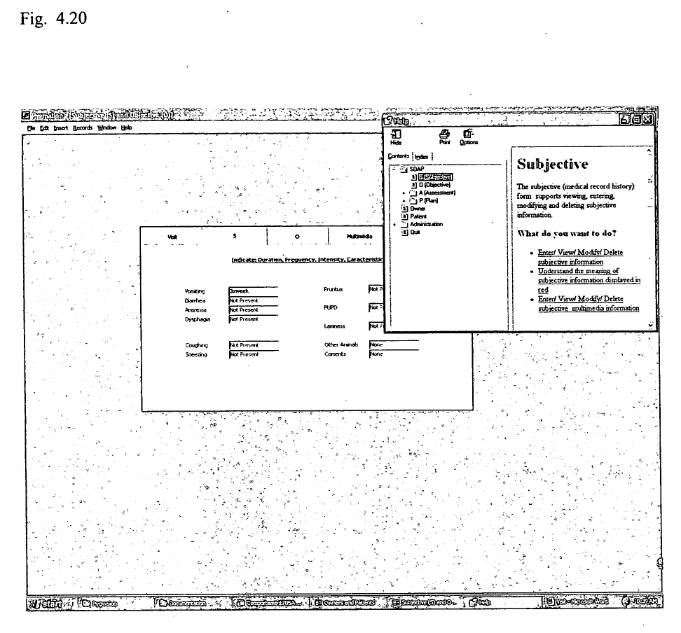

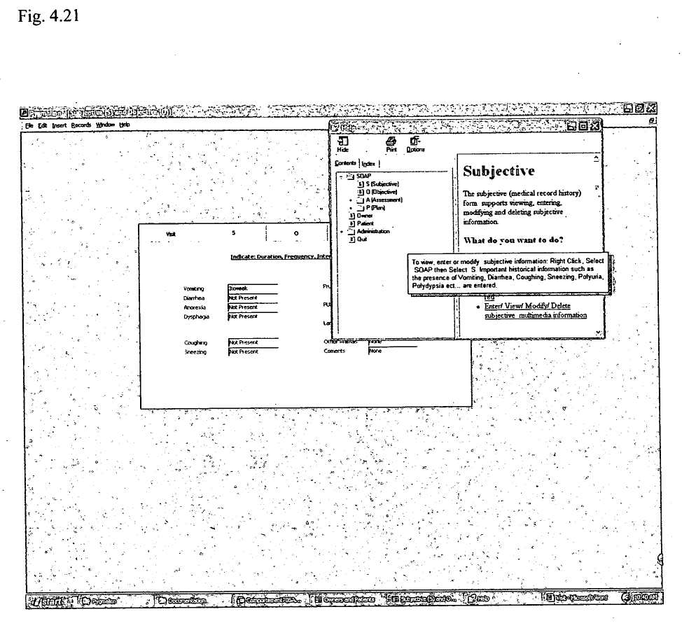

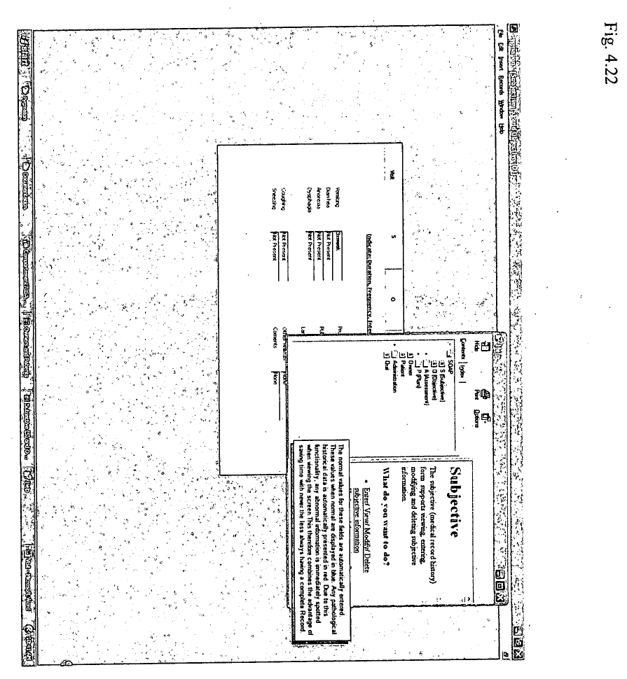

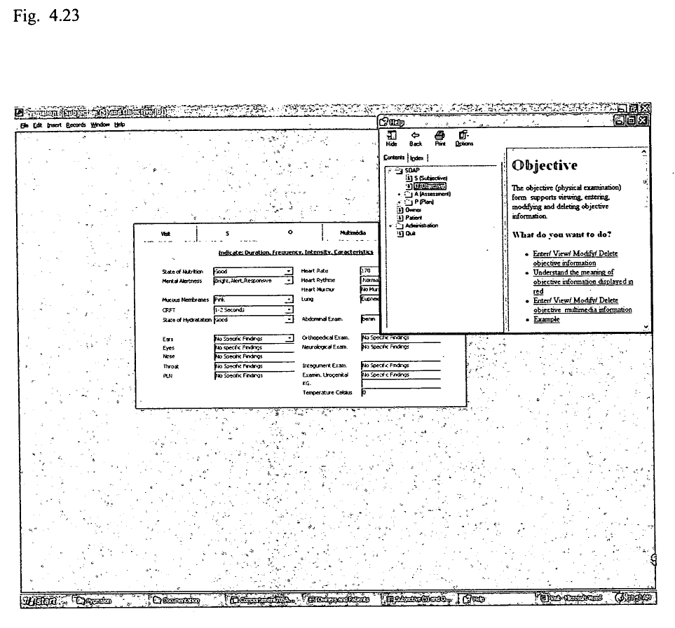

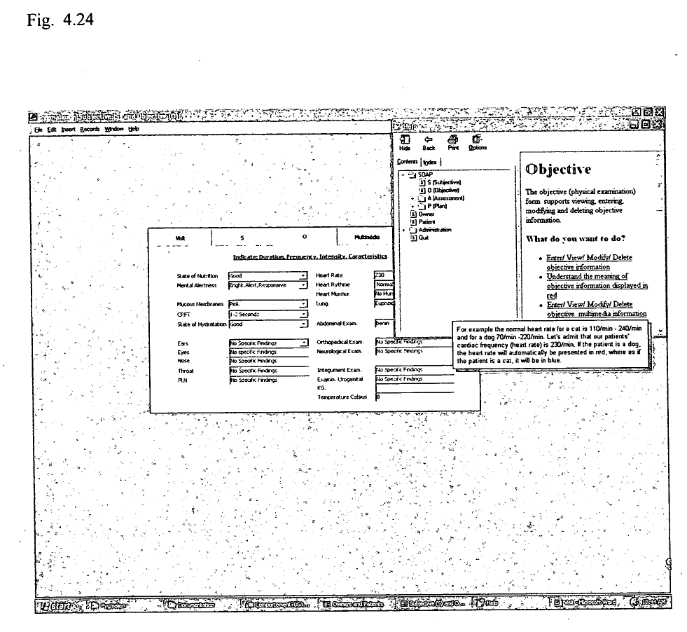

FIG. 4.1 shows:

How to allocate the Visit-Subjective (medical record history)-objective (physical examination) form.

The Medical Record is arranged in <<Visits>> (Office calls). The Identity of the consulting Dr is entered.

The medical Records are ordered according to the POMR (Problem Oriented Medical Record) each case is SOAP-ed (Subjective, Objective, Assessment, Plan).

This medical software saves the users' time, since data is entered with minimal typing, time is saved but nevertheless the medical Record is complete.

FIG. 4.2 shows:

The Visit form.

This medical software invention supplies auto-lookup fields distributed throughout the application where ever needed. For example: the Visit (consultation) form contains the following information which allows a good overview: doctor doing the consultation, if a report of this visit has been sent to a consultant: name of consultant with date of sending and button when activated by the user prepares automatically an email addressed to the consultant with the reports' profile information and: on the lower left corner the following billing information is detailed for each visit:

These Values are entered automatically by the software invention.
Total Amount Currency of the Invoice (only visible when this value is not zero).
Total Amount paid (only visible when this value is not zero).
Total Amount due (only visible when this value is not zero).

When an “Assessment” (Diagnostic, Evaluation) for this Visit is has been established, it is visible on the lower right corner. The software invention enters automatically the “Assessment” made by the user. When no “Assessment” has been made, the lower right corner remains empty.

FIG. 4.3 through 4.16 shows:

That whether a field is present; absent; enabled or disabled on the context sensitive navigation menu (which pops up with a “Right Click”), depends on the current context. For example:

FIG. 4.10 through FIG. 4.14 shows:

That from anywhere in the patients' record, the user may view the owners' and patients' profile.

FIG. 4.13 shows:

The patients pop-up form with its central multimedia field.

S: (Subjective=History)

THIS IS THE ONLY SOFTWARE OFFERING THESE FUNCTIONALITIES.

Important historical information such as the presence of Vomiting; Diarrhea; Coughing; Sneezing; Polyuria; Polydypsia . . . is entered.

The normal values for these fields are automatically entered in these fields. These values when normal are displayed in blue. Any pathological historical data is automatically presented in red. Due to this functionality, any abnormal historical information is immediately spotted when viewing the screen. This way of doing also avoids the user repeatedly entering normal data, therefore combines the advantage of saving time with never the less always having a complete Record.

Not only is any abnormal historical, but also any abnormal physical examination as any abnormal laboratory information immediately spotted when viewing the screen. Any pathological result is automatically high lightened.

FIG. 4.17 shows:

the Subjective (medical record history) form with a pathological value displayed in red.

O: (Objective=Physical Examination)

THIS IS THE ONLY SOFTWARE OFFERING THESE FUNCTIONALITIES.

Gathers information for a complete Physical Examination (Mucous membranes; CRFT; PLN; Heart (frequency; rhythm); Lungs; Abdomen; Orthopaedic Examination; Neurological Examination and Dermatological Examination).

The normal values for these fields are automatically entered in these fields. These values if normal are displayed in blue. Any pathological data is automatically presented in red. Due to this functionality, any abnormal information is immediately spotted when viewing the screen. This way of doing also avoids the user repeatedly entering normal data, therefore combines the advantage of saving time with never the less always having a complete Record.

For example the normal heart rate for a cat is 110/min-240/min and for a dog 70/min-220/min. Let's admit that our patients' cardiac frequency (heart rate) is 230/min. If the patient is a dog, the heart rate will automatically be presented in red, where as if the patient is a cat, it will be in blue.

FIG. 4.18 shows:

The Objective (physical examination) form with a pathological value displayed in red.

FIG. 4.19 shows:

The multimedia field for the Visit-Subjective (medical record history)-objective (physical examination) form.

Selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 4.20 shows:

Hyperlinks in the Topic Window for the Subjective form.

FIG. 4.21 through 4.22 shows:

Hyperlinks when activated present additional information in a pop-up window.

FIG. 4.23 shows:

Hyperlinks in the Topic Window for the Objective form.

FIG. 4.24 shows:

Hyperlinks when activated present additional information in a pop-up window.

Assessment

The assessment (physicians' assessment) form supports entering, viewing, modifying and deleting assessment information.

This medical software invention supplies auto-lookup fields distributed throughout the application where ever needed.

When an “Assessment” (Diagnostic, Evaluation) for this Visit is has been established, it is visible on the lower right corner. The software enters automatically the “Assessment” made by the user. When no “Assessment” has been made, the lower right corner remains empty.

Selecting <<Ctrl H>> opens the context sensitive Customized Help, which in order to facilitate orientation, highlights the users' current location on the Context outline (left window of the Customized Help), which is a schematic representation of the context sensitive navigation menu. Whether a field is present; absent; enabled or disabled on the context sensitive navigation menu (which pops up with a “Right Click”), depends on the current context.

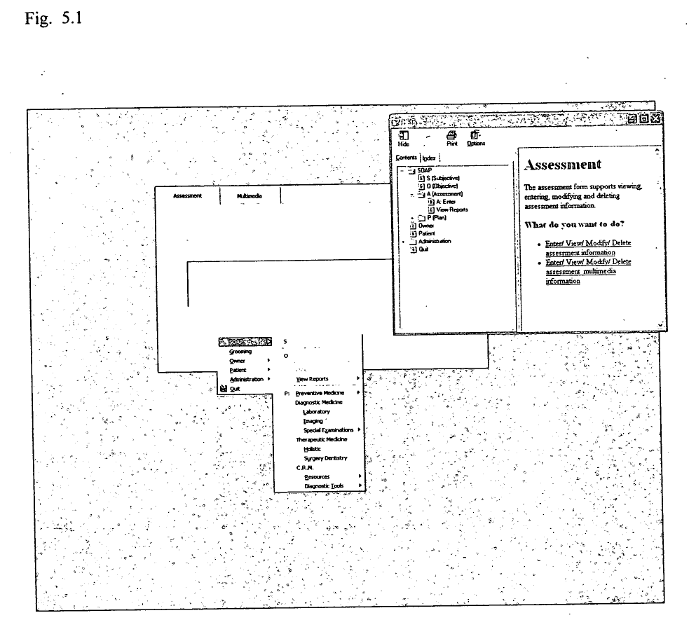

FIG. 5.1 shows:

The Assessment forms' topic Window Hyperlinks and context sensitive navigation men

Reports

This module supports reviewing or modifying a text-formatted report containing all the data entered in the History (S), the Physical examination (0), the Assessment (A) and the Plan (P).

This CRM application is capable of establishing within seconds, a complete (POMR—Problem Oriented Medical Record—, SOAP-ed—Subjective, Objective, Assessment, Plan—and for behaviour medicine based on the ASMC and AFMC standards) report. This medical software invention allows the user to establish reports with or without 1) all the laboratory results included 2) all the images included 3) only a selection of the laboratory results and images included. When needed the user may, edit it by clicking on the “Word” menu to transform the text in “Word”, thus take advantage of ail the functionalities offered in this application.

Pygmalion Concept (Trademark rights reserved) enables the doctor, within seconds, to send a complete and completely compliant to POMR; ASMC; AFMC and automatically established record to a consultant. Because of this functionality, the doctor will be able to use consulting services more often, and consultants will not waste time and energy with incomplete reports.

Selecting <<Ctrl H>> opens the context sensitive Customized Help, which in order to facilitate orientation, highlights the users' current location on the Context outline (left window of the Customized Help), which is a schematic representation of the context sensitive navigation menu. Whether a field is present; absent; enabled or disabled on the context sensitive navigation menu (which pops up with a “Right Click”), depends on the current context.

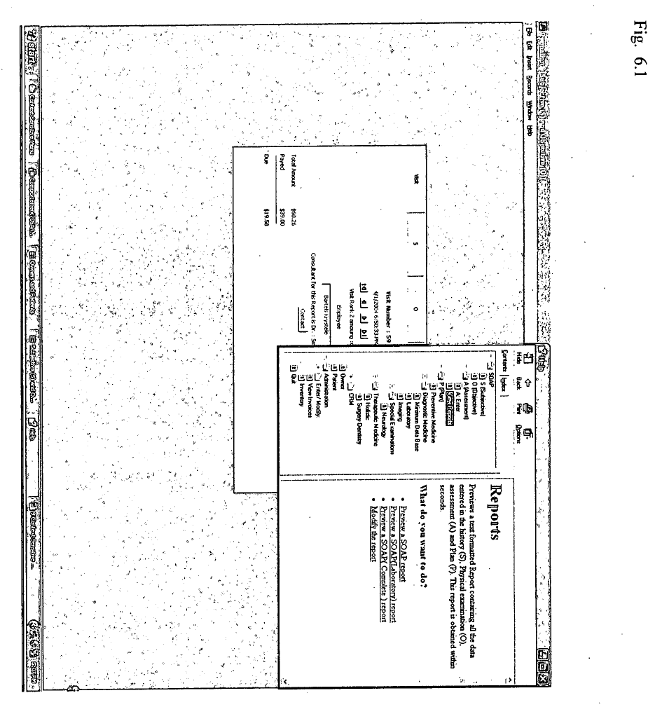

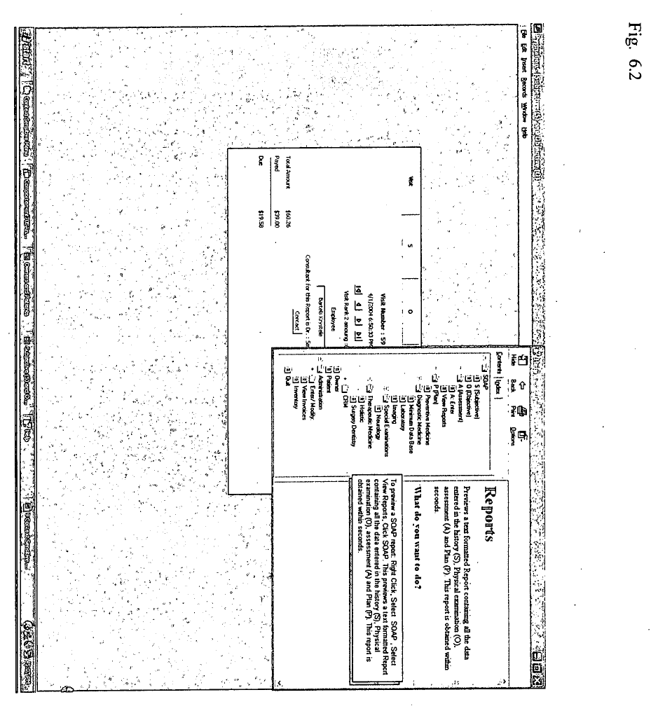

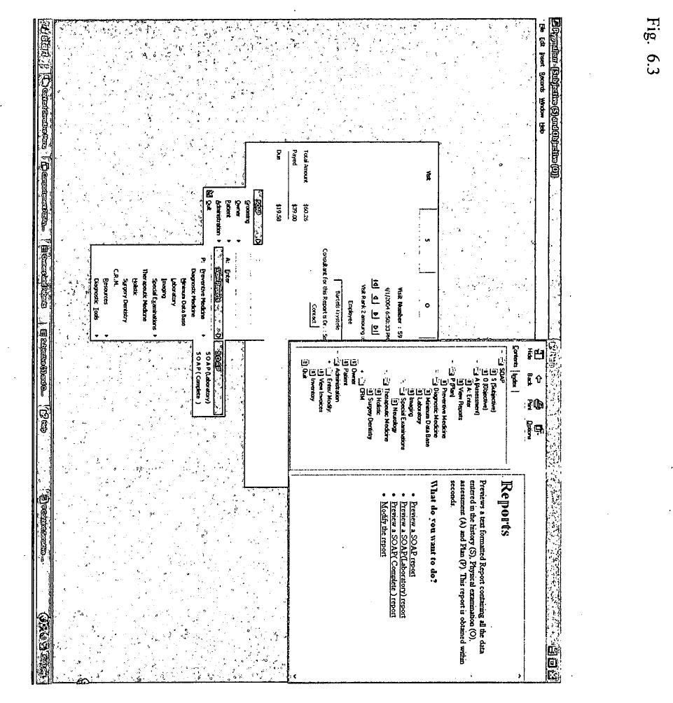

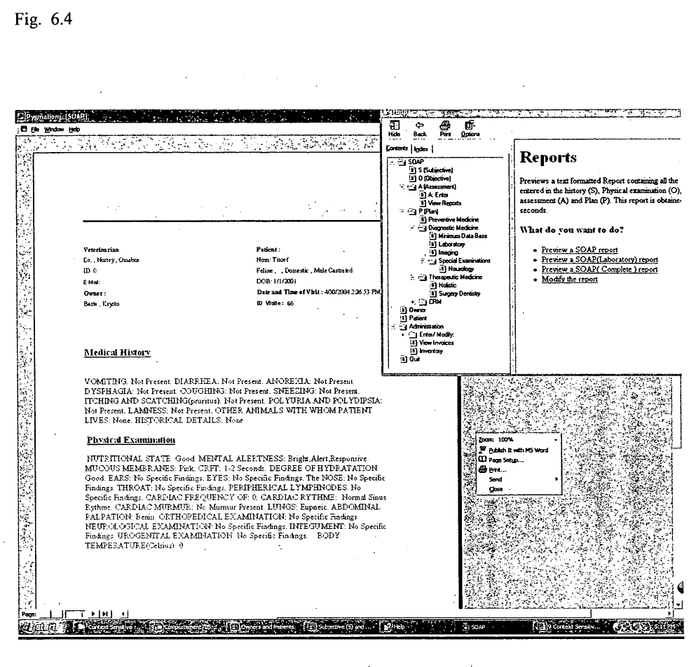

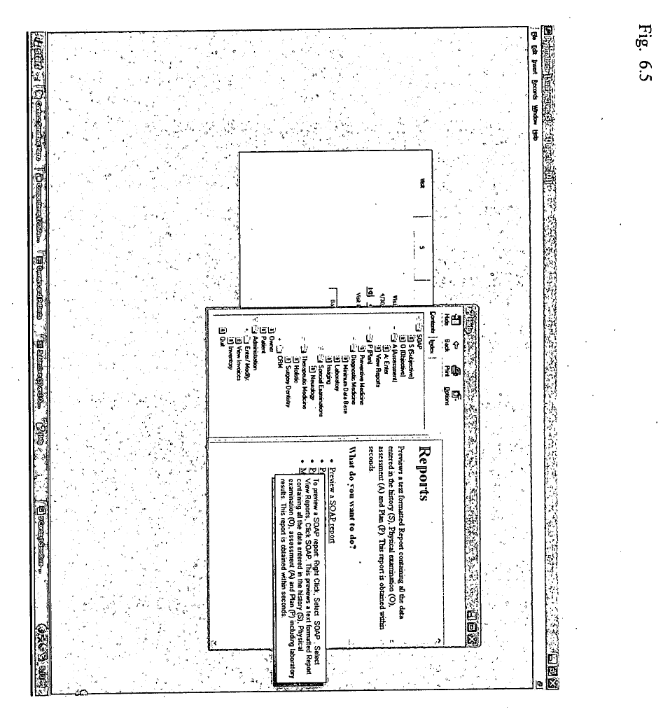

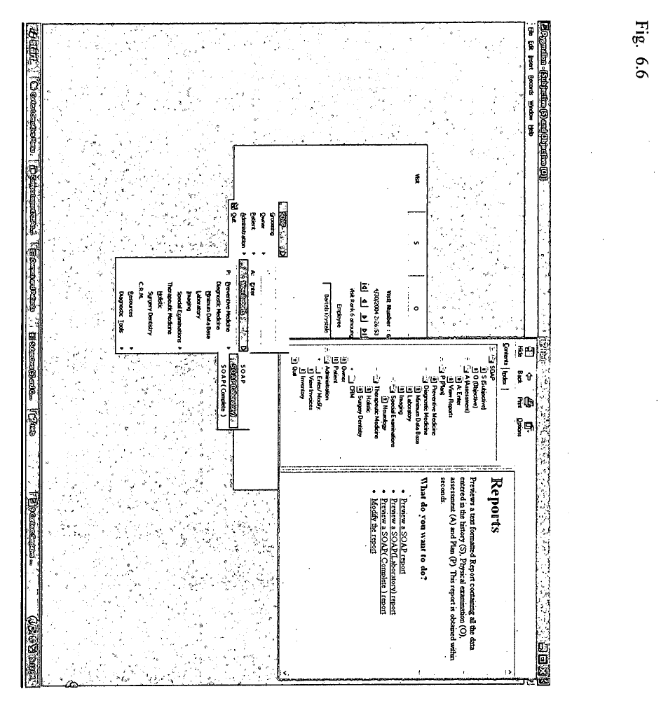

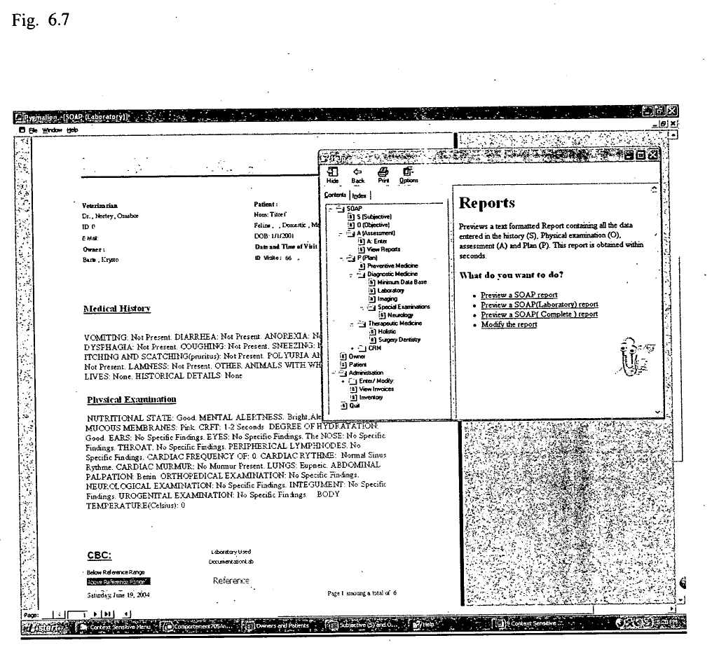

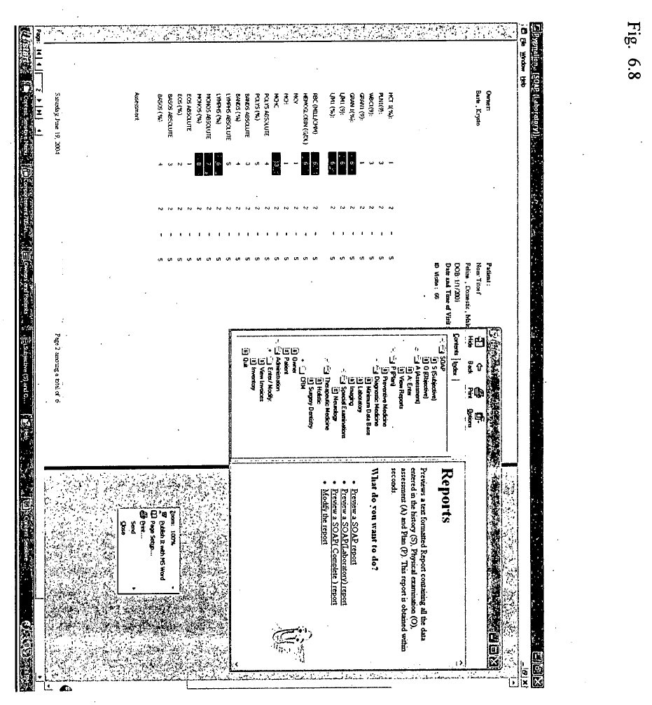

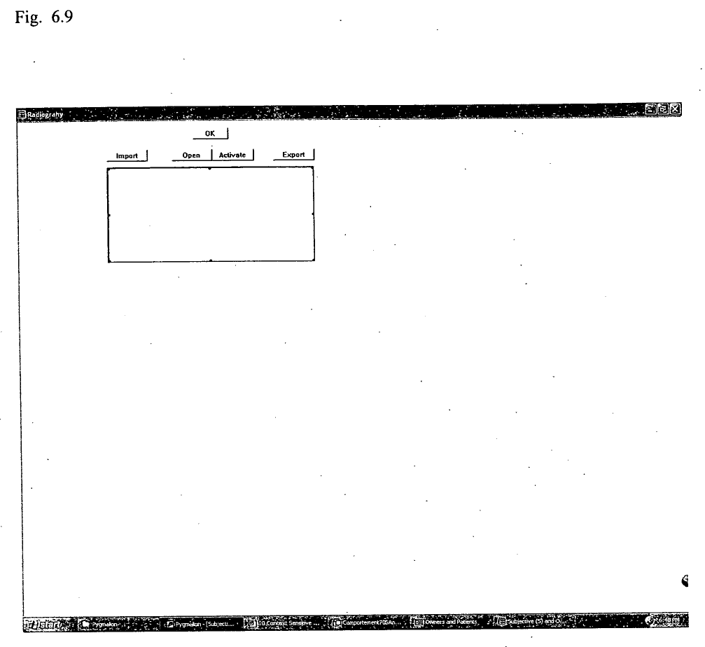

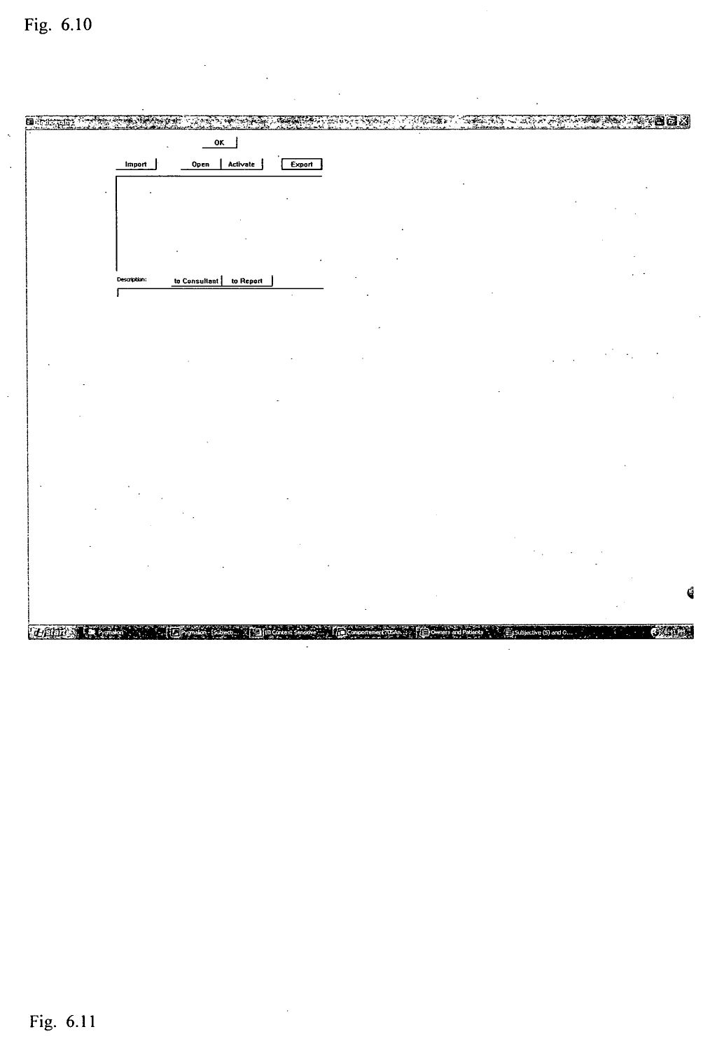

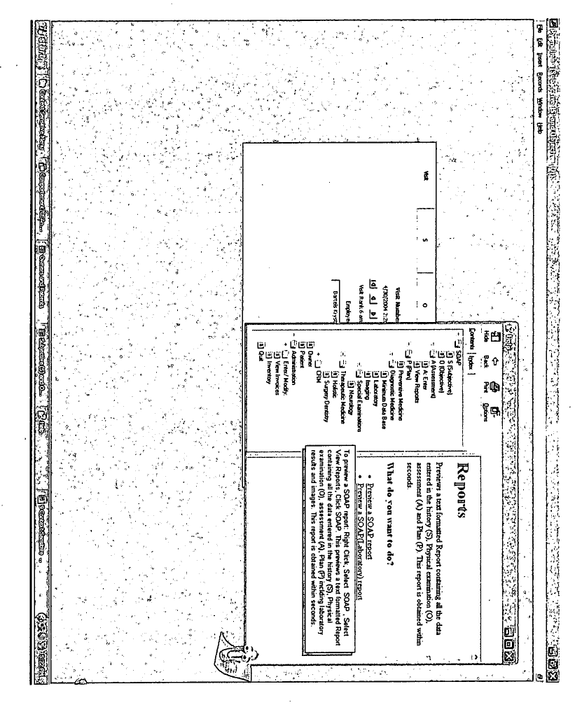

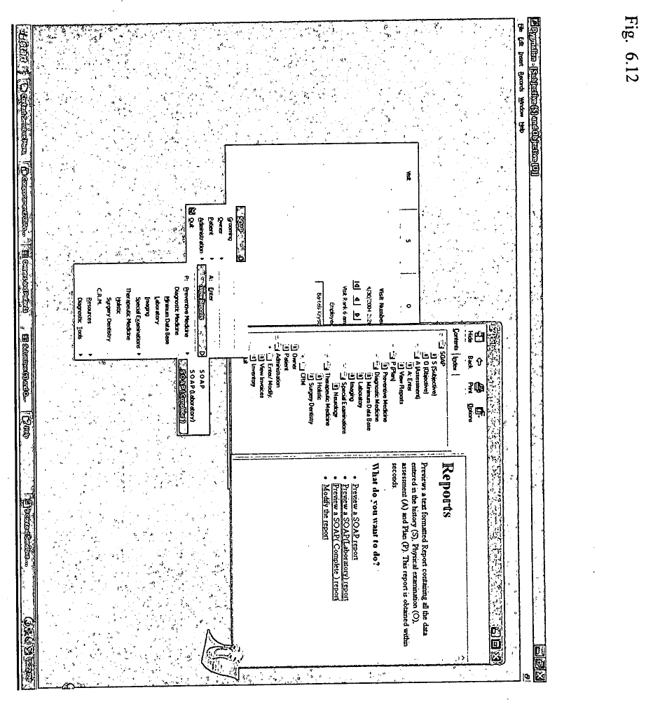

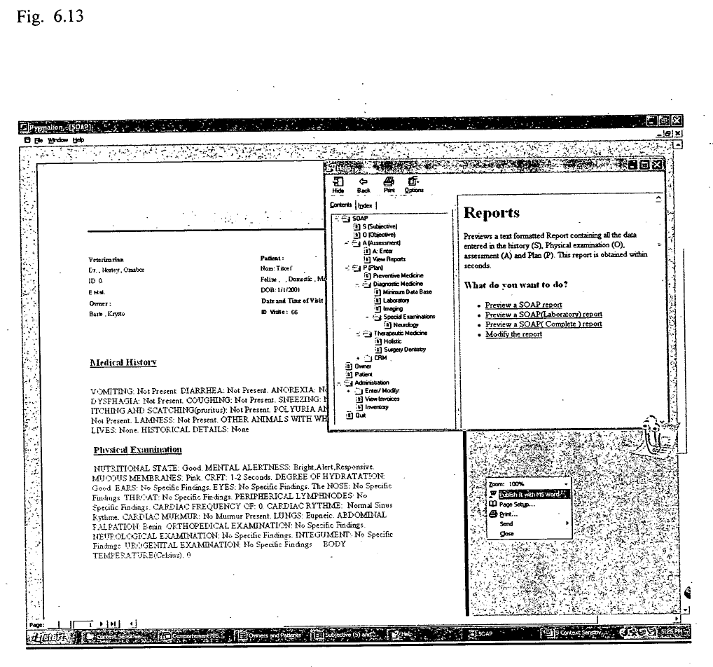

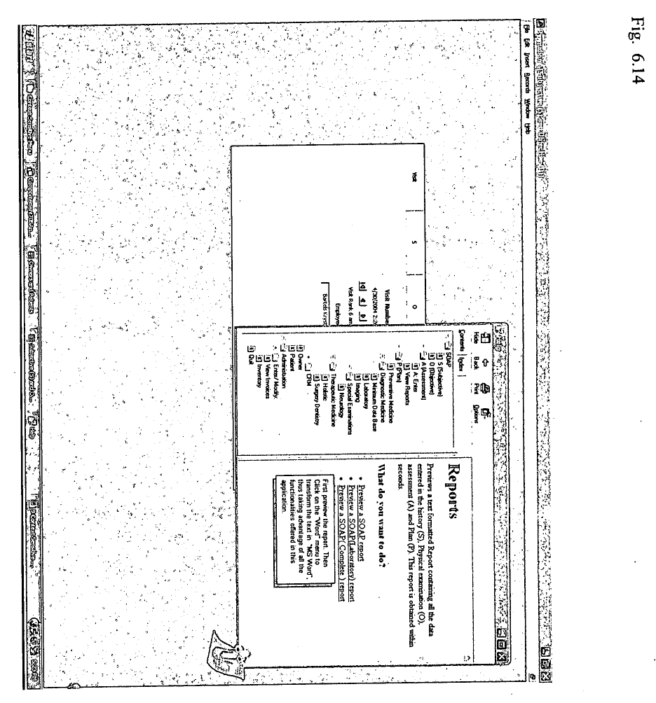

FIG. 6.1 shows:

The Reports' Topic Window Hyperlinks as well as its context sensitive navigation menu.

1. Report SOAP

A SOAP report will include the current visit as well as all the patients' visits that occurred after the current visit.

FIG. 6.2 shows:

Hyperlinks when activated present additional information in a pop-up window:

FIG. 6.3 shows:

How to preview the SOAP Report.

FIG. 6.4 shows:

A preview of a SOAP Report with its context sensitive navigation menu.

2. Report SOAP (Laboratory)

A SOAP (Laboratory) report will include the current visit (with Laboratory) as well as all the patients' visits that occurred after the current visit (with Laboratory).

FIG. 6.5 shows:

Hyperlinks when activated present additional information in a pop-up window:

FIG. 6.6 shows:

How to preview the SOAP (Laboratory) Report.

FIG. 6.7 through 6.8 shows a preview of a SOAP (Laboratory) Report with its context sensitive navigation menu.

3. Report SOAP (Complete)

A SOAP (Complete) report will include the current visit (with Laboratory and Images) as well as all the patients' visits that occurred after the current visit (with Laboratory and Images). The images (XR, ECG, ect . . . ) that are in the report have been selected by the user among images contained in the visits.

FIG. 6.9 through 6.10 shows:

How to select images to be included in the report:

1. Select SOAP, “Click Imaging”, “Double Click” on the image that should be included.

2. “Click Export”

3. “Click To Report”

FIG. 6.11 shows:

A Hyperlink pop up explaining how to preview a SOAP Report.

FIG. 6.12 shows:

How to preview the SOAP (Complete) Report.

FIG. 6.13 shows:

A preview of a SOAP (Complete) Report with its context sensitive navigation menu.

4. To Modify the Report

FIG. 6.14 shows:

An example of a Hyperlink in the Reports Topic Window.

Preventive Medicine

The necessary vaccinations are species-specific (canine; feline; rabbits; equine; human; etcetera . . . ). Also, vaccination protocols (when to do and when to repeat vaccinations) are specific to every species. Only a precise recording of which vaccine has been administered to a patient and when it was administered can allow an optimal immunity.

When the user selects the “Vaccination Protocols” options, Pygmalion Concept (Trademark rights reserved) brings up a form containing only the vaccines that are pertinent to the patient's species and to the specific patient. For example: selecting “Vaccinations” for a dog named Fluffy, will show the vaccines administered to Fluffy among a palette of available canine vaccines. Selecting “Vaccinations” for a cat named Irma, will bring up a Form containing only feline vaccines, and Irma's vaccines. Select in the calendar the vaccination date and click in the field where it should be entered. This inserts the date automatically in the respective field. Pygmalion Concept (Trademark rights reserved) will inform the user when a vaccination has to be repeated (see Reminders). The vaccination dates are formatted in different colours based on whether the time period between two vaccines is shorter than optimal, longer than optimal or is optimal. Therefore, any discrepancies from a correct vaccination protocol are readily pointed out to the user just by viewing the screen. This colour coding is especially appreciated when entering vaccination dates of a new patient, thus saving the user the often cumbersome task of checking if the vaccination protocols were previously respected.

Dewormings and Monitoring

This is the Only Software Offering These Functionalities.

“De-worming” and “Monitoring” modules are used in the same manner as the “Vaccinations” module, with the following differences:

For the “De-worming” module: The user enters the name of the de-worming medicine and the faecal test used.

For the “Monitoring” module: Pygmalion Concept (Trademark rights reserved) automatically selects the periodic tests specific to the patient's species. Besides the pre-entered periodic tests (heartworm test; laboratory tests; ECG; orthopaedic tests; neurological tests; pregnancy checkups), the user may enter the name of additional checkups. This allows the “De-worming” and “Monitoring” modules to be customized to suit the user's way of practicing medicine.

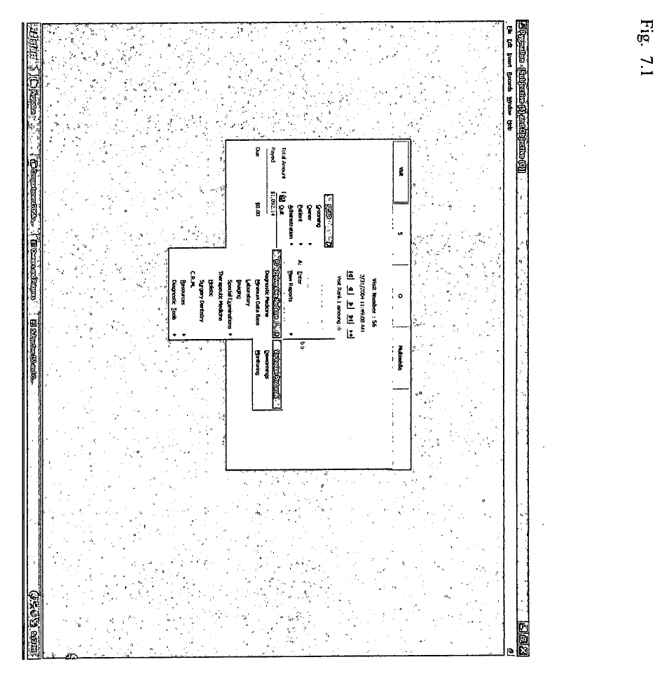

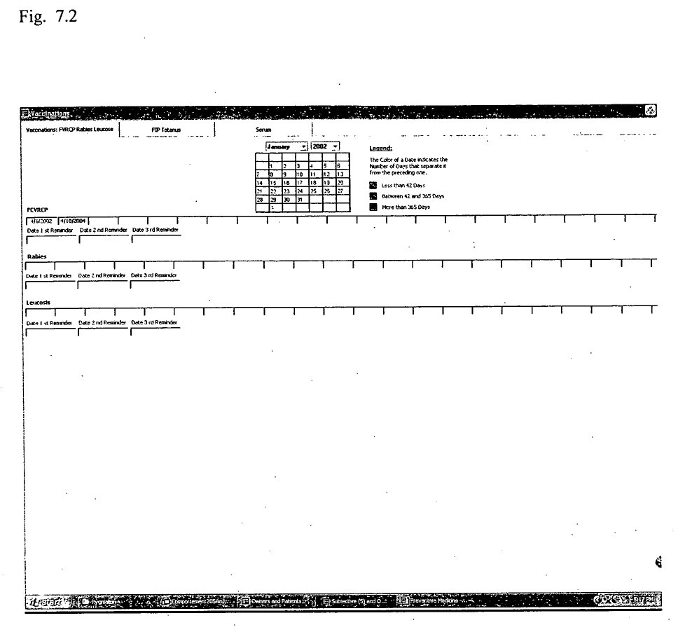

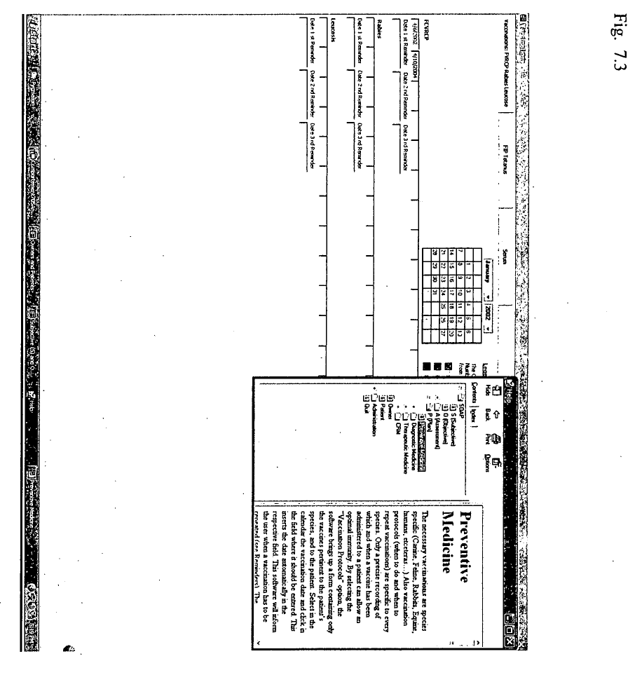

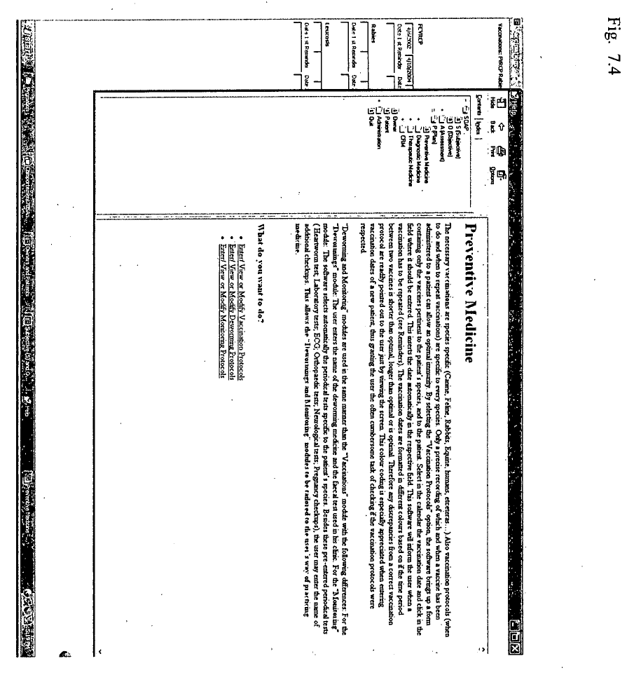

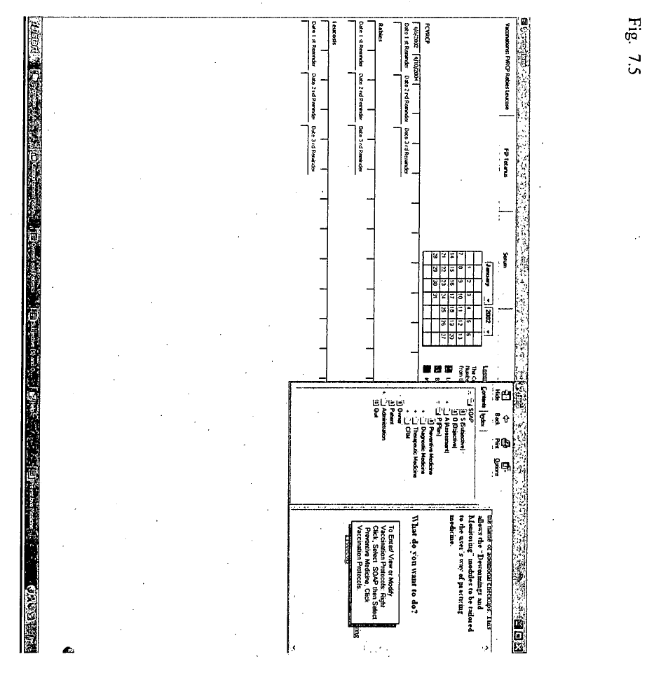

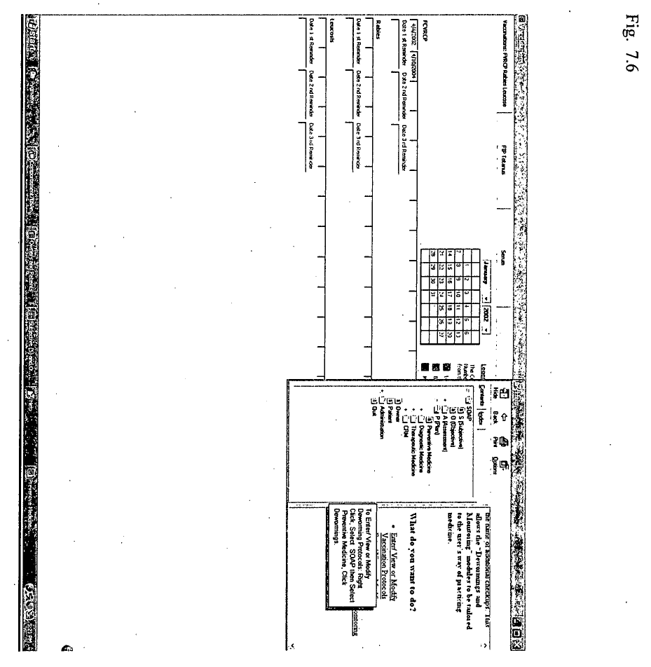

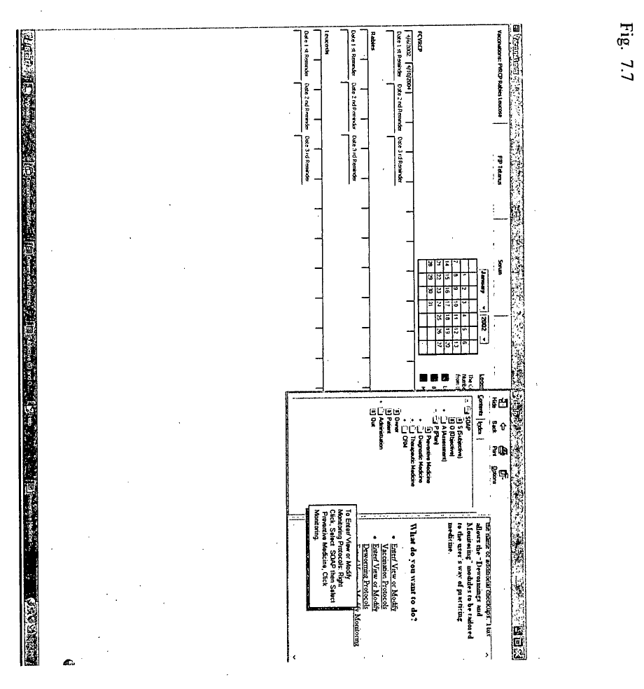

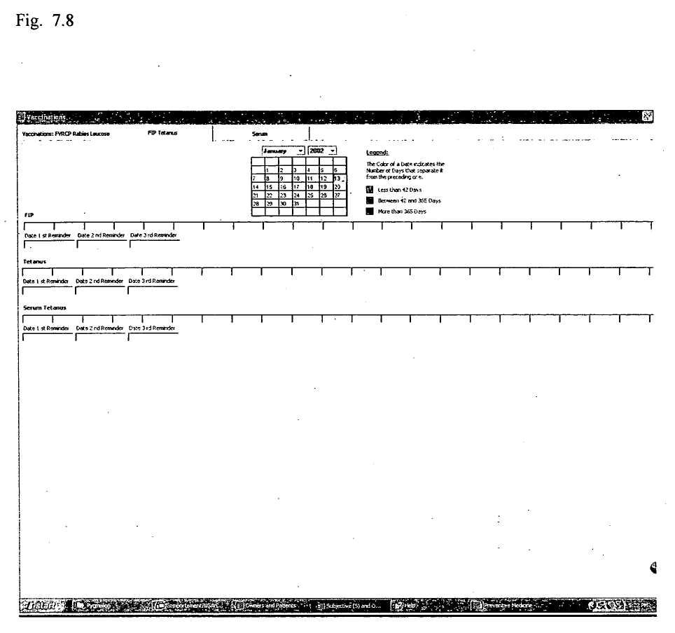

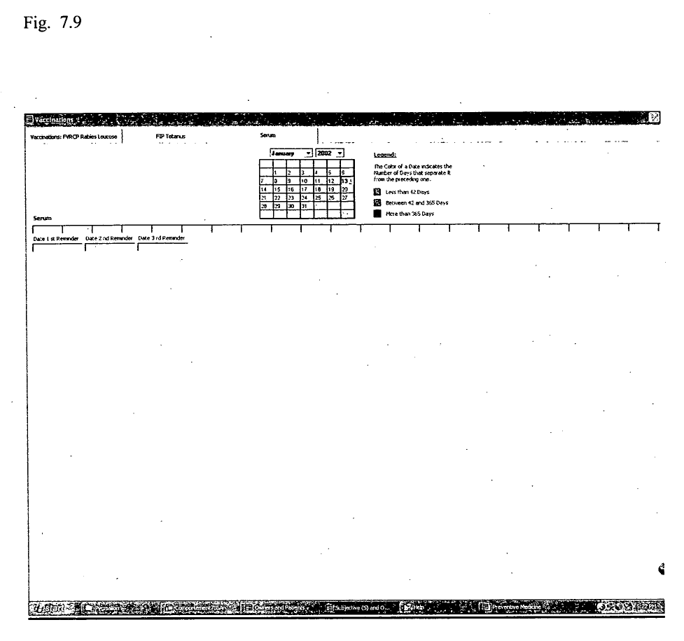

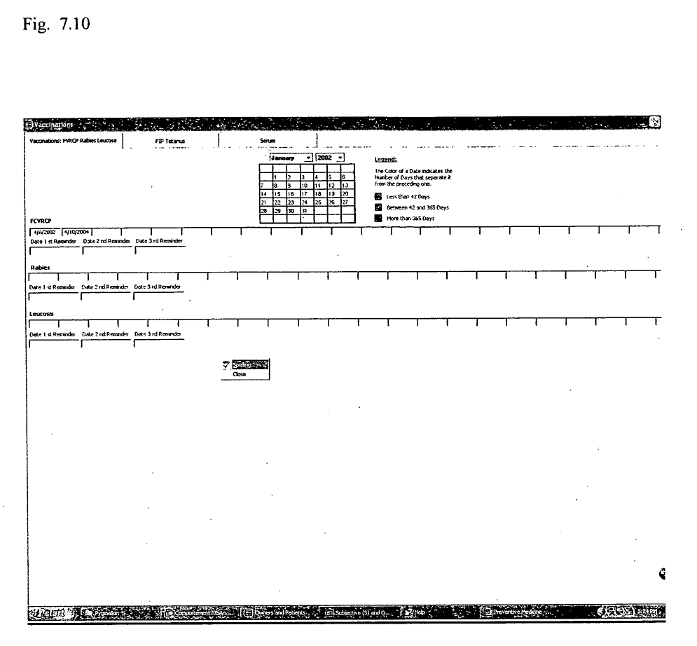

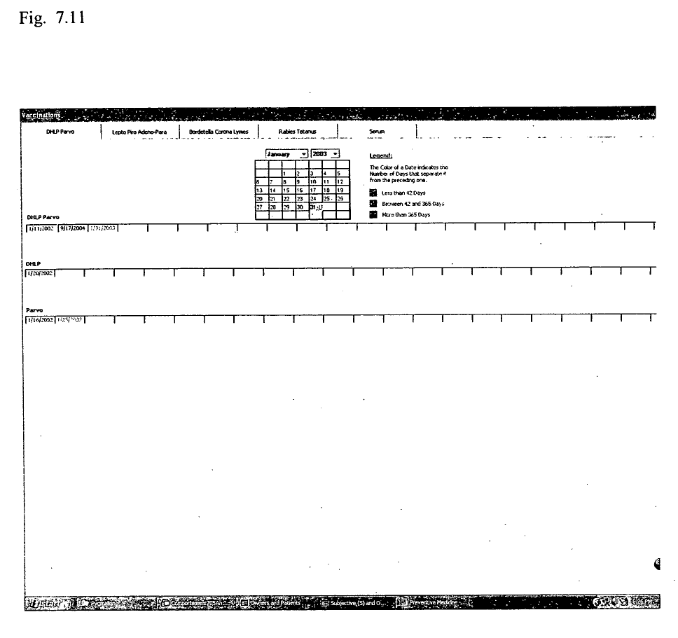

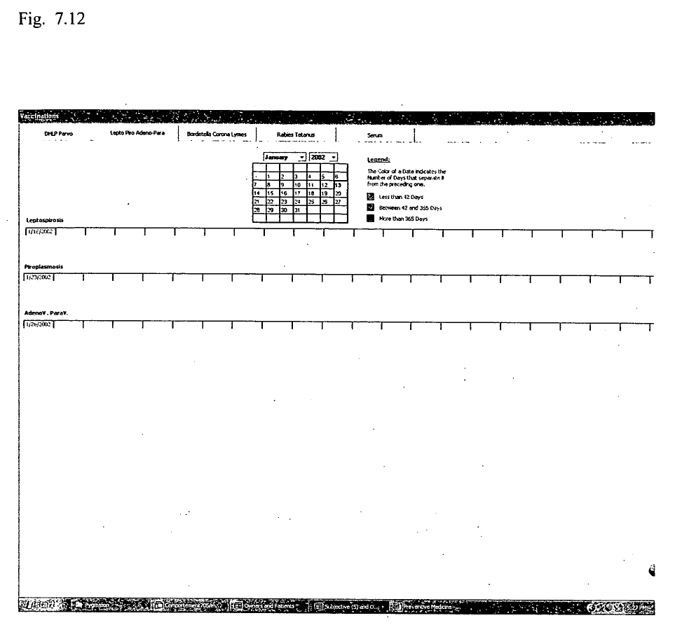

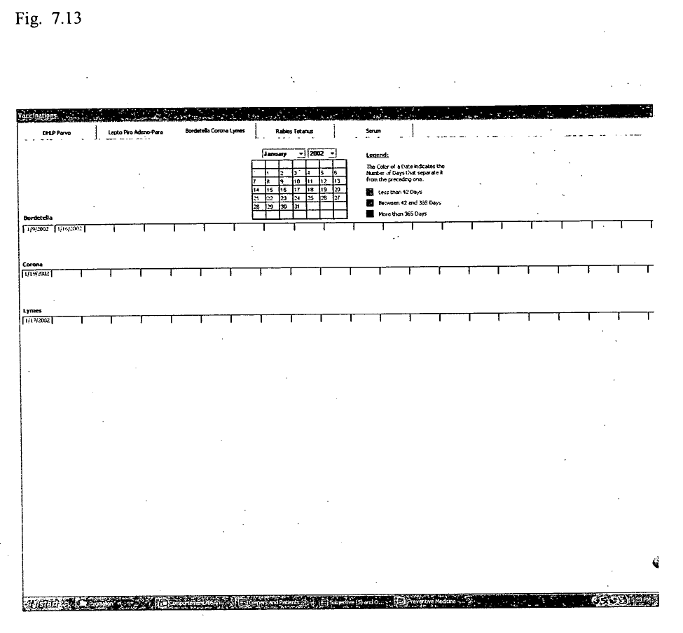

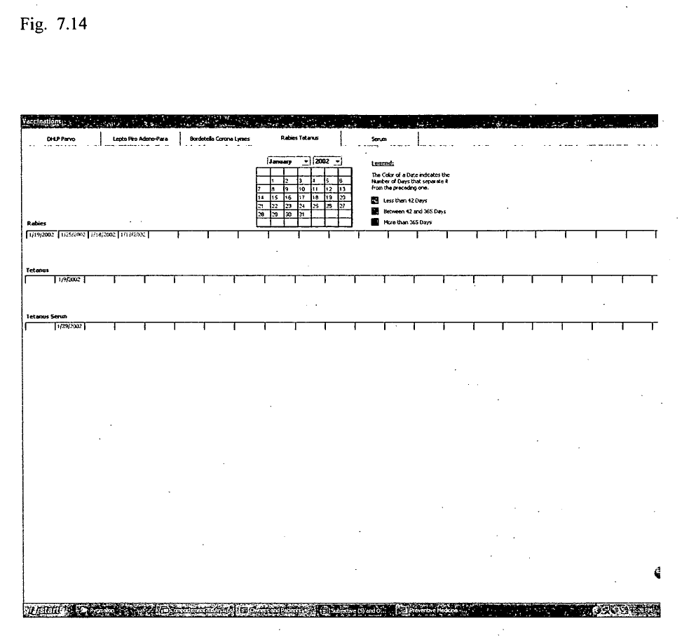

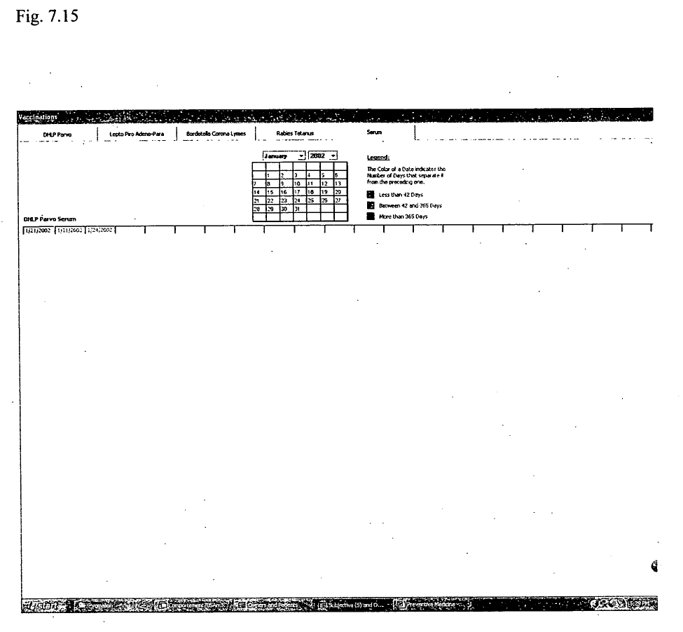

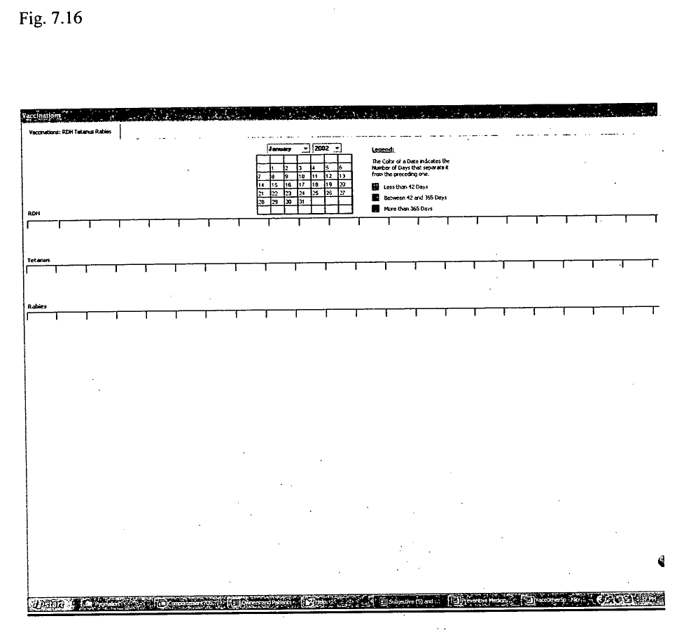

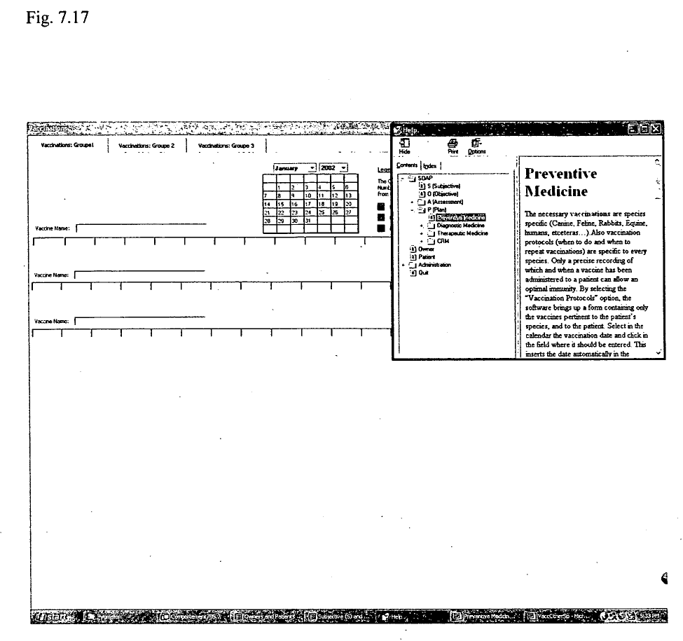

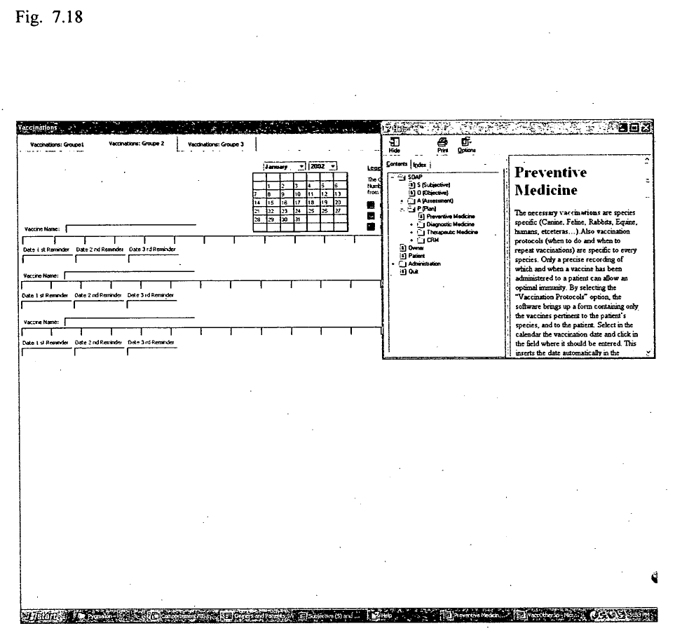

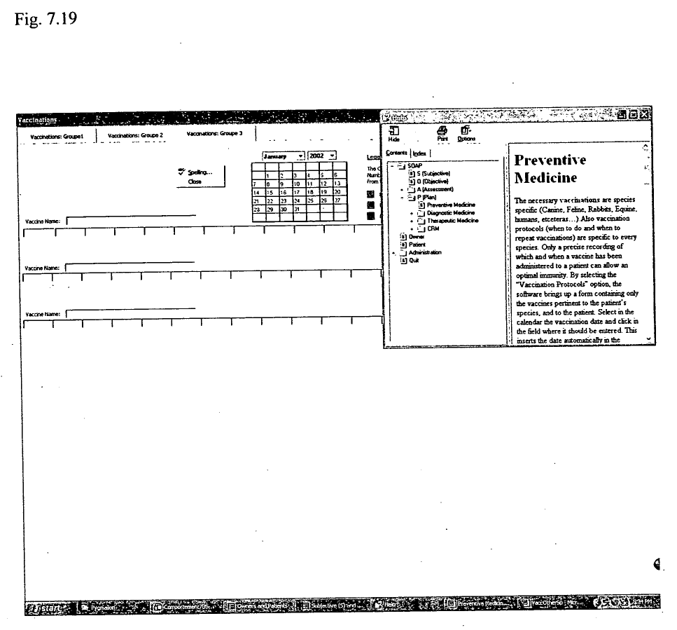

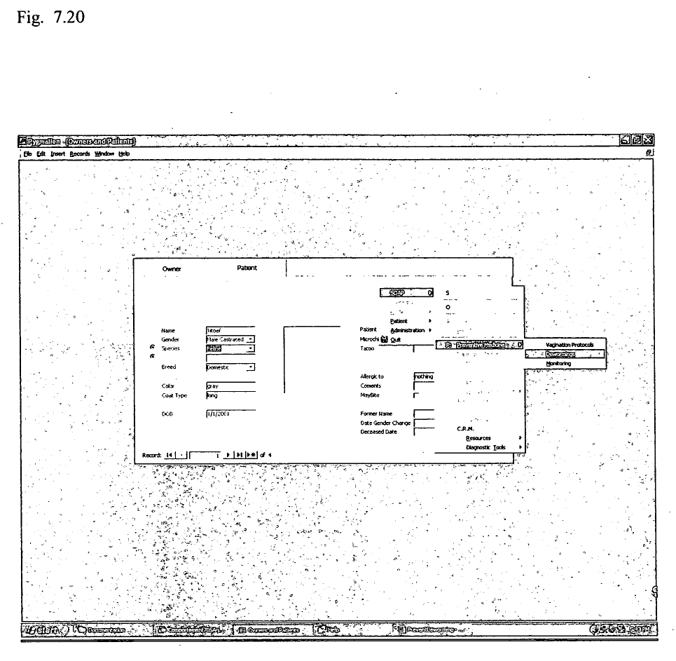

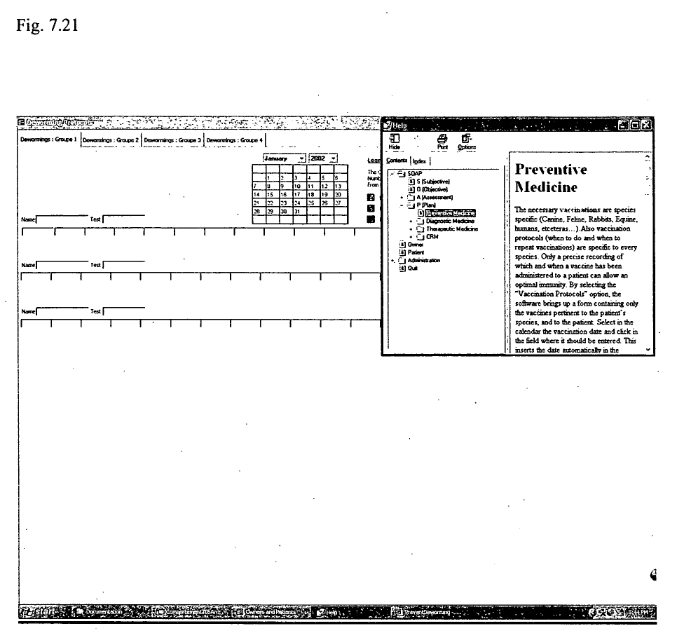

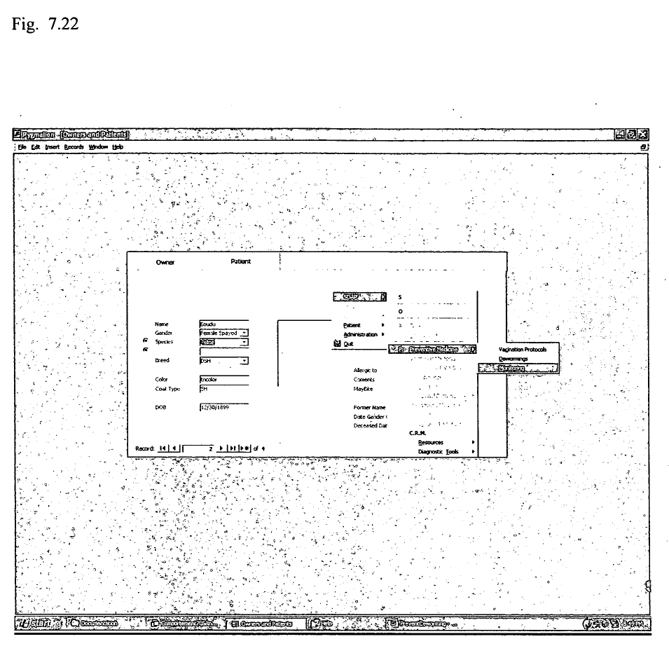

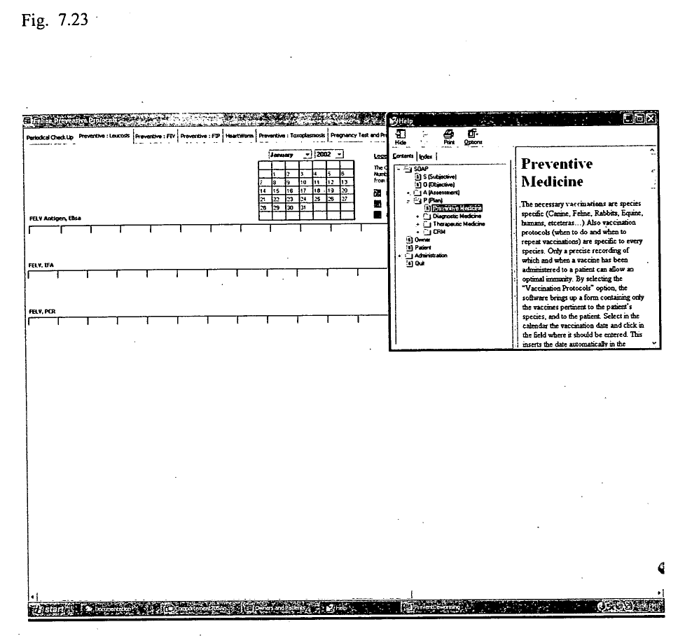

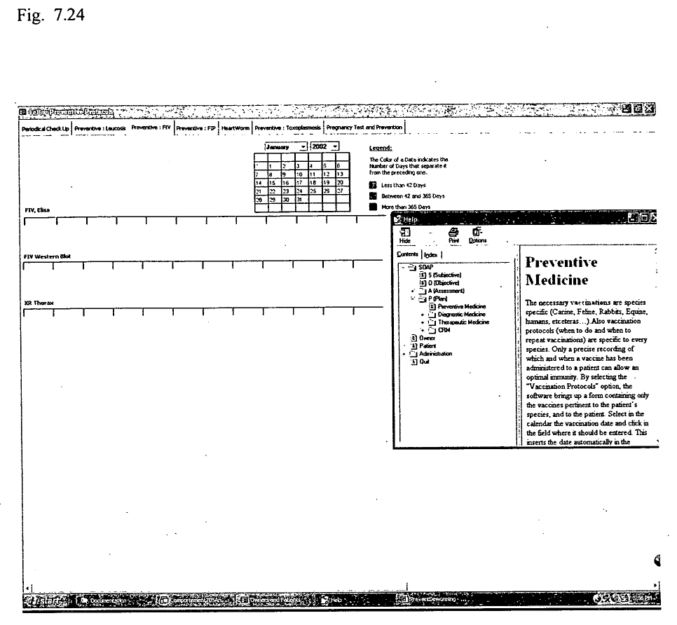

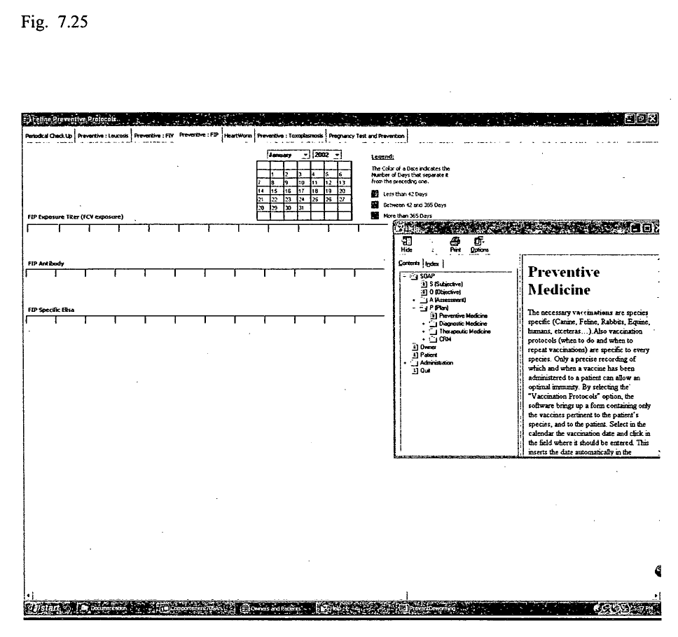

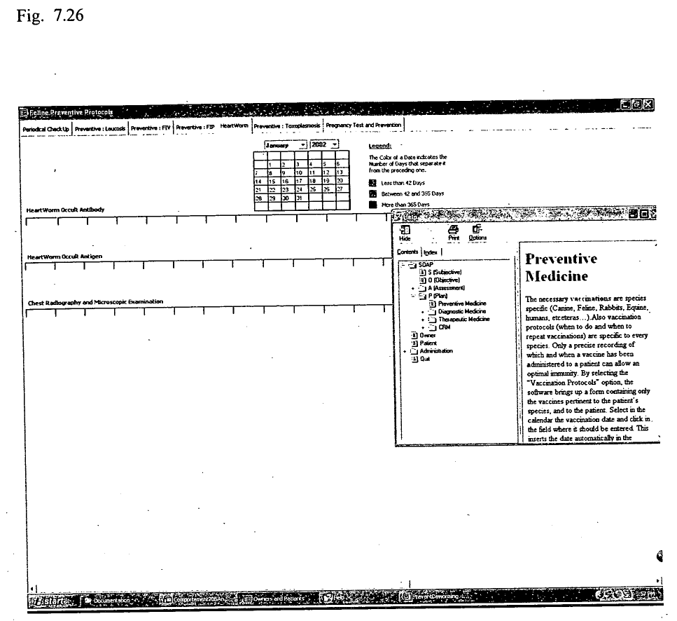

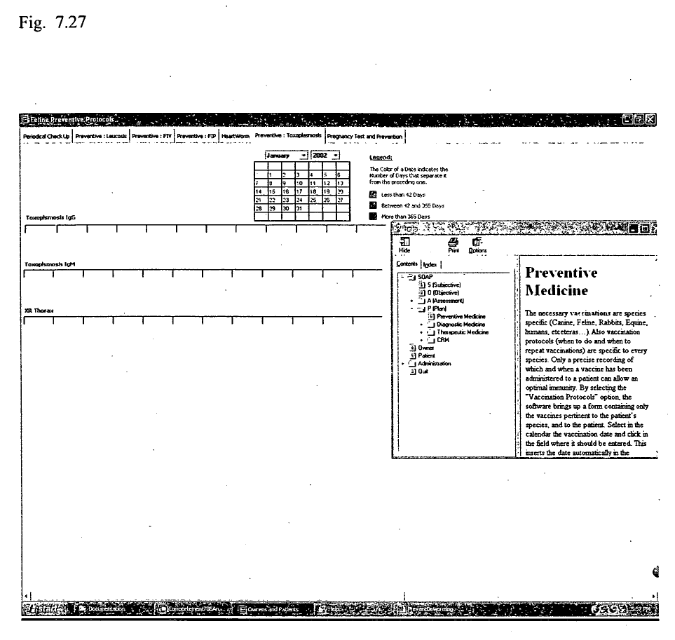

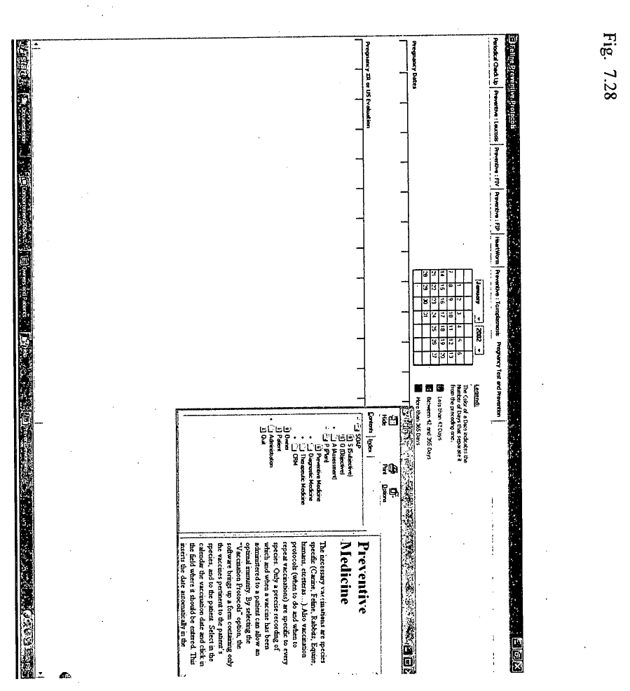

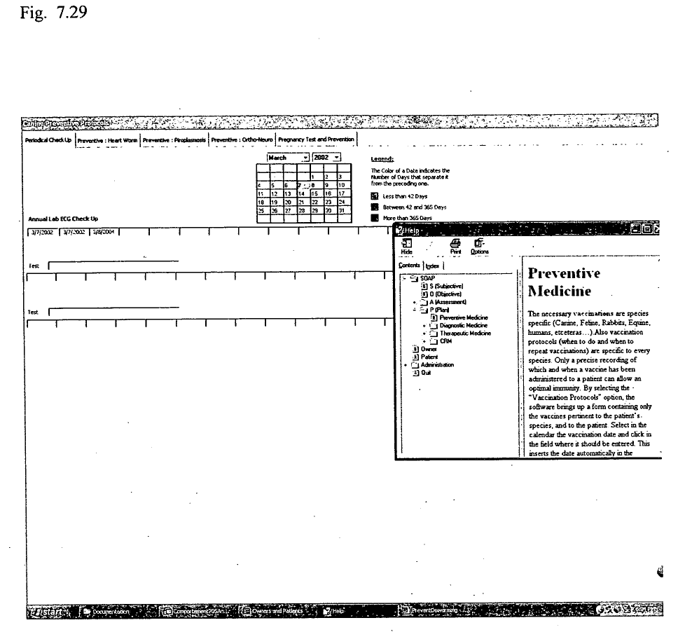

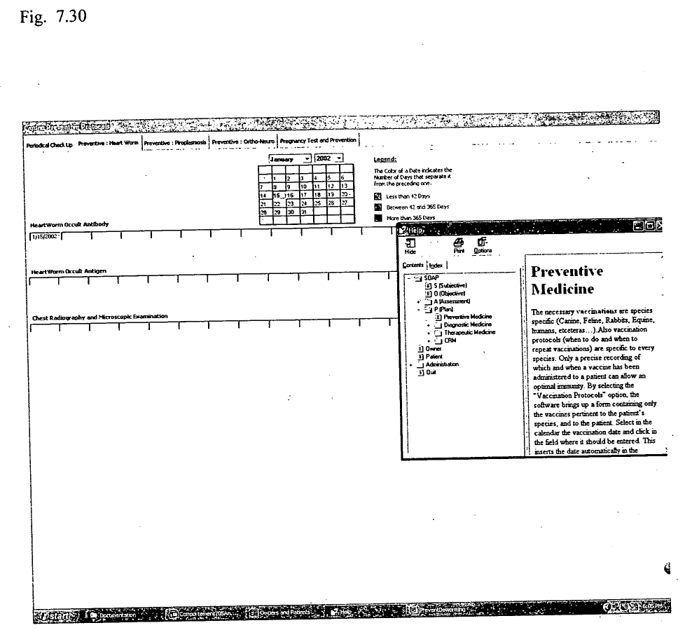

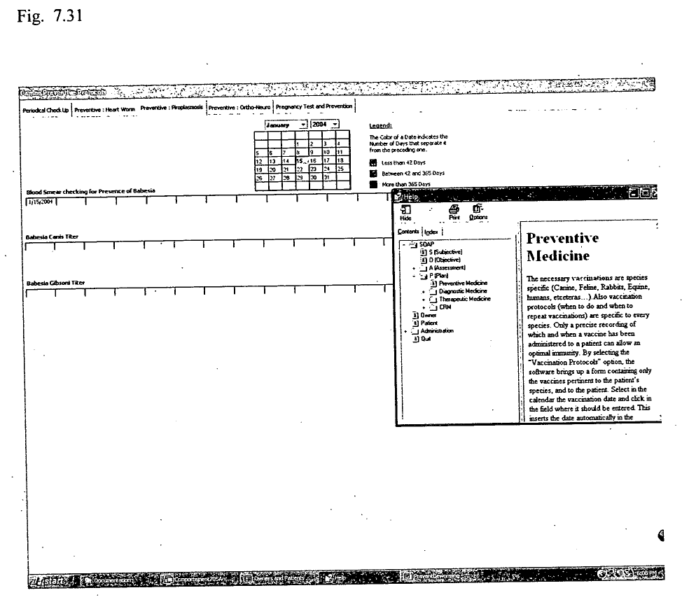

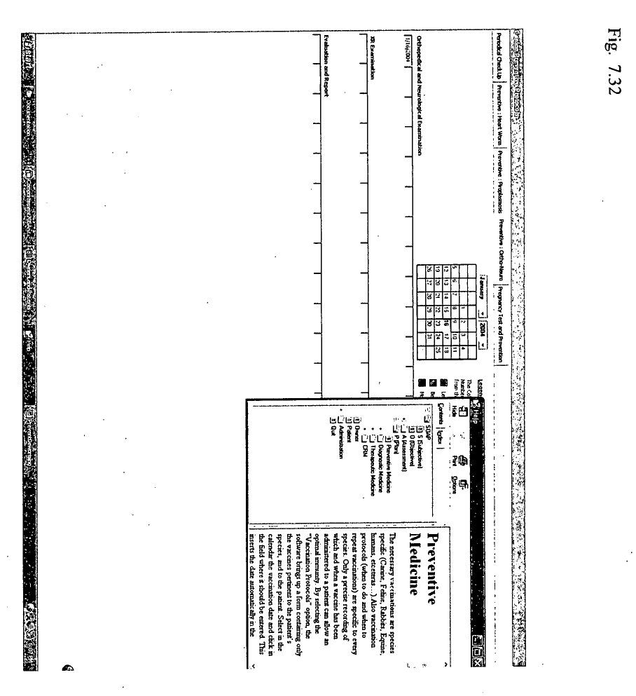

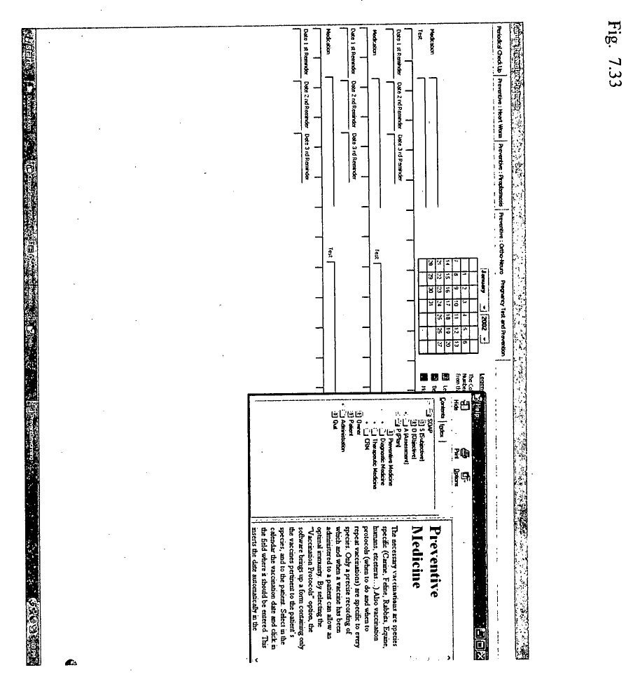

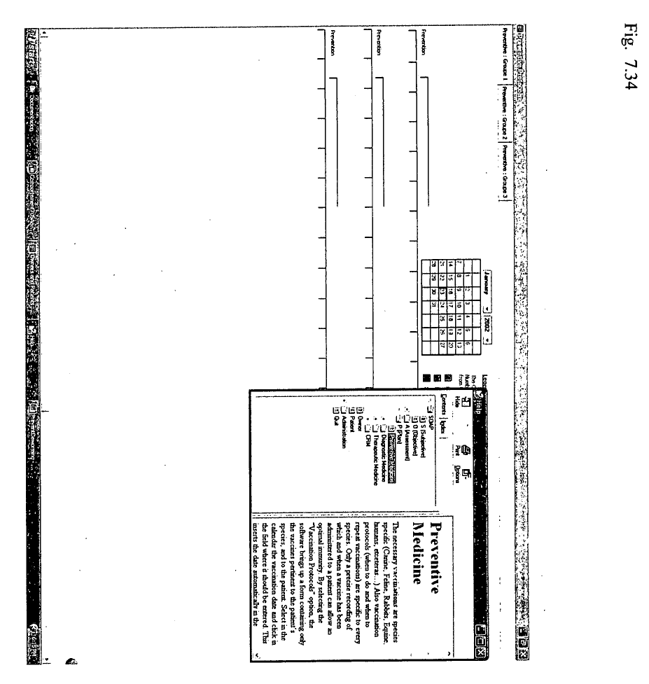

FIG. 7.1 shows:

How to allocate the Preventive Medicine Module.

1. Vaccination Protocols

a. Feline

FIG. 7.2 through FIG. 7.10 shows:

The feline vaccination module.

FIG. 7.3 through 7.7 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 7.4 shows:

Hyperlinks in the Topic Window for the Preventive Medicine Module.

FIG. 7.5 shows:

Hyperlink for the vaccination protocol, which when activated present additional information in a pop-up window.

FIG. 7.6 shows:

Hyperlink for the deworming protocol, which when activated present additional information in a pop-up window

FIG. 7.7 shows:

Hyperlink for the monitoring protocol, which when activated present additional information in a pop-up window

FIG. 7.10 shows:

That whether a field is present; absent; enabled or disabled on the context sensitive navigation menu (which pops up with a “Right Click”), depends on the current context.

b. Canine

FIG. 7.11 through FIG. 7.15 shows:

The canine vaccination module.

c. Rabbit

FIG. 7.16 shows:

The vaccination module for rabbits.

d. Species other than Feline, Canine and Rabbit

FIG. 7.17 through FIG. 7.19 shows:

The vaccination module for species other than feline; canine and rabbits.

2. Deworming

FIG. 7.20 shows:

How to allocate the deworming module.

FIG. 7.21 shows:

The deworming module.

3. Monitoring

a. Feline Female

FIG. 7.22 shows:

How to allocate the monitoring module.

FIG. 7.23 through FIG. 7.28 shows:

The feline female monitoring module.

The Periodical Check Up for this module is the same as in FIG. 7.29.

FIG. 7.21 shows:

The deworming module. Groups 2; 3 and 4 show a similar display as group1

FIG. 7.22 shows:

How to allocate the monitoring module.

b. Feline Male and Spayed Female

Displays the same as canine female except: pregnancy tests are absent.

c. Canine Female

FIG. 7.29 through FIG. 7.33 shows:

The canine female monitoring module.

d. Canine Male and Spayed Female

Displays the same as canine female except: pregnancy tests are absent.

e. Species Other than Feline and Canine

FIG. 7.34 shows:

Preventive module for other species then canine; feline and rabbit.

Groups 2; 3 and 4 show a similar display as group1

Minimum Data Base

This software provides the only CRM and ERP medical software for human and animal patients, with an Artificial Intelligence Module that helps minimize diagnostic errors, saves time, and is generally more cost-effective and better tolerated by clients.

The Minimum Data Base (MDB) opens a selection of frequently encountered symptoms. The same clinical manifestation may be due to a number of different diseases. In order to diagnose the causative illness, the physician needs the results of specific examinations.

This is the only medical software with artificial intelligence that selects and inserts in the patients' record, the most appropriate diagnostic procedures (CBC; blood chemistry; urine analysis; electro physiology; diagnostic imaging; biopsy) to establish a diagnosis and management plan. A predetermined set of diagnostic procedures, called minimum data base, for each type of patient or problem helps minimize medical diagnostic errors, saves time and is generally more economical and better accepted by clients. Omitting to offer patient appropriate diagnostic aids (minimum data base) may be legally held against a physician. The minimum data base module selection covers the large palette of medical problems which are the most frequently encountered, and for which doctors are most often suited for malpractice. Thanks to this selection, this medical software invention saves the users' time and may help him avoid omitting to offer all of the medical services and resources expected for managing these medical problems.

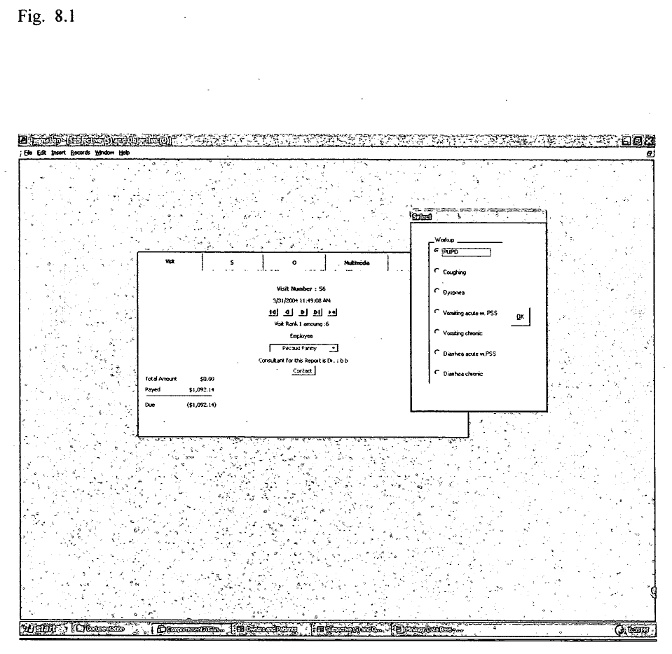

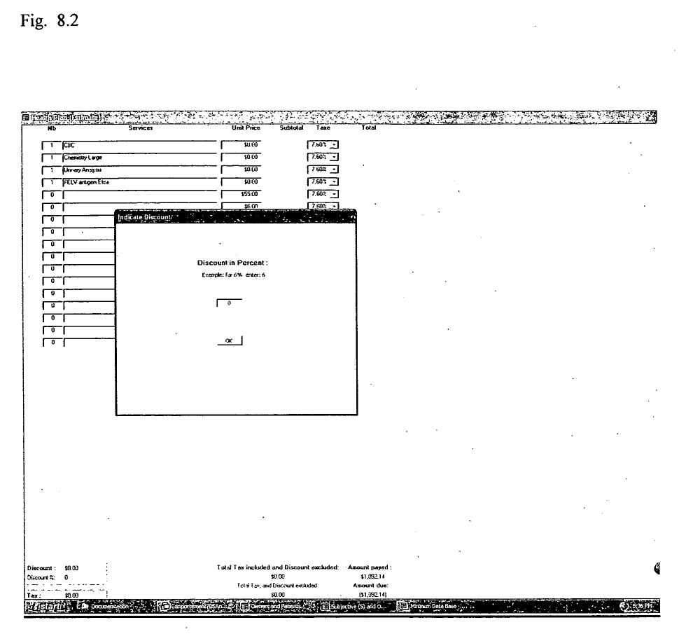

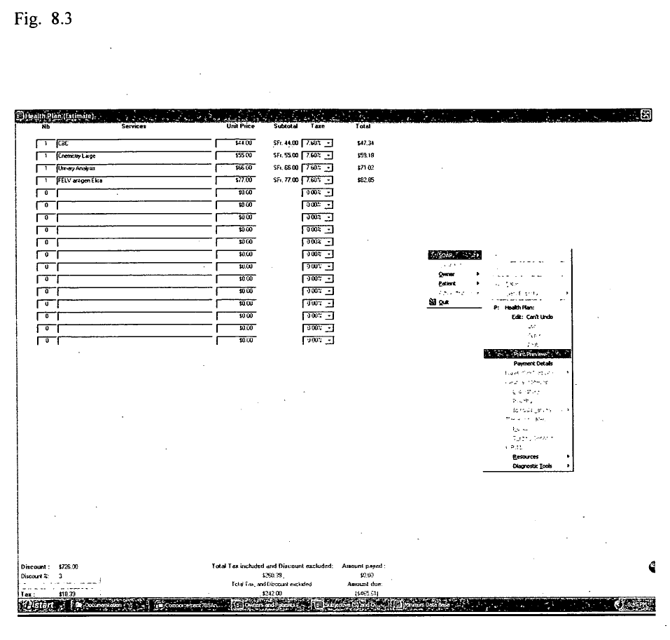

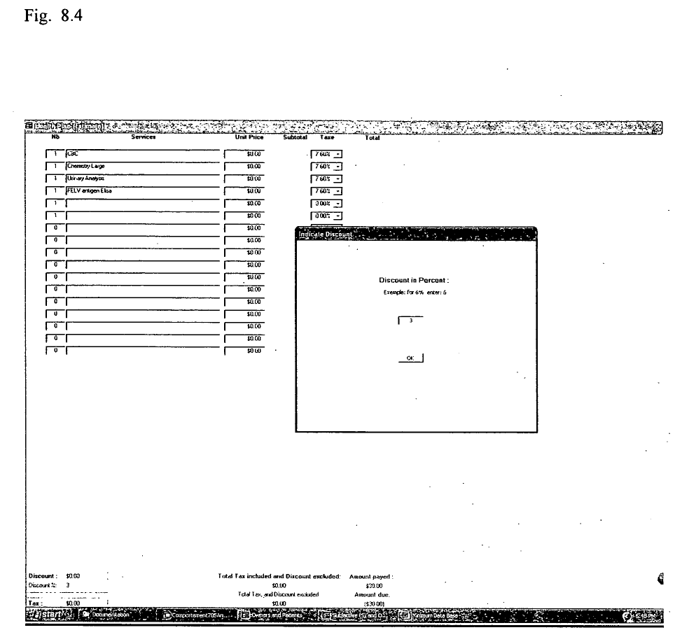

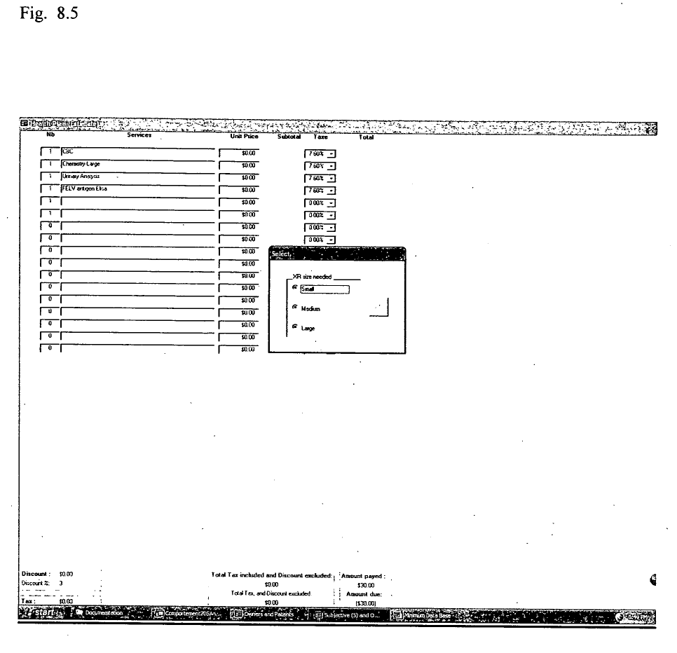

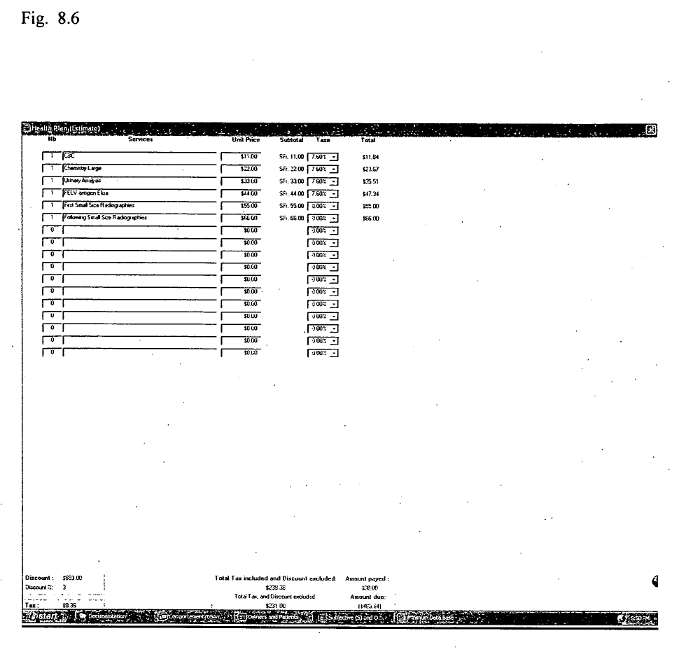

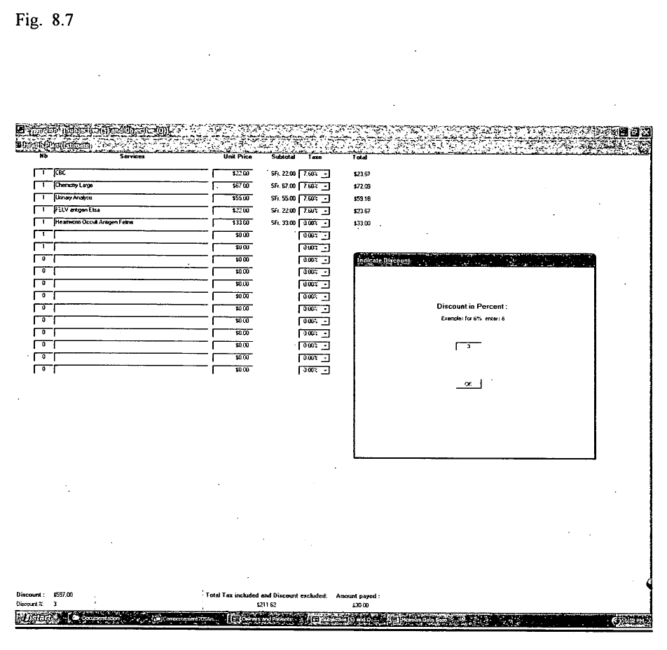

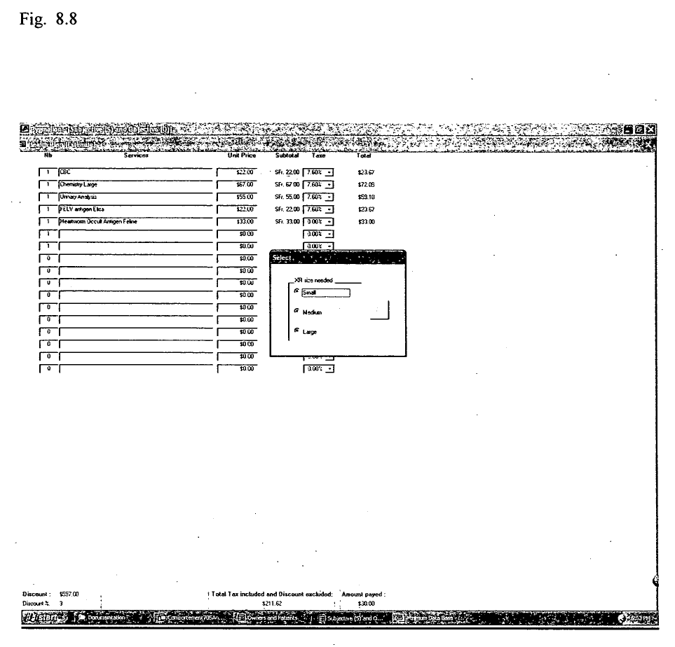

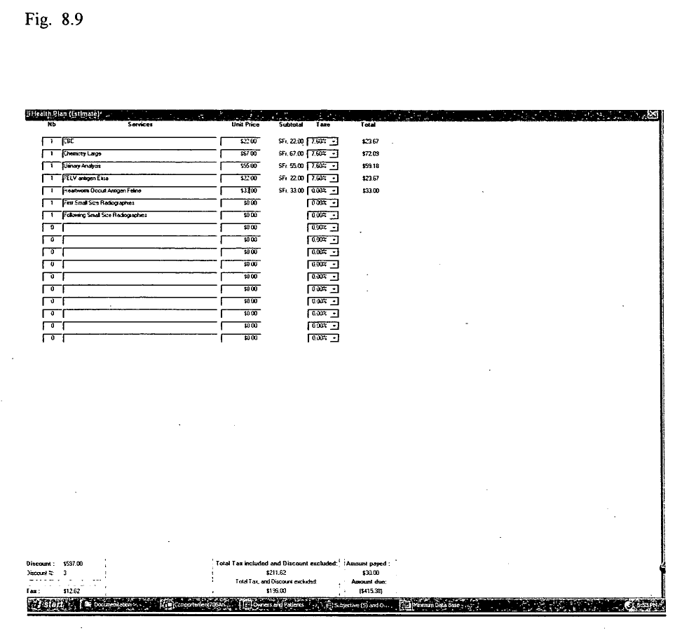

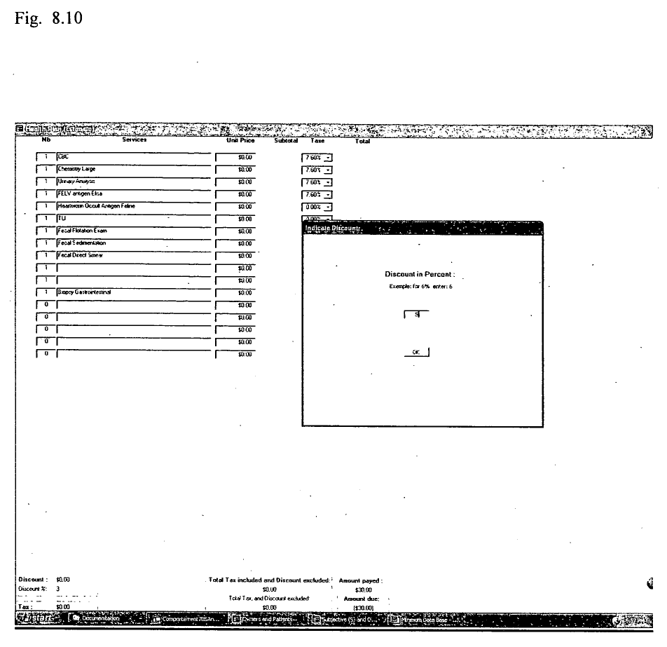

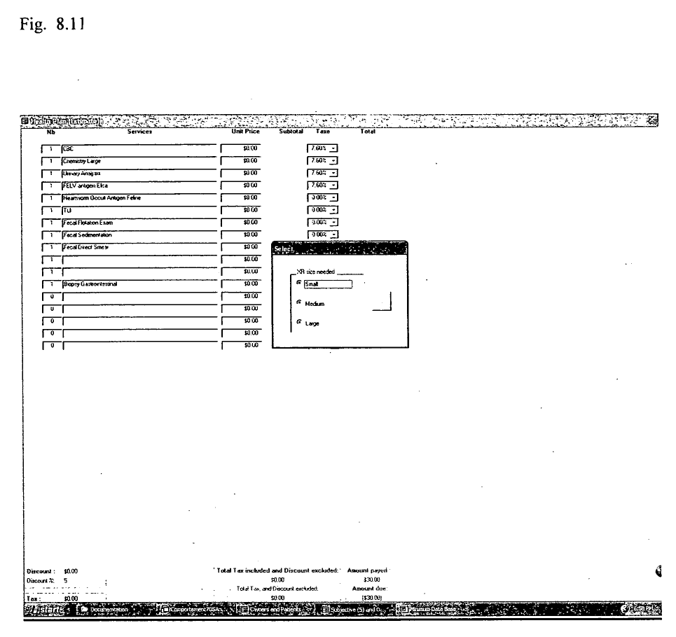

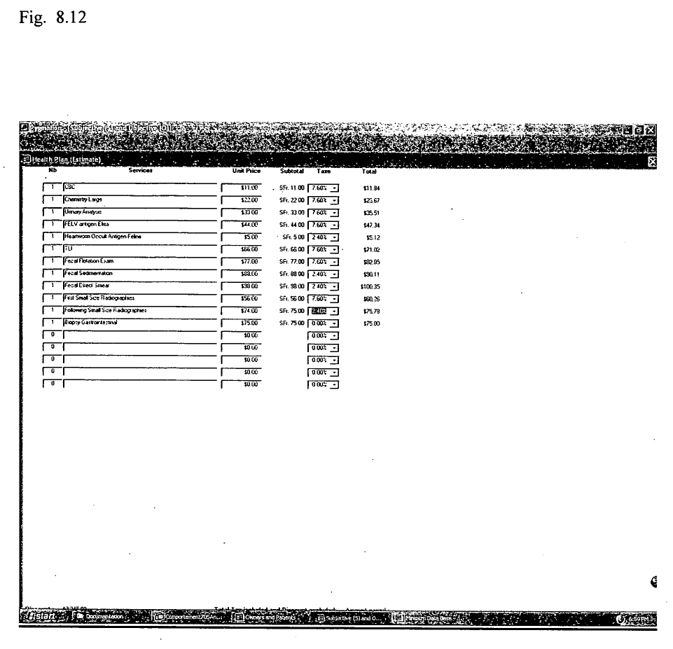

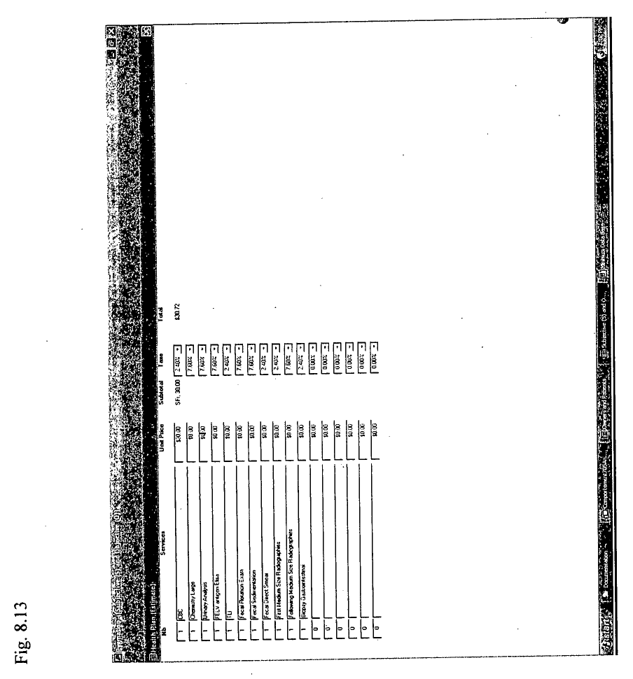

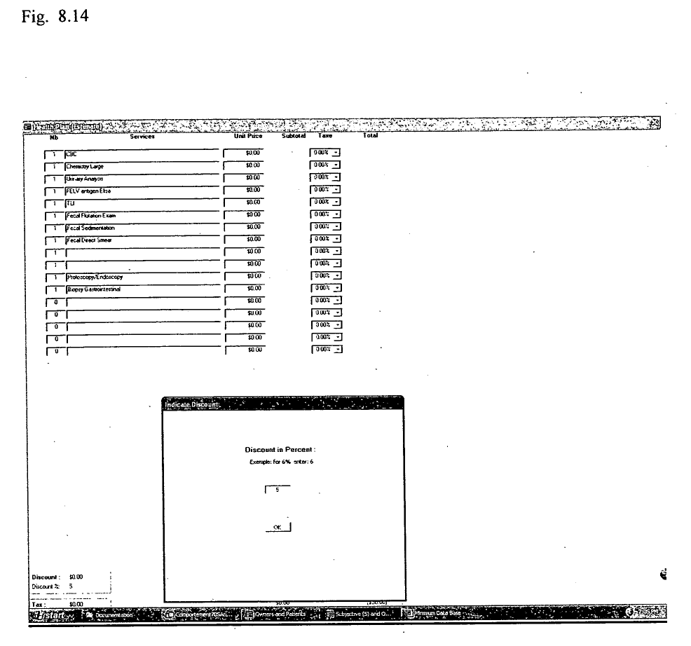

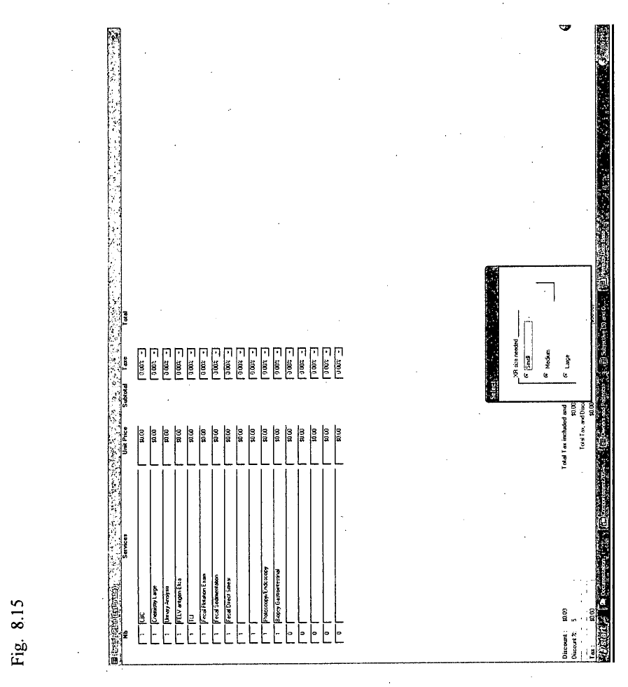

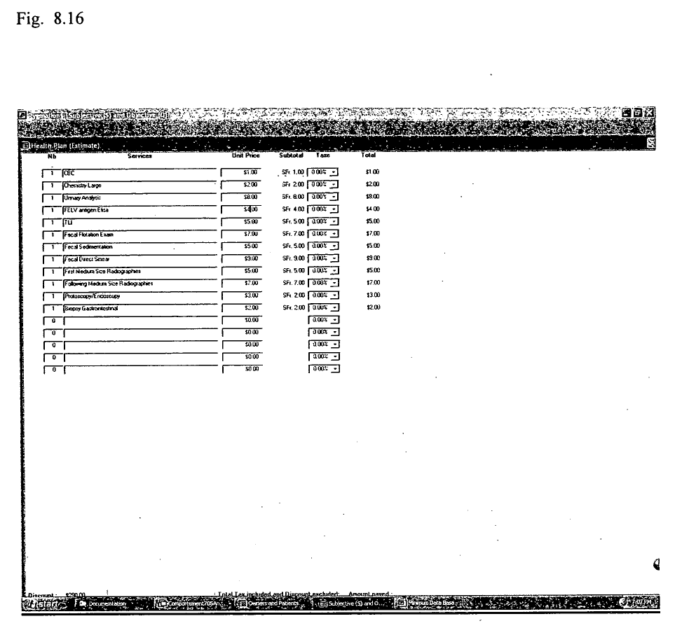

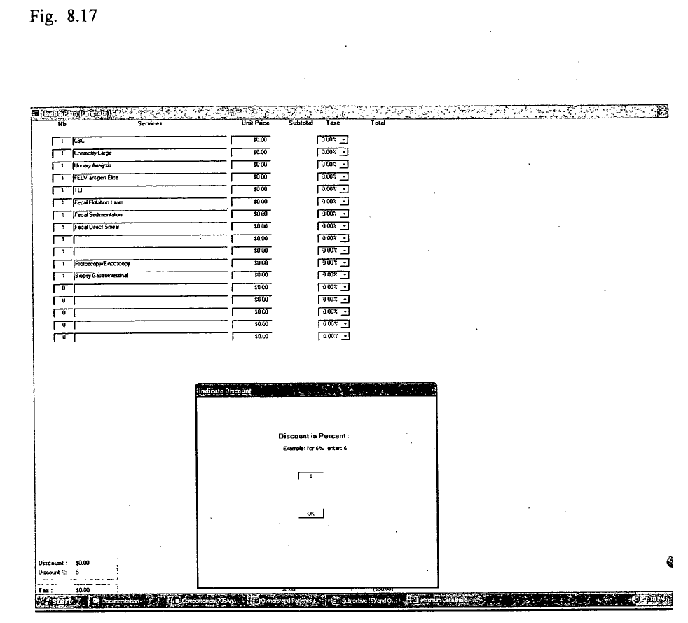

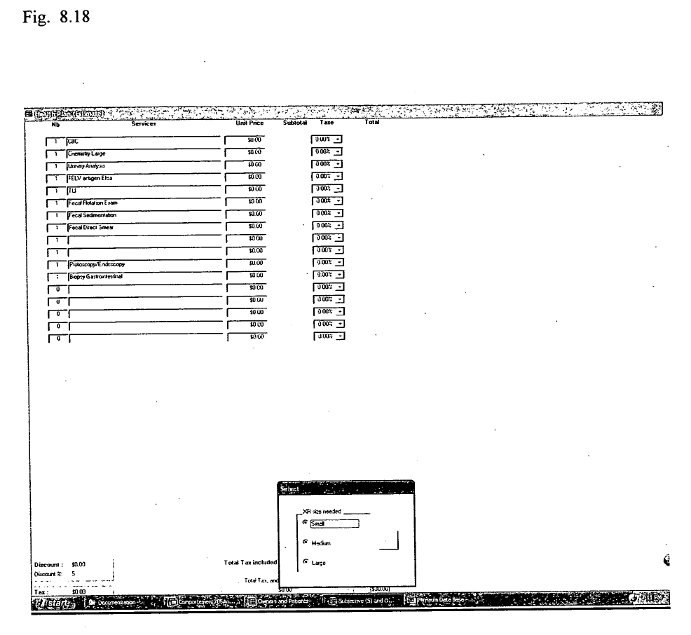

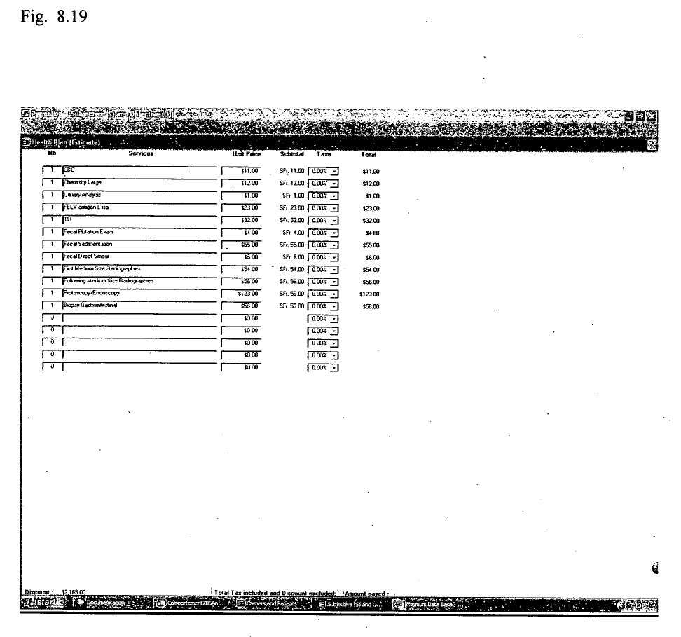

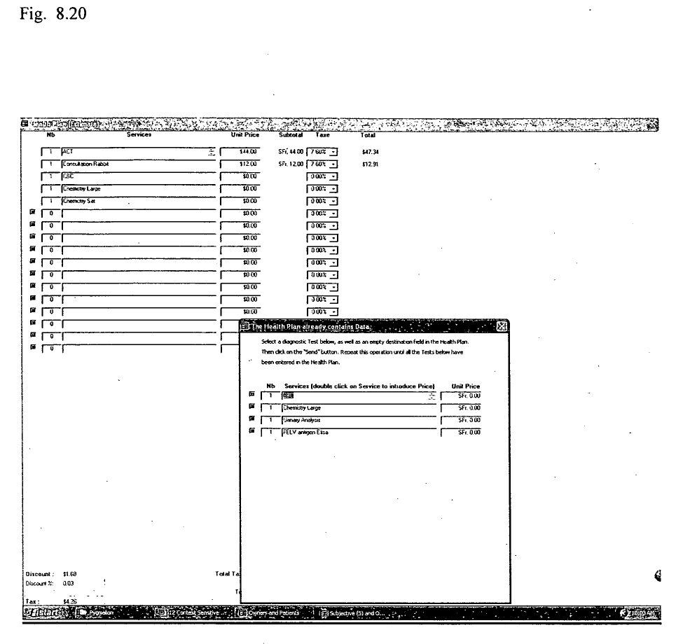

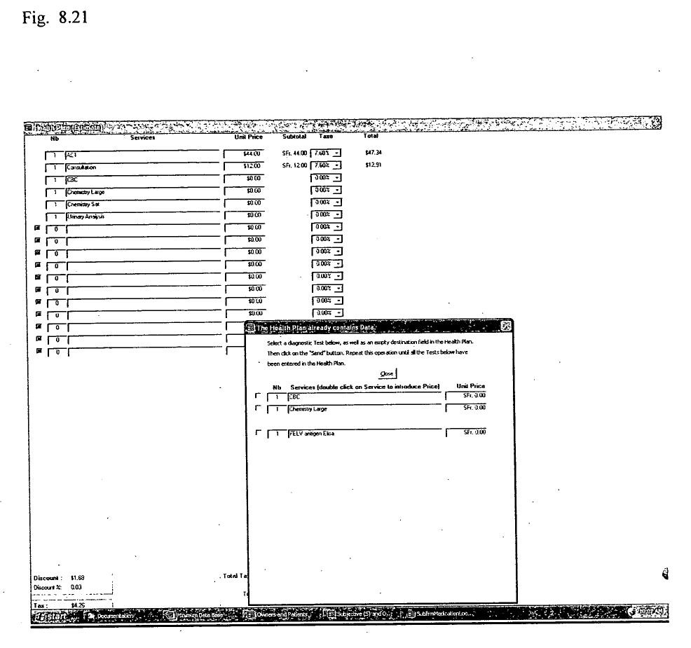

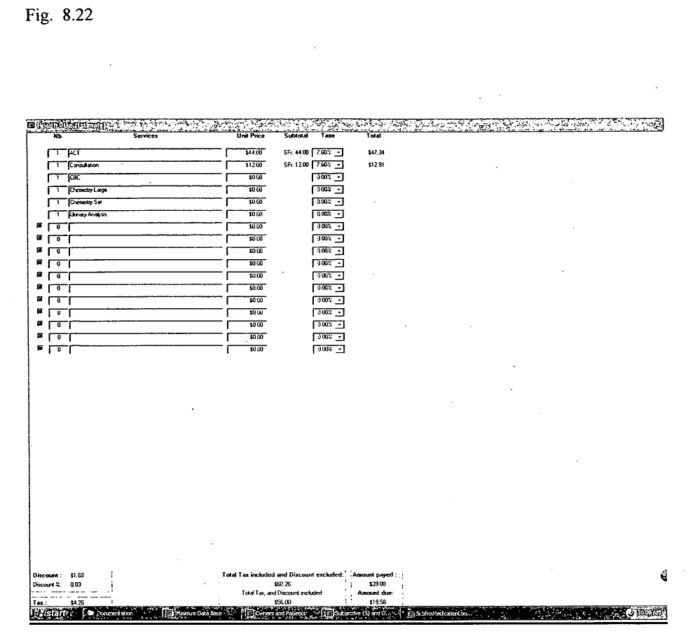

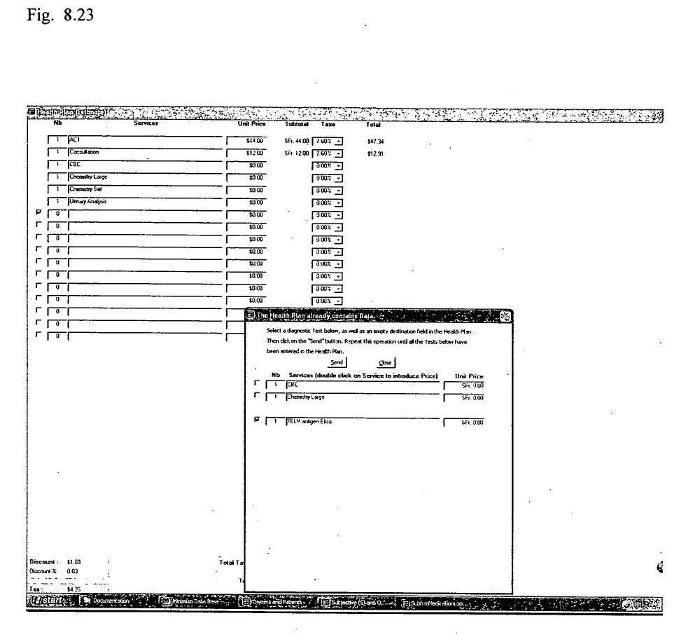

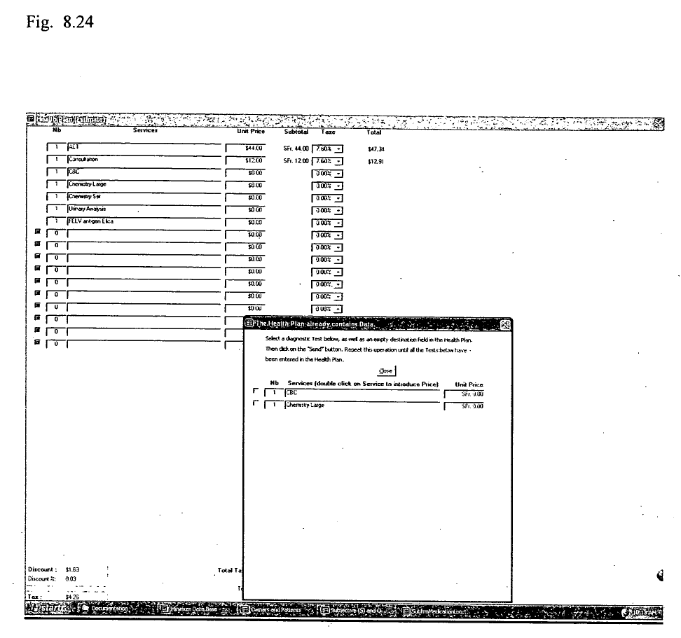

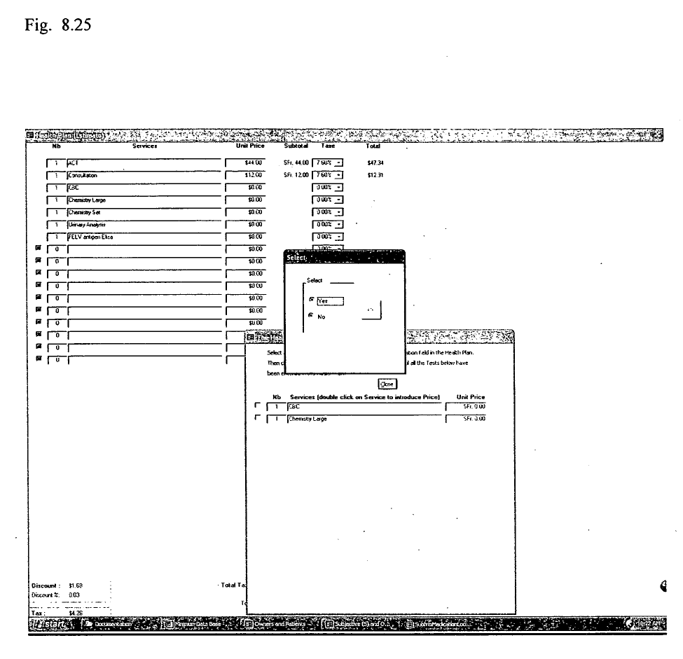

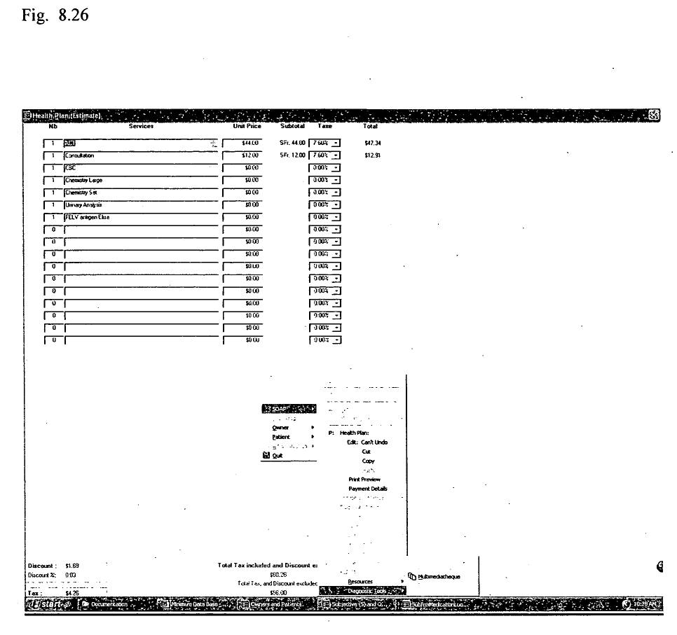

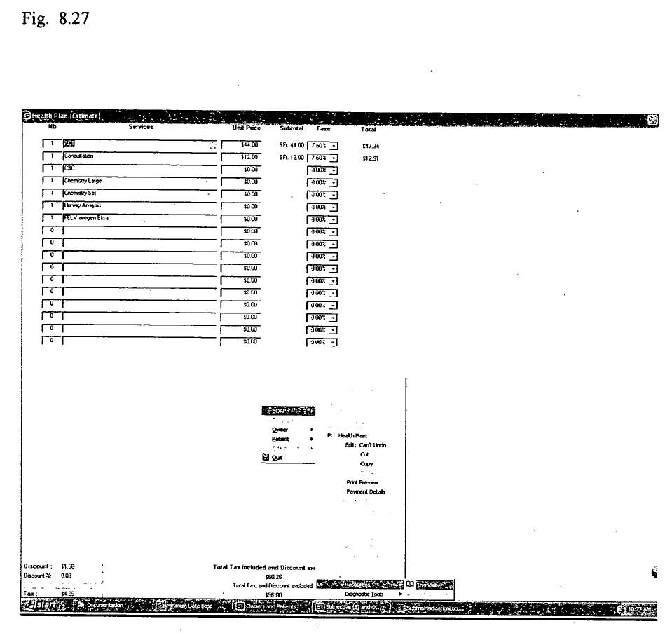

By choosing a symptom in the selection able Workups (see FIG. 8.1), the MDB is automatically entered in the “Health Plan”—Trademark rights reserve—(Estimate) with its respective prices (doctors' fees). This medical software invention creates a detailed fee estimate of services that are medically indicated for the patient (see FIG. 8.2). When the price of an examination may differ among patients (for example: X-Ray prices may depend on the size of the X-Ray and the radiography dimensions are proportional to the patient's size), a message box prompts the user to determine choice (see FIG. 8.5).

This is the only medical software that establishes invoice estimates (called “health plan”—trademark rights reserved—) for recommended treatments and services for predefined symptomatologies. Depending on the clinical signs present, a certain number of diagnostic aids (CBC, blood chemistry, urine analysis, electro-physiology, diagnostic imaging, biopsy, etc.) may be recommended to establish a diagnosis and management plan. This software establishes just with a few mouse clicks a minimum data base cost estimate tailored to: 1) The doctors way of practicing medicine 2) The patient 3) The context 4) The physicians fees. This software documents 1) an estimate which is presented to the owner or to the patient 2) a estimate signed by the owner or patient for approval. Both estimates are, either similar if the patient or owner accepts that the totality of the services be rendered, or not if this is not the case.

An alternative way of using this functionality is: A website with Online patient records for which invoice estimates for recommended treatments and services are established for predefined symptomatologies. The invoice estimates are based on doctors' personal fees.

FIG. 8.1 shows:

An example of symptoms in the Workup selection.

1. Feline

a. PUPD

FIG. 8.2 shows:

The MDB for Feline PUPD inserted in the health plan (Trademark rights reserved), with the possibility for the user of according a discount.

FIG. 8.3 shows:

That whether a field is present; absent; enabled or disabled on the context sensitive navigation menu (which pops up with a “Right Click”), depends on the current context.

b. Coughing

FIG. 8.4 through 8.6 shows:

The MDB for Feline Coughing inserted in the health plan (Trademark rights reserved), with possibility for the user of according a discount.

FIG. 8.5 shows:

That when the price of an examination may differ among patients (for example: X-Ray prices may depend on the size of the X-Ray and the radiography dimensions are proportional to the patient's size), a message box prompts the user to determine choice.

c. Dyspnea

FIG. 8.7 through 8.9 shows:

The MDB for Feline Dyspnea inserted in the health plan (Trademark rights reserved), with the possibility for the user of according a discount.

FIG. 8.8 shows:

That when the price of an examination may differ among patients (for example: X-Ray prices may depend on the size of the X-Ray and the radiography dimensions are proportional to the patient's size), a message box prompts the user to determine choice.

d. Vomiting Acute with Polysytemic Signs

FIG. 8.10 shows:

The MDB for Feline Vomiting acute with polysytemic signs inserted in the health plan (Trademark rights reserved), with the possibility for the user of according a discount.

FIG. 8.11 shows:

That when the price of an examination may differ among patients (for example: X-Ray prices may depend on the size of the X-Ray and the radiography dimensions are proportional to the patient's size), a message box prompts the user to determine choice.

FIG. 8.12 shows:

Radiographies inserted in the health plan (Trademark rights reserved),

e. Vomiting Chronic

FIG. 8.13 shows:

The MDB for Feline chronic vomiting signs inserted in the health plan (Trademark rights reserved), with the possibility for the user of according a discount.

f. Diarrhea Acute with Polysytemic Signs

FIG. 8.14 shows:

The MDB for Feline Diarrhea acute with polysytemic signs inserted in the health plan (Trademark rights reserved), with the possibility for the user of according a discount.

FIG. 8.15 shows:

That when the price of an examination may differ among patients (for example: X-Ray prices may depend on the size of the X-Ray and the radiography dimensions are proportional to the patient's size), a message box prompts the user to determine choice.

g. Diarrhea Chronic

FIG. 8.16 shows:

That when the price of an examination may differ among patients (for example: X-Ray prices may depend on the size of the X-Ray and the radiography dimensions are proportional to the patient's size).

FIG. 8.17 shows:

The MDB for Feline Diarrhea chronic diarrhea signs inserted in the health plan (Trademark rights reserved), with the possibility for the user of according a discount.

FIG. 8.18 shows:

That when the price of an examination may differ among patients (for example: X-Ray prices may depend on the size of the X-Ray and the radiography dimensions are proportional to the patient's size), a message box prompts the user to determine choice.

FIG. 8.19 shows:

The MDB for Feline Diarrhea chronic diarrhea signs inserted in the health plan (Trademark rights reserved).

2. Some of the Minimum Databases for Other Species (Including Humans)
a. PUPD
b. Coughing
c. Dyspnea
d. Vomiting acute with polysytemic signs
e. Vomiting chronic
f. Diarrhea acute with polysytemic signs
g. Diarrhea chronic
h. Chest Pain
i. Acute Abdomen
j. Breast disease

The Minimum data bases for other species are specific to the species concerned, for example: canines are the same as for felines but, without Feleuc.

3. When the Health Plan Already Contains Data

FIG. 8.20 through FIG. 8.25 shows:

How the software enters data in the “Health Plan” when it already contains data.

The user selects a diagnostic test in the pop-up form, as well as an empty destination field in the “Health Plan”. Clicking “send” will enter the value in the field of origin in the field of destination. This should be repeated until all the tests the user desires entering in the “Health Plan” have been entered, then “close” should be selected.

When done the user must click “close”, “yes” and “ok”. If the user has clicked on “close” but desires entering more fields he should click on “no” and “ok”.

FIG. 8.26 through FIG. 8.27 shows:

That whether a field is present; absent; enabled or disabled on the context sensitive navigation menu (which pops up with a “Right Click”), depends on the current context.

FIG. 8.27 shows:

The current Visit module and that the invention has automatically entered the data from the Health Plan in it.

Customizable Extended Data Base

This is the only medical software with a customizable extended data base functionality and information on how to accomplish procedures.

Laboratory

The laboratory form supports entering, viewing, modifying and deleting laboratory information.

This medical software has functionalities that no other medical software has. Some examples of this, among which making a enhanced use of laboratory services, therefore making the laboratory more profitable, are described below.

The interpretation of laboratory results is performed by comparing each result to its respective reference values (minimal normal and maximal normal). In addition to the reference range, an additional set of parameters measures tissue integrity as well as organ efficiency: “Optimal Range”. Many laboratories use different equipment and different methods for running their tests. Therefore, many laboratories have different reference and optimal ranges for the same tests. The reference and optimal values for each laboratory are entered in the software application only once. Then when the user selects the laboratories' name, these values are automatically entered by the software in the patients' report besides the patient's results with nothing more than a few clicks. (If these values are not yet entered in the database, the user is prompt to do so.) Consequently, the user is informed as to which laboratory ran each test and its respective normal and optimal values.

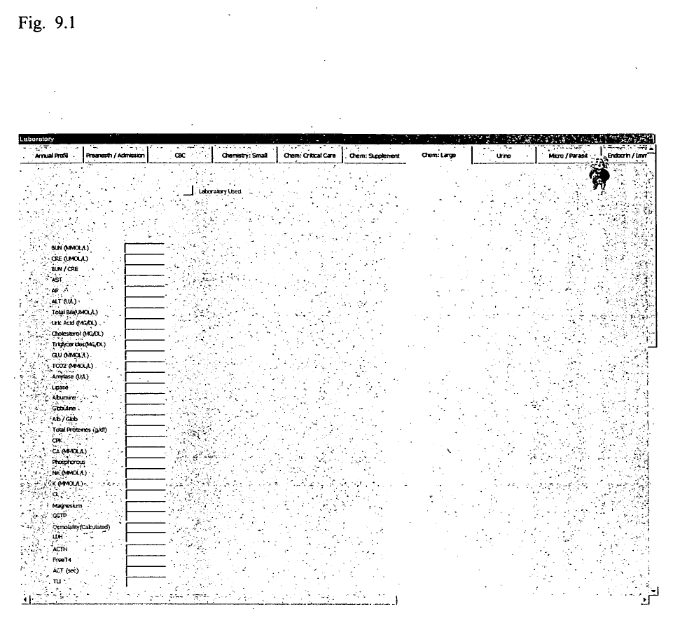

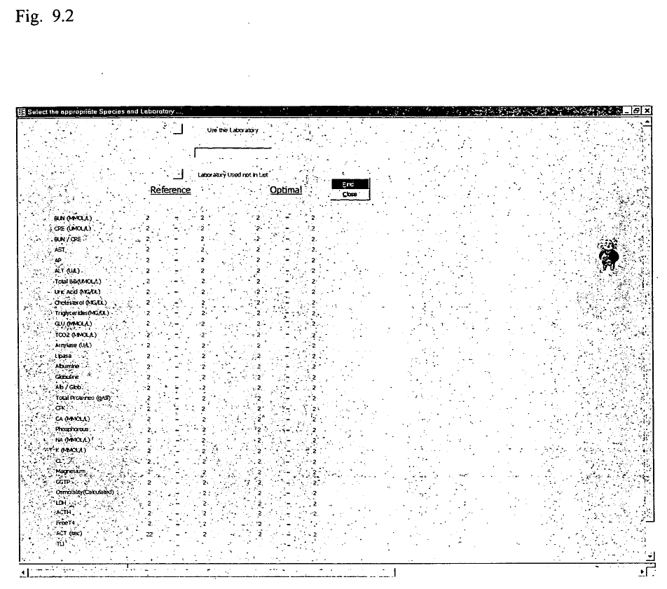

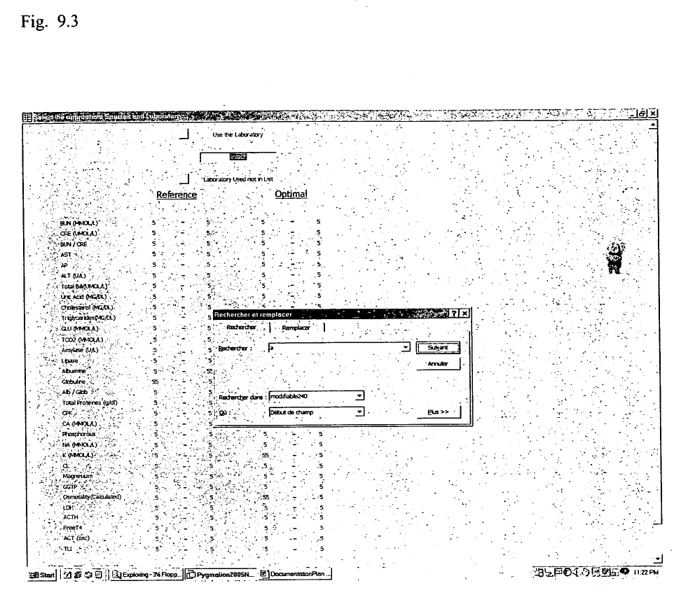

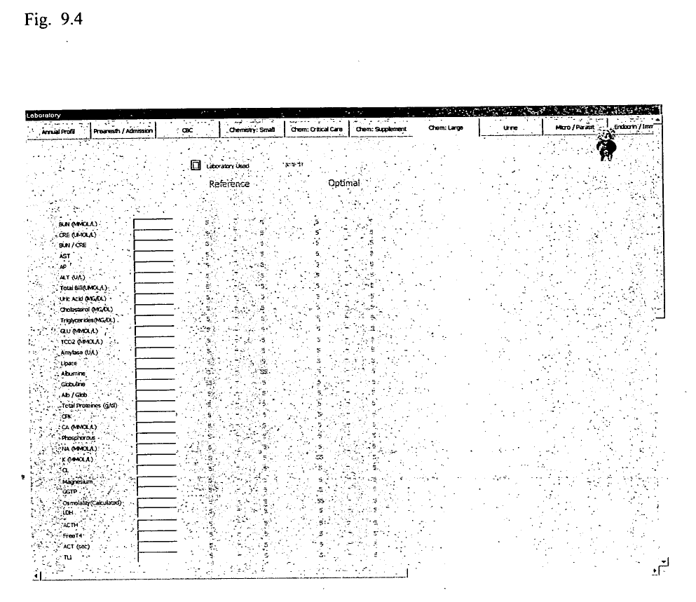

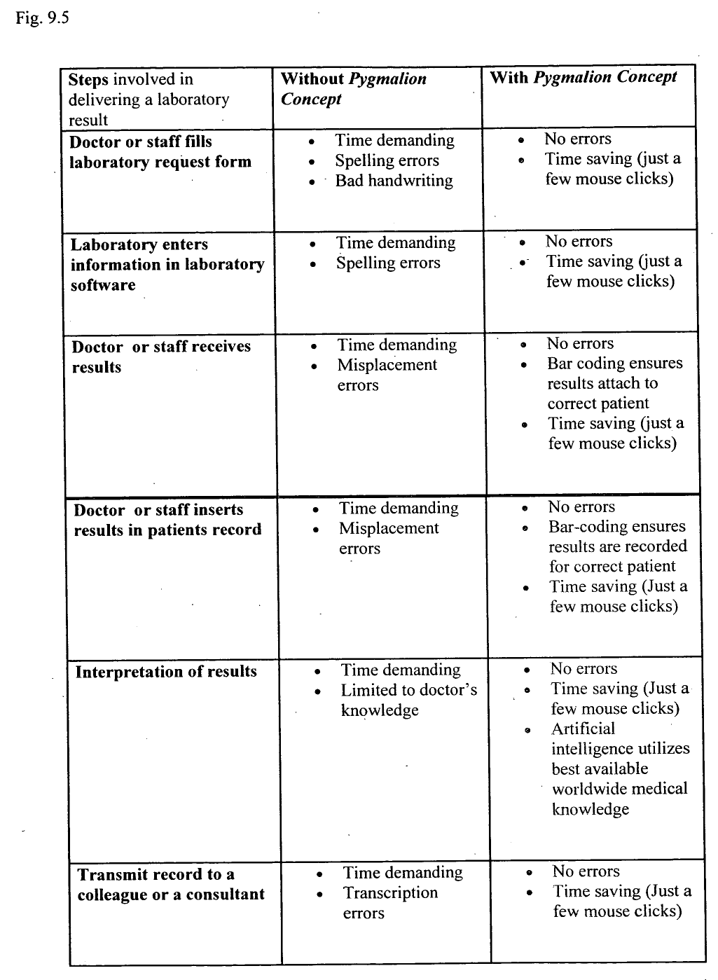

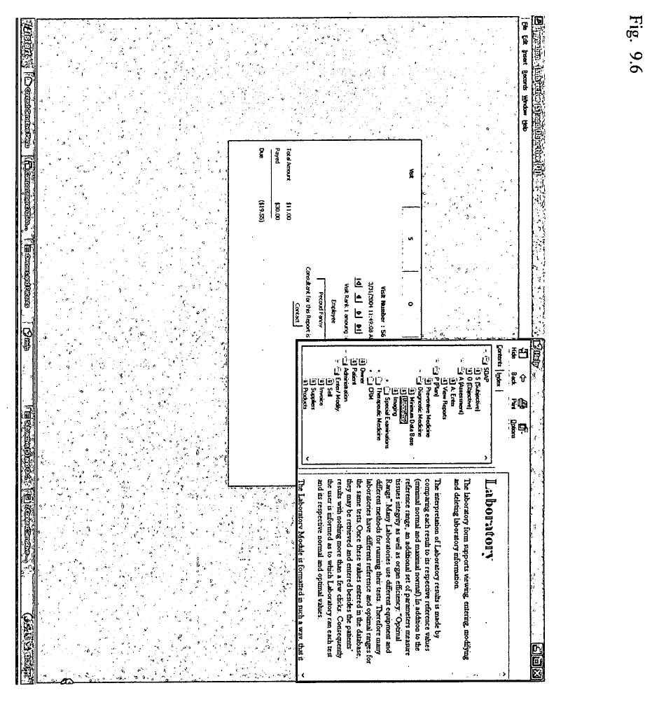

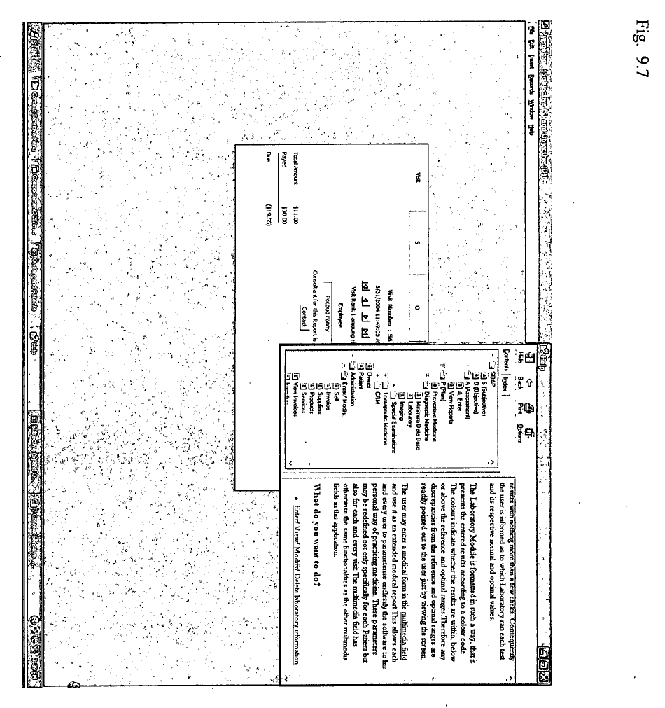

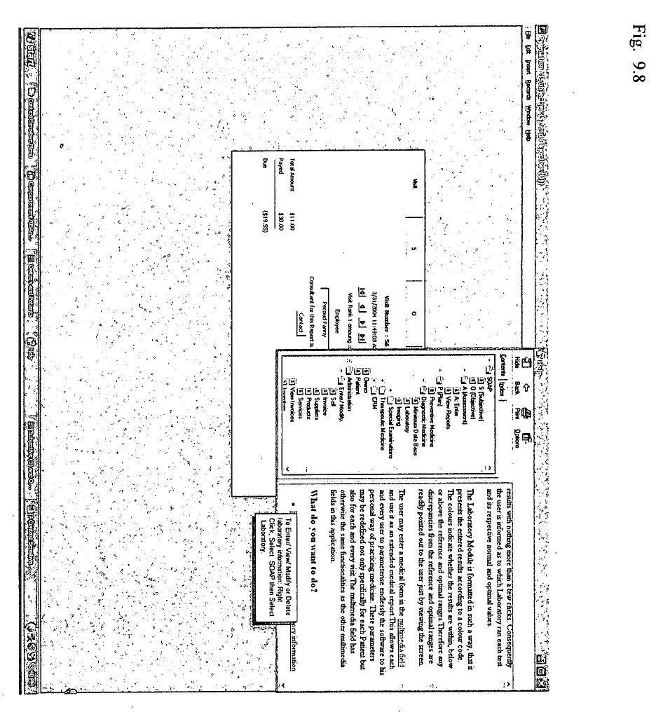

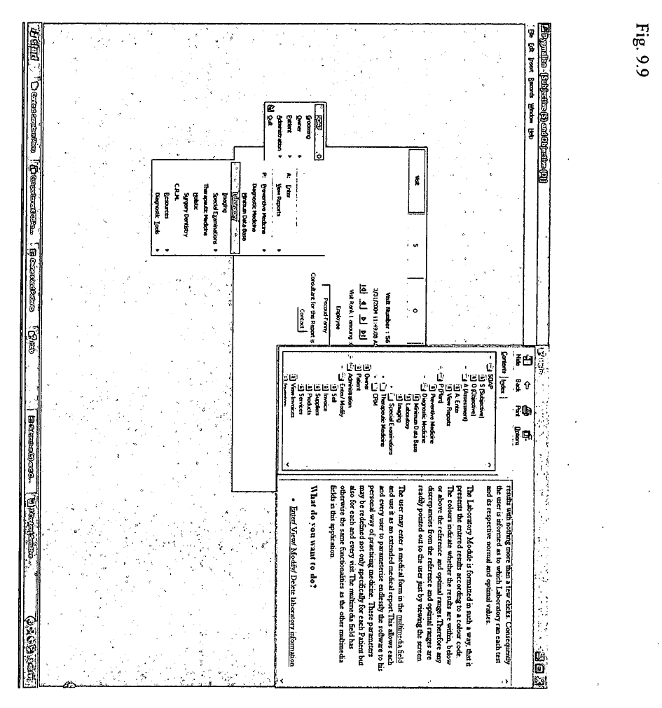

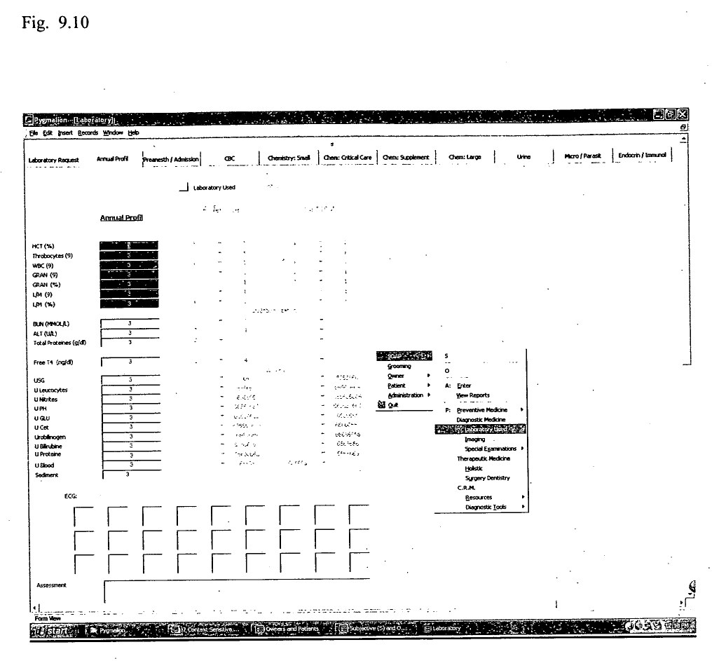

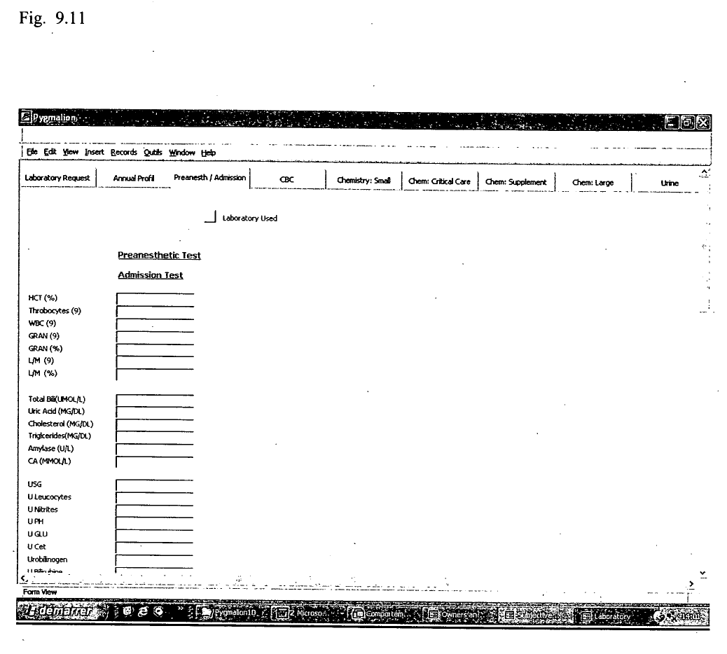

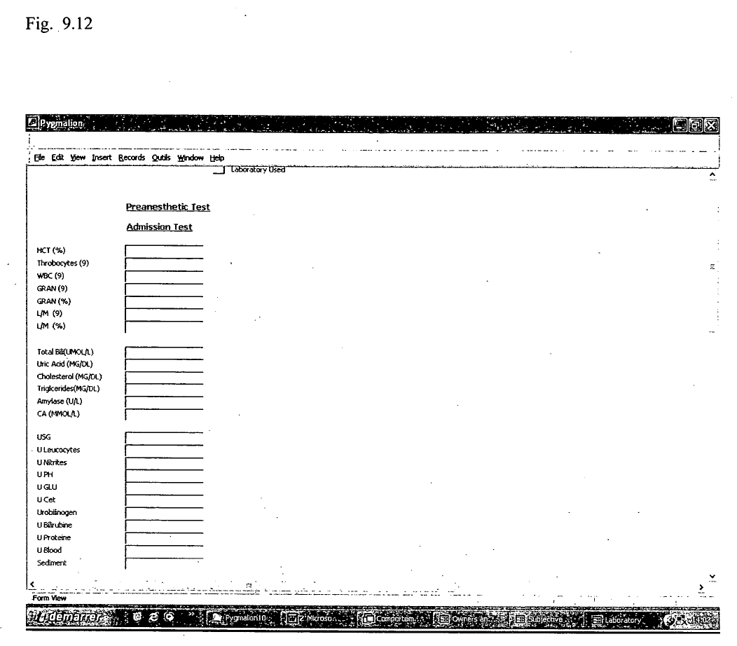

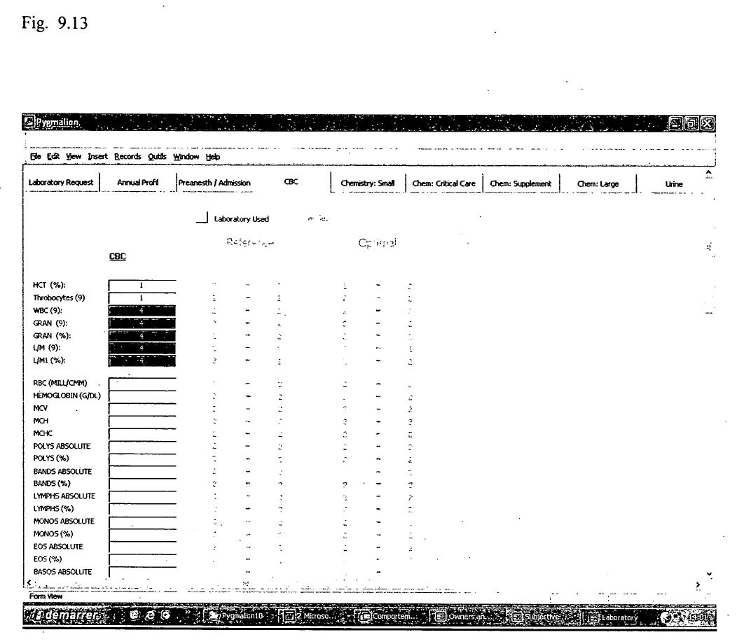

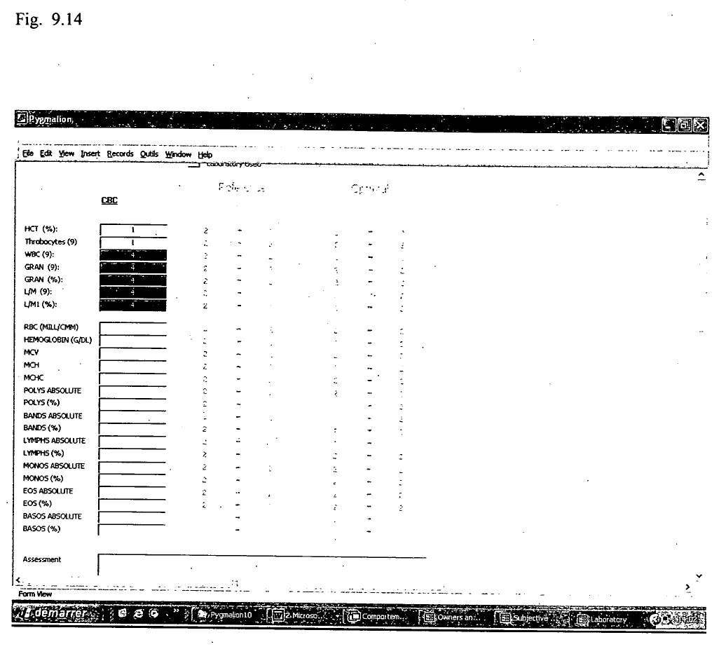

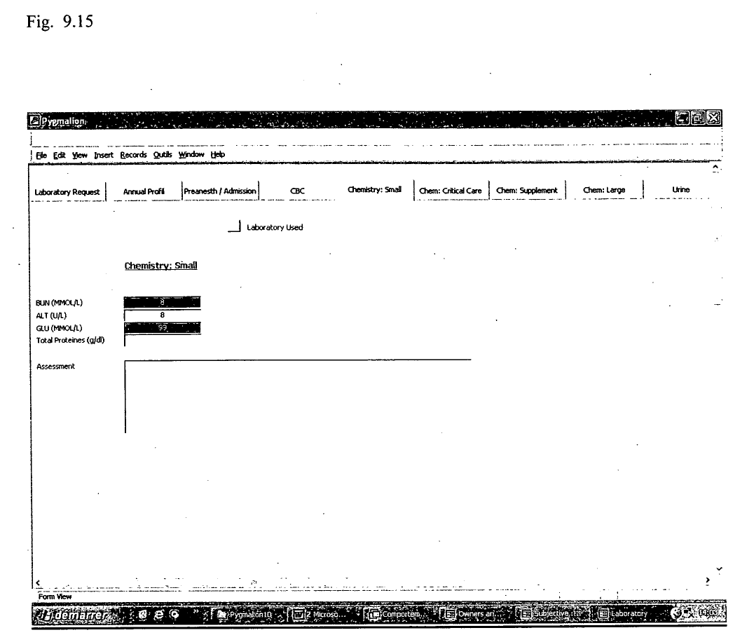

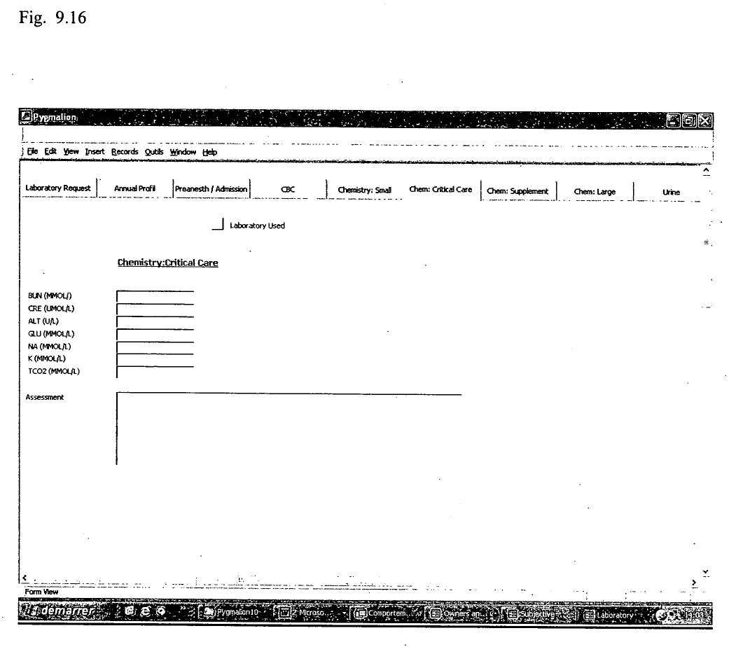

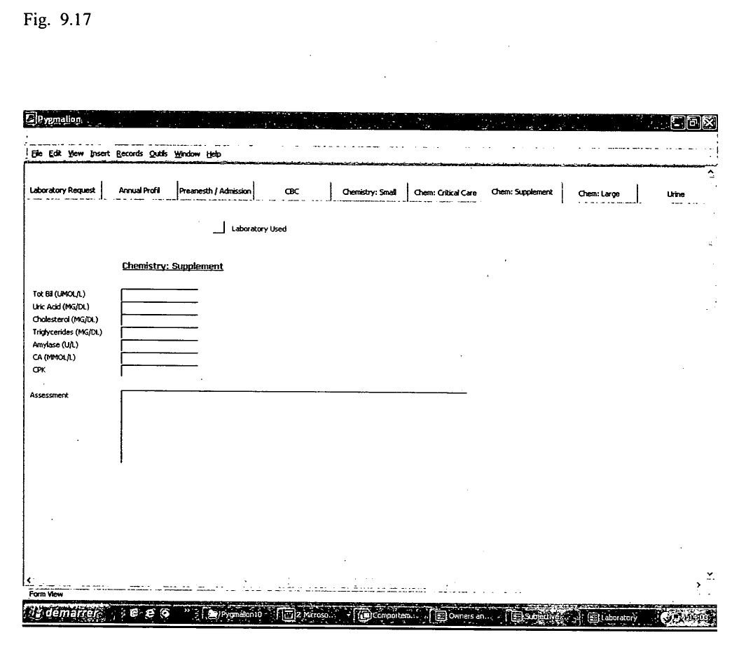

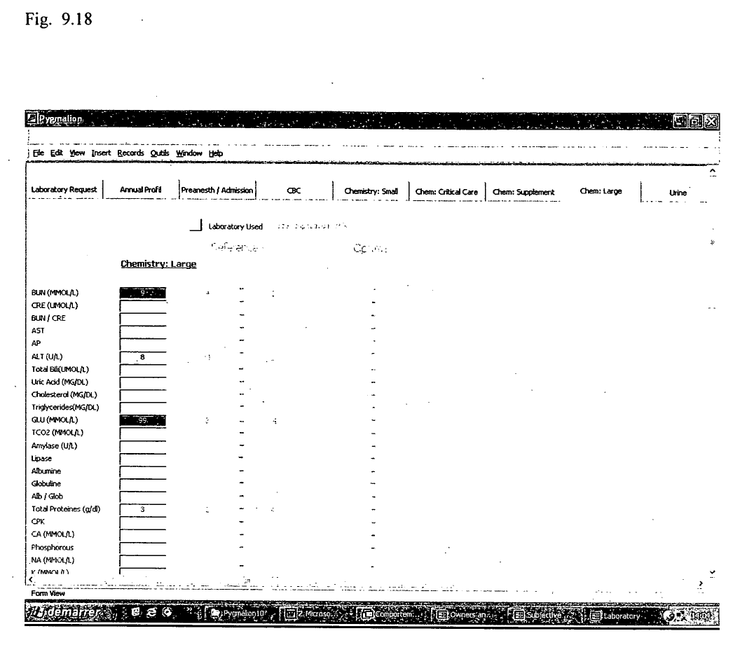

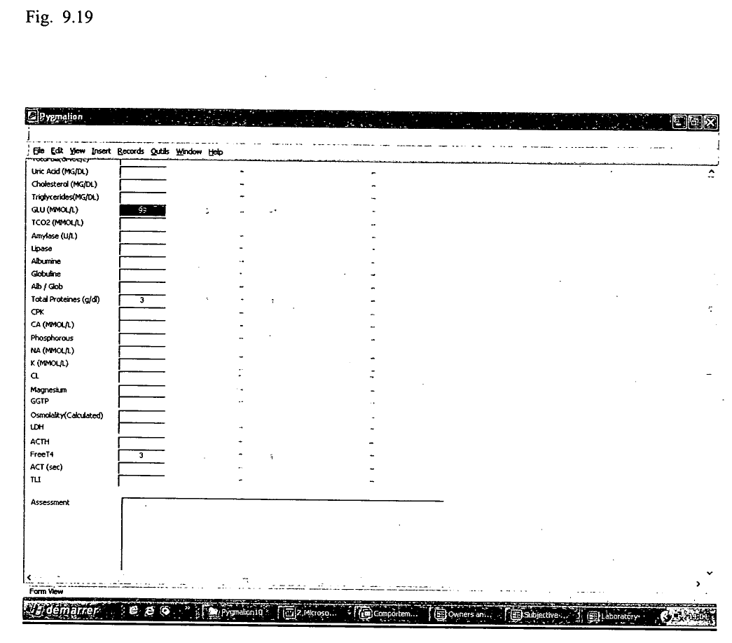

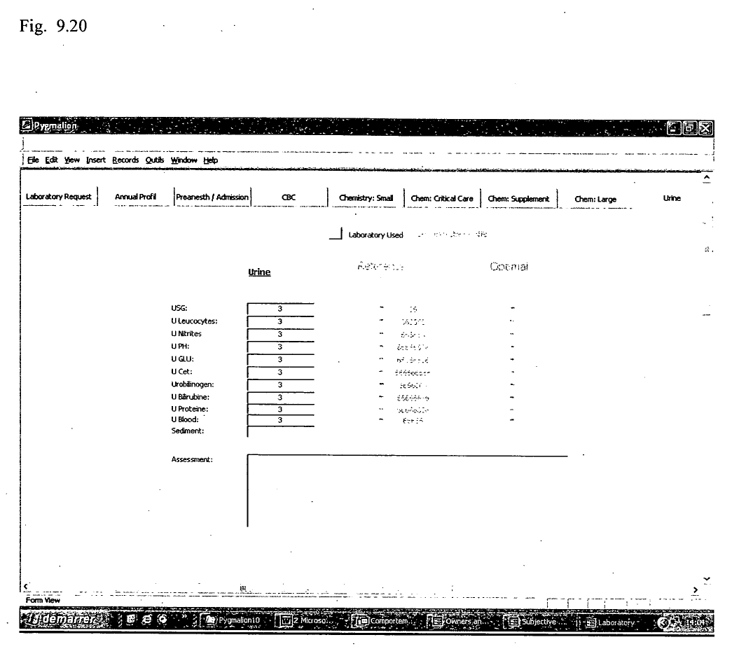

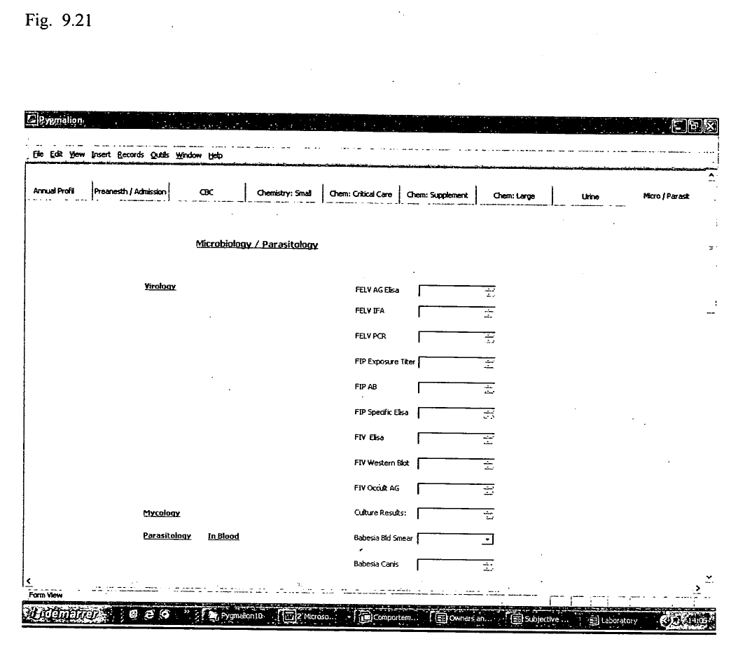

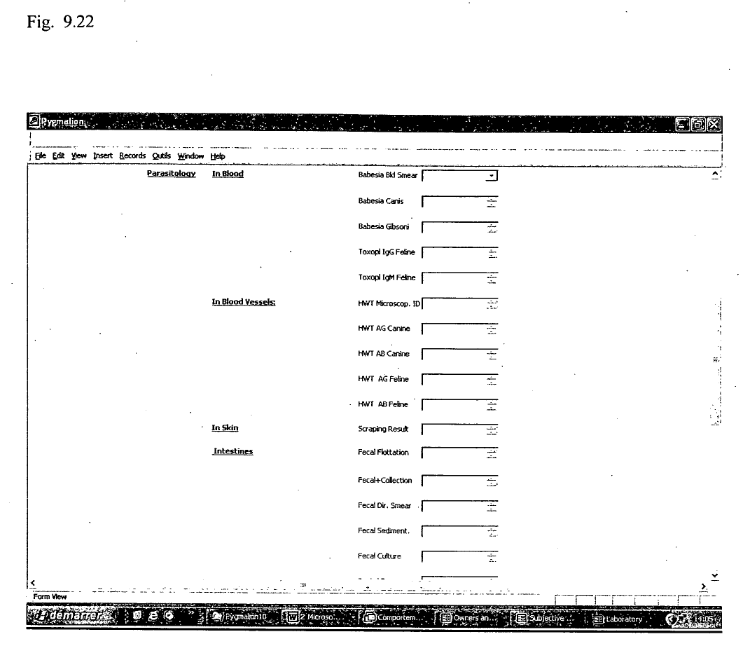

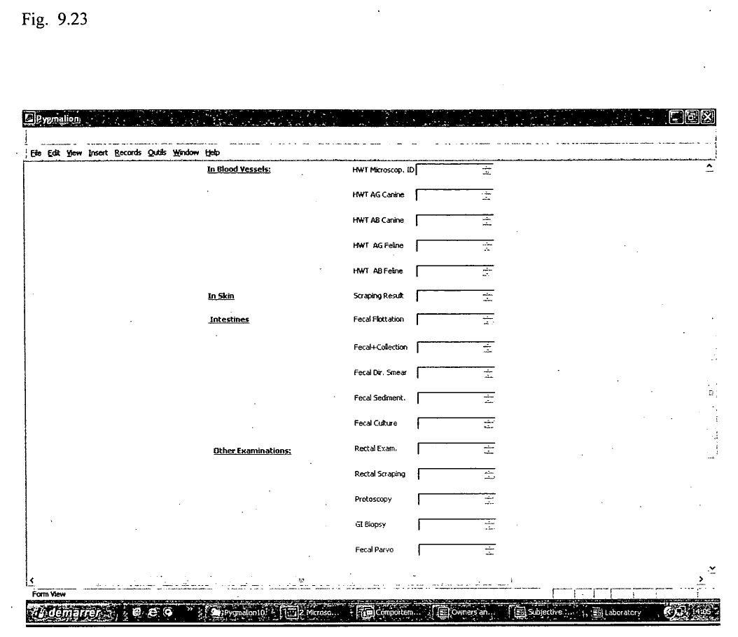

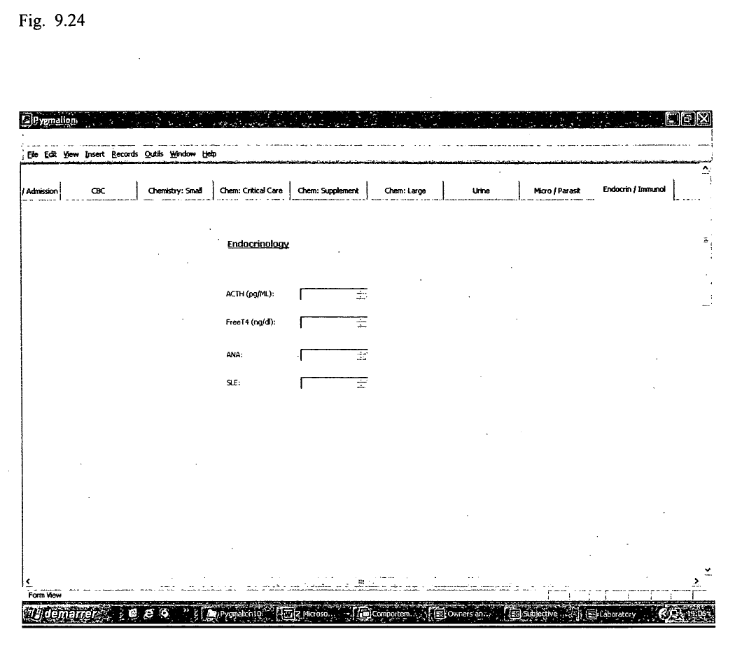

FIG. 9.1 through FIG. 9.4 shows:

How the user should proceed to enter all reference and optimal values from a specific laboratory in the patients' form. If the laboratory sends the test results to the doctor, these values are automatically entered with the according lab results into the patients' form.

The Laboratory Module is formatted in such a way that it presents the entered results according to a colour code. The colours indicate whether the results are within, below or above the reference and optimal ranges. Therefore, any discrepancies from the reference and optimal ranges are readily pointed out to the user just by viewing the screen.

The user may enter a medical form in the multimedia field and use it as an extended medical report. This allows each and every user to endlessly customize the parameters of the software to suit personal way of practicing medicine. These parameters may be redefined not only specifically for each patient but also for each and every visit. The multimedia field has otherwise the same functionalities as the other multimedia fields in this application.

This Module Saves on Time, Manpower and Request Forms, Avoids Transcription Errors and Makes Future Retrieval of Results Fast and Easy:

Far too often, doctors receive laboratory results with errors (practitioners name, address, patients name, age, weight, sex, etc.).

Besides the potential embarrassment for the doctor, this can eventually become a source for medical malpractice suits. Errors may arise at different levels between the process of sending a sample to a laboratory and inserting the results in the patient's record.

FIG. 9.5 shows:

Steps involved in delivering a laboratory result.

Pygmalion Concept (Trademark rights reserved) prints a bar-coded request form for each laboratory specimen. The bar code contains all the needed pertinent information (veterinarian profile, patient profile, and requested tests—entered in the Laboratory Request form).

Upon arrival at the laboratory a simple scanning of the bar code inserts the request form's information into the laboratory's database.

Once the laboratory tests are processed, the results can be sent to the doctor by e-mail. The uniqueness of the Pygmalion Concept (Trademark rights reserved) software makes it possible to automatically insert these into the patients' record. This saves transcription time, avoids errors and makes the results readily available at all times.

Tests are Requested

Because Pygmalion Concept (Trademark rights reserved) is designed to help doctors make informed decisions faster, the integrated artificial intelligence presents a list of possible diagnoses based on the patients' record. Each diagnosis is detailed with its symptoms, its relative probability of being appropriate for the current patient, the reasons why it has been chosen, and additional tests needed to confirm it as the diagnosis Depending on the clinical signs present, a certain number of diagnostic aids (CBC; blood chemistry; urine analysis; electro-physiology; diagnostic imaging; biopsy; etcetera . . . ) may be recommended to establish a diagnosis and management plan.

A pre-determined set of diagnostic procedures for each type of patient or problem helps minimize diagnostic errors, saves time, and is generally more cost-effective and better tolerated by clients. Because this fast and easy-to-use approach avoids omitting laboratory tests, Pygmalion Concept (Trademark rights reserved) can make a better use of laboratory services.

This medical software also allows an automatic insertion of laboratory results from indoor laboratory into the patient's record.

FIG. 9.6 and FIG. 9.7 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 9.8 shows:

Hyperlinks when activated present additional information in a pop-up window.

FIG. 9.9 shows:

How to allocate the Laboratory module, and that whether a field is present; absent; enabled or disabled on the context sensitive navigation menu (which pops up with a “Right Click”) depends on the current context.

All the Laboratory forms' have menu with the same structure but they are context sensitive.

The Laboratory Request form is tailored on the specifications given by the laboratory.

FIG. 9.10 shows:

The Laboratory annual profile

FIG. 9.11 through FIG. 9.12 shows:

The Laboratory Preanaesthetic and Admission Profile

FIG. 9.13 through FIG. 9.14 shows:

The Laboratory CBC Profile

FIG. 9.15 shows:

The Laboratory Chemistry Small Profile

FIG. 9.16 shows:

The Laboratory Chemistry Critical Care Profile

FIG. 9.17 shows:

The Laboratory Chemistry Supplement Profile

FIG. 9.18 through FIG. 9.19 shows:

The Laboratory Chemistry Large Profile

FIG. 9.20 shows:

The Laboratory Urine Profile

FIG. 9.21 through FIG. 9.23 shows:

The Laboratory Microbiology and Parasitology Profile

FIG. 9.24 shows:

The Laboratory Endocrinology and Immunology Profile

Imaging

The images form supports entering, viewing, modifying and deleting images information.

This is the only medical software with an automatic insertion of X-rays; electrocardiograms(ECG); echograms; CT Scans; IRMs; dictated notes, videos, etcetera . . . a total of 22 different types of documents can be inserted (see Multimedia).

This is the only veterinary and human medical software with multimedia fields integrated throughout the software, plus within the imaging module with the following characteristics: The huge number of fields in this module (379) allows the user to customize it endlessly. One may, for example, decide to use some of the radiography fields to hold X-rays and others to document a radiographic report as a Microsoft Word document or even as vocal comments. Some may desire having a video of an orthopaedic examination beside the radiograms Others may choose to enclose a video of a bronchoscopie with spoken comments adjacent to the chest X-rays and cytology images and reports . . . . The options are unlimited.

This module may be applied to enter and view the following documents:

1. Electrocardiograms (27 fields)

2. Radiographies
i. Small size (27 fields for first radiographies and 27 for following ones)
ii. Medium size (27 fields for first radiographies and 27 for following ones)
iii. Large size (27 fields for first radiographies and 27 for following ones)

As one notice each of these sizes are subdivided in two groups:
1. first radiographies
2. following ones

This differentiation is very useful for the users that charge different fees for first radiographies than for the following ones.

2. Contrast Radiographies
i. Small size (27 fields)
ii. Medium size (27 fields)
iii. Large size (27 fields)

3. Cardiac echography (27 fields)

4. Abdominal echography (27 fields)

5. Other body parts echography (27 fields)

6. Computered Tomography (27 fields)

7. IRM (27 fields)

8. Multimedia (one field)

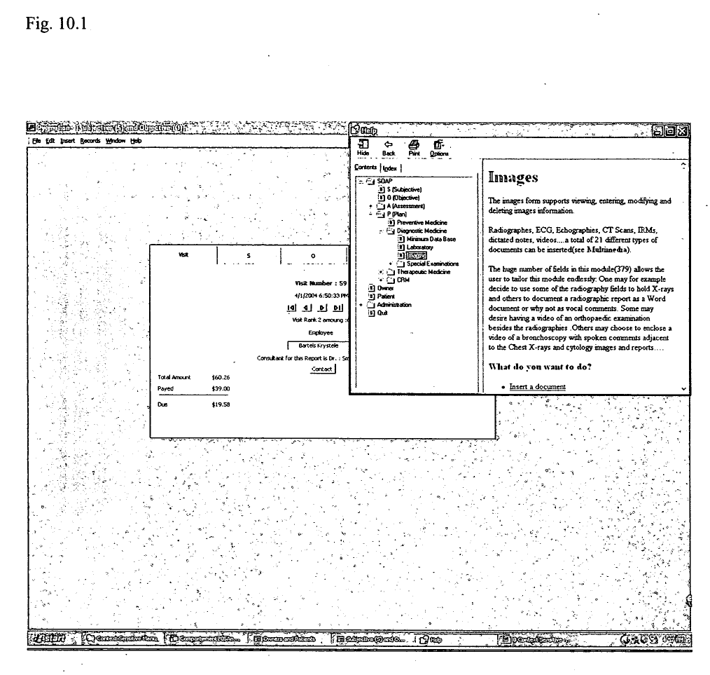

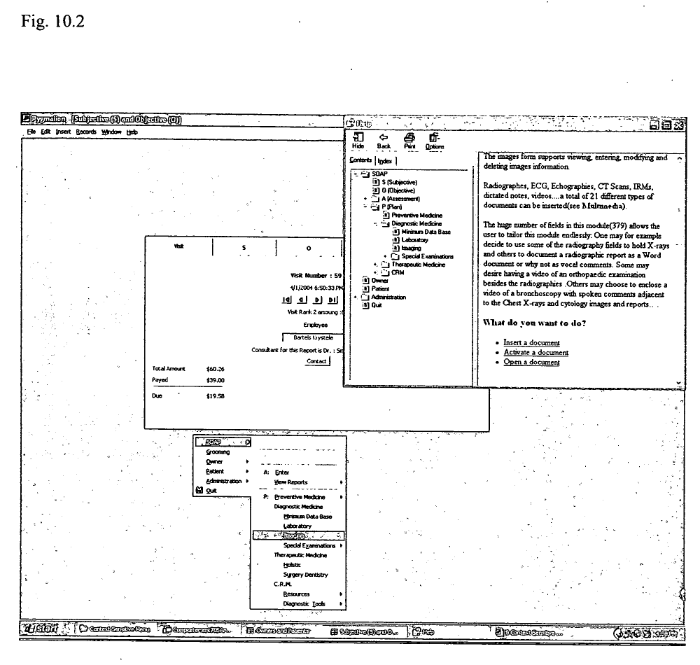

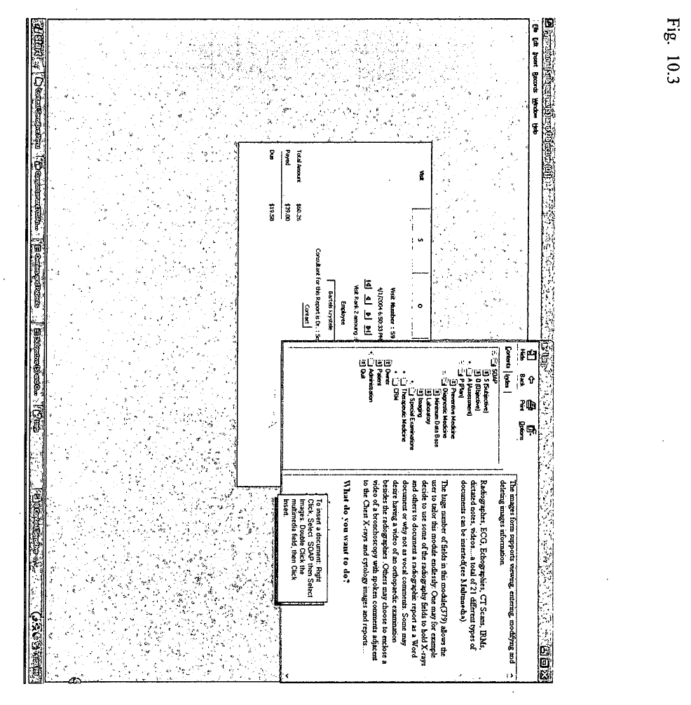

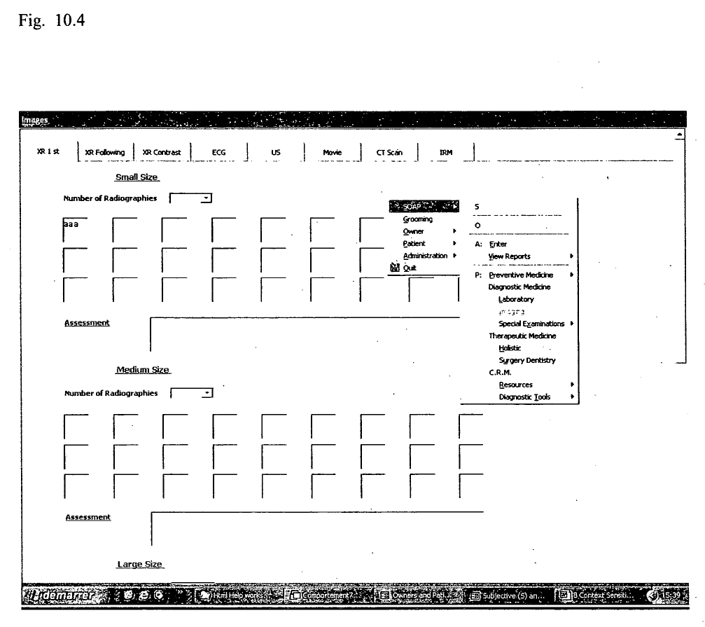

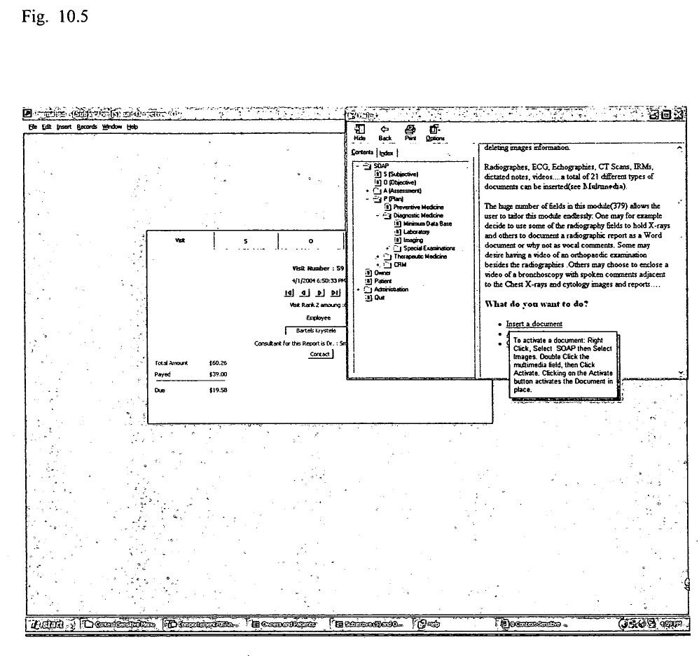

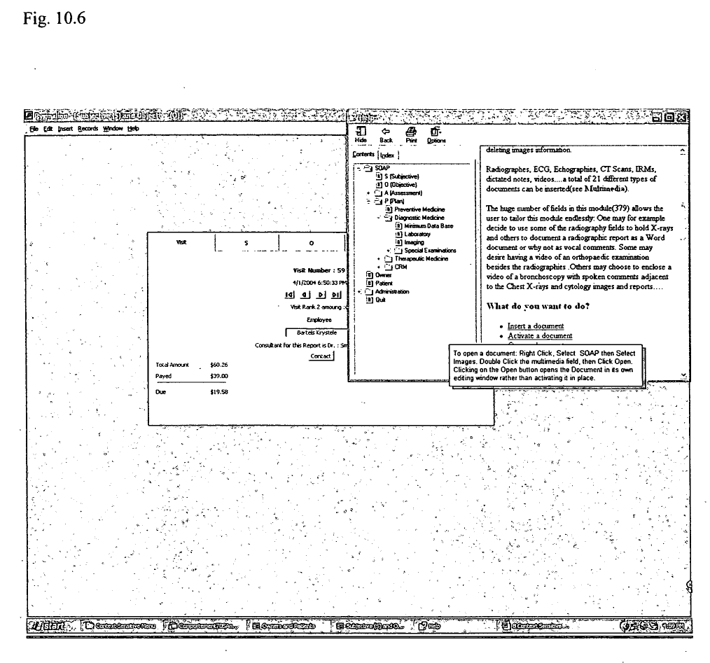

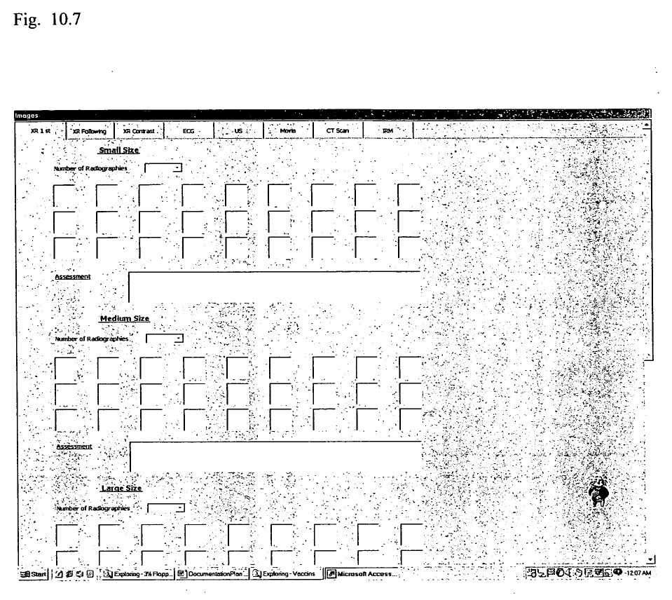

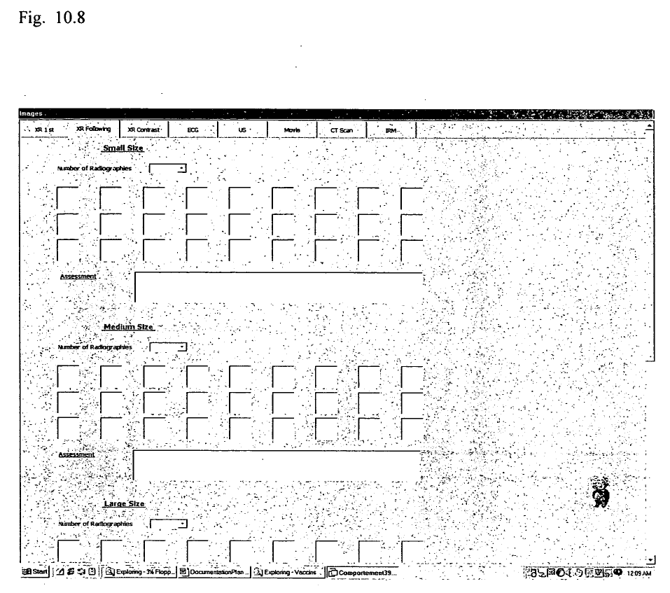

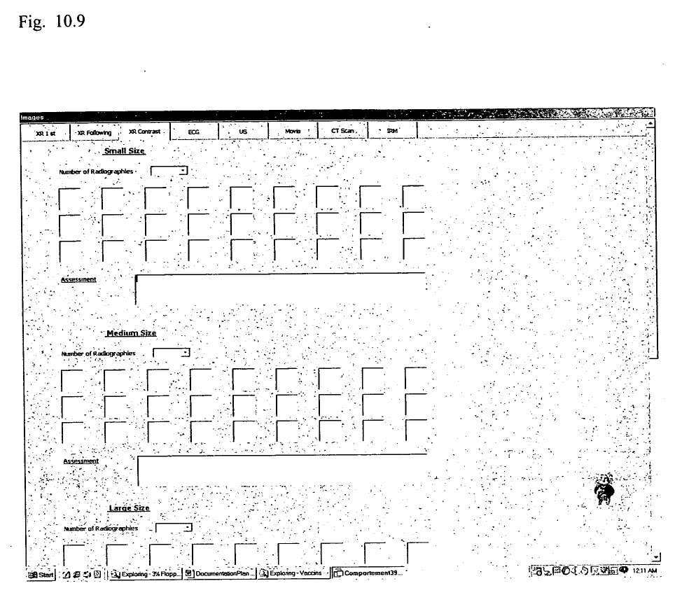

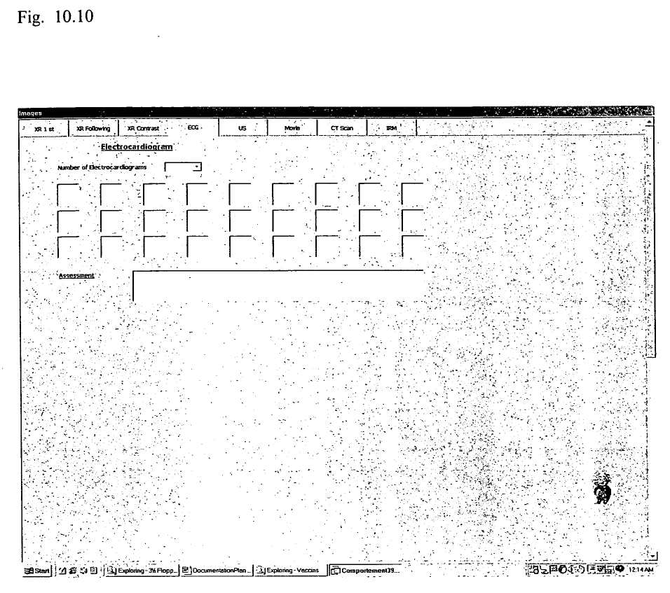

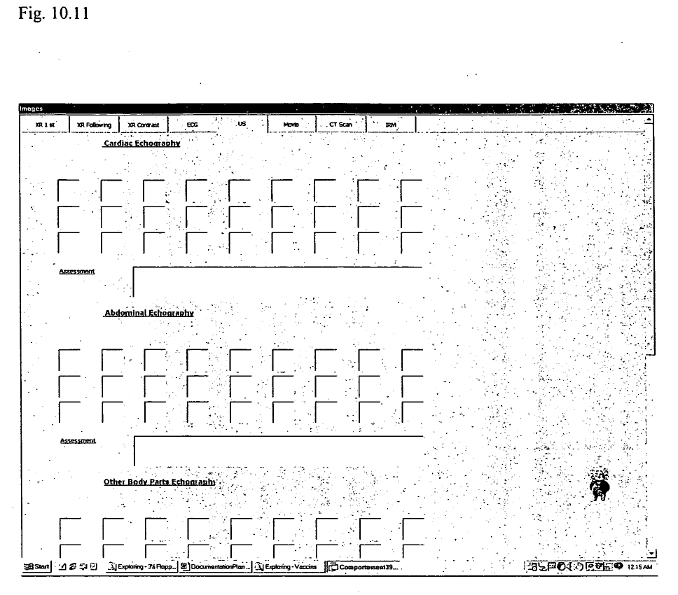

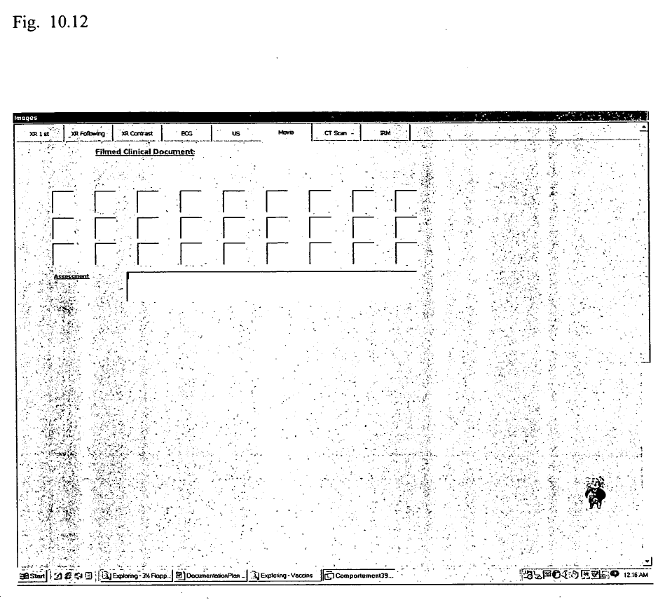

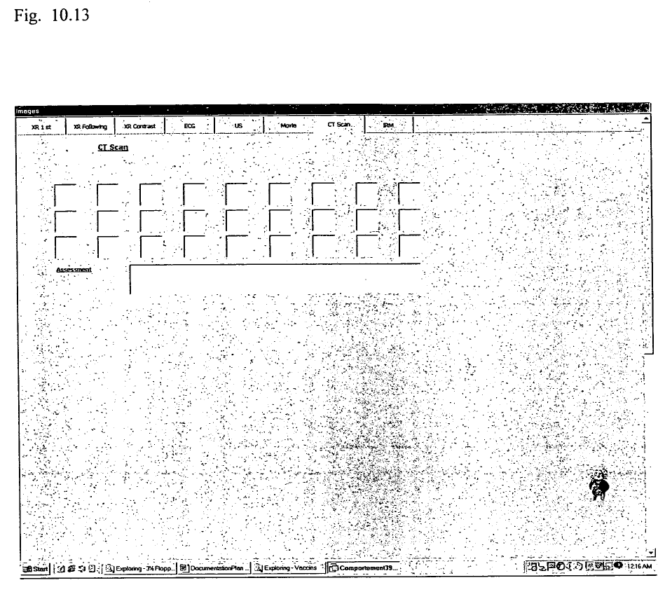

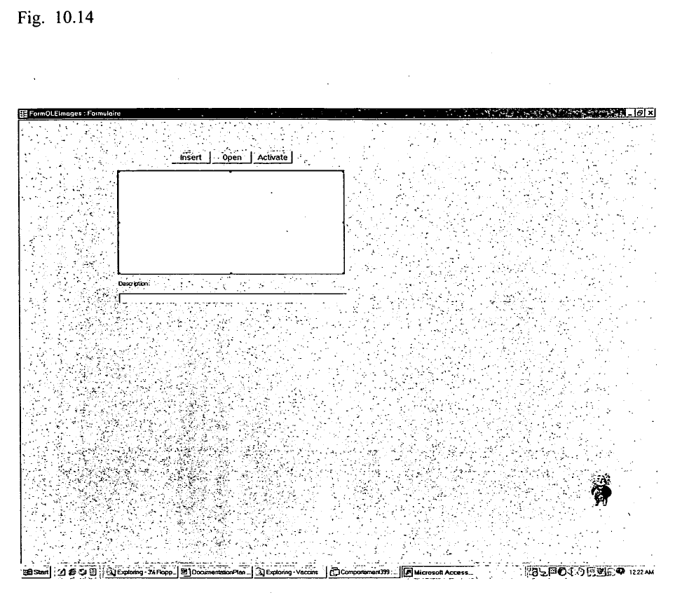

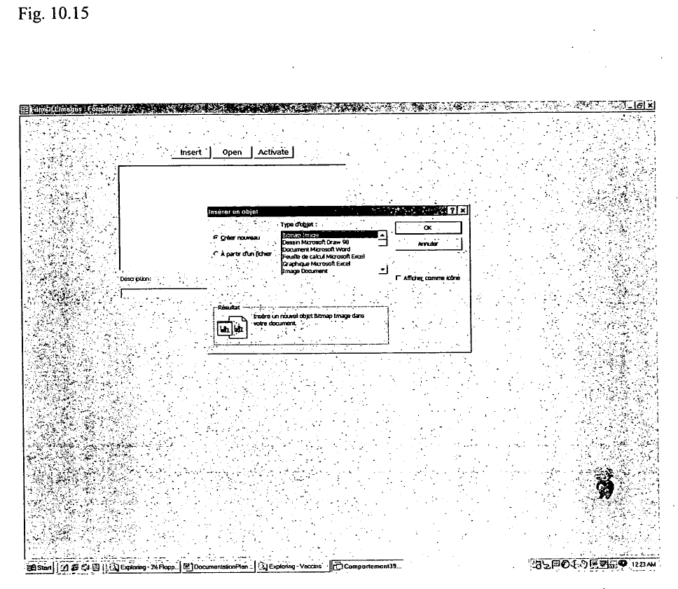

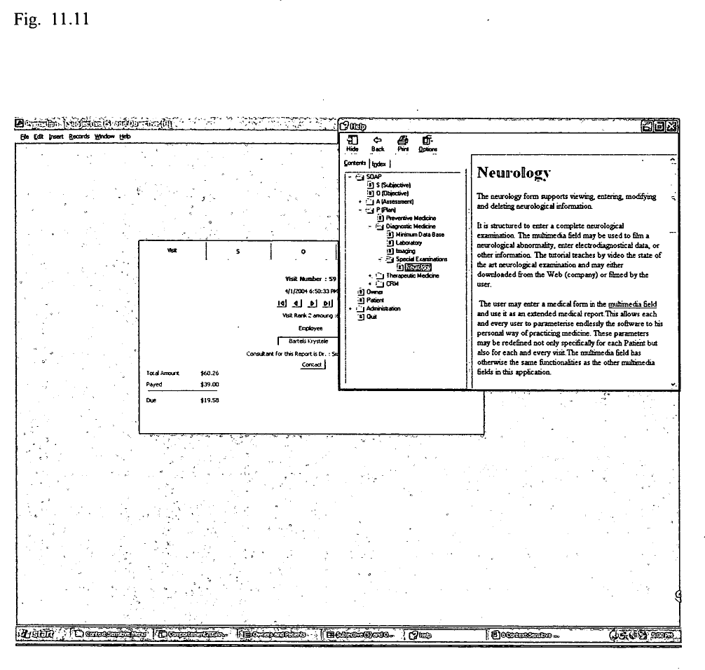

FIG. 10.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 10.2 shows:

How to allocate the Imaging module as well as the hyperlinks in its' the Topic Window.

FIG. 10.3 shows:

Hyperlinks when activated present additional information in a pop-up window. The example illustrated here is the Imaging Topic Window.

FIG. 10.4 shows:

The Imaging Module and that whether a field is present; absent; enabled or disabled on the context sensitive navigation menu (which pops up with a “Right Click”), depends on the current context. It also shows the XR form.

FIG. 10.5 through FIG. 10.6 shows:

Hyperlinks when activated present additional information in a pop-up window. The example illustrated here is the Imaging Topic Window.

FIG. 10.7 shows:

The first plain radiographies form

FIG. 10.8 shows:

The following plain radiographies form

FIG. 10.9 shows:

The contrast radiographies form

FIG. 10.10 shows:

The Electrocardiogram form

FIG. 10.11 shows:

The cardiac and abdominal and other body parts echography form

FIG. 10.12 shows:

The movie form

FIG. 10.13 shows:

The computered tomography form

The IRM form presents the same display of fields as the CT Scan form.

Entering an Image in a Field:

Double-clicking the field enlarges this field on the screen and brings up three command buttons (Insert, Open, Activate; see FIG. 10.14). Clicking on the “Insert” button calls up the Insert Dialog box allowing the user to insert the selected Document (see FIG. 10.15).

Viewing a Image:

A small size image is readily visible on the screen. Double-click the image to obtain an enlarged view This brings up three command buttons (Insert, Open, Activate). Clicking on the “Activate” button activates the Document in place. Clicking on the “Open” button opens the Document in its own editing window rather than activating it in place (see FIG. 10.14).

Replacing an Image by Another:

Double-click the image to obtain an enlarged view. This brings up three command buttons(Insert, Open, Activate). Clicking on the “Insert” button calls up the Insert Dialog box allowing the user to insert the new Document in replacement of the former one (see FIG. 10.14).

Types of Documents that may be Inserted:

THIS IS THE ONLY SOFTWARE OFFERING THE POSSIBLILTY OF INSERTING 22 DIFFERENT TYPES OF DOCUMENTS IN THE PATIENTS IMAGE MODULE.

The user may insert all kinds of Documents in this field and comment them. The Documents may be of the following types:
1. Acrobate Document: The user may scan a medical form and use it as an extended medical report. This allows each and every user to parameterise endlessly the software to his personal way of practicing medicine. These parameters may be redefined not only specifically for each Patient but also for each and every visit.
2. Clip Multimedia
3. Clip Video
4. Corel Photo Home Image
5. Document WordPad
6. Image Bitmap
7. Image Paintbrush
8. Image Wang
9. Microsoft Clip Gallery
10. Microsoft Excel Chart
11. Microsoft worksheet
12. Microsoft Graph Chart
13. Microsoft PowerPoint Presentation
14. Microsoft PowerPoint Slide
15. Microsoft Word Document
16. Microsoft Picture
17. Package
18. QuickTime Movie
19. QuickTime Picture
20. Sequence MIDI
21. Son Wave
22. E film

BECAUSE OF THE MASSIVE NUMBER OF FIELDS IN THIS MODULE (379), AND VAST DIFFERENT TYPES OF DOCUMENTS THAT MAY BE ENTERED (22), THIS IS THE ONLY SOFTWARE OFFERING THE FUNCTIONNALITY TO THE USER OF TAILORING THIS MODULE EXACTLY TO THE WAY HE PRACTICES MEDECINE. THIS IS THE ONLY SOFTWARE OFFERING SUCH A POSSIBLILTY.

Neurology

The neurology form supports entering, viewing, modifying and deleting neurological information.

This is the only medical software that is structured to allow the user to enter a complete neurological examination, has a video tutorial and that the user may endlessly customize. The multimedia field may be used to film a neurological abnormality, enter electro-diagnostic data or other information. The tutorial teaches by video the state-of-the-art neurological examination and may either be downloaded from the Web (company) or filmed by the user.

The user may enter a medical form in the multimedia field and use it as an extended medical report. This allows each and every user to endlessly customize the parameters of the software to suit personal way of practicing medicine. These parameters may be redefined not only specifically for each patient but also for each and every visit. The multimedia field has otherwise the same functionalities as the other multimedia fields in this application. The tutorial teaches by video the state of the art neurological examination.

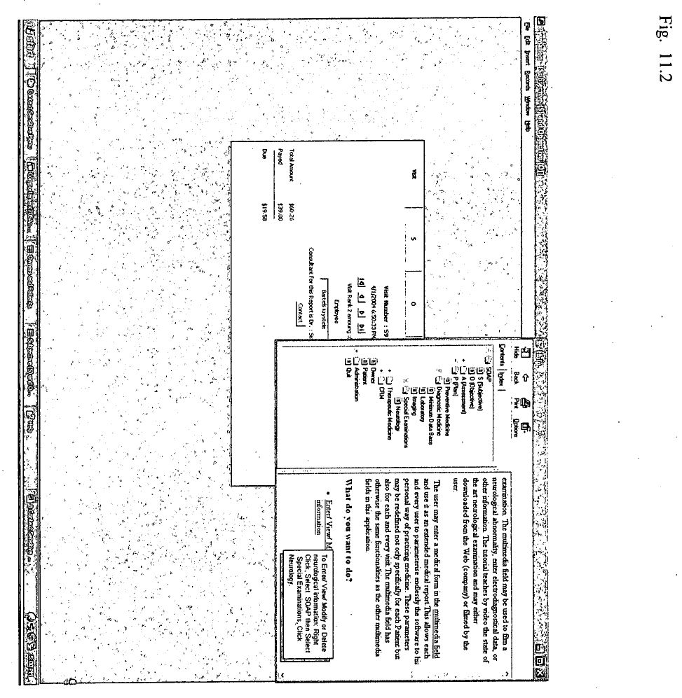

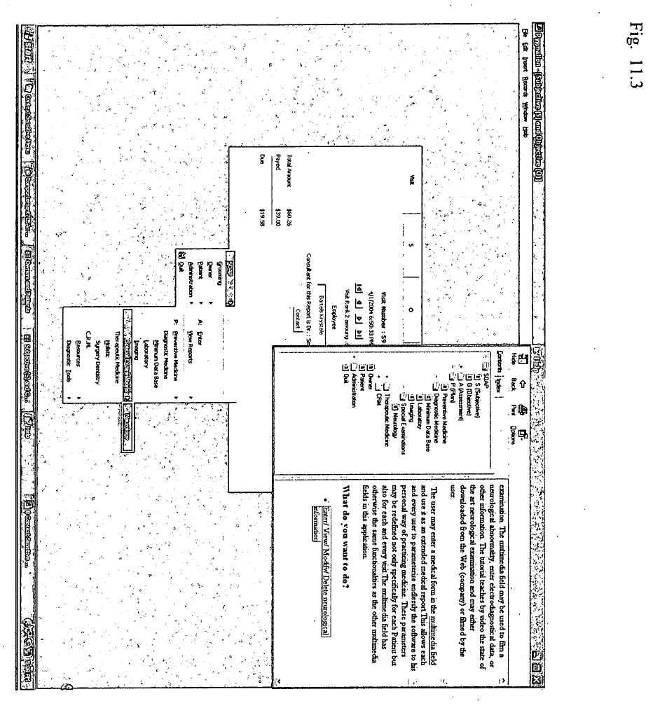

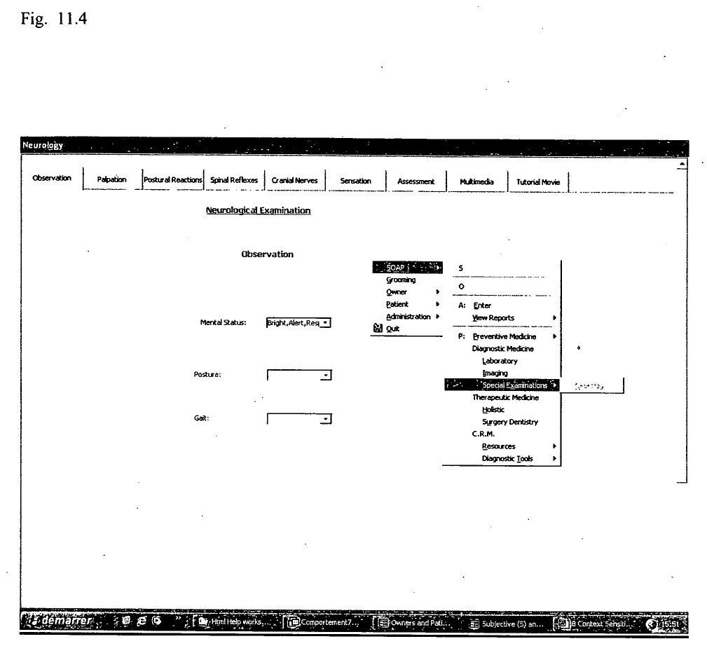

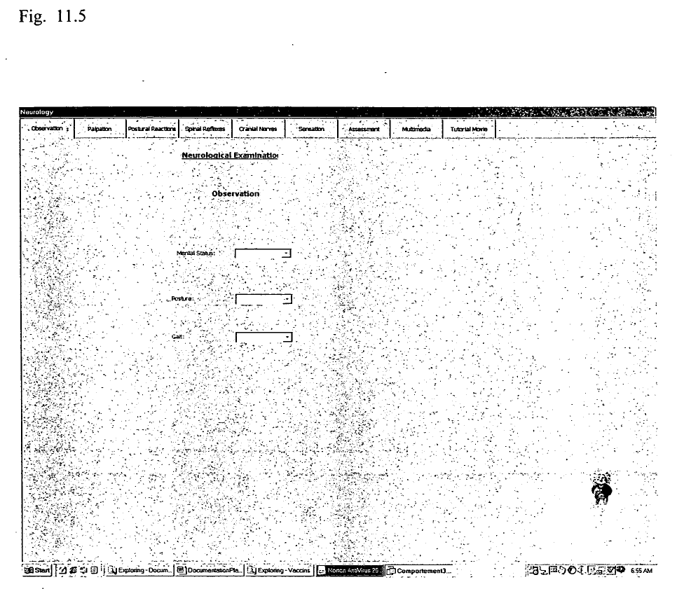

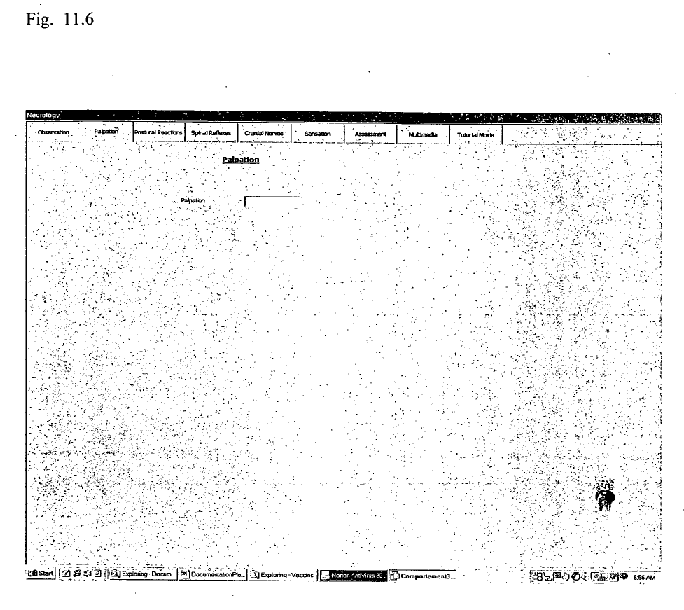

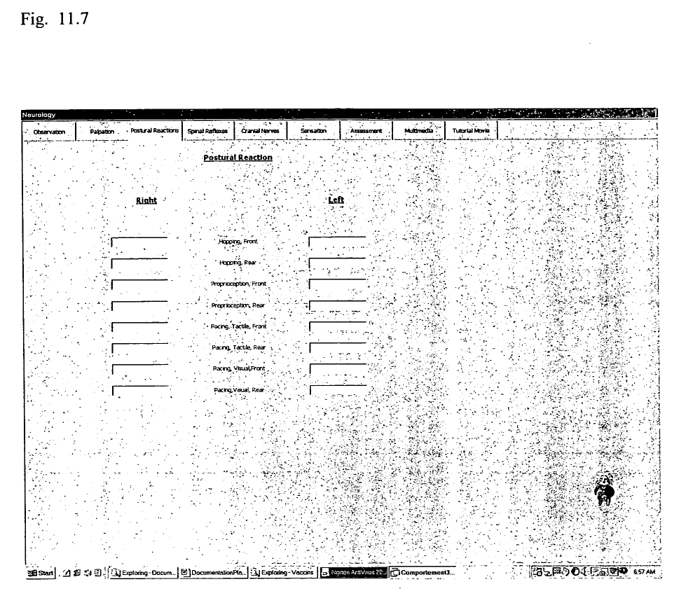

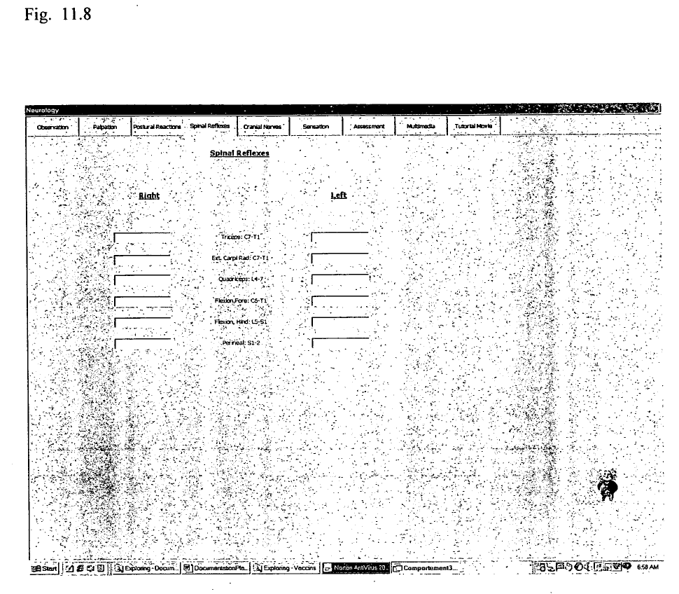

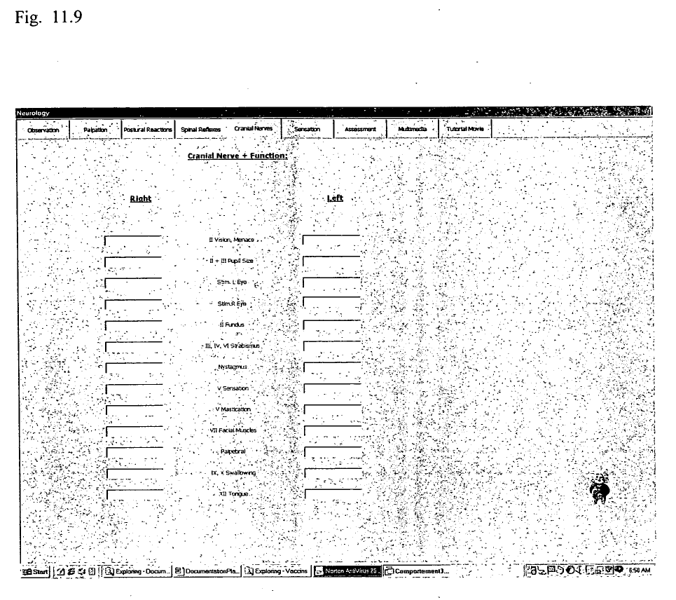

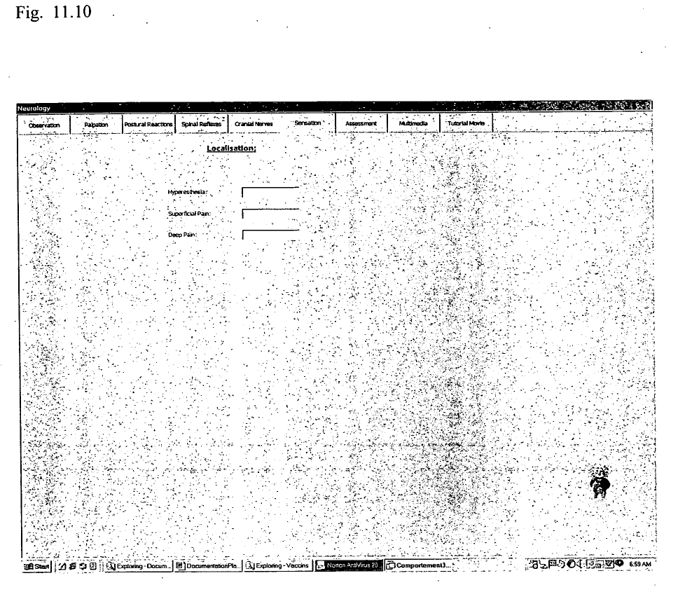

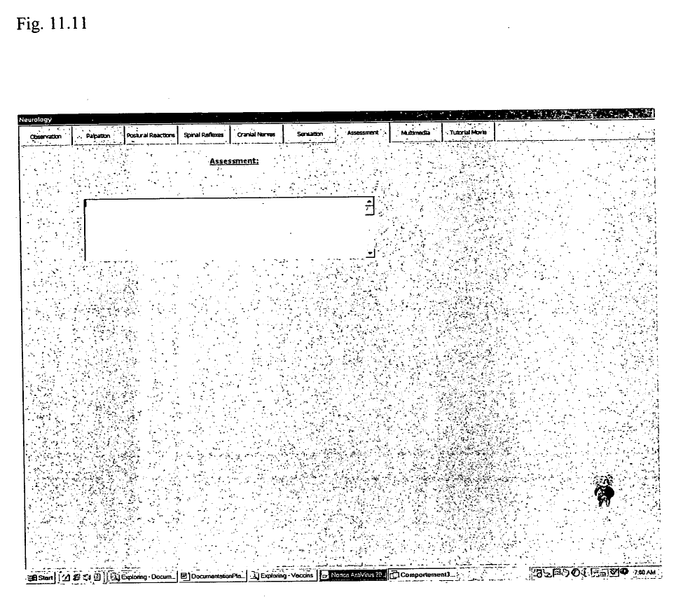

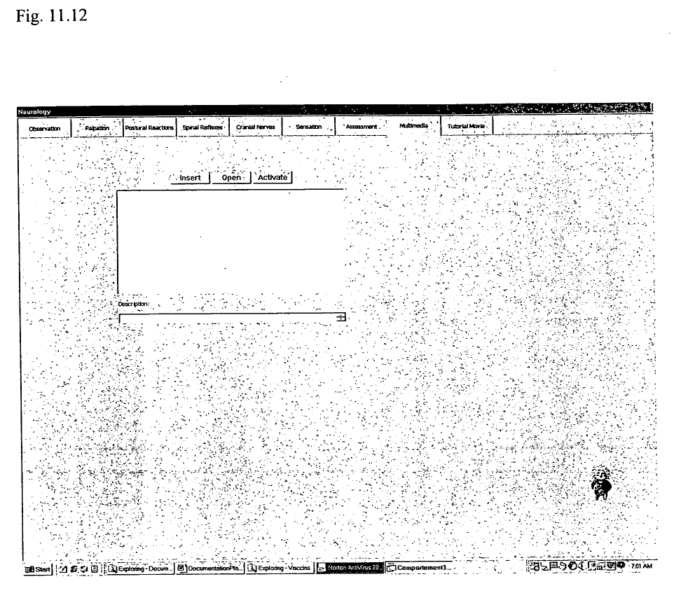

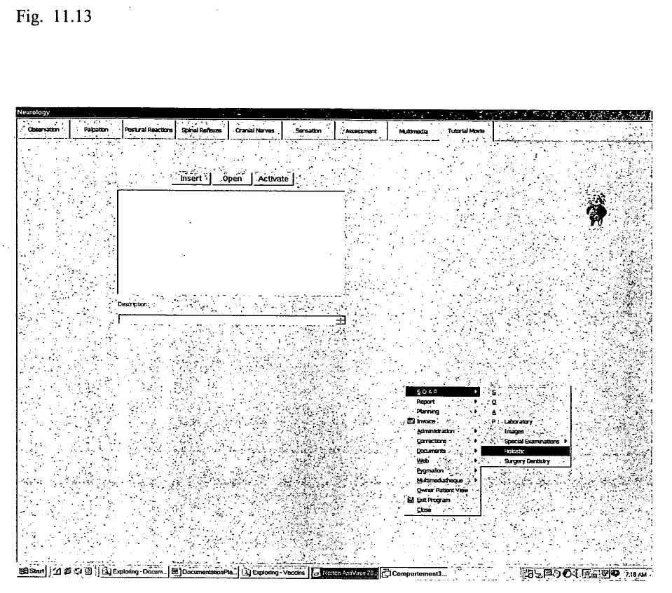

FIG. 11.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 11.2 shows:

Hyperlinks when activated present additional information in a pop-up window.

FIG. 11.3 through FIG. 11.4 shows:

How to allocate the Neurology module and that whether a field is present; absent; enabled or disabled on the context sensitive navigation menu (which pops up with a “Right Click”), depends on the current context.

FIG. 11.5 through FIG. 11.13 shows:

The screen images of the different forms contained in the Neurology module.

Tutorials may be either included in the software; downloaded from the Web (company) or filmed by the user.

Holistic

The holistic form supports entering, viewing, modifying and deleting holistic therapy information.

Five types of holistic therapies are supported:
1. Acupuncture, Chinese medicine.
2. Homeopathy
3. Bioresonance
4. BSF
5. The user may enter a medical form in the multimedia field and use it as an extended medical report. This allows each and every user to endlessly customize the parameters of the software to suit personal way of practicing medicine. These parameters may be redefined not only specifically for each patient but also for each and every visit.

This is the only medical software with a holistic module that can establish complete holistic reports documenting homeopathy; acupuncture; Chinese medicine; bio resonance; bio spectrum frequency and bio nutritional analysis at same time. The artificial intelligence selects a holistic management plan (for example: acupuncture points; Chinese medicine prescription; bioresonance . . . ) based on the patients record. The inventor has several diplomas (the highest level that may be given to a non Chinese doctor) for acupuncture and Chinese medicine from Institute of traditional Chinese Medicine in Peking, has a diploma for bioresonance and is practicing homeopathy since 1984.

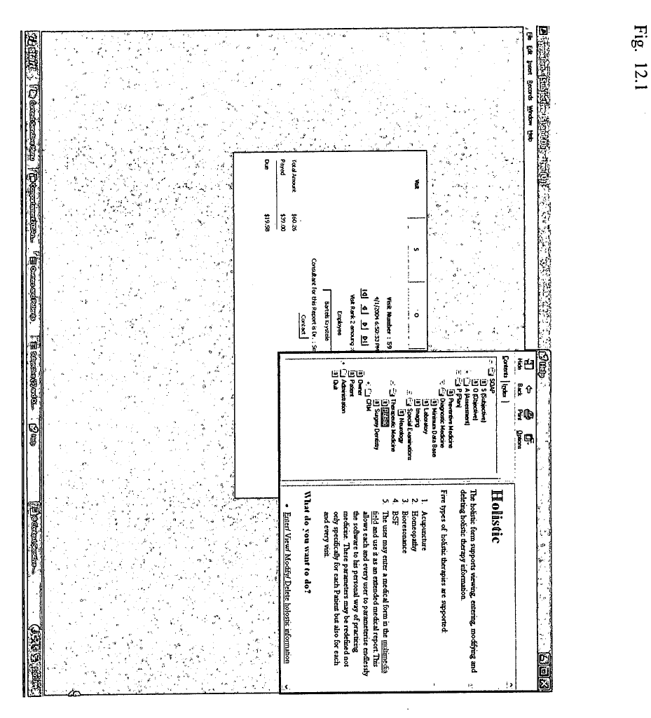

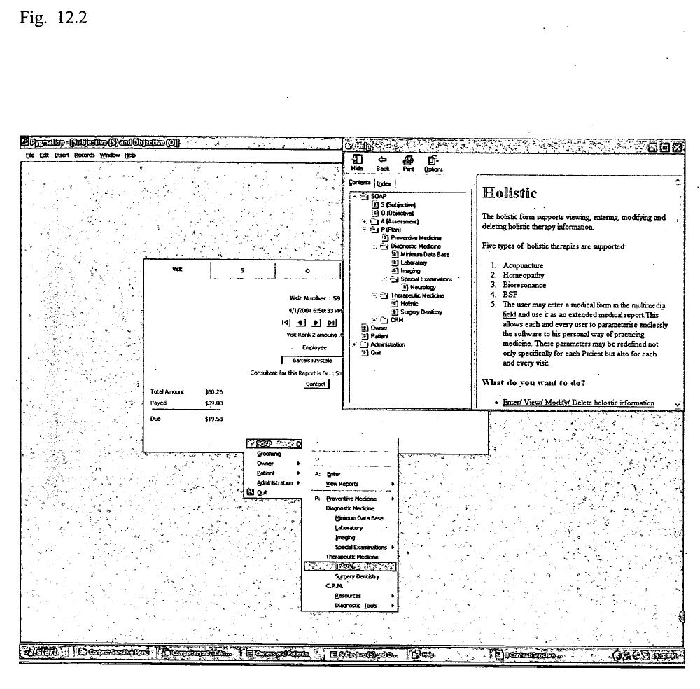

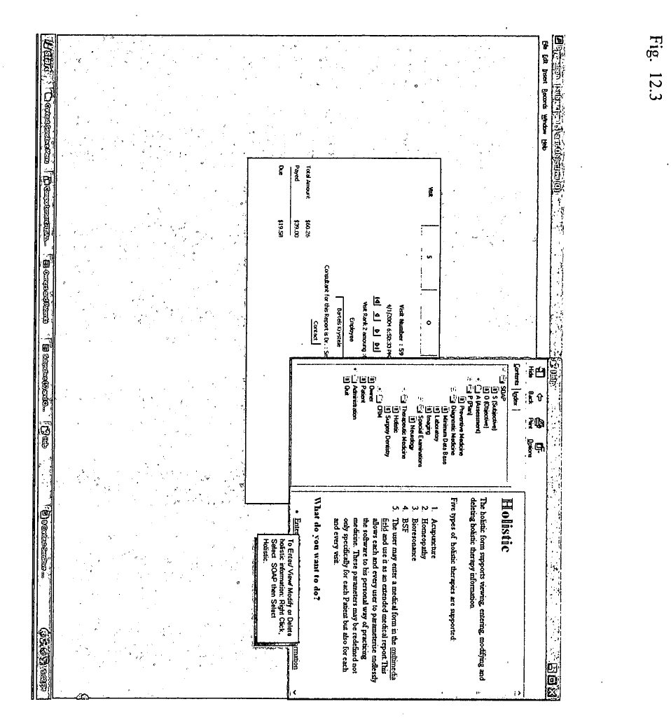

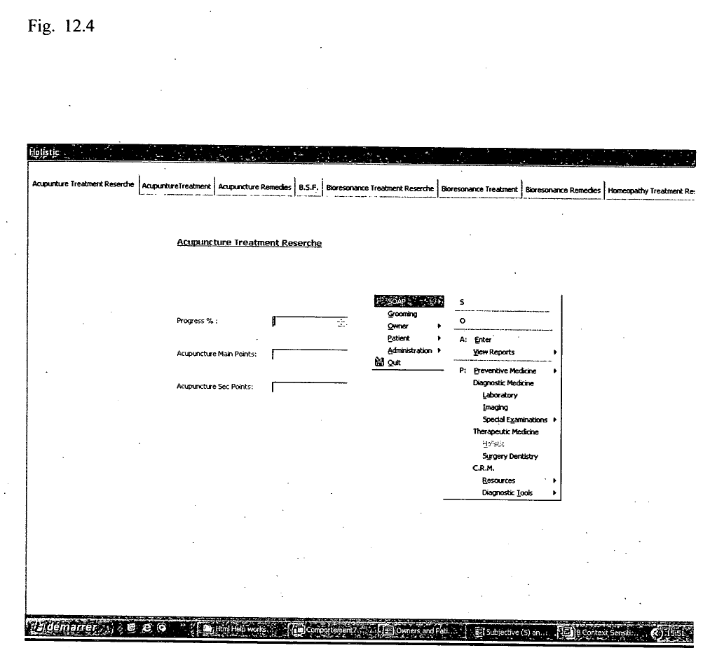

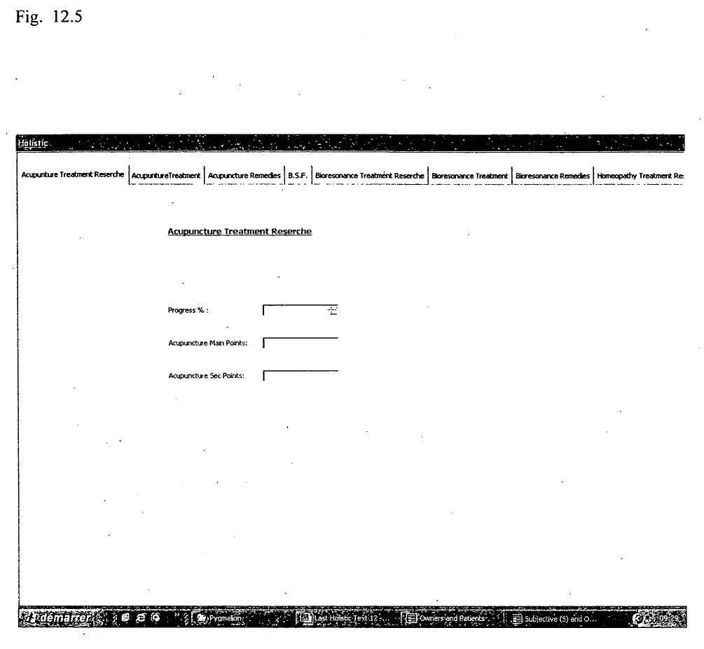

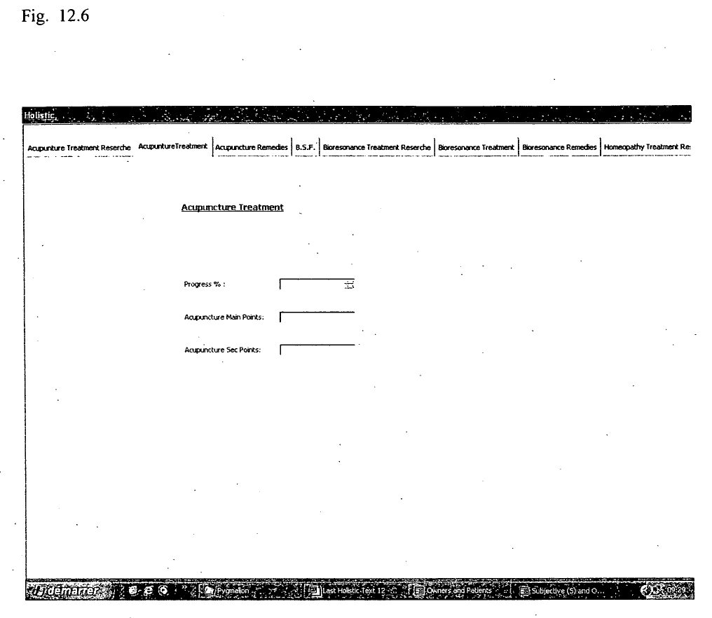

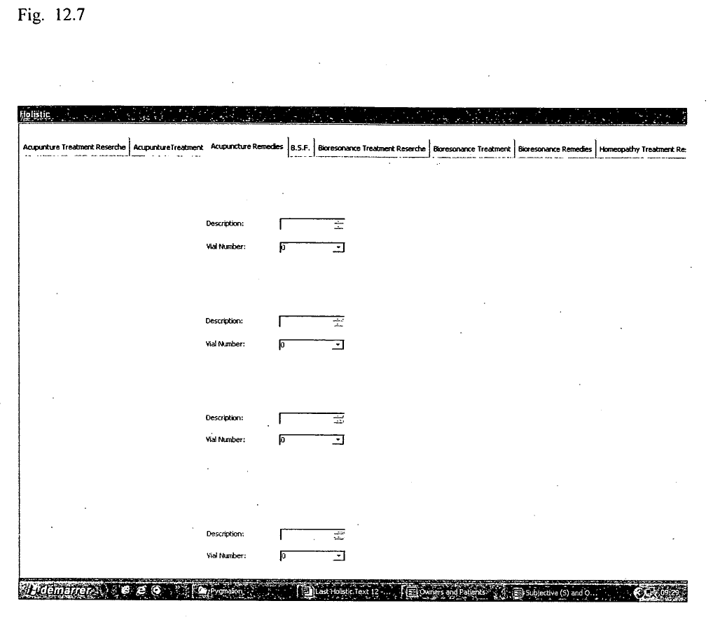

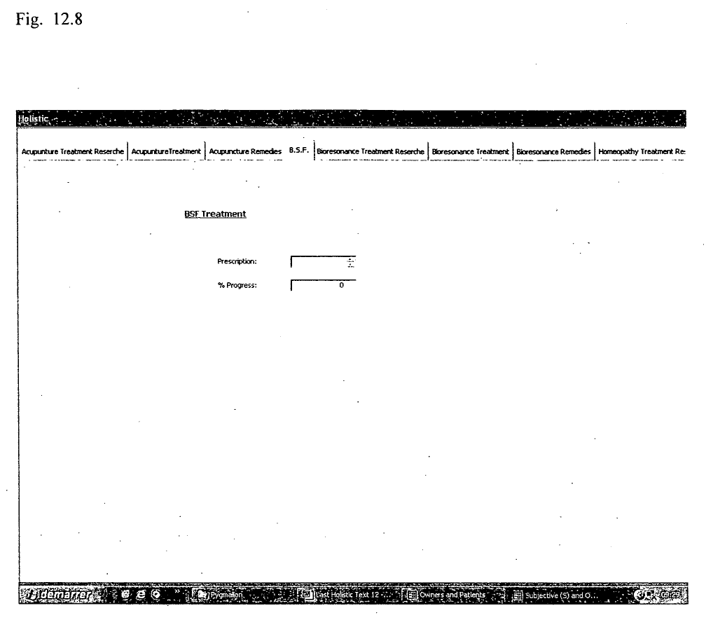

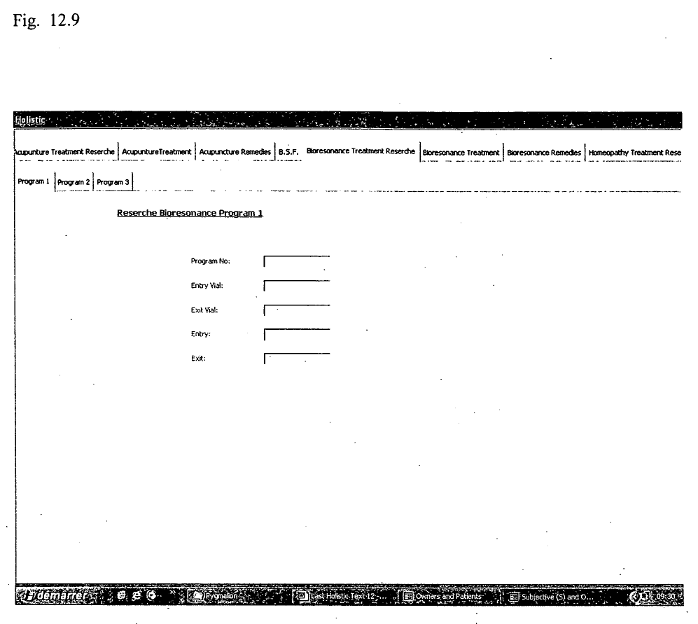

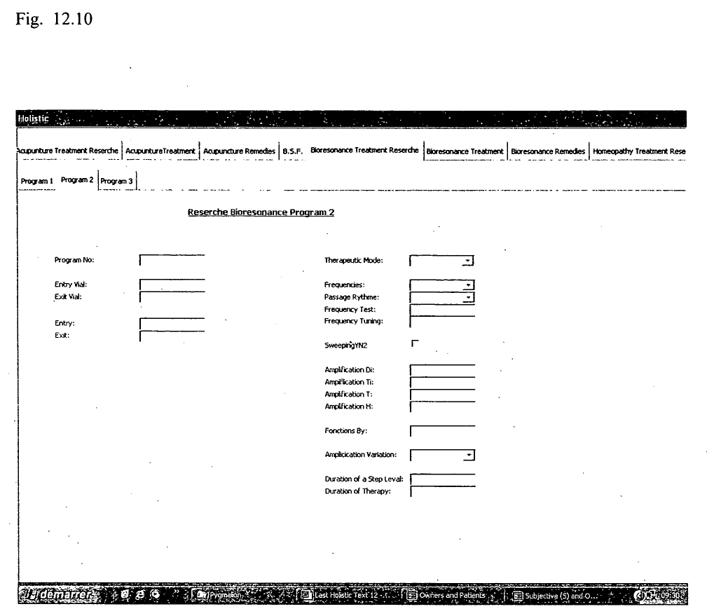

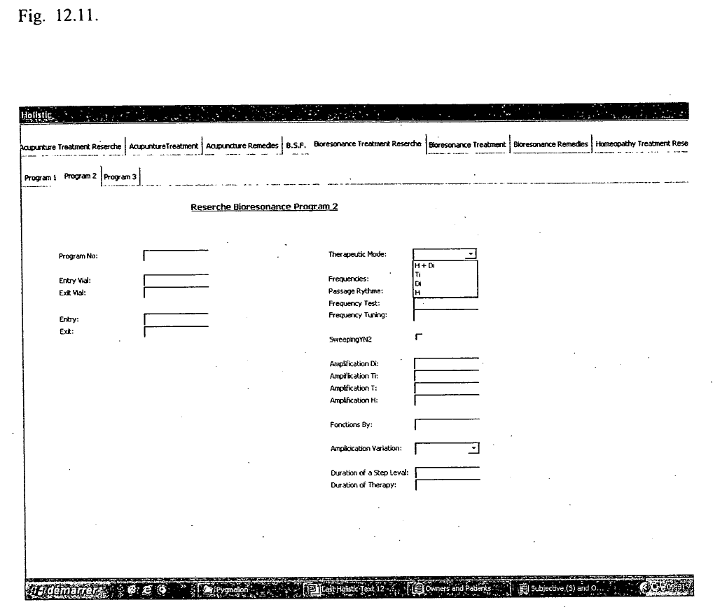

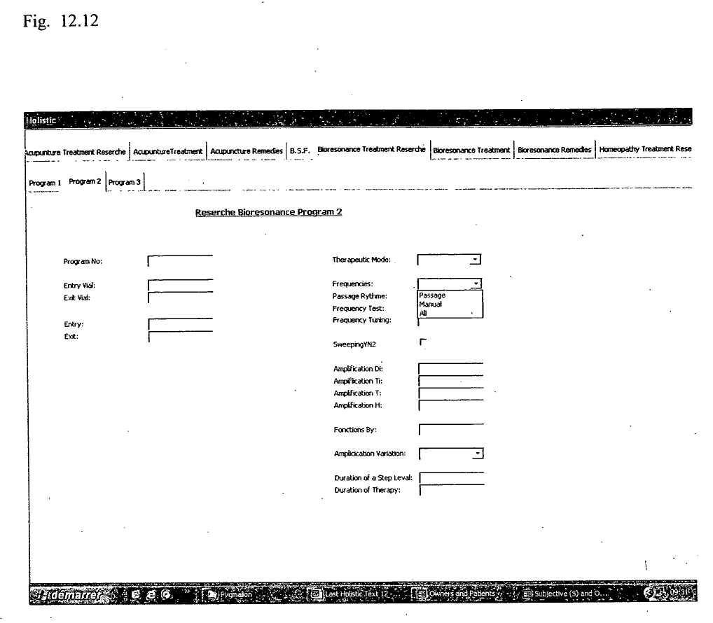

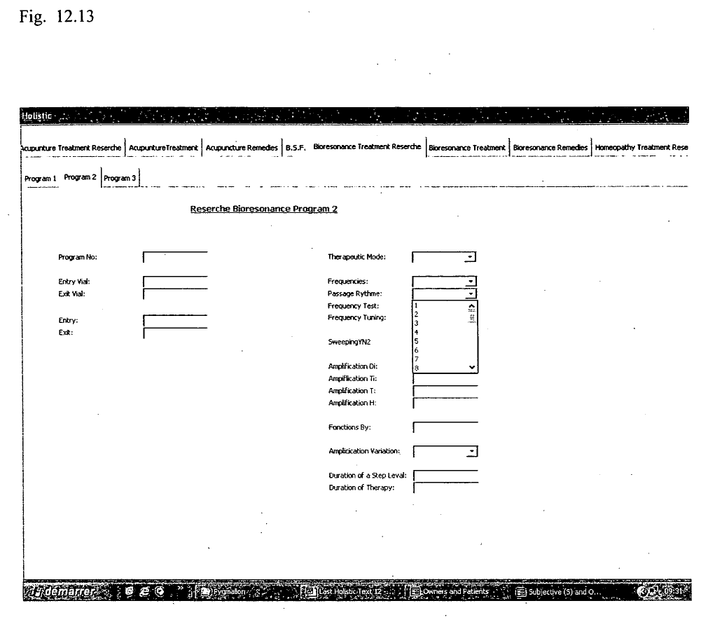

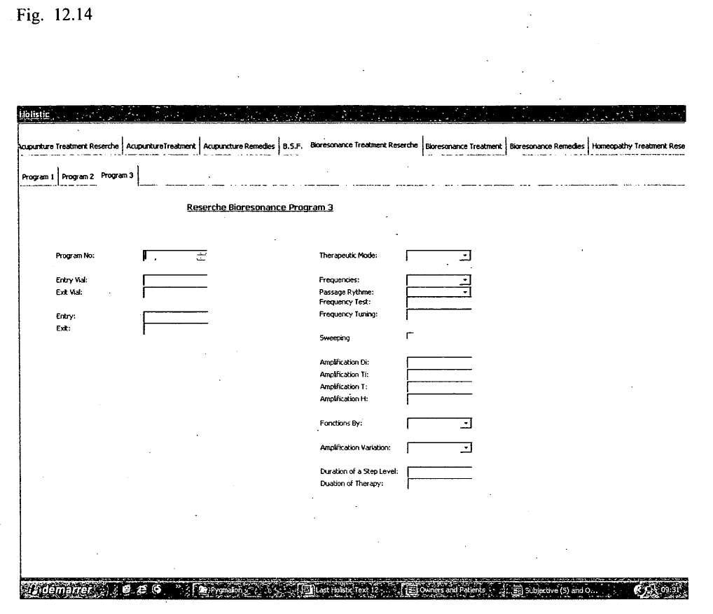

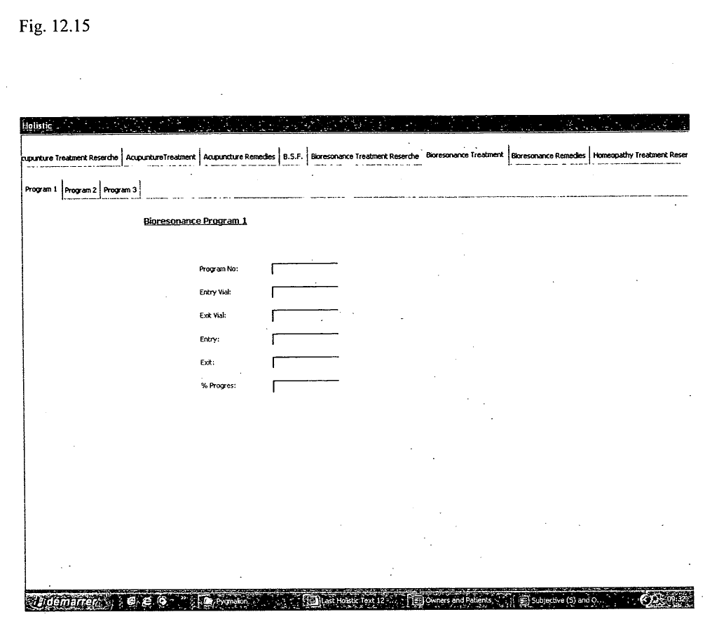

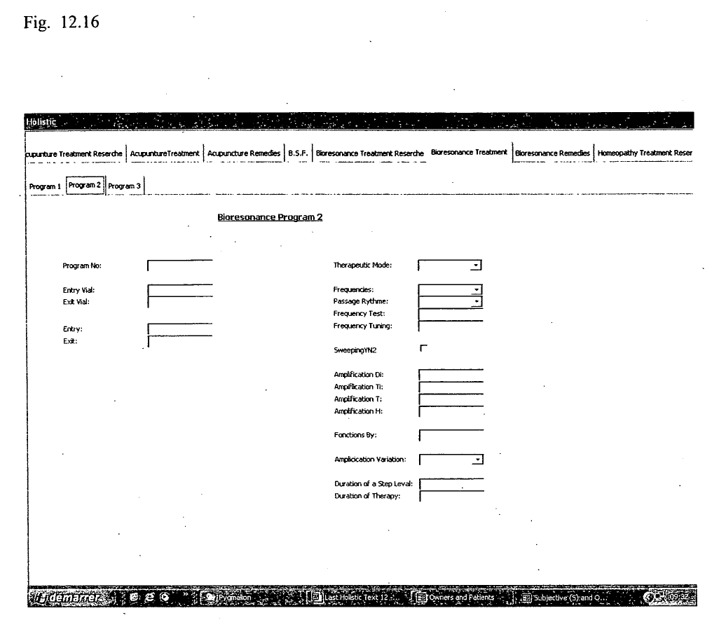

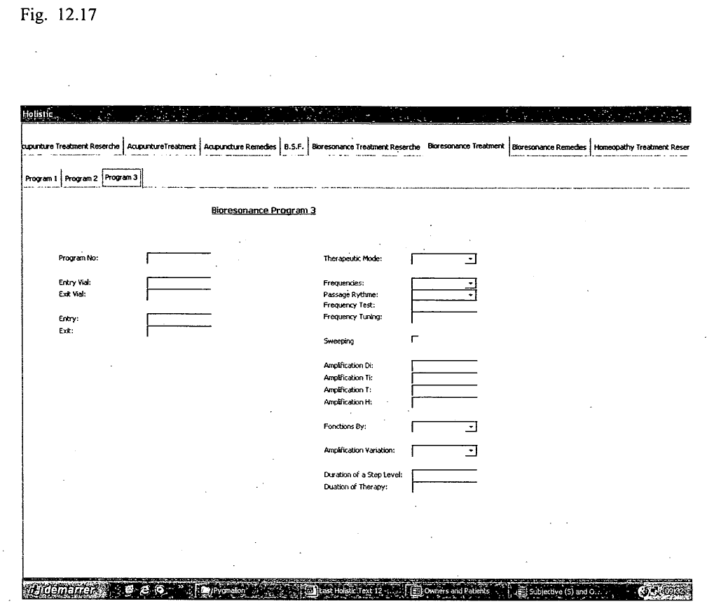

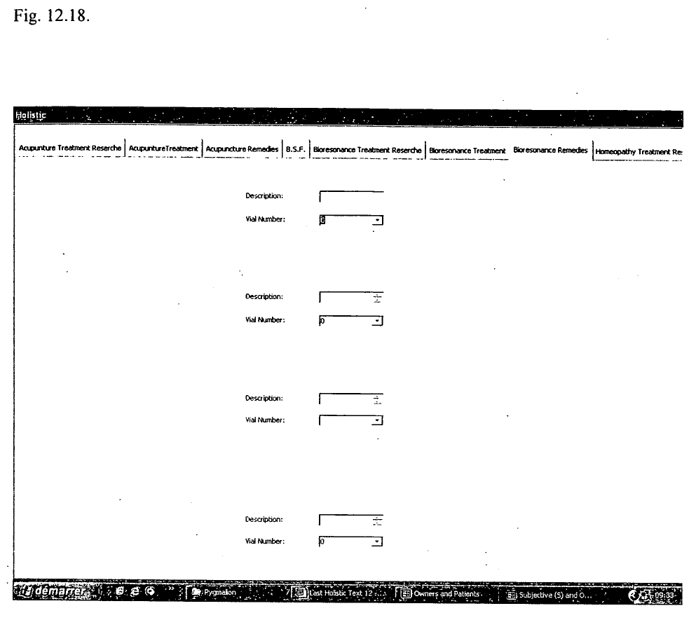

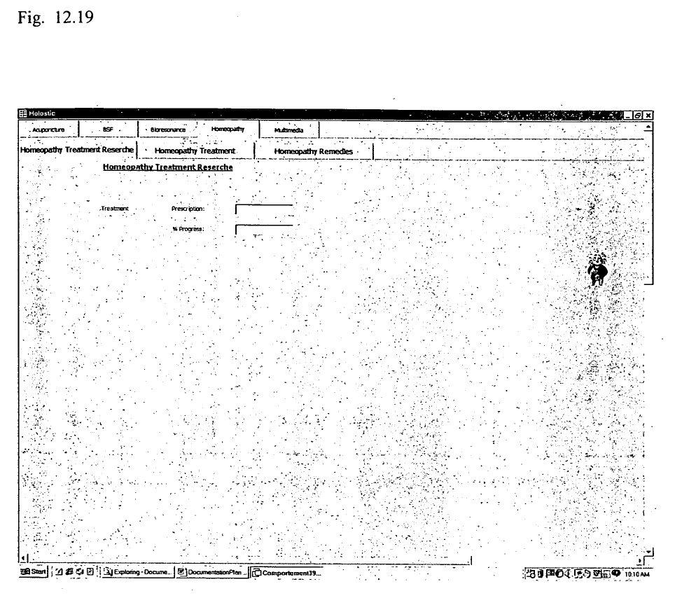

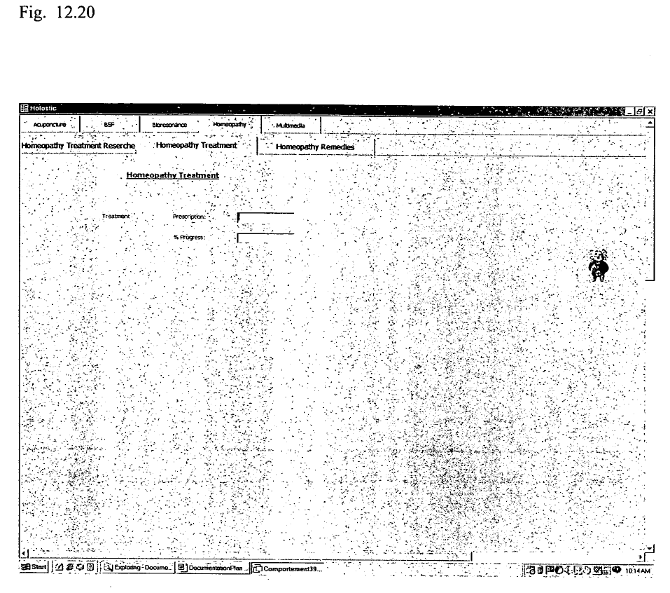

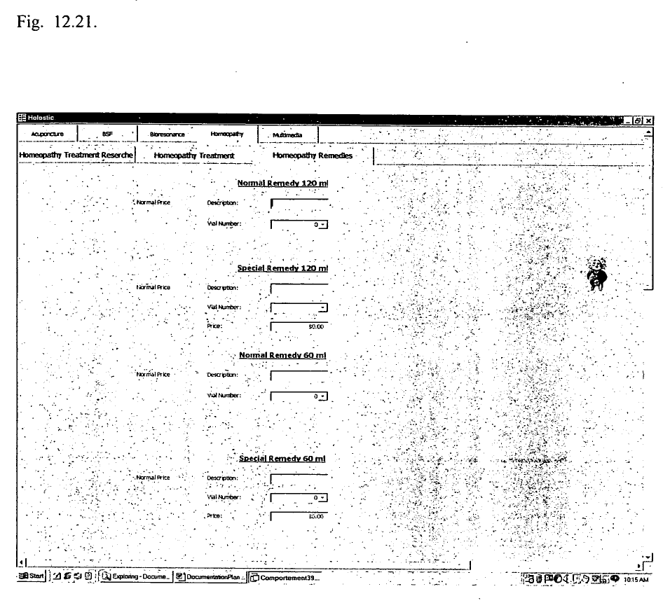

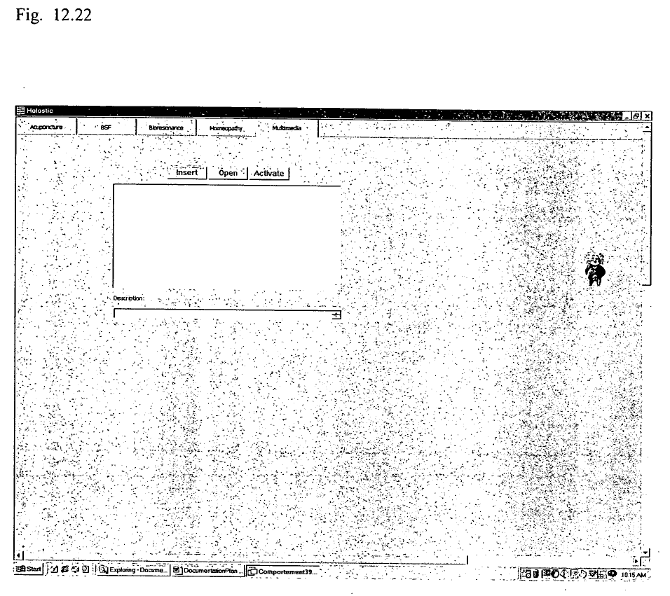

FIG. 12.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu.

FIG. 12.2 shows:

Hyperlinks in the Topic Window for the Holistic module.

FIG. 12.3 shows:

Hyperlinks when activated present additional information in a pop-up window.

FIG. 12.4 shows:

That whether a field is present; absent; enabled or disabled on the context sensitive navigation menu (which pops up with a “Right Click”), depends on the current context

FIG. 12.5 through FIG. 12.22 shows:

The Holistic Module forms.

Surgery Dentistry

The surgery/dentistry form supports entering, viewing, modifying and deleting information concerning surgery and dentistry.

This module is conceived for the entrance of all the details of surgical and dental treatments:

A. Bath Grooming

B. Anaesthesia:
i. Preanesthesia
ii. Induction
iii. Maintenance

C. Perfusion

D. Dentistry:
i. Periodontal treatment description
ii. Orthodontic treatment description

E. Surgery treatment description

F. Post Operation

G. Multimedia field: For insertion of pictures, video sequences of the treatments, vocal notes or other documents. The user may enter a medical form in the multimedia field and use it as an extended medical report. This allows each and every user to customize the software to suit personal way of practicing medicine with an unlimited number of self-defined parameters. These parameters may be redefined not only for each specific patient but also for each and every visit. The surgery/dentistry multimedia field has otherwise the same functionalities as the other multimedia fields in this application.

THIS IS THE ONLY SOFTWARE OFFERING ALL THESE FUNCTIONALITIES AT THE SAME TIME.

Remark: For compete Grooming software see our Grooming module.

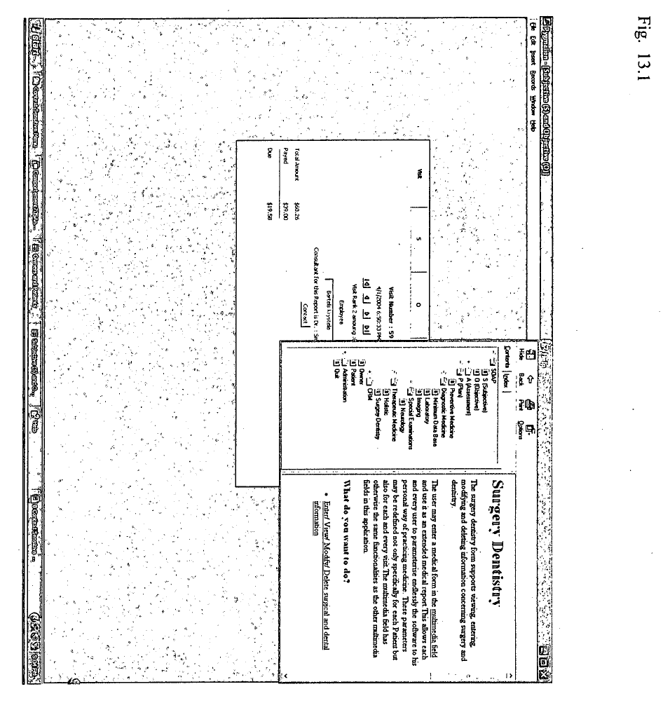

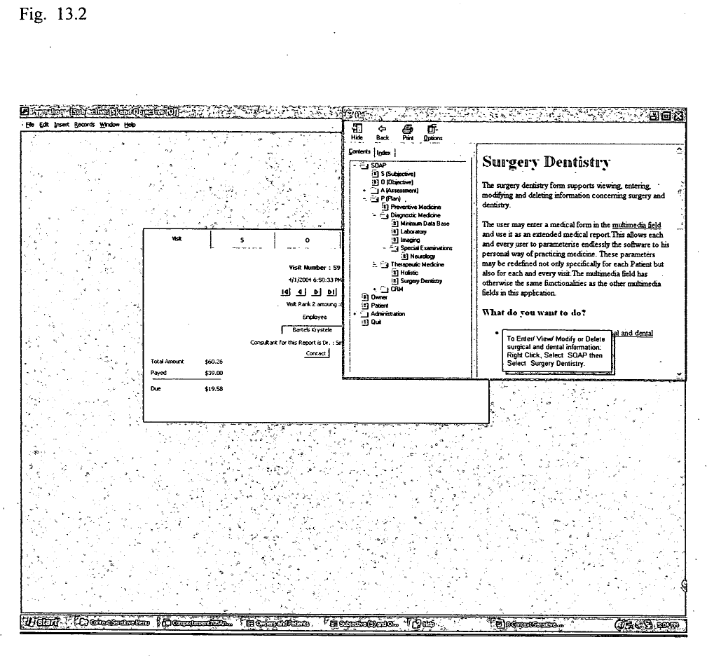

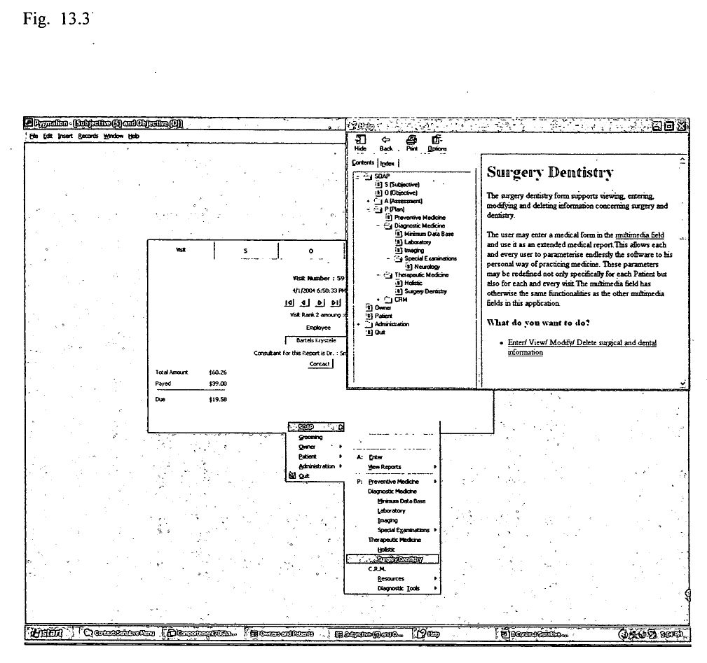

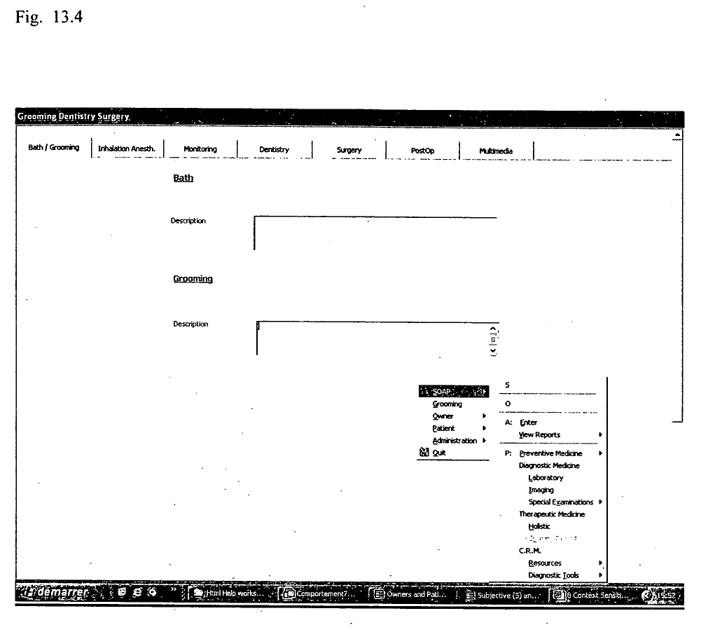

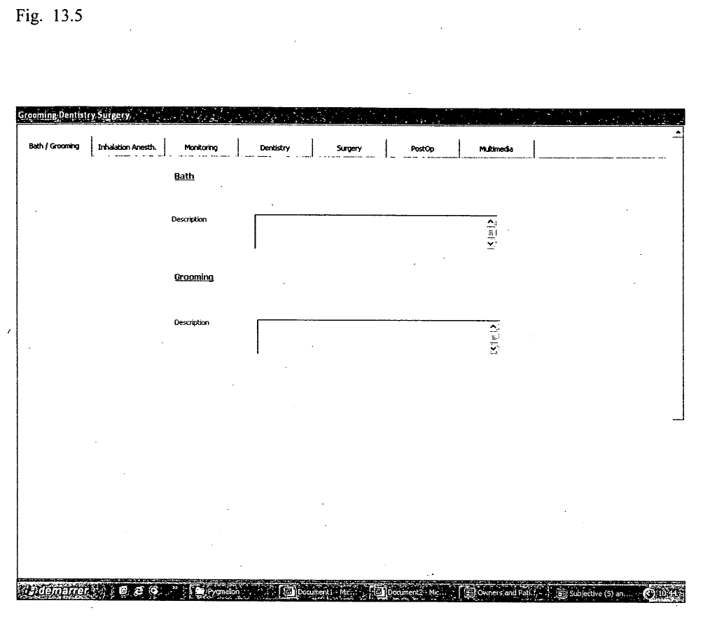

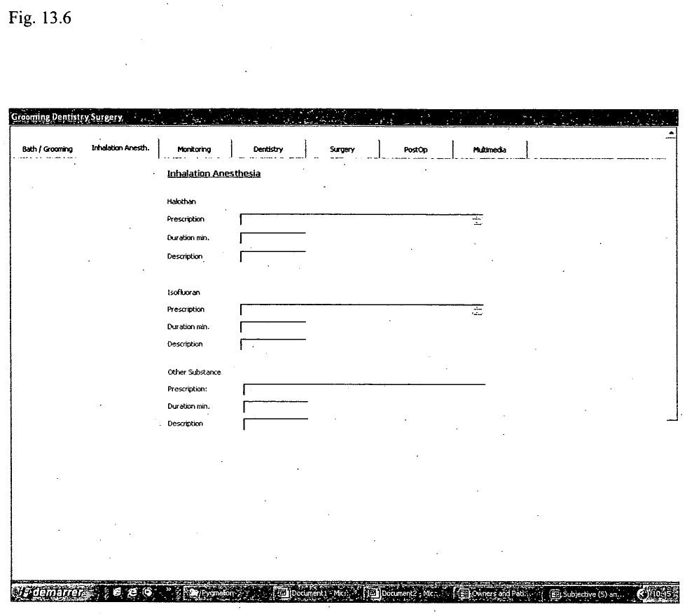

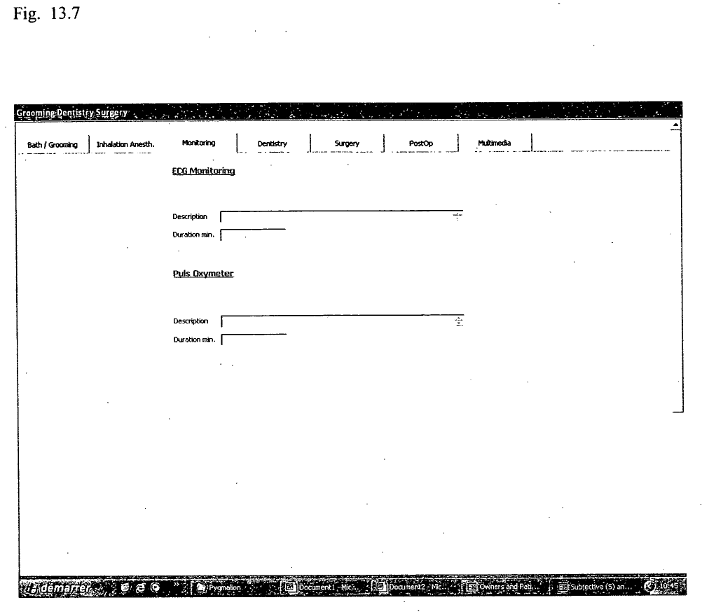

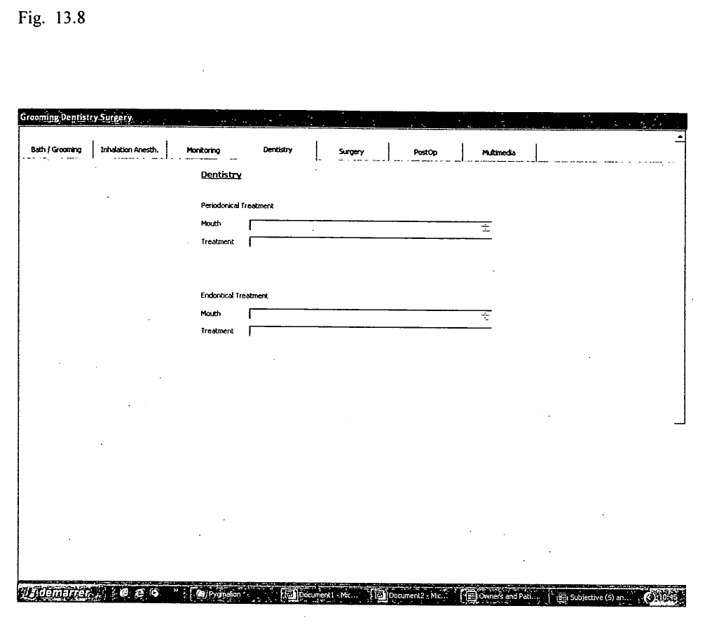

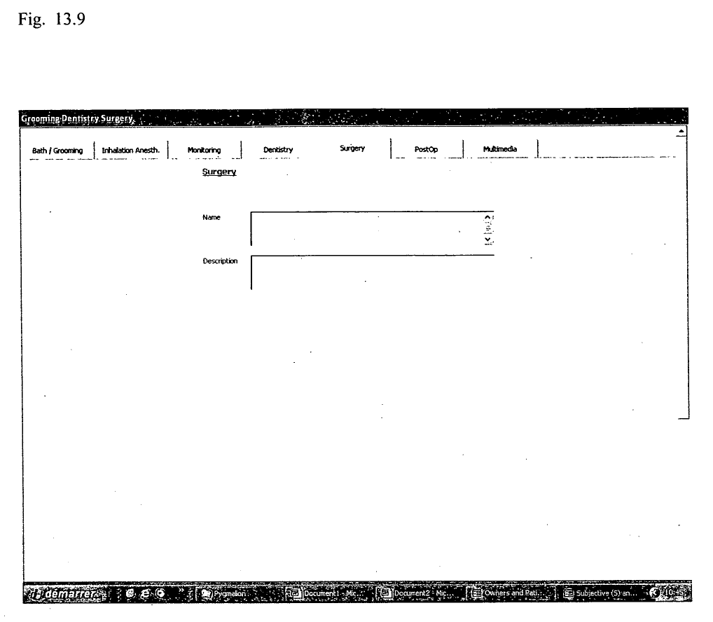

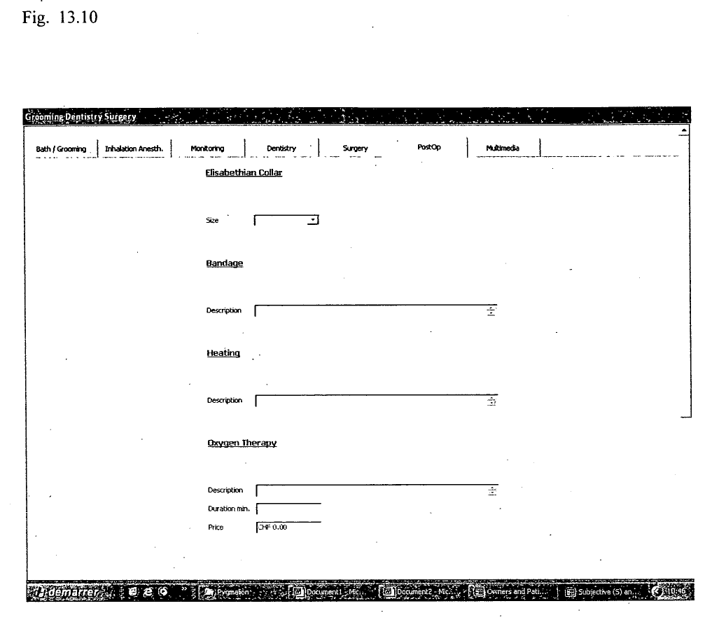

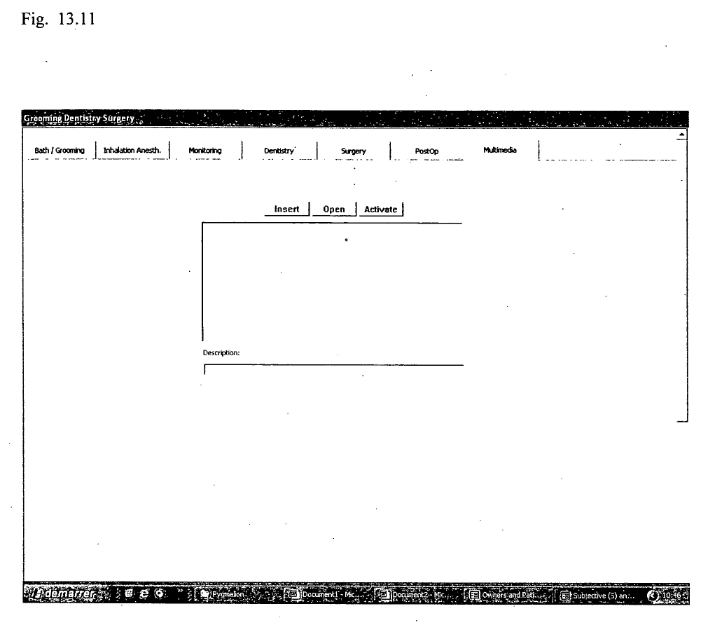

FIG. 13.1 shows:

The context sensitive Customized Help for the surgery/dentistry module.

FIG. 13.2 shows:

Hyperlinks when activated present additional information for the surgery/dentistry module in a pop-up window.

FIG. 13.3 shows:

How to allocate the surgery/dentistry module.

FIG. 13.4 shows:

That whether a field is present; absent; enabled or disabled on the context sensitive navigation menu (which pops up with a “Right Click”), depends on the current context. The example here is the surgery/dentistry modules' navigation menu.

FIG. 13.5 through FIG. 13.11 shows:

The Surgery Dentistry Module forms.

CRM and ERP

As the only medical (human and veterinary) CRM (Client Relationship Management) software, Pygmalion Concept (Trademark rights reserved) affects every step of patient interaction, whether it be marketing, sales or service-related. It allows management of the workload by distributing the chores among staff members and automates medical and business processes through workflow rules. It enables users to view and update tasks, medical cases, appointments, sales, phone calls, faxes, emails, and letters. As part of the CRM, the Artificial intelligence feature not only presents a list of possible diagnoses based on the patients' record but also delivers detailed diagnostic differentials and selects the most appropriate diagnostic procedures and information on diseases. Another valuable aspect of this CRM application is its capability of establishing a complete or edited report and, when needed, sending it directly to a consultant.

As the only medical (human and veterinary) ERP (Enterprise resource planning) software, Pygmalion Concept (Trademark rights reserved) serves the needs of people in medicine as well as it does the people in human resources, finance and inventory control. It provides full invoicing and payment recording services as well as inventory control with automatic ordering. Pygmalion Concept (Trademark rights reserved) integrates easily and powerfully with Microsoft Word, Outlook, Excel, Great Plains and other business systems.

As a result of these functionalities, this medical software may increase Profitability by decreasing work load for clinic Staff, decreasing administrative work for Doctors, and reducing management tasks (which can represent an average off 20 to 40 hours per week in a one-person veterinary practice).

Best of all, Pygmalion Concept's (Trademark rights reserved) powerful applications are easy to learn, easy to use and capable of infinite customization to fit your needs and the way you work.

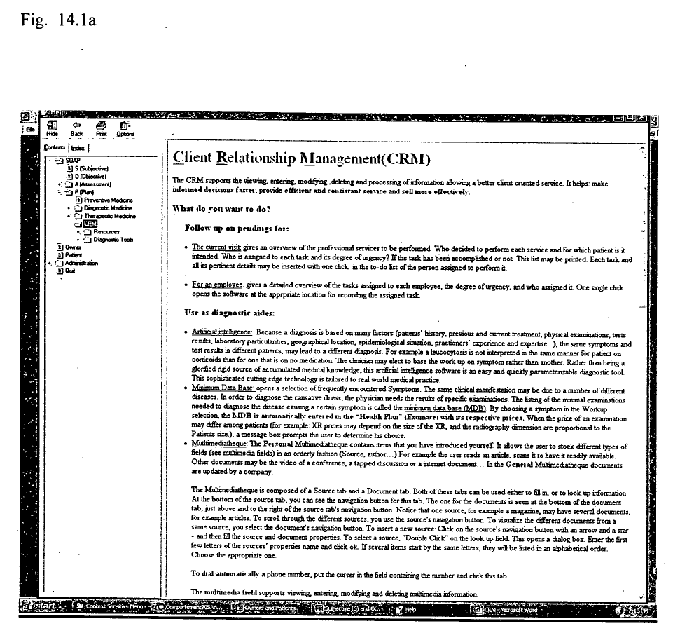

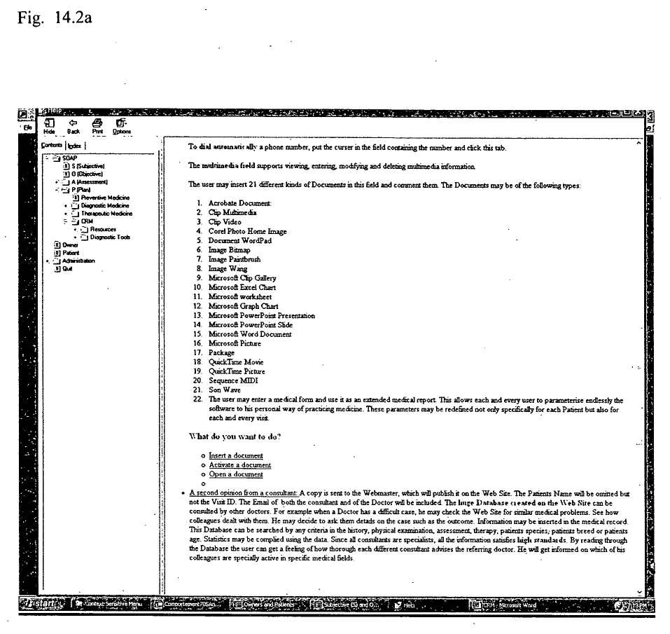

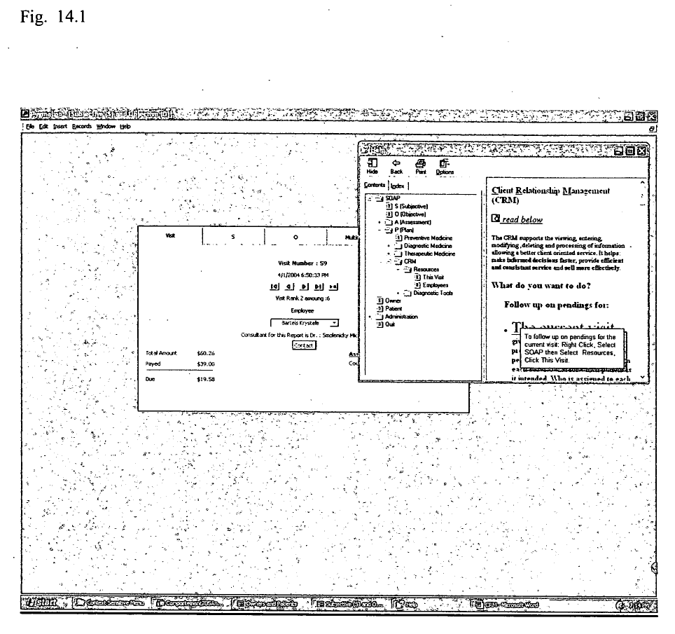

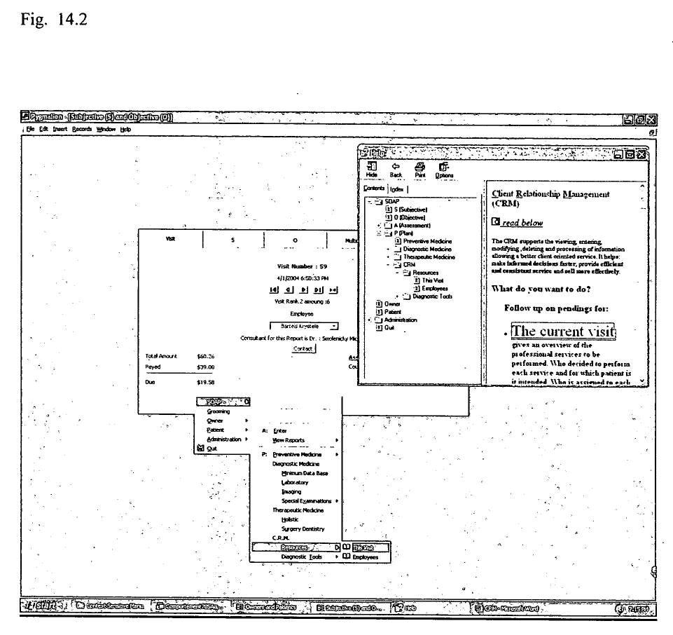

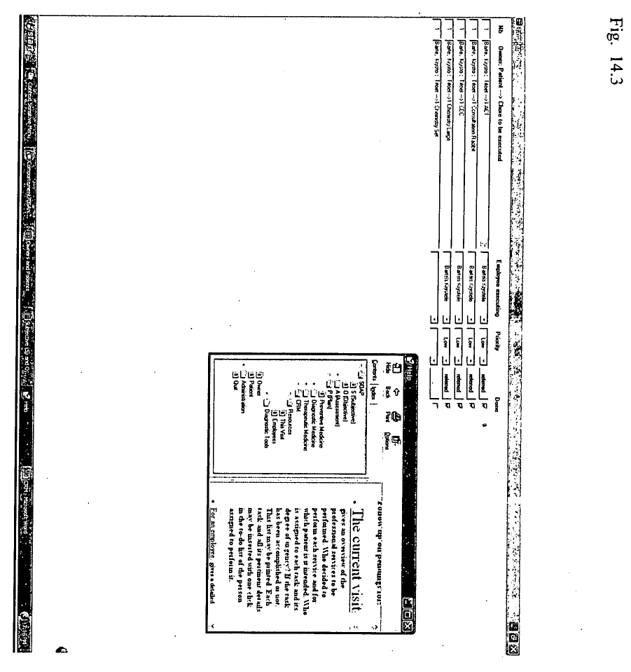

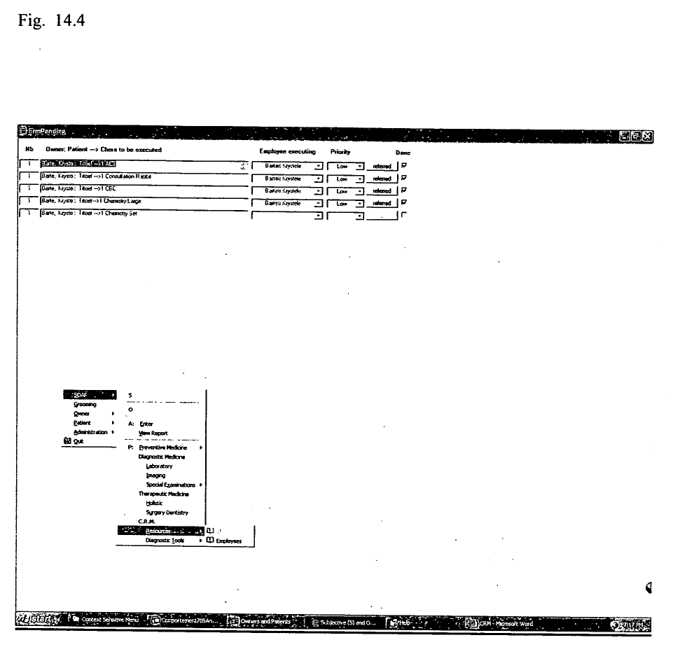

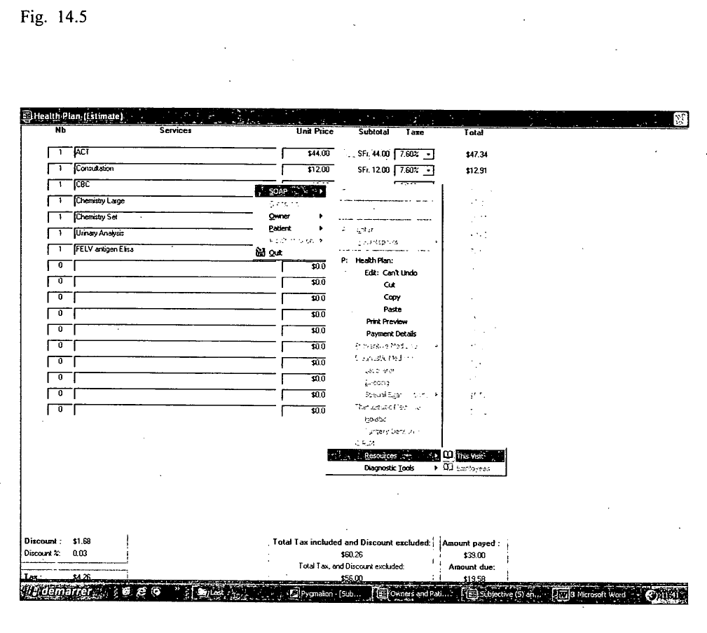

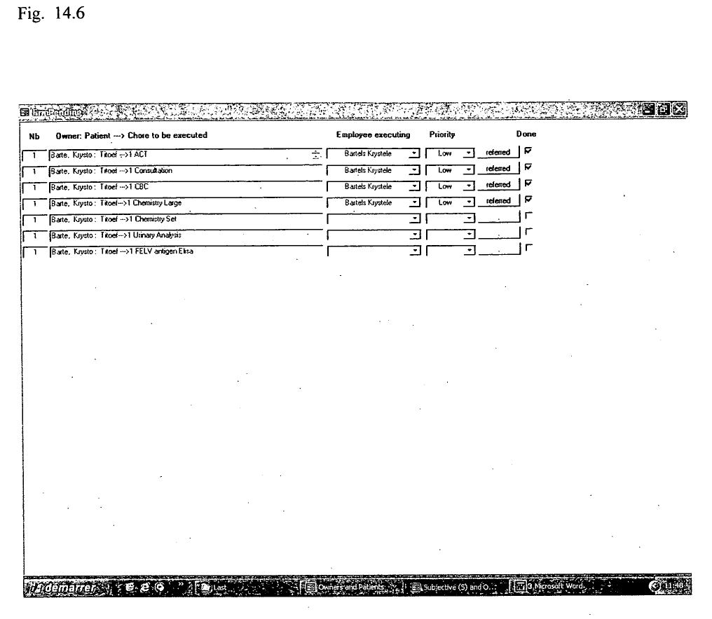

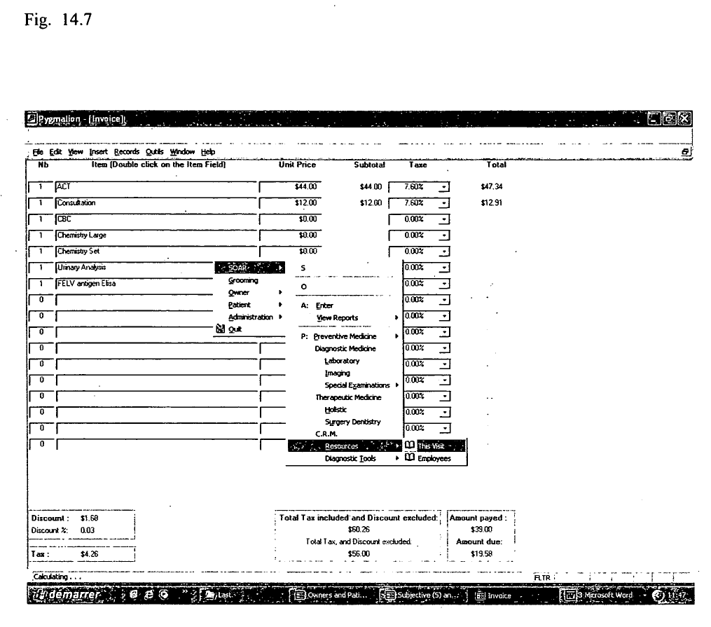

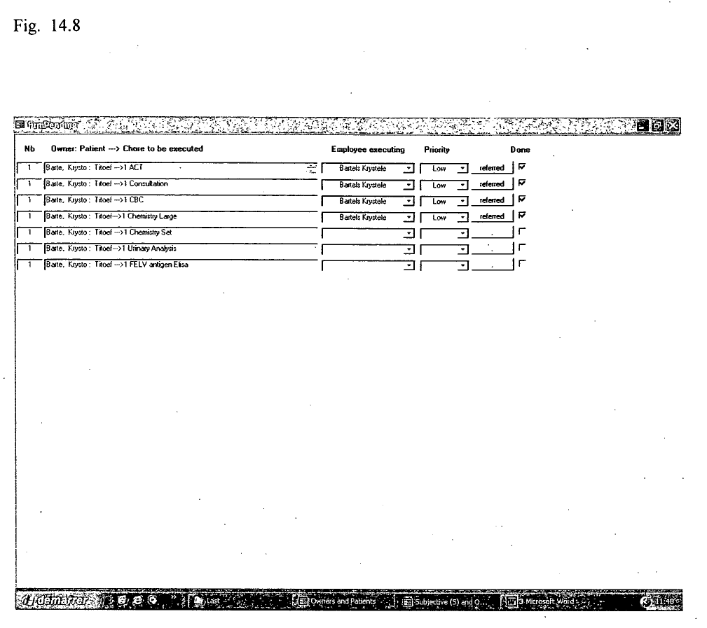

FIG. 14.1a through 14.2a shows:

The context sensitive Customized Help for the CRM.

Resources

1. This Visit

This visit gives an overview of the professional services to be performed. Who decided to perform each service and for which patient is it intended? Who is assigned to each task and what is degree of urgency? Tells if the task has been accomplished or not. This list may be printed. Each task and all its pertinent details may be inserted with one click into the to-do list of the person assigned to perform it. Their follow-up can be controlled in real time, when necessary through the Internet. This module enables precise, time-saving, stress-free communication of what must be done by each member of the staff.

FIG. 14.1 shows:

Hyperlinks when activated present additional information in a pop-up window. This pop up window indicates how to allocate the “This Visit” module.

FIG. 14.2 through FIG. 14.3:

Walks us through to this allocation.

The “This Visit” is a To-do list of all the tasks planned for one visit. It gives on one screen an overview of:
Professional services to be performed.
Who decided to perform each service and for which patient is it intended.
Who is assigned to each task and its degree of urgency.
If the task has been accomplished or not.
The list may be printed.
Each task and all its pertinent details may be with one click inserted in the to-do list of the person assigned to perform it.

FIG. 14.4 shows:

That whether a field is present; absent; enabled or disabled on the context sensitive navigation menu (which pops up with a “Right Click”), depends on the current context. The example here is for the “This Visit” module.

When this module is opened from the health plan:

FIG. 14.5 through FIG. 14.6 shows:

That if ones selects “This Visit” from the “Health Plan”, all the items of the “Health Plan” are inserted in the Pending list. The name of the consulting Doctor, the name of the Owner and the patients name are also entered. All of this is done automatically. THIS IS THE ONLY SOFTWARE OFFERING THIS FUNCTIONALITY.

When this module is opened from the “Invoice” module:

FIG. 14.7 through FIG. 14.8 shows:

That if ones selects “This Visit” from the “Invoice”, all the items of the “Bill” are inserted in the Pending list. The name of the consulting Doctor, the name of the Owner and the patients name are also entered. All of this is done automatically. THIS IS THE ONLY SOFTWARE OFFERING THIS FUNCTIONALITY.

FIG. 14.8 shows:

The following controls:

Select the Employee that is to execute the Task:

THIS IS THE ONLY SOFTWARE OFFERING THIS FUNCTIONALITY

Beside each task there is a list box with the name of all the employees. Select the one that is to perform the task.

Select the degree of urgency:

THIS IS THE ONLY SOFTWARE OFFERING THIS FUNCTIONALITY

Beside each task there is a list box with three degrees of urgencies: Low, Medium and High.

Check box:

THIS IS THE ONLY SOFTWARE OFFERING THIS FUNCTIONALITY.

The check box beside each task is clicked to indicate that a task has been completed

OK Button:

THIS IS THE ONLY SOFTWARE OFFERING THIS FUNCTIONALITY.

The “OK button” beside each task when clicked automatically enters all the information concerning the task in the employees' personal to-do list. The employee concerned is the one whose name has been selected to perform the task. The information sent is: the Owners name, the Patients name, the task, the degree of urgency, the consulting Doctor, the date the task was decided and the visits ID Number. Once the “OK button” has been selected, the word “referred” appears on the button to let the user know that the task has been referred to the member of the staff named beside.

Employees

Diagnostic and therapeutic procedures may be distributed among staff members just with a few mouse clicks. Their follow-up can be controlled in real time, when necessary through the Internet. This module enables precise, time-saving, stress-free communication of what must be done by each member of the staff.

An inestimably valuable feature of Pygmalion Concept (Trademark rights reserved) is that when scrolling through the “to-do list”, a single mouse click brings the user to the precise location in the patient's record where the procedure should be entered. This functionality avoids misplacing the results of a procedure, reduces stress and is extremely time saving. The use of this system prevents forgetting to execute a procedure or invoicing one that should have been but has not been done. Additionally, the busier the day, the more prone we are to involuntarily omit billing items. This is thus a valuable money-saving aspect.

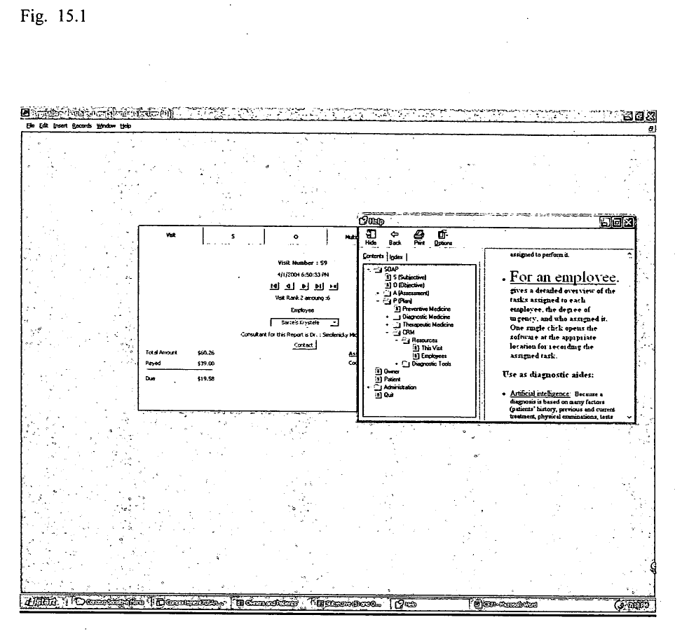

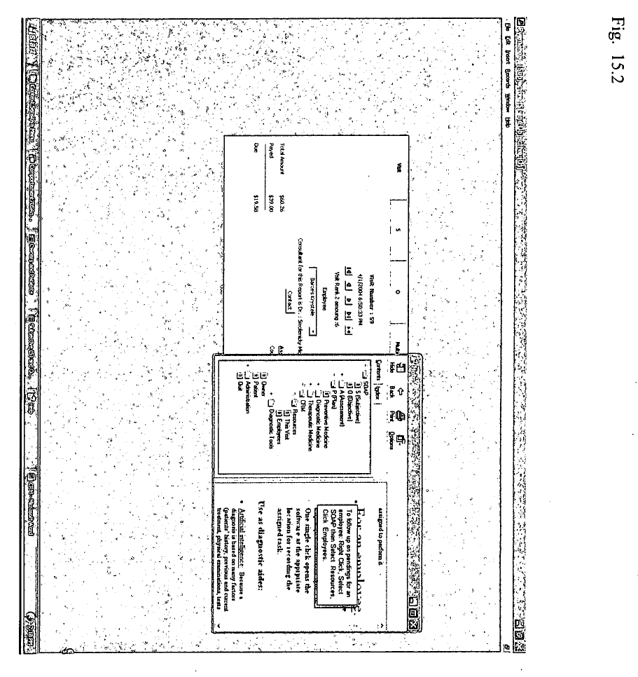

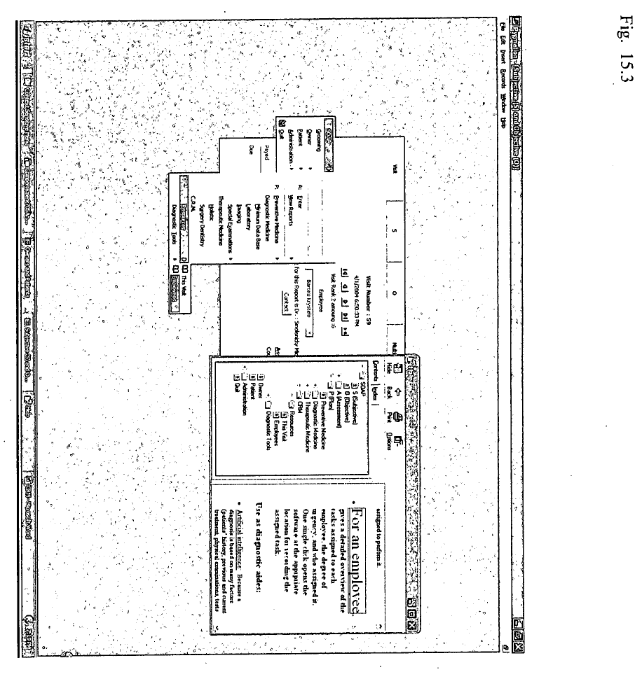

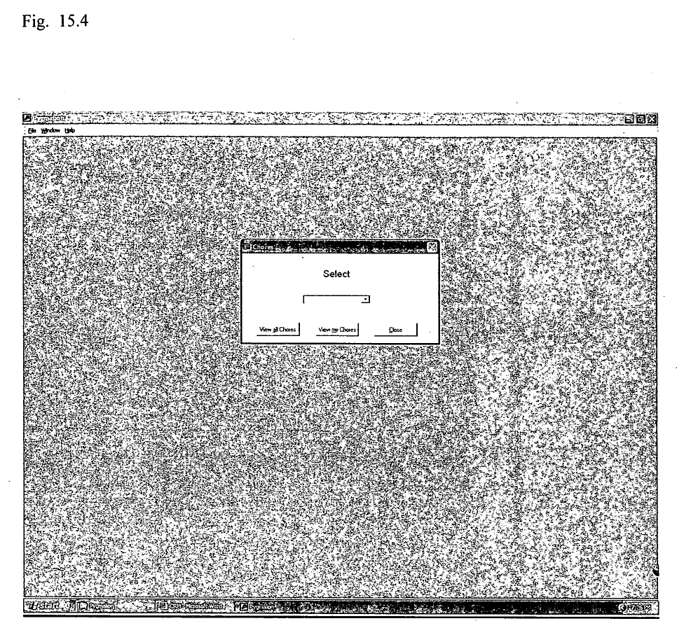

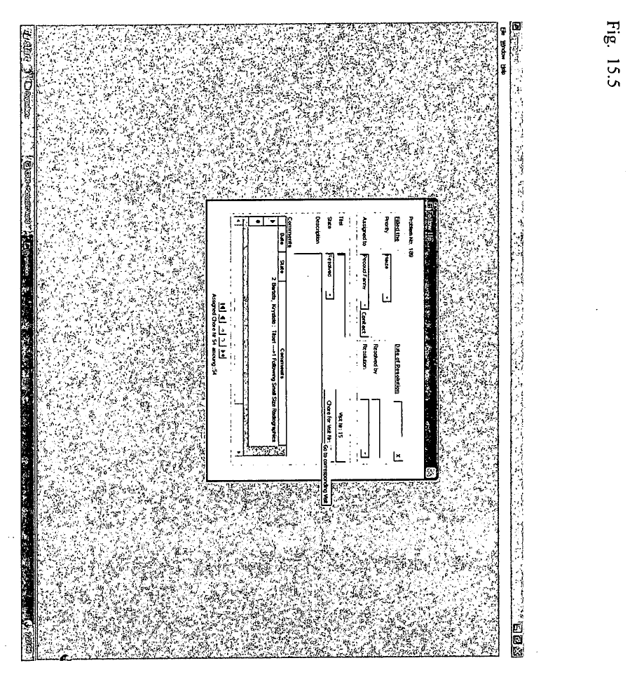

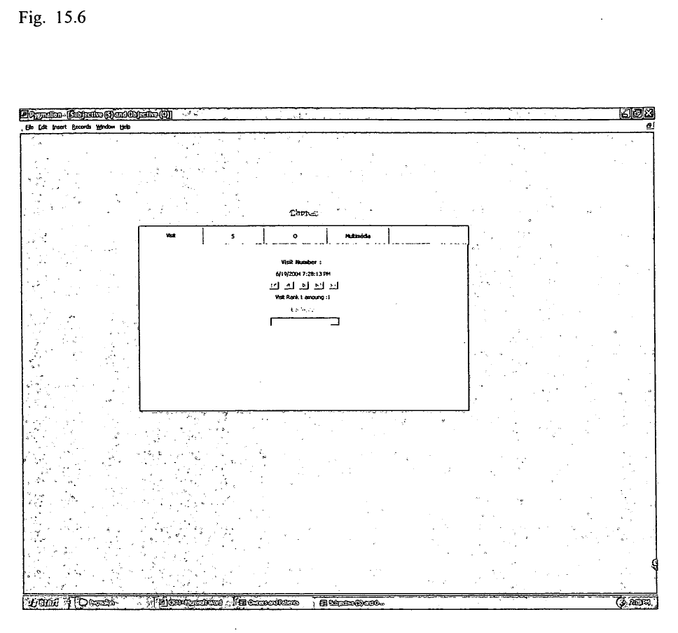

FIG. 15.1 shows:

The context sensitive Customized Help for the Employees module.

FIG. 15.2 shows:

Hyperlinks when activated present additional information in a pop-up window. This pop up window indicates how to allocate the “Employees” module.

FIG. 15.3 through FIG. 15.5:

Walks us through to how to allocate the “Employees” module.

FIG. 15.5 shows:

A dialog box asking to choose between viewing the To-do list of all the employees or only of a specific one. Each Task has the following details that may be indicated:
i. The Tasks description
ii. The Who is to execute the Task:

The task will be automatically reassigned to another person by changing the name in the list box.
iii. Who assigned the Task
iv. The degree of urgency:

One among three degrees may be selected: Low, Medium and High.
v. The state of execution
vi. If the task concerns a visit:

THIS IS THE ONLY SOFTWARE OFFERING THESE FUNCTIONALITIES.

The Owners name, the Patients name, the consulting Doctor, the Visit ID Number.
vii. Controls:
“Contact” button:

Opens a Outlook Folder in which one may either insert or view the personal data of the employee to which the task is assigned to.
“Visit No” button:

THIS IS THE ONLY SOFTWARE OFFERING THESE FUNCTIONALITIES

The Visit ID number labels automatically this button. One click opens this visit so that the task may readily be accomplished.
“Pending list” button:

THIS IS THE ONLY SOFTWARE OFFERING THESE FUNCTIONALITIES.

One click opens the To-do list (Planning this Visit)for the visit that is indicated on the “Visit No” button.

FIG. 15.5 shows:

The tab button marked “Chores for Visit Nr: Vist number ID”

FIG. 15.6 shows:

That clicking on the tab button marked “Chores for Visit Nr: Vist number ID” will bring the user to the corresponding visit. From now on the user is in the software at the precise visit where the chore must be entered. This whole Visit (SOAP) is labeled with the word “chores” in red. This reminds the user that a specific task must be accomplished.

This invention provides the only medical (human and veterinary) CRM (Client Relationship Management) software. This invention affects every step of patient interaction, whether it is marketing, sales or service-related. It allows management of the workload by distributing the chores among staff members and automates medical and business processes through workflow rules. It enables users to view and update tasks, medical cases, appointments, sales, phone calls, faxes, emails, and letters. This module enables precise, time-saving, stress-free communication of what must be done by each member of the staff with its degree of urgency.

This invention allows the Follow-Up of diagnostic, therapeutic and other procedures to be distributed among staff members just with a few mouse clicks. Their follow-up can be controlled in real time, when necessary through the Internet.

An inestimably valuable and unique feature of this invention is that when scrolling through the “to-do list”, a single mouse click brings the user to the precise location in the patient's record where the procedure should be entered. This functionality avoids misplacing the results of a procedure, saves time and is very ergonomic at use. The use of this system prevents forgetting to execute a procedure or invoicing one that should have been but has not been done. Additionally, the busier the day, the more prone we are to involuntarily omit billing items. This is thus a valuable money-saving aspect.

This medical software may increase Profitability: decreased work load for clinic Staff, decreased administrative work for Doctors, and reduction in management tasks (which can represent an average off 20 to 40 hours per week in a one-person veterinary practice).

Artificial Intelligence

Because Pygmalion Concept (Trademark rights reserved) is designed to help doctors make informed decisions faster, the integrated artificial intelligence presents a list of possible diagnoses based on the patients' record. Each diagnosis is detailed with its symptoms, each of which is rated according to its relative probability of being appropriate for the current patient, the reasons why it has been chosen and additional tests needed to confirm it as the diagnosis. This is the only medical software with a context-sensitive source of information on diseases and medical procedures based upon the patients report.

Depending on the clinical signs present, a certain number of diagnostic aids (CBC; blood chemistry; urine analysis; electro-physiology; diagnostic imaging; biopsy etcertera . . . ) may be recommended to establish a diagnosis and management plan.

A pre-determined set of diagnostic procedures for each type of patient or problem helps minimize diagnostic errors, saves time, and is generally more cost-effective and better tolerated by clients. Because this fast and easy-to-use approach avoids omitting laboratory tests, Pygmalion Concept (Trademark rights reserved) can make a better use of laboratory services.

Because a diagnosis is based on many factors (patients' history, previous and current treatment, physical examinations, tests results, laboratory particularities, geographical location, epidemiological situation, practioners' experience and expertise, etcetera . . . ), the same symptoms and test results in different patients, may lead to different diagnoses. For example, a leucocytosis is not interpreted in the same manner for a patient on corticoids as for one that is on no medication. The clinician may elect to base the work-up on one symptom rather than another. In our example of a patient under corticoid treatment, the clinician will not use the leucocytosis as an important diagnostic criterion. Rather than being a rigid source of accumulated medical knowledge, this artificial intelligence software is an easy to use diagnostic tool whose parameters can be quickly customized to meet the needs of each individual case

Thanks to this context-sensitive source of information on diseases and medical procedures, as well as the use of artificial intelligence, Pygmalion Concept (Trademark rights reserved) assists even the best-experienced doctor to achieve a higher standard of medicine.

Because each patient record has an area for insertion of supplementary relevant information (extended data base) such as a document that the doctor has scanned, a link to a streaming tutorial video on how to take a bone marrow biopsy or a trans-tracheal wash specimen, or a link to the Real Case Reference Database. This invention is the only medical software in which context-sensitive tutorials can be implemented by the user and by the software company. This invention assures that patients receive the highest standard of treatment available.

Each diagnosis is based on the patients' current record and is personalized and customized to: 1) the doctors' way of practicing medicine, 2) the patient, and 3) the context.

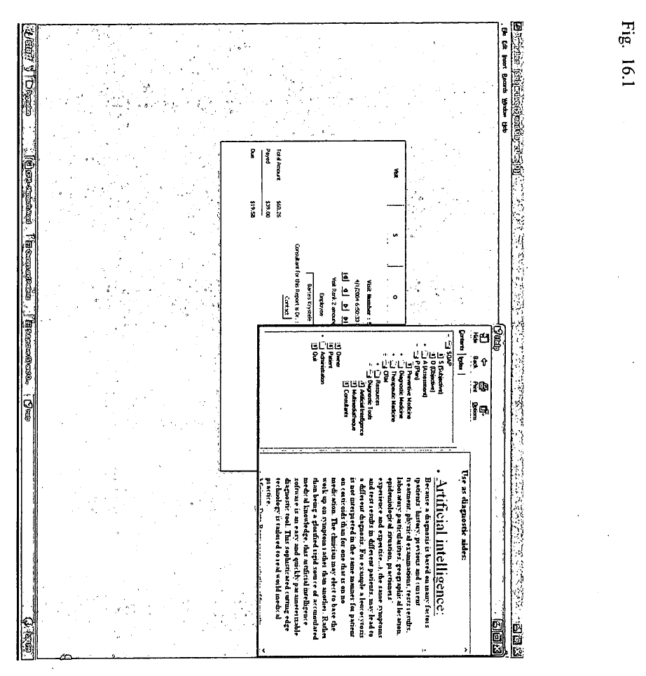

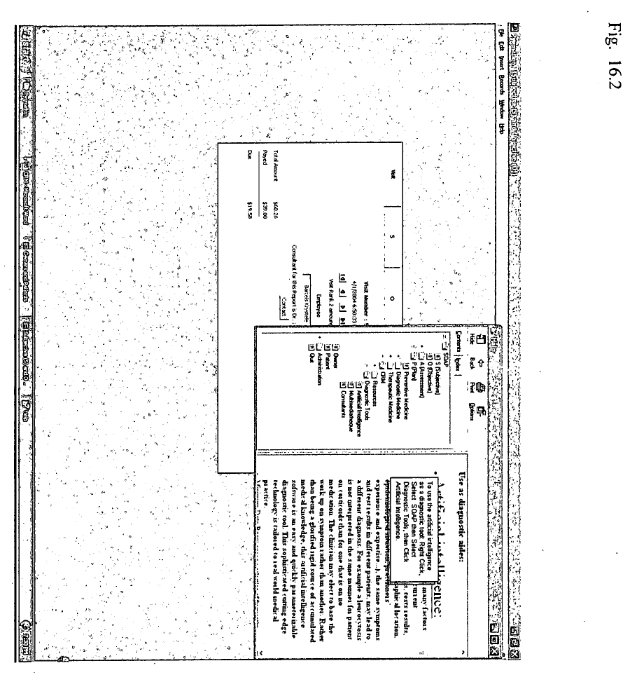

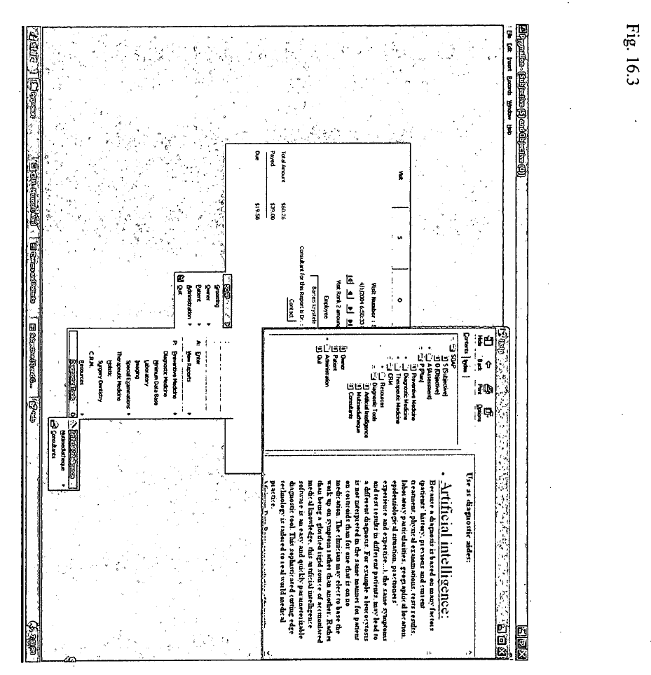

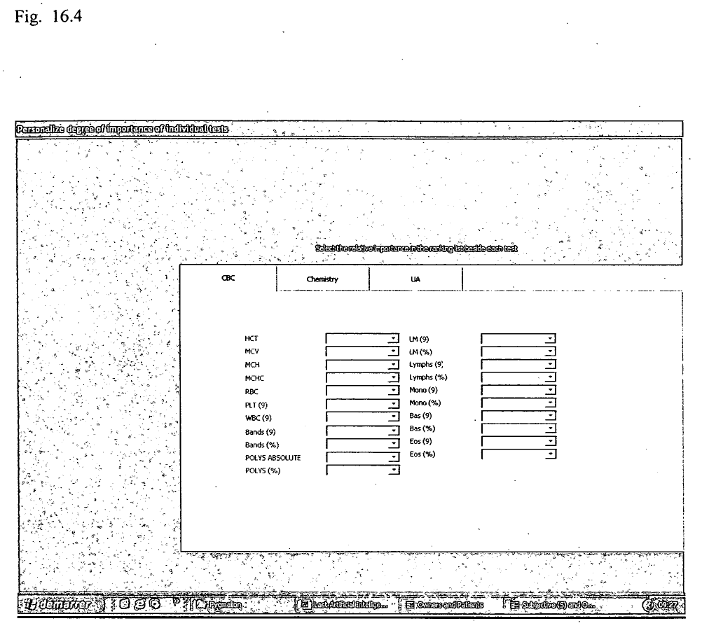

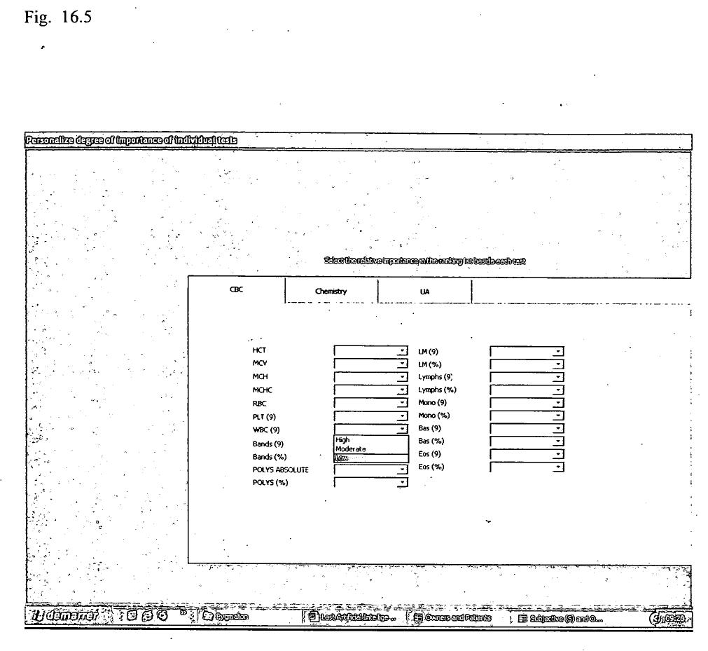

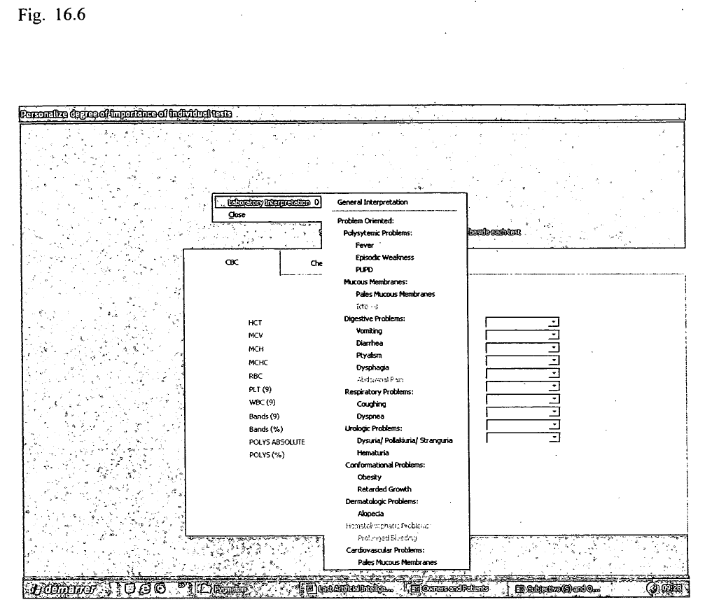

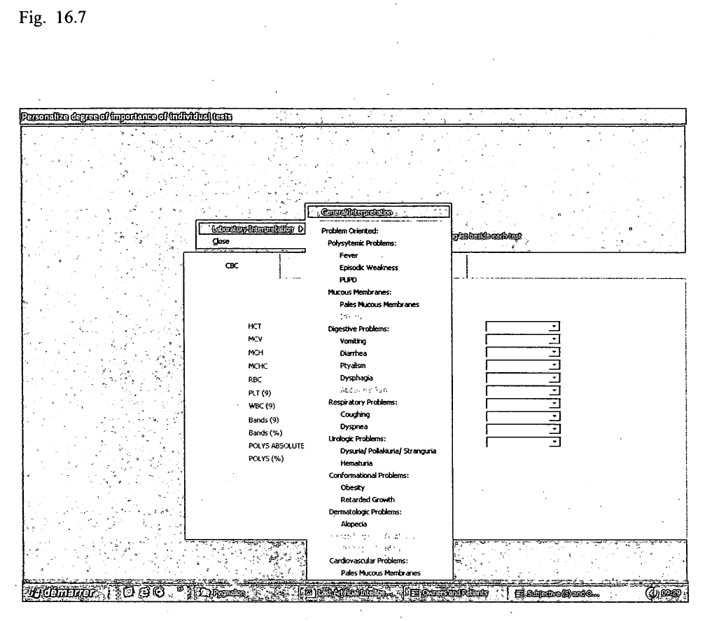

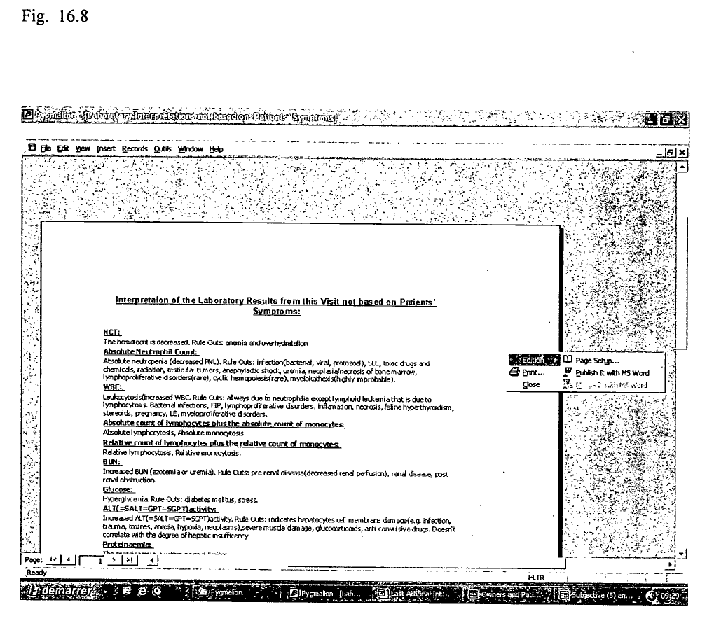

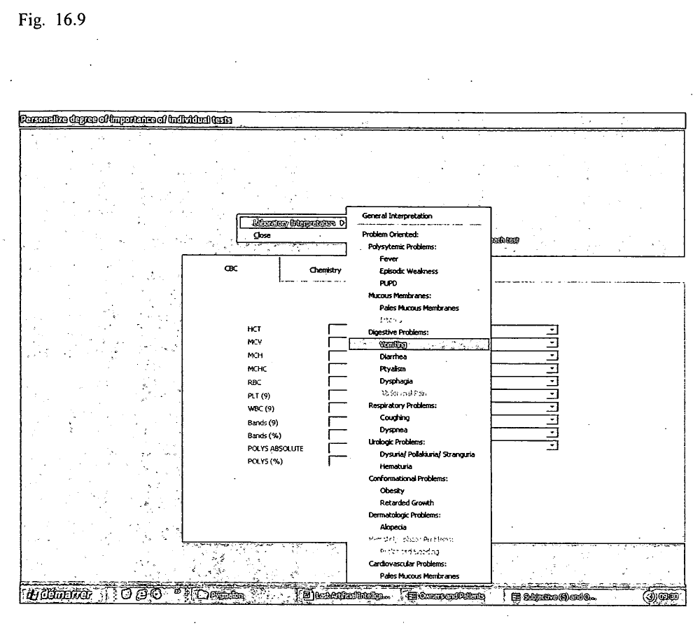

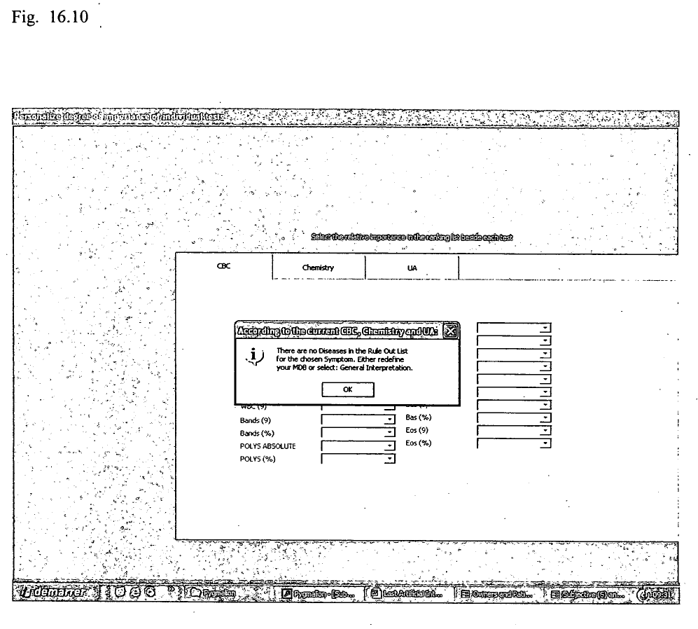

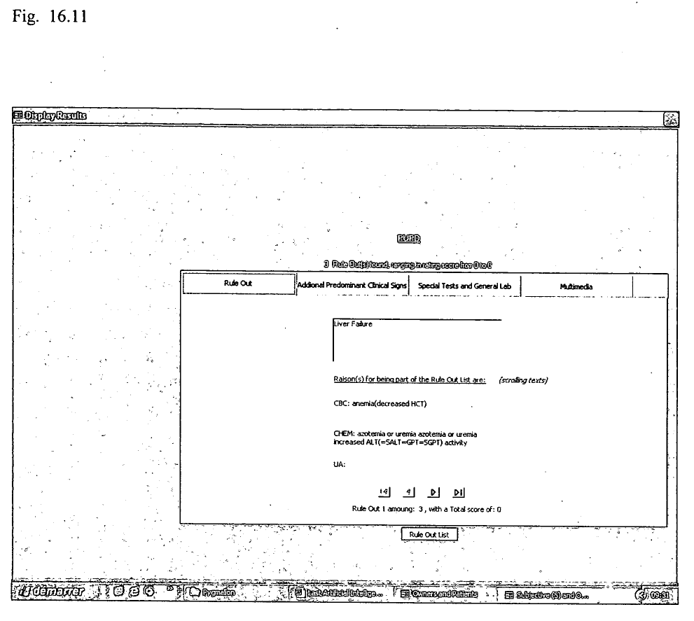

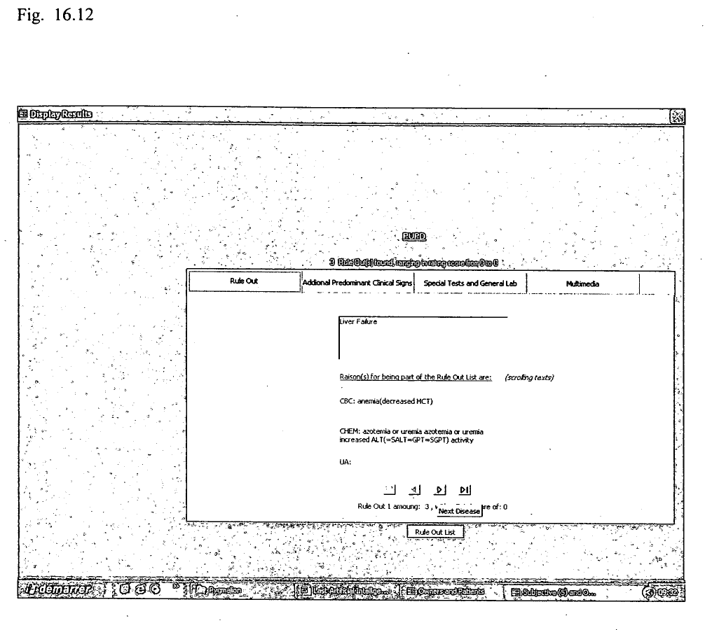

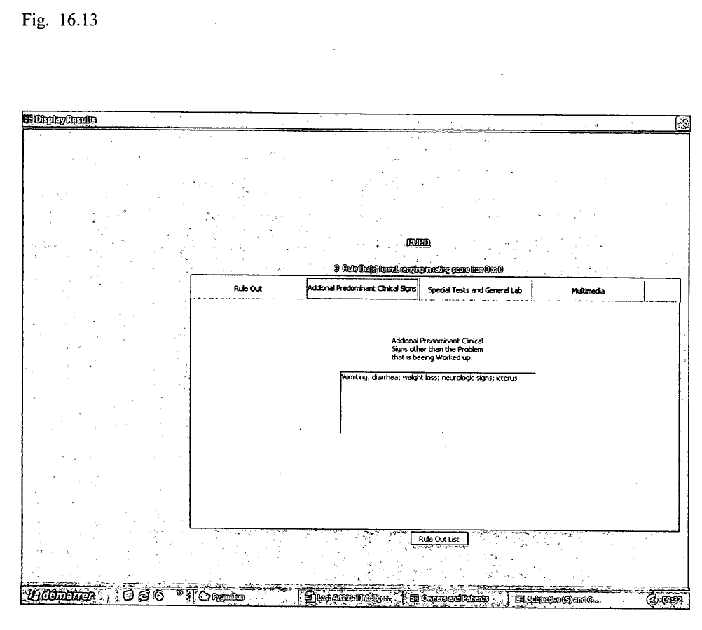

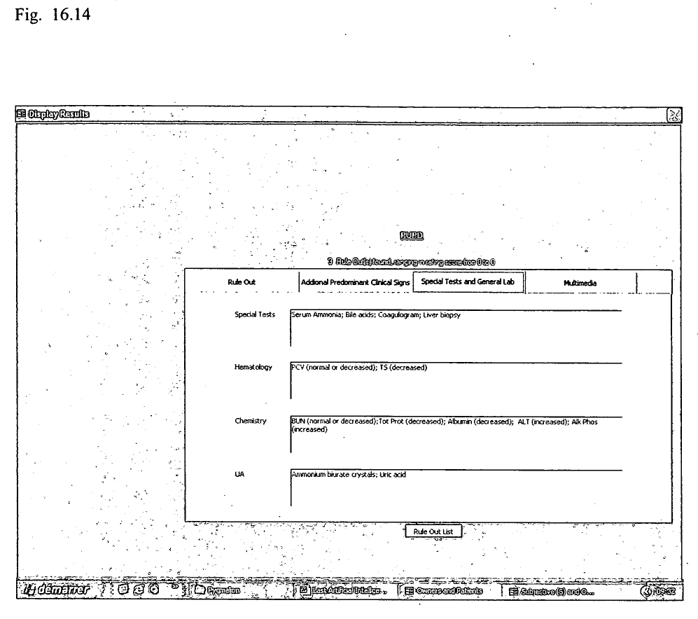

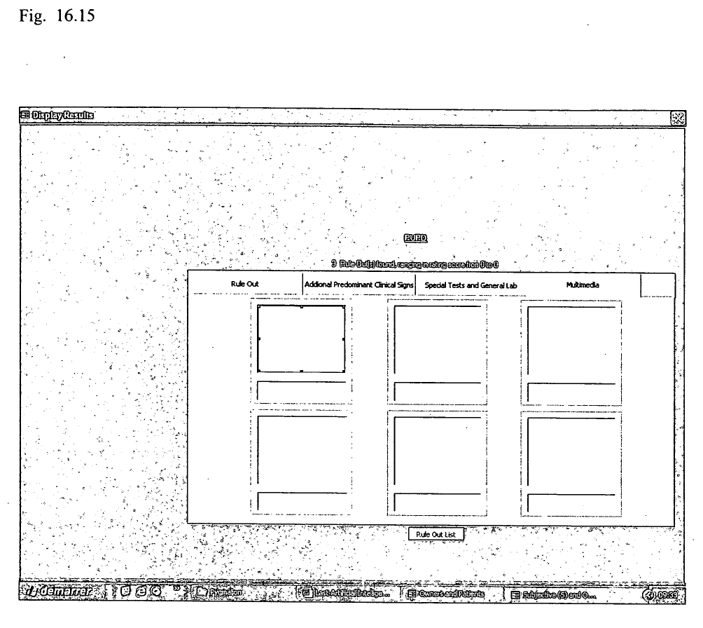

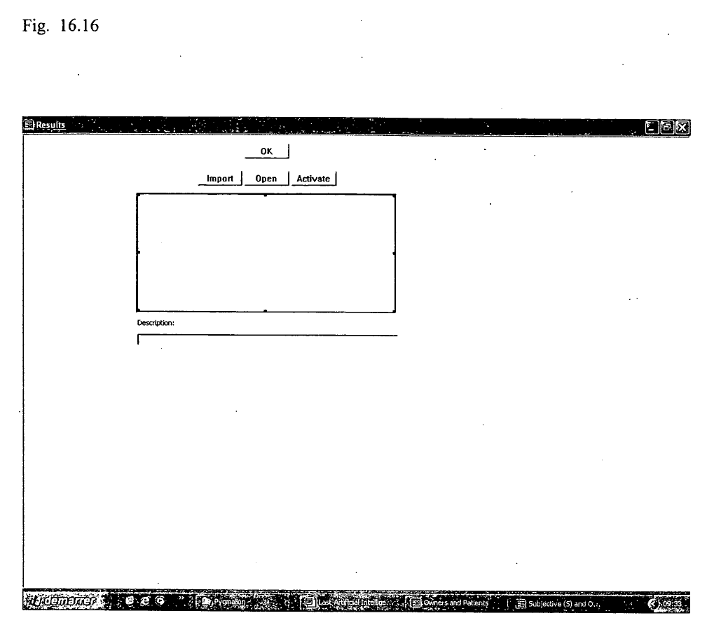

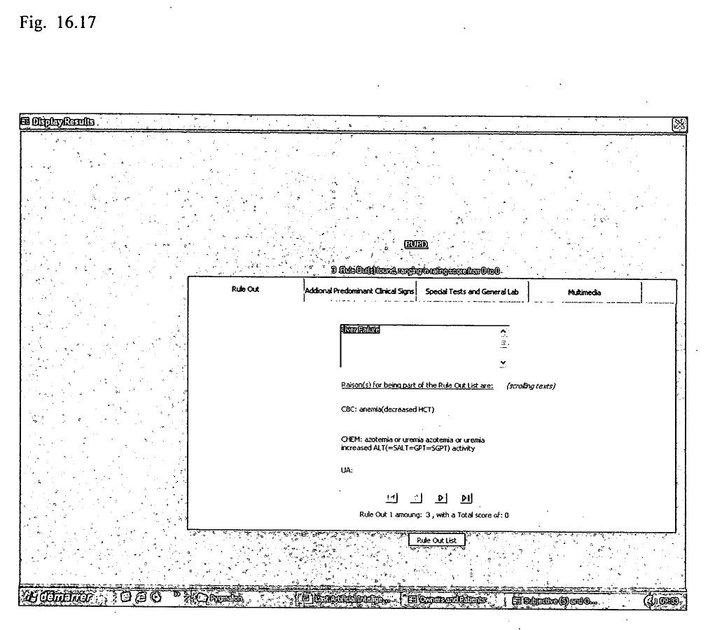

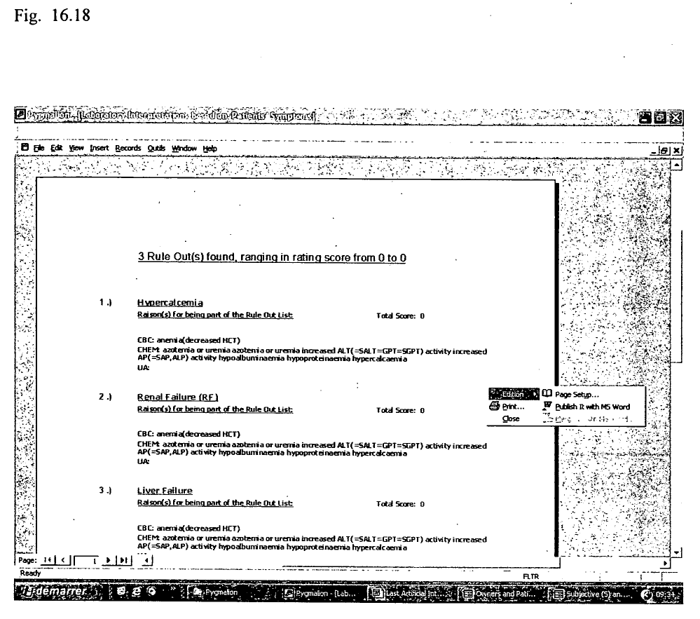

The interpretation is presented as a Differential Diagnosis list. Each Disease listed is described by:
i. A numeric value (Total score) which represents its relative probability of being the correct diagnosis. The higher the Total score, the more probable the disease is the current diagnosis
ii. The raisons (laboratory results) for which the artificial intelligence has selected this disease.
iii. The enumeration of the disease symptoms.
iv. The laboratory results (CBC, Chemistry, Urinary analysis) commonly present with this disease (see FIG. 16.14)
v. The diagnostic procedures used to evaluate the condition.
Vi. The Multimedia page (see FIG. 16.15) contains additional information (XR, ECO, Videos, audios, tutorials . . . ) concerning the disease
vii. With one click the user can scroll through the different diseases and view ail the details described above.

This module gives: 1) a context sensitive diagnosis; 2) context sensitive information on diseases; 3) context driven tutorials on medical procedures; 4) when combined to the consultancy module, examples of similar medical cases and expert guidance on the current case. 5)) when combined to Real Case Reference Database, examples of similar medical cases and expert guidance on the current case.

FIG. 16.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the artificial intelligence module.

FIG. 16.2 shows:

Hyperlinks when activated present additional information in a pop-up window. This pop up window indicates how to allocate the “artificial intelligence” module.

FIG. 16.3 shows:

Walks us through to allocating the “artificial intelligence” module and shows that whether a field is present; absent; enabled or disabled on the context sensitive navigation menu (which pops up with a “Right Click”), depends on the current context.

FIG. 16.4 shows:

The module that allows the user to personalize the degree of importance of individual tests.

FIG. 16.5 shows:

The clinician may elect to base the work-up on one symptom rather than another. In our example of a patient under corticoid treatment, the clinician will not use the leucocytosis as an important diagnostical criterion; therefore select a low degree of importance.

FIG. 16.6 shows:

That whether a field is present; absent; enabled or disabled on the context sensitive navigation menu (which pops up with a “Right Click”), depends on the current context.

Here is represented the context sensitive navigation menu for the module that allows the user to personalize the degree of importance of individual tests.

FIG. 16.7 shows:

How to allocate the “General interpretation” module, which is based on the patients laboratory results; the degree of importance of individual tests and all the symptoms.

FIG. 16.8 shows:

An example of results in the “General interpretation” module and its' respective context sensitive navigation menu.

FIG. 16.9 shows:

How to allocate the “Symptom based interpretation” module, which is based on the patients laboratory results; the degree of importance of individual tests; the symptom selected by the user and upon which the interpretation should be focused.

FIG. 16.10 shows:

The message box that appears when no there are no diseases in the “Symptom based interpretation” module rules out list for the chosen symptom.

FIG. 16.11 through 16.16 shows:

The “Symptom based interpretation” module rules outs for the chosen symptom and the current patient.

FIG. 16.15 shows:

The customizable extended data base functionality and information on how to accomplish procedures. Information such as a document that the doctor has scanned, a link to a streaming tutorial video on how to take a bone marrow biopsy or a trans-tracheal wash specimen, or a link to the Real Case Reference Database can easily be inserted and updated. This invention is the only medical software in which context-sensitive tutorials can be implemented by the user and by the software company. This invention assures that patients receive the highest standard of treatment available. To insert a source of information in a multimedia field: double click this field. Select “import” (see FIG. 16.16), select the document in “explorer” and click “ok”.

FIG. 16.17 shows:

By selecting “Rule Out List” button (another possibility is through the context sensitive menu) the user allocates: the “Symptom based interpretation” module displaying the rule outs with their respective scores and raisons for which the artificial intelligence has selected them.

FIG. 16.18 shows:

The “Symptom based interpretation” module displays rule outs with their respective scores and raisons for which the artificial intelligence has selected them. Its' respective context sensitive navigation menu is also displayed.

Multimediatheque(Trademark Rights Reserved)

This software invention is the only medical software with a multimediatheque (trademark rights reserved). This multimediatheque (trademark rights reserved) is offered in two versions:

The Personal Multimediatheque (trademark rights reserved)contains items that the user has introduced. It allows the user to stock different types of fields (see multimedia fields) in an orderly fashion (source, author, etc.) For example, the user reads an article and scans it to have it readily available. Other documents may be the video of a conference, a taped discussion or an Internet document.

In the General Multimediatheque(trademark rights reserved), documents are updated by a company. The personal multimediatheque(trademark rights reserved) allows the user to have handy at all times any medical document that is relevant for him. The general multimediatheque(trademark rights reserved) allows the user to have handy at all times any medical document that is relevant for the profession.

The Multimediatheque (trademark rights reserved)is composed of a Source tab, and a Document tab. Both of these tabs can be used either to fill in or to look up information. At the bottom of the Source tab, you can see the navigation button for this tab. The one for the documents is seen at the bottom of the Document tab, just above and to the right of the Source tab's navigation button. Notice that one source, for example a magazine, may have several documents, for example articles.

To scroll through the different sources: Use the source's navigation button.

To visualize the different documents from the same source: Select the document's navigation button.

To insert a new source: Click on the source's navigation button with an arrow and a star, and then fill in the source and document properties.

To select a source: “Double Click” on the look-up field. This opens a dialog box. Enter the first few letters of any of the source's properties (title, author, ect . . . ) and click OK. If several items start with the same letters, they will be listed in alphabetical order. Choose the appropriate one.

To automatically dial a telephone number: Put the curser in the field containing the number and click this tab.

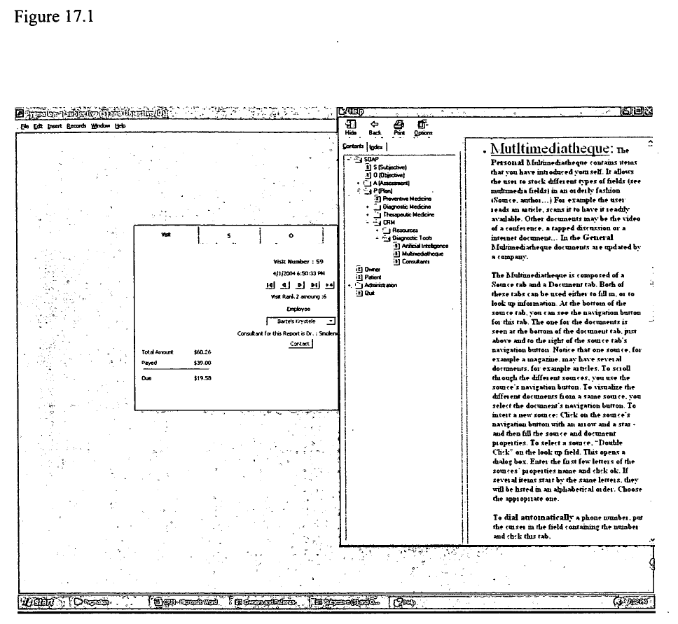

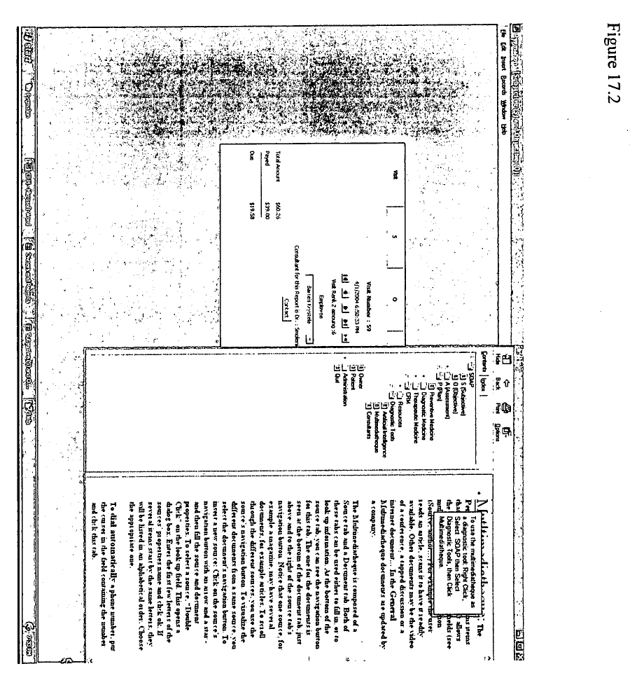

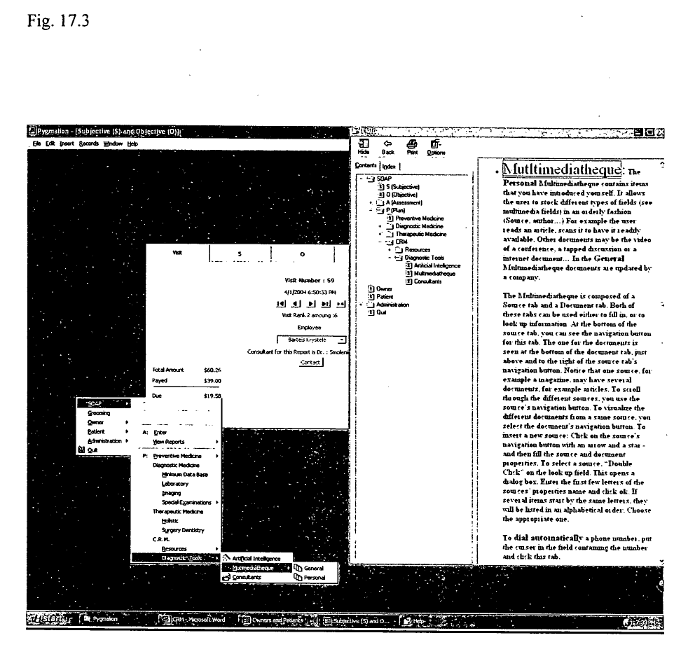

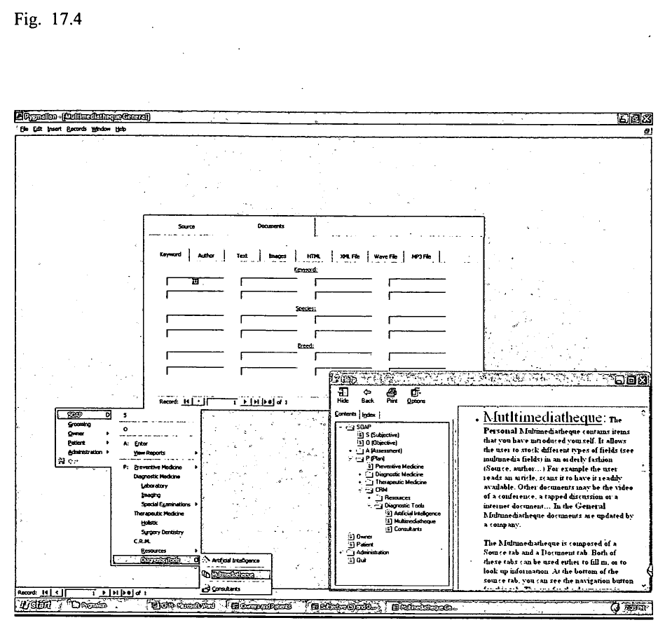

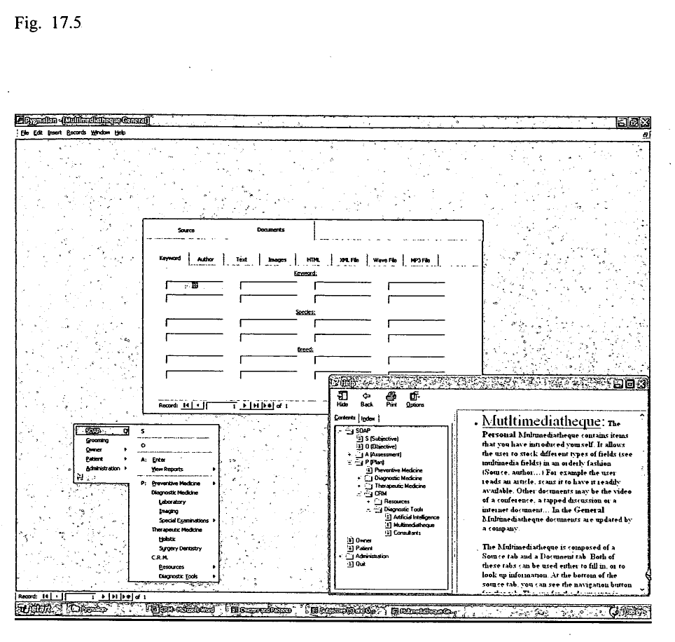

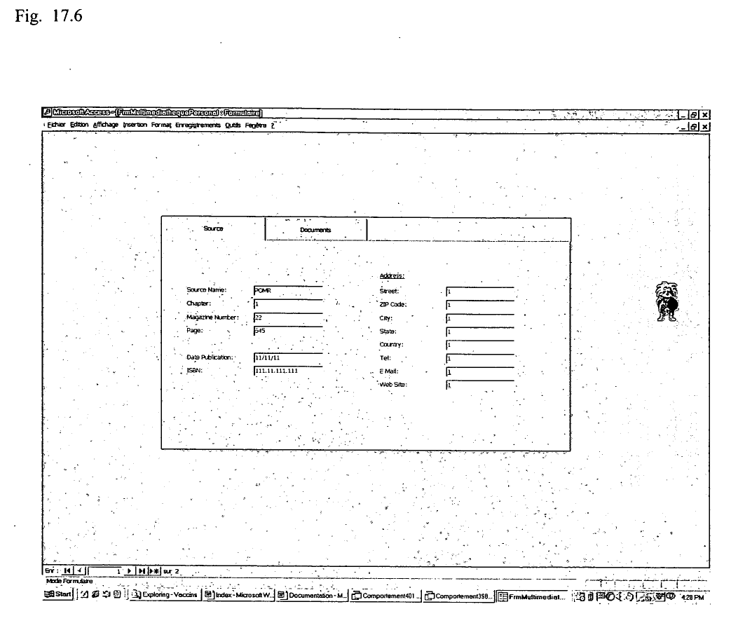

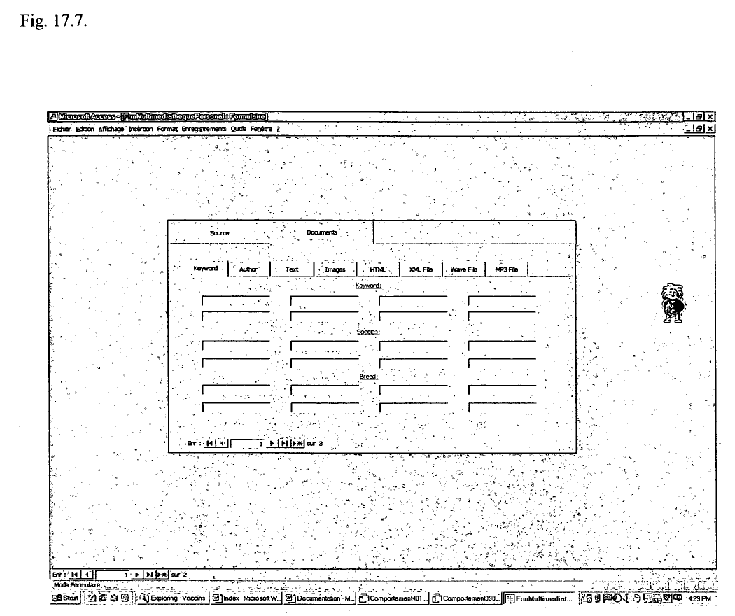

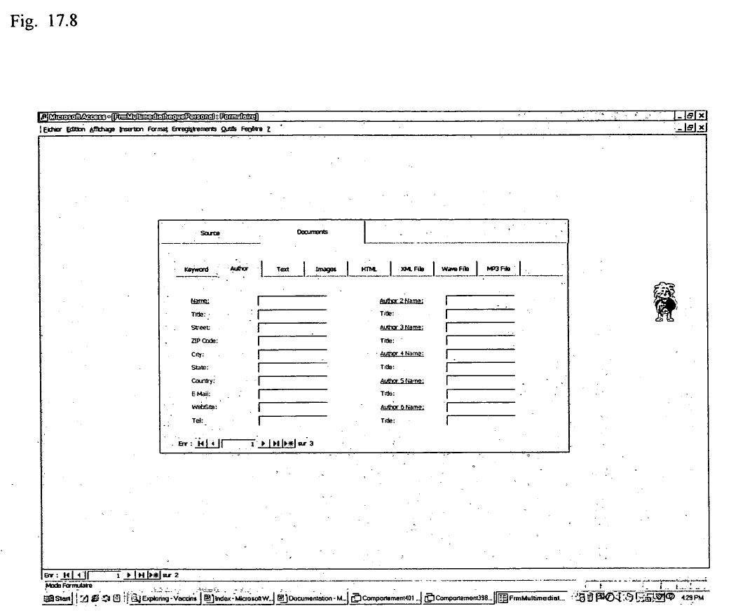

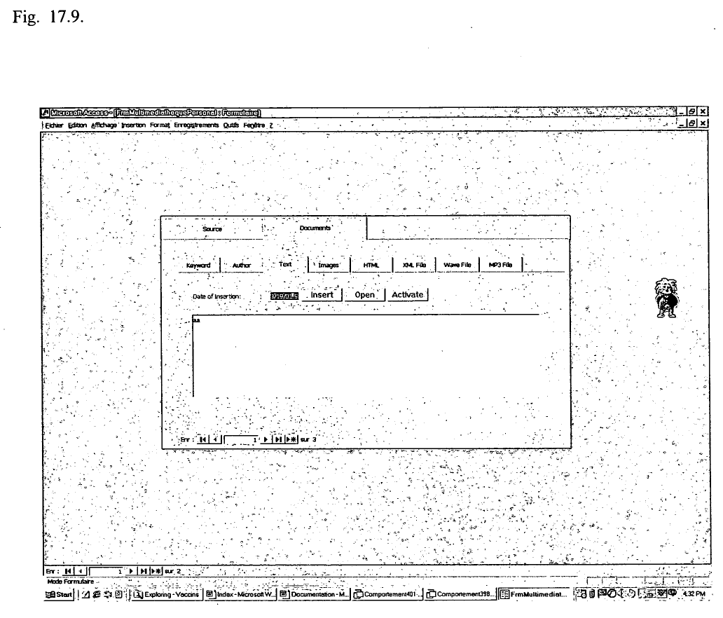

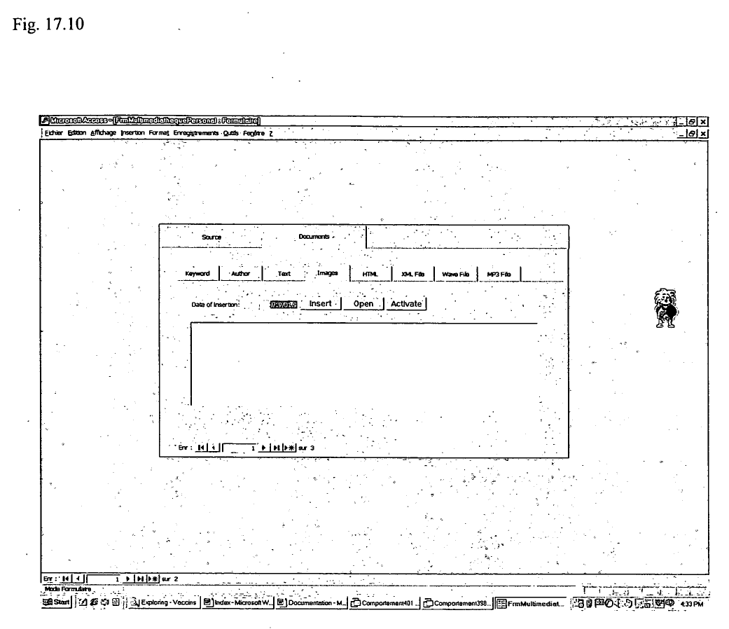

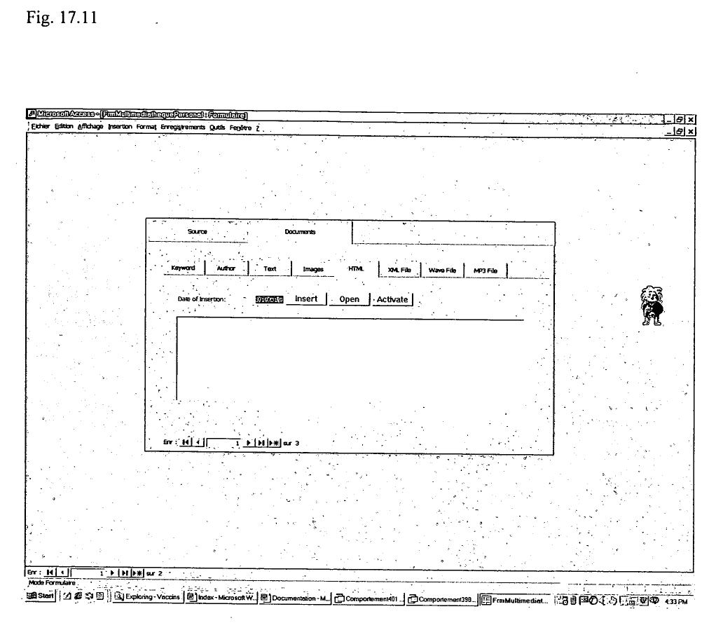

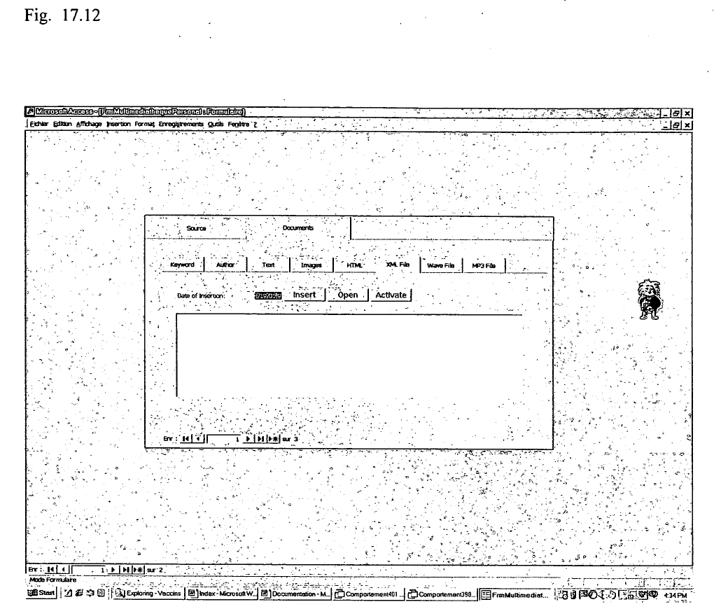

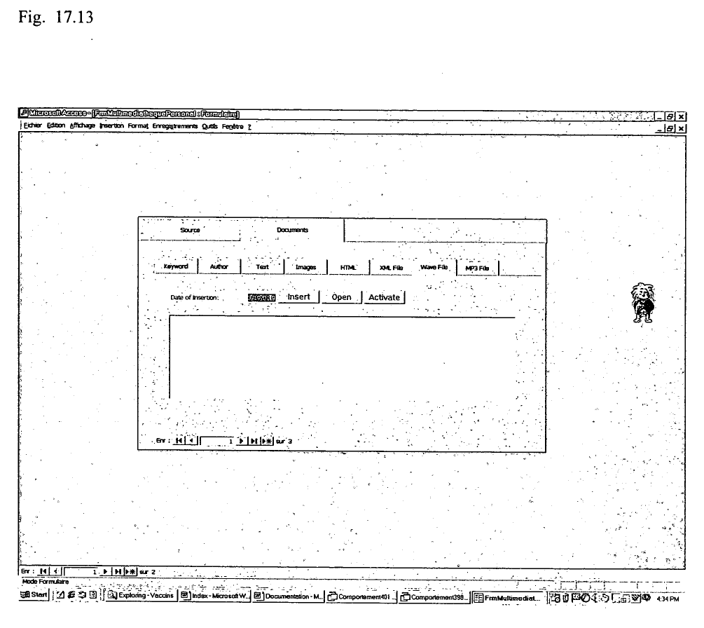

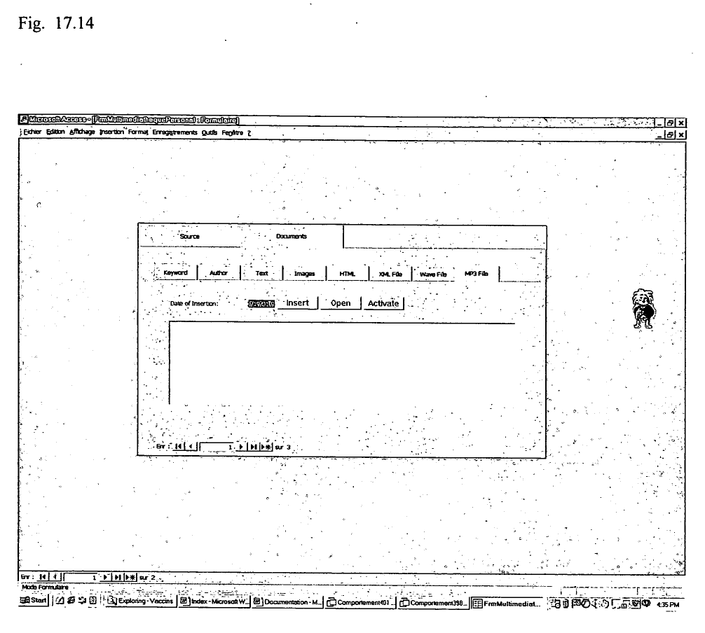

FIG. 17.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Multimediatheque module.

FIG. 17.2 shows:

Hyperlinks when activated present additional information in a pop-up window. This pop up window indicates how to allocate the “Multimediatheque” (trademark rights reserved) module.

FIG. 17.3:

Walks us through to allocating the “Multimediatheque” (trademark rights reserved) module from without the “Multimediatheque” module, and shows that whether a field is present; absent; enabled or disabled on the context sensitive navigation menu (which pops up with a “Right Click”), depends on the current context.

FIG. 17.4:

Walks us through to allocating the “Multimediatheque” (trademark rights reserved) module from within the “Multimediatheque(trademark rights reserved)” module.

In the context sensitive menu of the “Multimediatheque General”: Diagnostic tools->
1. Artificial intelligence
2. Multimediatheque Personal
3. Consultant

In the context sensitive menu of the “Multimediatheque Personal”: Diagnostic tools->
1. Artificial intelligence
2. Multimediatheque General
3. Consultant

FIG. 17.5 through 17.14 shows:

The “Multimediatheque” (trademark rights reserved) module.

Multimedia

The multimedia form supports entering, viewing, modifying and deleting multimedia information.

The user may insert 22 different kinds of multimedia sources in these fields in this field along with comments on them. The multimedia sources may be of the following types:

THIS IS THE ONLY SOFTWARE OFFERING THE POSSIBLILTY OF INSERTING 22 DIFFERENT TYPES OF DOCUMENTS IN THE PATIENTS HISTORY OR PHYSICAL EXAMINATION AND THROUGH OUT THE SOFTWARE.
1. Adobe Acrobat Document: The user may scan a medical form and use it as an extended medical report. This allows each and every user to parameterise endlessly the software to his personal way of practicing medicine. These parameters may be redefined not only specifically for each Patient but also for each and every visit.
2. Clip Multimedia
3. Clip Video
4. Corel Photo Home Image
5. Document WordPad
6. Image Bitmap
7. Image Paintbrush
8. Image Wang
9. Microsoft Clip Gallery
10. Microsoft Excel Chart
11. Microsoft worksheet
12. Microsoft Graph Chart
13. Microsoft PowerPoint Presentation
14. Microsoft PowerPoint Slide
15. Microsoft Word Document
16. Microsoft Picture
17. Package
18. QuickTime Movie
19. QuickTime Picture
20. Sequence MIDI
21. Son Wave
22. E film

To insert a multimedia document:

A. Double click on the field where the document should be inserted.

B. Clicking on the “lnsert” button calls up the Insert Dialog box allowing the user to insert the selected Document.

C. Clicking on the “Activate” button activates the Document in place.

D. Clicking on the “Open” button opens the Document in its own editing window rather than activating it in place.

The user may enter a medical form and use it as an extended medical report. This allows each and every user to endlessly customize the parameters of the software to personal way of practicing medicine. These parameters may be redefined not only specifically for each patient but also for each and every visit.

This software invention is the only medical software with an automatic insertion of X-ray; cardiac echography; abdominal echography; CT Scan; radio-magnetic imaging (IRM); electrocardiograms (ECGs); surgery; dentistry; neurology; acupuncture; bio-resonance; BSF; homeopathy; videos; photos; dictated memos; etcetera . . . (22 different document profiles) in the patients' record.

This software invention provides the only veterinary and human medical software with multimedia fields integrated throughout the software with the following characteristics: The huge number of fields in the image module (379), and enormous different types of documents (2I), allow the user to tailor this module endlessly: One may for example decide to use some of the radiography fields to hold X-rays and others to document a radiographic report as a Ward document or why not as vocal comments. Some may desire having a video of an orthopaedic examination besides the radiographies. Others may choose to enclose a video of a bronchoscopy with spoken comments adjacent to the Chest X-rays and cytology images and reports . . . .

Consultants

Instead of spending precious time preparing a specialized synopsis of a medical record (with lab work, images, ECG, etc.), Pygmalion Concept (Trademark rights reserved) enables the doctor, within seconds, to send an automatically established record to a consultant. Before sending a report to a consultant, the user is informed which consultants are on duty. This avoids unnecessary delay in response on a case due to sending a report to a consultant that is absent. Because of this functionality, the doctor will be able to use consulting services more often, consultants will not waste time and energy with incomplete reports, and even the best-experienced doctors achieve a higher standard of medicine.

Real Case Reference Database

The medical record as well as the consultant's recommendations may be inserted into the online “Real Case Reference Database” discussion forum located at: www.VETERINARIANS.org. for veterinary and another site for human medicine (the patient's name and address are omitted). This huge database may be searched by other doctors. This online Reference Database also contains medical cases for which doctors are the most often suited for malpractice because of having omitted to offer all of the medical services and resources expected for managing such medical problems. When a practitioner has a difficult case, he may check this Website for similar medical problems to see how colleagues dealt with them and to interact in the discussion forum.

This Database can be searched by any criteria in the history, the physical examination, the assessment, or the therapy plan or (for veterinary patients) by the patients' species, breed or age. Statistics may be compiled using this data. Statistics may be compiled using this data. Since all consultants are specialists, all the information satisfies high standards. This invention thus offers the first interactive database, of completely SOAP-ed and compliant to ASMC and AFMC standards (for veterinary behaviour medical cases) real cases all reviewed by specialists.

Since all consultants are specialists, all the information satisfies high standards. Pygmalion Concept (Trademark rights reserved).

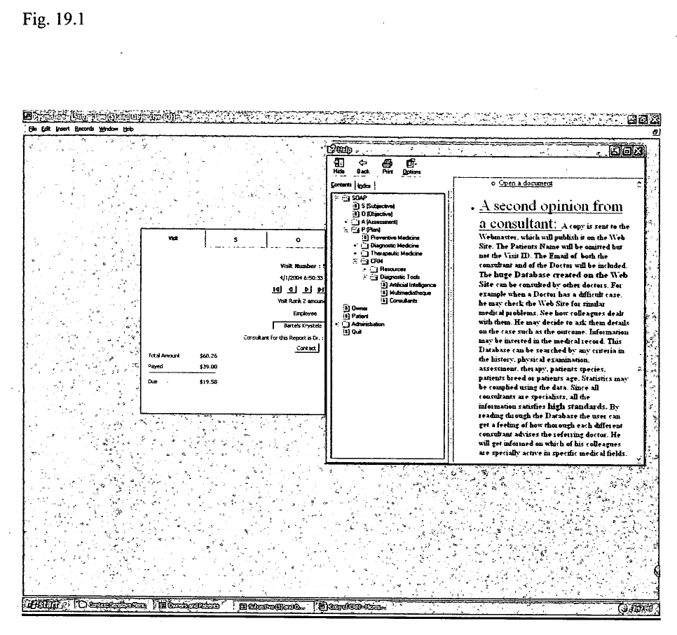

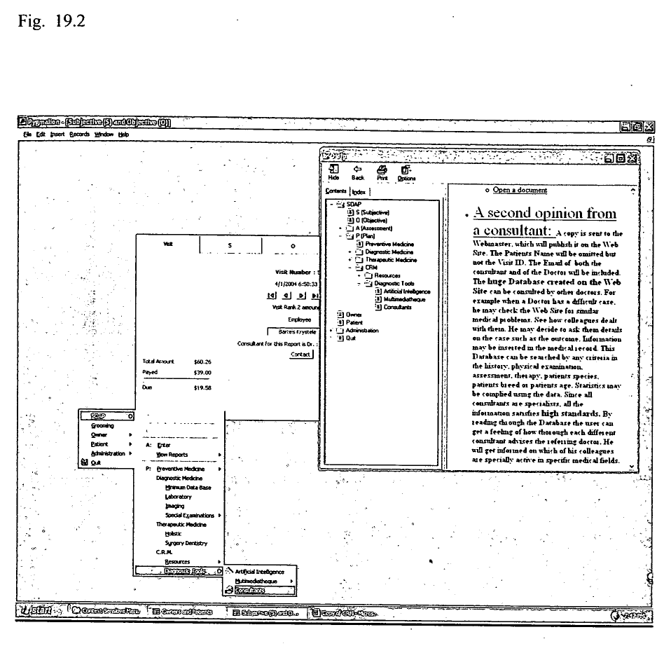

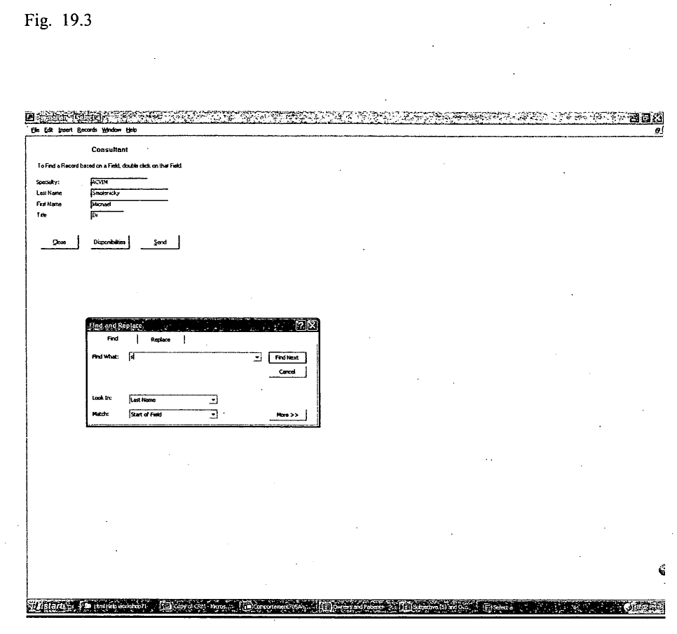

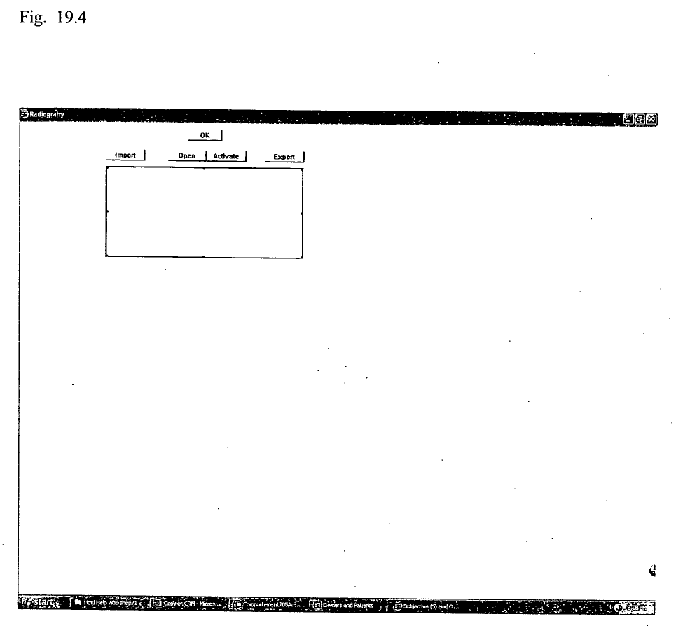

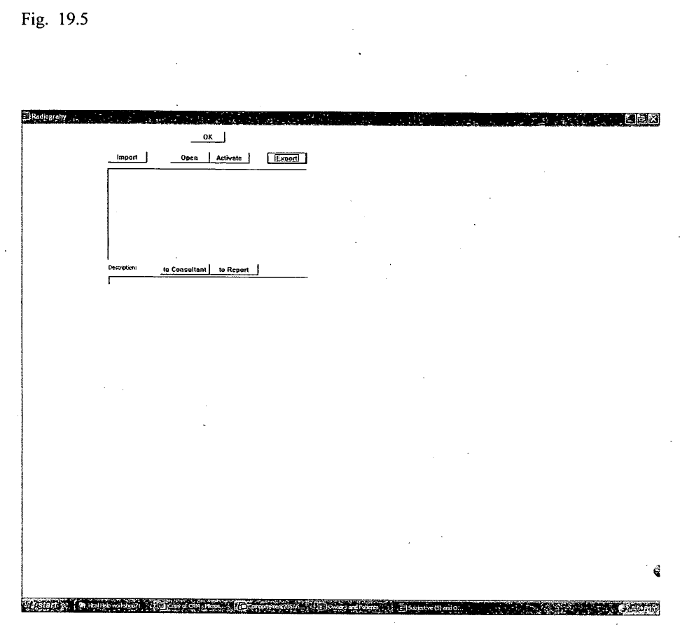

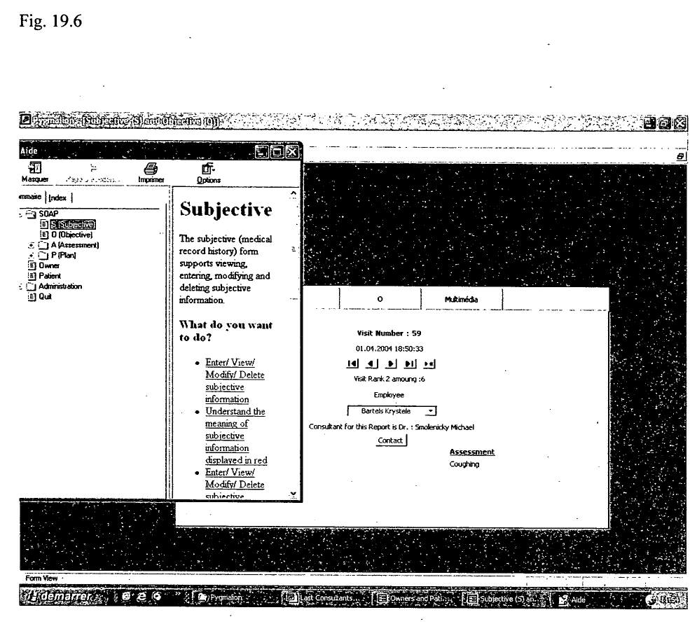

FIG. 19.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Consultants module.

FIG. 19.2:

Walks us through to allocating the “consultants” module and shows that whether a field is present; absent; enabled or disabled on the context sensitive navigation menu (which pops up with a “Right Click”), depends on the current context.

FIG. 19.3 shows:

That the “Disponibilities” button when activated opens a web page where the disponibility of each consultant is displayed. This avoids sending a case to a consultant that is on leave.

Once the user has selected the desired consultant by clicking “Send”, a complete SOAP ed report with laboratory will automatically be sent to the consultant. The report will include the current visit with its laboratory results; as well as all the patients' visits that occurred after the current visit with their respective laboratory results. The images (XR, ECG, ect . . . ) that are in the report have been selected by the user among images contained in the visits.

FIG. 19.4 through FIG. 19.5 shows:

How to select images to be sent to a consultant:
1. Select SOAP, click “lmaging”, “Double Click” on the image that should be sent.
2. Click “Export”
3. To Consultant

FIG. 19.6 shows:

That in order stay informed about every report that has been sent to a consultant: the software displays, the name of the consultant as well as contact button, on the SO form of the visit from which the report has been sent. This button when clicked opens automatically “MS Outlooks' Contact” Form with all the consultants information(Name address, email . . . ). The user does not at any time have or have had to enter this information manually. This allows to contact the consultant when necessary or to follow up on the sent report within seconds.

Sell Over the Counter

This module supports the establishment of invoices for over-the-counter sales.

FIG. 20.1 through FIG. 20.3 shows:

How the user can use context sensitive Customized Help in combination with the context sensitive navigation menu: selecting <<Ctrl>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic. This tab has a field named: “Type in the keyword to Find:” for entering keywords. As a keyword is being typed in this field (in this case: Sell), all the alphabetically related keywords are shown. When the user “double clicks” the keyword, the related topic is displayed in the Topic Window. Since several topics concern the same keyword, a window pops up with a listing of these topics. Clicking a topic, then selecting “Click Display” presents the related topic in the Topic Window, highlights its location in the Context field and allows the user to locate the topic on the applications map (Context tab).

FIG. 20.4 shows:

The additional information displayed in the pop-up window, when the hyperlink for “Selling over the counter” is activated.

FIG. 20.5 through FIG. 20.13:

Walks us through following the indications from the Hyperlink pop-up window for “Selling over the counter”, and shows that whether a field is present; absent; enabled or disabled on the context sensitive navigation menu (which pops up with a “Right Click”), depends on the current context.

As in Invoices: Clicking <<Calculator>> pops-up a calculator

Invoices

To view, enter, modify and delete the invoice for the current Visit: “Right Click”, select “Administration”, then “Click Invoice”.

Entering Items

Double clicking in the item field opens a dialog box. Enter the first few letters of the items name and click ok. If several items start by the same letters, they will be listed in an alphabetical order. Choose the appropriate one. Then Click “This is the desired Product or Service” and this Item with its respective price will be automatically inserted in the Invoice. To enter a new Product or Service in the Database: Click: “The desired Product or Service is not on this Form” and you will be prompted to enter it.

Enter the Number of Items

Select the Tax the Item is Subject to:

For countries where the tax is always the same and always applied, the software is par metered to do so automatically without needing the users' intervention. For countries where the tax is subject to change (ex: depending on the type of professional service, if the Owner works for an embassy . . . ), this represents a precious time saving functionality.

Click “Calculator”: Pops up a calculating machine (useful for calculating medication dosage or number of Tablets needed.). This also exists in the “Health Plan”. (See Health Plan)

Clients' Invoices

FIG. 21.1 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Invoices module.

FIG. 21.2 shows:

Hyperlinks in the Topic Window for the Invoices module.

FIG. 21.3:

Walks us through to allocating the “Invoice” module.

FIG. 21.4 shows:

That whether a field is present; absent; enabled or disabled on the context sensitive navigation menu (which pops up with a “Right Click”), depends on the current context.

Invoices from All Doctors

FIG. 21.5 through FIG. 21.13 shows:

The functionalities of the Invoice from all Doctors module.

To Enter a Date

“Double click” on the date field and a calendar pops-up.

“Click” on selected date and “Click” in date field.

Enter second date and select “OK”

FIG. 21.11 through FIG. 21.12 shows:

The Invoice Reminders (or Invoices to collection) and that before sending them, the user may check when the Invoices have been sent.

Invoices from One Doctor

FIG. 21.13 through FIG. 21.19 shows:

The functionalities of the Invoice from one Doctors module.

For one Owner

Select the Owner

Indicate if you desire paid or unpaid Invoices

Invoices from Suppliers

FIG. 21.20 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic, then selecting “Click Display” presents the related topic in the Topic Window, highlights its location in the Context field and allows the user to locate the topic on the applications map (Context tab). This is demonstrated here for the Suppliers module.

FIG. 21.21 shows:

Hyperlinks when activated present additional information in a pop-up window. This pop up window indicates how to allocate the “Suppliers” module.

FIG. 21.22:

Walks us through to allocating the “Suppliers” module and shows that whether a field is present; absent; enabled or disabled on the context sensitive navigation menu (which pops up with a “Right Click”), depends on the current context.

FIG. 21.23 shows:

The “Suppliers” module.

FIG. 21.24 shows:

That to check if a product has been delivered the user must select <<Products Delivered Y/N”

FIG. 21.25 shows:

The module allowing the user to check if a product has been delivered or not, for example before paying the invoice.

FIG. 21.26 through FIG. 21.29 shows:

The module allowing the user to follow up on payments made to suppliers. To allocate this module the user must select “Payments Enter/Modify”. This form has the same fields and presentation as the form for entering payments made.

FIG. 21.27 shows:

How the user should select “Payments: View” in order to view payments made to suppliers.

To Enter a Date

“Double click” on the date field and a calendar pops-up.

“Click” on selected date and “Click” in date field.

FIG. 21.28 through FIG. 21.29 shows:

The module allowing to view payments concerning Suppliers' Invoice.

FIG. 21.30 through FIG. 21.31 shows:

How, while viewing payments concerning Suppliers' Invoice, the user may access supplementary information concerning the Supplier.

Suppliers

The supplier form supports entering, viewing, modifying, allocating and deleting supplier information.

FIG. 22.1 through FIG. 22.7 shows:

How the user can use context sensitive Customized Help in combination with the context sensitive navigation menu to allocate the Supplier module: selecting <<Ctrl H>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic. This tab has a field named: “Type in the keyword to Find:” for entering keywords. As a keyword is being typed in this field (in this case: Supplier), all the alphabetically related keywords are shown. When the user “double clicks” the keyword, the related topic is displayed in the Topic Window. Since several topics concern the same keyword, a window pops up with a listing of these topics. Clicking a topic, then selecting “Click Display” presents the related topic in the Topic Window, highlights its location in the Context field and allows the user to locate the topic on the applications map (Context tab).

FIG. 22.8 through FIG. 22.10 shows:

The Suppliers Catalogues' functionalities.

FIG. 22.11 through FIG. 22.12 shows:

How to enter or modify a Supplier.

FIG. 22.13 shows:

How to allocate the order List.

FIG. 22.14 shows:

The order Lists' functionalities.

Products

The product module supports viewing, entering, modifying and deleting product information.(see also Inventory).

FIG. 23.1 through FIG. 23.5 shows:

Hyperlinks in the Topic Window for “Entering, Modifying or Allocating a Product”, and walks us through what the user encounters while following their indications.

FIG. 23.6 through FIG. 23.7 shows:

Hyperlinks in the Topic Window for “Entering, Modifying or Allocating Product Category” and walks us through what the user encounters while following their indications.

FIG. 23.8 shows:

Service/Medical Act Category

FIG. 23.9 shows:

Vaccinations Category

FIG. 23.10 shows:

Medication Category

FIG. 23.11 through FIG. 23.12 shows:

Hyperlinks in the Topic Window for “Entering, Modifying or Allocating a Product”, and walks us through what the user encounters while following their indications.

FIG. 23.13 shows:

Product module.

FIG. 23.14 shows:

Products are in the Categories of “Material” and “Medicament”. When the category is Service/Medical Act or Vaccinations all fields except for the “Category” field are disabled.

FIG. 23.15 shows:

Hyperlinks in the Topic Window for “View Product order List”, and walks us through what the user encounters while following their indications.

FIG. 23.16 shows:

Hyperlinks in the Topic Window for “View Product order List”, and walks us through what the user encounters while following their indications.

FIG. 23.17 through FIG. 23.18 shows:

Product order List and some of its' functionalities.

FIG. 23.19 shows:

How the user can use context sensitive Customized Help in combination with the context sensitive navigation menu to allocate the “View; Enter; modify information on Products received”.

FIG. 23.20 through FIG. 23.21 shows:

How to “View; Enter; modify information on Products received”.

FIG. 23.22 through FIG. 23.27 shows:

Hyperlinks in the Topic Window for “Entering, Modifying or Allocating a Product; Entering or Modifying Inventory and Viewing Reminders”, and walks us through what the user encounters while following their indications.

Reminders for ordering Products and Inventory of Reminders for preventive medicine.

As the only medical (human and veterinary) ERP software, Pygmalion Concept (Trademark rights reserved) serves the needs of people in medicine as well as it does the people in human resources, finance and inventory control. It provides full invoicing and payment recording services as well as inventory control with automatic ordering. Pygmalion Concept (Trademark rights reserved) integrates easily and powerfully with Microsoft Word, Outlook, Excel, Great Plains and other business systems.

Best of all, Pygmalion Concept's (Trademark rights reserved) powerful applications are easy to learn, easy to use and capable of infinite customization to fit your needs and the way you work.

Reminders for ordering Products module is the same as the Reorder module previously described.

The inventory of Reminders module allows the viewing and sending reminders for vaccinations, de-wormings, follow-up examinations and tests. The reminders are species- and sex-specific.

FIG. 23.22 through FIG. 23.27 shows:

How the user can use context sensitive Customized Help in combination with the context sensitive navigation menu to allocate the “Reminders for ordering Products and for preventive medicine” modules: selecting <<Ctrl H>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic. This tab has a field named: “Type in the keyword to Find:” for entering keywords. As a keyword is being typed in this field (in this case: Reminders), all the alphabetically related keywords are shown. When the user “double clicks” the keyword, the related topic is displayed in the Topic Window. Since several topics concern the same keyword, a window pops up with a listing of these topics. Clicking a topic, then selecting “Click Display” presents the related topic in the Topic Window, highlights its location in the Context field and allows the user to locate the topic on the applications map (Context tab).

FIG. 23.22 through FIG. 23.27 shows:

Hyperlinks in the Topic Window for “Entering, Modifying or Allocating a Product; Entering or Modifying Inventory and Viewing Reminders”, and walks us through what the user encounters while following their indications.

Services

This module supports entering, viewing, modifying, allocating and deleting services. This includes medical acts (services rendered) and employees' information (those who render a service).

FIG. 24.1 shows:

How the user can use context sensitive Customized Help in combination with the context sensitive navigation menu to allocate the “Medical Acts” modules: selecting <<Ctrl H>> opens the context sensitive Customized Help, which in order to facilitate orientation, highlights the users' current location on the Context outline (left window of the Customized Help), which is a schematic representation of the context sensitive navigation menu. The Index tab alphabetically lists keywords that assist the user in finding a particular topic.

This tab has a field named: “Type in the keyword to Find:” for entering keywords. As a keyword is being typed in this field, all the alphabetically related keywords are shown. When the user “double clicks” the keyword, the related topic is displayed in the Topic Window.

FIG. 24.2 shows:

If several topics concern the same keyword, a window pops up with a listing of these topics.

Clicking a topic, then selecting “Click Display” presents the related topic in the Topic Window, highlights its location in the Context field and allows the user to locate the topic on the applications map (Context tab).

FIG. 24.3 shows:

That clicking a topic, then selecting “Click Display” presents the related topic in the Topic Window, highlights its location in the Context field and allows the user to locate the topic on the applications map (Context tab).

FIG. 24.4 shows:

Hyperlinks in the Topic Window for “Entering or Modifying Services”, and walks us through what the user encounters in the Medical Act module.

FIG. 24.5:

Walks us through opening the “Services” module.

FIG. 24.6:

Walks us through opening the “Medical Act” module.

FIG. 24.7 shows:

The “Medical Act” module.

FIG. 24.8 through FIG. 24.12 shows:

The “Services and Medical Acts” module and its' context sensitive menu.

Inventory

FIG. 25.1 through FIG. 25.6 shows:

Hyperlinks in the Topic Window for “Entering or Modifying Inventory”.

FIG. 25.7 shows:

What the user encounters when selecting “Inventory” on the context sensitive menu.

From here: “Categories, Products, Order List, Reception of Supplies, Reminders” is the same as “Categories, Products, Order List, Reception of Supplies, Reminders” from Menu Administration→Products.

Quit

To close the database or schedule backups: “Right Click” and select “Quit”. Only the administrator should have permission to schedule backups. Just prior to the shutdown time, the software issues a warning message to users. When the shutdown time arrives, the software will save any procedure that is opened and then close the Database.

FIG. 25.8 shows:

That selecting <<Ctrl H>> opens the context sensitive Customized Help, which in order to facilitate orientation, highlights the users' current location on the Context outline (left window of the Customized Help), which is a schematic representation of the context sensitive navigation menu. Clicking a topic (in this case “Quit”), then selecting “Click Display” presents the related topic in the Topic Window, highlights its location in the Context field and allows the user to locate the topic on the applications map (Context tab).

FIG. 25.9 through FIG. 25.10 shows:

How the user allocates the “Quit” module.

Comportement (Behaviour)

This invention is the only medical software with a Behaviour Module in which a text formatted Report is automatically created with the information entered. This Report may be fused in a “MS Word” format, and therefore use all the functionalities of “MS Word”. The report may be sent by Email or Printed. This is the only software with such functionalities and that is developed based on the ASMC and AFMC standards. A complete formatted behaviour report generally is elaborated without this module in several hours, but and with this module within minutes on a Pentium 4; 500 mb. This is an extreme time saver.

FIG. 26.1 through FIG. 26.2 shows:

Motifs form

FIG. 26.3 shows:

The Aggression form

FIG. 26.4 through FIG. 26.10 shows:

Dangerosité form

FIG. 26.11 through FIG. 26.14 shows:

Développement form

FIG. 26.15 through FIG. 26.20 shows:

Apprentissage Social form

FIG. 26.21 through FIG. 26.26 shows:

Alimentation Elimination form

FIG. 26.27 through FIG. 26.31 shows:

“Socialisation Sexualité Education Obéissance” form

FIG. 26.32 through FIG. 26.34 shows:

“Humeur Jeu Emotion” form

FIG. 26.35 through FIG. 26.38 shows:

“Exploration Sommeil Somesthésie Stéréotypie>> form

FIG. 26.39 through FIG. 26.42 shows:

“Séparation Solitude Isolement>> form

Grooming

THIS IS THE ONLY SOFTWARE OFFERING THESE FUNCTIONALITIES.

This module is designed to collect all the information as to grooming a small animal. Grooming of different body parts are documented through multimedia fields (see multimedia fields' description). Details on the grooming; shampooing; drying and brushing may be entered. This module has an option (not shown on these Figures) that allows the user note information concerning the animals' health, the treating veterinarian, persons to contact if an emergency arises and other information. Even if the user isn't from the medical profession, this is nevertheless important information to keep handy.

This module (as also the hair dressing module) may either be linked to Pygmalion Concept (Trademark rights reserved) or used as an independent module.

When this module is linked to Pygmalion Concept (Trademark rights reserved), the Owners' Name, private phone, professional phone, mobile phone number, patients name, species, breed, age and gender are automatically displayed.

The auto dial functionality may be used to automatically call the Owner.

FIG. 27.1 through FIG. 27.7 shows:

The “Grooming” modules' forms for entering documents concerning the grooming of different body parts. The body Parts are for example: Head details; Neck details; Body details; Limbs details and tail details. Each body part is represented by a multimedia field and a text box.

Entering an Image in a field:

Double-clicking the field enlarges this field on the screen and brings up three command buttons (Insert, Open, Activate). Clicking on the “lnsert” button calls up the Insert Dialog box allowing the user to insert the selected Document.

Viewing a Image:

A small size image is readily visible on the screen. Double-click the image to obtain an enlarged view This brings up three command buttons (Insert, Open, Activate). Clicking on the “Activate” button activates the Document in place. Clicking on the “Open” button opens the Document in its own editing window rather than activating it in place.

Replacing an Image by Another:

Double-click the image to obtain an enlarged view. This brings up three command buttons (Insert, Open, Activate). Clicking on the “lnsert” button calls up the Insert Dialog box allowing the user to insert the new Document in replacement of the former one.

Types of Documents that May be Inserted:

The user may insert all kinds of Documents in this field and comment them. The Documents may be of the following types:
1. Acrobate Document: The user may scan a medical form and use it as an extended medical report. This allows each and every user to parameterise endlessly the software to his personal way of practicing medicine. These parameters may be redefined not only specifically for each Patient but also for each and every visit.
2. Clip Multimedia
3. Clip Video
4. Corel Photo Home Image
5. Document WordPad
6. Image Bitmap
7. Image Paintbrush
8. Image Wang
9. Microsoft Clip Gallery
10. Microsoft Excel Chart
11. Microsoft worksheet
12. Microsoft Graph Chart
13. Microsoft PowerPoint Presentation
14. Microsoft PowerPoint Slide
15. Microsoft Word Document
16. Microsoft Picture
17. Package
18. QuickTime Movie
19. QuickTime Picture
20e. Sequence MIDI
21. Son Wave
22. E film

The fields may be used for viewing pictures; films; vocal notes or other documents on how the animal has been groomed (hair dressing).

One may also document how the animal should be groomed (for humans: clients' hair dressing).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. Claim 1 comprises a computer-readable medium encoded with a method of diagnosing a patient wherein the method applies artificial intelligence techniques to a patient's medical record.

2. The medium of claim 1, wherein the artificial intelligence techniques comprise the knowledge of the physician's experience in the contextual situation:
patients' history;
previous treatments;
current treatments;
physical examinations;
tests results;
laboratory particularities;
geographical location;
epidemiological situation;
doctors' experience and
doctors' expertise restricted as well as not restricted to current symptoms, such knowledge being recorded in a database and retrieved when the patient's medical record:
clinical signs; and
diagnostic laboratory results matches a given number of parameters associated with a disease profile.

3. The medium of claim 1, wherein the method compares and prioritizes a list of likely diagnoses, which are presented in association with a likelihood, represented via a numeric score, of their applicability to the given patient.

4. The medium of claim 1, wherein the artificial intelligence techniques comprise a diagnostic module which is based on:
the patients' laboratory results;
the degree of importance of individual tests; and
the symptoms selected by the user and upon which the interpretation should be focused.

5. The medium of claim 1, wherein the artificial intelligence techniques comprise a diagnostic module which is based on:
the patients laboratory results; and
the degree of importance of individual tests, and in which the interpretation is focused upon all the symptoms.

6. The medium of claim 1, wherein the artificial intelligence techniques makes visually stand out:
any abnormal historical;
any abnormal physical examination results;
any abnormal laboratory results; and
any pathological particularities, so it may immediately be spotted by the user when viewing the screen.

7. The medium of claim 1, wherein the artificial intelligence techniques delivers detailed diagnostic differentials each of which is based on the patients' record and is customizable:
to the doctors' way of practicing medicine;
to the patient;
to the visit;
to the context, and presents:
the most appropriate diagnostic procedures;
a context-sensitive source of information on diseases;
a context-sensitive source of information on medical procedures, and offers the possibility for the user to implement context-sensitive tutorials.

8. The medium of claim 1, wherein the artificial intelligence techniques delivers detailed diagnostic differentials each described by:
a numeric value which represents its relative probability of being the correct diagnosis;
the raisons for which the artificial intelligence has selected this disease;
the enumeration the symptoms for each selected disease;
the laboratory results commonly present in each selected disease;
the diagnostic procedures used to evaluate each selected condition; and
a Multimedia page which may contain additional information:
radiographies of abnormalities when seen in the selected disease;
echographies of abnormalities when seen in the selected disease;
videos of abnormalities when seen in the selected disease;
audios of abnormalities when seen in the selected disease; and
tutorials concerning the selected disease.

9. The medium of claim 1, wherein the method establishes complete holistic reports documenting:
homeopathy;
acupuncture;
Chinese medicine;
bio resonance;
bio spectrum frequency; and
bio nutritional analysis, and in which artificial intelligence selects a holistic management plan based on the patients record and consisting in treatments in: homeopathy;
acupuncture;
Chinese medicine;
bio resonance; and
bio spectrum frequency and that allows the user to insert:
videos of the patients' holistic examinations;
holistic treatments;
holistic data;
voice notes and other holistic information.

10. Claim 10 comprises a computerized medium encoded with a computer readable method of managing the back off ice and front office of:
a veterinary medical practice;
a veterinary clinic;
a veterinary hospital;
a medical practice in the fields of human medicine;
a clinic in the fields of human medicine; and
a hospital in the fields of human medicine.

11. The medium of claim 10, wherein the method includes work flow processing steps which manage workflow including the submission and storage of laboratory results, wherein the laboratory results from professional outdoor laboratories that are transmitted by email or by another media may be automatically inserted into the patient's record.

12. The medium of claim 10, wherein the method includes work flow processing steps which manage workflow including the submission and storage of laboratory results, wherein the laboratory results from in-house laboratories may be either manually or automatically inserted into the patient's record.

13. The medium of claim 10, wherein the Laboratory module stores pre-entered laboratory reference and optimal values from numerous laboratories and enters them automatically in the patients' record after the user has selected the laboratories' name.

14. The medium of claim 10, wherein the patient medical records' Visit module comprise information:
on total amount money charged;
on amount money paid;
on amount money due;
on medical assessment;
on doctor doing the consultation;
on the name of consultant if a report of this visit has been sent to a consultant; and
date of sending if a report of this visit has been sent to a consultant and button when activated by the user prepares automatically an email addressed to the consultant with the reports' profile information, and field allowing insertion of prior history documents.

15. The medium of claim 10, wherein the patient medical records' Assessment module comprise information on the patients' medical assessment and a field allowing easy insertion of different kinds of documents:
Adobe Acrobat Document;
Clip Multimedia;
Clip Video;
Corel Photo Home Image;
Document WordPad;
Image Bitmap;
Image Paintbrush;
Image Wang;
Microsoft Clip Gallery;
Microsoft Excel Chart;
Microsoft Worksheet;
Microsoft Graph Chart;
Microsoft PowerPoint Presentation;
Microsoft PowerPoint Slide;
Microsoft Word Document;
Microsoft Picture;
Package;
QuickTime Movie;
QuickTime Picture;
Sequence MIDI;
Sound Wave; and
E film.

16. The medium of claim 10, wherein the method schedules backups, by issuing just prior to the shutdown time, a warning message to users informing them that the shutdown time arrives then saves any procedure that is opened and then closes the Database.

17. The medium of claim 10, wherein the method provides a module which contains different kinds fields in which the user may insert in an orderly fashion:
sources;
authors; and
dates, and different kinds of documents:
Adobe Acrobat Document;
Clip Multimedia;
Clip Video;
Corel Photo Home Image;
Document WordPad;
Image Bitmap;
Image Paintbrush;
Image Wang;
Microsoft Clip Gallery;
Microsoft Excel Chart;
Microsoft Worksheet;
Microsoft Graph Chart;
Microsoft PowerPoint Presentation;
Microsoft PowerPoint Slide;
Microsoft Word Document;
Microsoft Picture Package;
QuickTime Movie;
QuickTime Picture;
Sequence MIDI;
Sound Wave; and
E film to look up and have handy the information at all times.

18. The medium of claim 10, wherein the method provides a module which contains different kinds fields in which a company inserts and updates in an orderly fashion:
sources;
authors; and
dates, and different kinds of documents:
Adobe Acrobat Document;
Clip Multimedia;
Clip Video;
Corel Photo Home Image;
Document WordPad;
Image Bitmap;
Image Paintbrush;
Image Wang;
Microsoft Clip Gallery;
Microsoft Excel Chart;
Microsoft Worksheet;
Microsoft Graph Chart;
Microsoft PowerPoint Presentation;
Microsoft PowerPoint Slide;
Microsoft Word Document;
Microsoft Picture Package;
QuickTime Movie;
QuickTime Picture;
Sequence MIDI;
Sound Wave; and
E film, allowing users to look up and have handy any medical document that is relevant for the profession.

19. The medium of claim 10, wherein the method provides fields integrated throughout the software in which the user may insert different kinds of documents:
sources;
authors; and
dates, and different kinds of documents:
Adobe Acrobat Document;
Clip Multimedia;
Clip Video;
Corel Photo Home Image;
Document WordPad;
Image Bitmap;
Image Paintbrush;
Image Wang;
Microsoft Clip Gallery;
Microsoft Excel Chart;
Microsoft Worksheet;
Microsoft Graph Chart;
Microsoft PowerPoint Presentation;
Microsoft PowerPoint Slide;
Microsoft Word Document;
Microsoft Picture Package;
QuickTime Movie;
QuickTime Picture;
Sequence MIDI;
Sound Wave; and
E film, used as extended medical reports and which allow each user to customize the software to personal way of practicing medicine.

20. The medium of claim 10, wherein the method provides a online Real Case Reference Database discussion forum, in which complete reports compliant with:
Problem Oriented Medical Record (P.O.M.R.) system;
Subjective, Objective, Assessment, Plan (S.O.A.P.) record system;
ASMC standards for behaviour medicine; and
AFMC standards for behaviour medicine, each of which is revised and contains recommendations from a consultant specialist in the field, and may be searched by users selecting any criteria in the report and from which statistics may be compiled.

21. The medium of claim 10, wherein the method allows, wherever useful throughout the invention, the user to find a record based on a field, by double clicking on it, which pops up the search menu.

22. The medium of claim 10, wherein the method allows, where ever a telephone number is displayed in the invention, the user to automatically dial up the number by double clicking on it.

23. The medium of claim 10, wherein the method allows, where ever e mail or a website address is displayed in the invention, the user to automatically open, a email message whose destination is the e mail address or to open the web sites home page, by double clicking on it.

24. Claim 24 comprises a computer-readable medium encoded with a method of:
human medical Client Relationship Management(C.R.M.);
veterinary medical Client Relationship Management(C.R.M.);
human medical Enterprise resource planning (E.R.P.); and
veterinary medical Enterprise resource planning (E.R.P.), wherein the method
manages the back office and front office of a medical practice; clinic and hospital.

25. The medium of claim 24, wherein the method provides full control and processing of information on:
employees;
accounting;
suppliers;
services; and
products including medication dosages and full inventory information control and processing with automatic ordering when needed as well as complete traceability of all paid and unpaid invoices including:
when payments have been made;
to whom payments have been made; and
to which employee payments have been made;
in which form payments:
cash;
checks;
bank;
post;
credit cards; and
factoring have been done.

26. The medium of claim 24, wherein the method enables users to view and update:
tasks;
medical cases;
appointments;
sales;
over the counter sales;
phone calls;
faxes;
emails;
letters;
diagnostic procedures; and
therapeutic procedures, and to distribute them with a traceable method (who gave orders to whom and when) among staff members just with a few mouse clicks, and brings the user with a single mouse click from the list of tasks to be accomplished, to the precise location in the patient's record where the procedure should be entered.

27. The medium of claim 24, wherein the method provides a predetermined set of diagnostic procedures, called minimum data base, for each type of patient or problem which covers medical problems:
PUPD;
Dyspnea;
acute vomiting with polysytemic signs;
chronic vomiting;
acute diarrhea with polysytemic signs;
chronic diarrhea;
coughing;
obstetric medical problems;
acute abdomen; and
breast problems, and establishes invoice estimates for recommended treatments and services for these symptomatologies, and also displays a message box that prompts the user to determine choice when prices of a service differs among patients such as radiography dimensions, which are proportional to the patient's size.

28. The medium of claim 24, wherein the method establishes based on the patients record and within seconds, a complete report compliant to:
Problem Oriented Medical Record (P.O.M.R) system;
Subjective, Objective, Assessment, Plan (S.O.AP) record system;
ASMC standards for behaviour medicine; and
AFMC standards for behaviour medicine.

29. The medium of claim 24, wherein the method automatically establishes and sends within seconds a complete report with images compliant to:
Problem Oriented Medical Record (P.O.M.R) system;
Subjective, Objective, Assessment, Plan (S.O.AP) record system;
ASMC standards for behaviour medicine; and
AFMC standards for behaviour medicine to a consultant that is on duty.

30. The medium of claim 24, wherein the method provides Preventive Medicine module that informs the user when:
FVRCP vaccinations;
FIP vaccinations;
Leucosis vaccinations;
Rabies vaccinations;
Tetanus vaccinations;
Tetanus serum;
DHLP vaccinations;
DHLPParvo vaccinations;
Parvo vaccinations;
Leptospirosis vaccinations;
Piroplasmosis vaccinations;
Adeno V vaccinations;
Parainfluensa V vaccinations.;
Bordetella vaccinations;
Corona V vaccinations.;
Lymes vaccinations;
DHLP Parvo serum;
DHLP serum;
Parvo serum;
12 user defined dewormings;
annual Lab check Ups;
and ECG check Ups;
Felv Elisa;
Felv IFA;
Felv PCR;
FIV Elisa;
FIV Western Blot;
radiographies;
FIP Exposure Titer;
FIP Antibody;
FIP specific Elisa;
Vaccines for humans;
Heartworm occult antibody;
Heartworm occult antigen;
Heartworm microscopic examination;
toxoplasmosis IgG;
toxoplasmosis IgM;
Pregnancy dates;
Pregnancy XR evaluations;
Pregnancy echographique examinations;
Pregnancy tests,
Pregnancy preventions;
Blood smear check for presence of Babesia;
Babesia Canis titer;
Babesia Gibsoni titer;
orthopedic evaluations;
neurological evaluations; and
other evaluations pertinent to:
the patient's species;
the patients' gender; and
to the patient, have been and should be done, pointing out any discrepancies from a correct protocol by using a colour code readily visible on the screen and automatically printing reminder letters to be sent to clients informing them of the upcoming due dates for preventive measures.

31. The medium of claim 24, wherein the method provides extended data base module containing context sensitive information inserted by a company and customizable by the user by inserting Information:
descriptions on how to accomplish procedures;
documents that he has scanned;
a link to a streaming tutorial video; and
a link to the Real Case Reference Database discussion forum to view similar cases.

32. The medium of claim 24, wherein the method provides a neurological module that is structured to enter a complete neurological examination, contains tutorial videos that teaches the state of the art neurological examination, and that allows the user to insert:
videos of the patients' neurological examinations;
electro-diagnostic data; and
voice notes.

33. The medium of claim 24, wherein the method provides a surgical module that is structured to enter a complete surgical examination and protocols, and that allows the user to insert:
pictures of the patients' surgeries;
videos of the patients' surgeries; and
voice notes.

34. The medium of claim 24, wherein the method provides a dental module that is structured to enter a complete dental examination and protocols, and that allows the user to insert:
pictures of the patients' dentistries;
videos of the patients' dentistries; and
voice notes.

35. The medium of claim 24, wherein the method provides a medical acts and medical services module that is structured to enter protocols on medical acts and medical services, and that allows the user to insert:
Pictures concerning the medical act and service
videos concerning the medical act and service;
tutorials concerning the medical act and service;
voice notes concerning the medical act and service;
fees concerning the medical act and service; and
documents concerning the medical act and service.

36. The medium of claim 24, wherein the method provides a imaging module containing 379 fields with 22 different document profiles:
Adobe Acrobat Document;
Clip Multimedia;
Clip Video;
Corel Photo Home Image;
Document WordPad;
Image Bitmap;
Image Paintbrush;
Image Wang;
Microsoft Clip Gallery;
Microsoft Excel Chart;
Microsoft Worksheet;
Microsoft Graph Chart;
Microsoft PowerPoint Presentation;
Microsoft PowerPoint Slide;
Microsoft Word Document;
Microsoft Picture Package;
QuickTime Movie;
QuickTime Picture;
Sequence MIDI;
Sound Wave; and
E film, that is structured for automatic insertion of:
radiographies;
cardiac echography;
abdominal echography;
Computer Tomography Scan(CT Scan);
radio-magnetic imaging (IRM);
electrocardiograms (ECGs);
videos;
photos;
protocols on imaging techniques;
tutorials; and
dictated memos, in the patient's record and allowing storage and transmission of these documents through internet.

37. The medium of claim 24, wherein the method provides a grooming for animals and a hairdresser for humans module which is designed to collect all the information as to the grooming and hairdressing, into fields specific for every body part, in form of:
pictures;
films;
vocal notes;
text;
documents on how the animal has been or should be groomed;
documents on how persons' hair cut has been or should be acomplished, and information on current medical problems that are useful knowing when the animal is left at the groomers':
allergies;
cardiac problems; and
epilepsy;
phobias;
aggressions.

38. The medium of claim 24, wherein the method provides a Behaviour Module from which a text formatted Report based on the ASMC and AFMC standards is automatically created from the patients' record and that may be sent via internet.
